(19) United States
(12) Patent Application Publication
(10) Pub. No.: US 2026/0369587 A1
(43) Pub. Date: Nov. 19, 2026

(54) POSITIVE ELECTRODE ACTIVE MATERIAL AND BATTERY

(71) Applicant: SEMICONDUCTOR ENERGY LABORATORY CO., LTD., Atsugi-shi, Kanagawa-ken (JP)

(72) Inventors: Jo SAITO, Atsugi, Kanagawa (JP); Yohei MOMMA, Isehara, Kanagawa (JP); Shuhei YOSHITOMI, Ayase, Kanagawa (JP); Kenta NAKANISHI, Atsugi, Kanagawa (JP); Kousuke SASAKI, Atsugi, Kanagawa (JP); Tatsuyoshi TAKAHASHI, Atsugi, Kanagawa (JP)

(21) Appl. No.: 19/148,395

(22) PCT Filed: Feb. 29, 2024
(86) PCT No.: PCT/IB2024/051939

§ 371 Date: Jul. 16, 2025

(30) Foreign Application Priority Data
Mar. 7, 2023 (JP) 2023-034998
Aug. 30, 2023 (JP) 2023-140351
Oct. 16, 2023 (JP) 2023-178317
Dec. 22, 2023 (JP) 2023-216382

(51) Int. Cl. H01M 4/525; C01G 51/42; H01M 10/0525; H01M 10/0569

(52) U.S. Cl. CPC H01M 4/525; C01G 51/42; H01M 10/0525; H01M 10/0569; C01P 2002/74; C01P 2004/03; C01P 2004/61; H01M 2300/004

(57) ABSTRACT

A novel positive electrode active material is provided. A secondary battery with favorable charge/discharge performance is provided. In a battery including a positive electrode, the positive electrode includes lithium cobalt oxide; a surface portion of the lithium cobalt oxide includes magnesium, titanium, aluminum, and nickel; the surface portion is a region at less than or equal to 50 nm from a surface of the lithium cobalt oxide; and when the surface portion is subjected to STEM-EDX line analysis in a depth direction, a peak of the magnesium is closer to the surface of the lithium cobalt oxide than a peak of the aluminum.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a power storage device including a secondary battery, a semiconductor device, a display device, a light-emitting device, a lighting device, an electronic device, or a manufacturing method thereof.

Electronic devices in this specification refer to all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry, and the lithium-ion secondary batteries are essential as rechargeable energy supply sources for today's information society.

In particular, secondary batteries for mobile electronic devices, for example, are highly demanded to have high discharge capacity per weight and excellent cycling performance. In order to meet such demands, positive electrode active materials included in positive electrodes of secondary batteries have been actively improved (e.g., Patent Document 1 and Patent Document 2). In addition, a crystal structure of a positive electrode active material has also been studied (Non-Patent Document 1 to Non-Patent Document 3).

X-ray diffraction (XRD) is a method used for analysis of the crystal structure of a positive electrode active material. With the use of the ICSD (Inorganic Crystal Structure Database) described in Non-Patent Document 4, XRD data can be analyzed. For example, the ICSD can be referred to for the lattice constant of lithium cobalt oxide described in Non-Patent Document 5. For Rietveld analysis, the analysis program RIETAN-FP (Non-Patent Document 6) can be used, for example. As software for drawing crystal structures, VESTA (Non-Patent Document 7) can be used.

As image processing software, for example, ImageJ (Non-Patent Document 8 to Non-Patent Document 10) is known. Using this software makes it possible to analyze the shape of a positive electrode active material, for example.

Nanobeam electron diffraction can also be effectively used to identify the crystal structure of a positive electrode active material, in particular, the crystal structure of a surface portion of the positive electrode active material. For analysis of electron diffraction patterns, an analysis program called ReciPro (Non-Patent Document 11) can be used, for example.

### REFERENCES

### Patent Documents

[Patent Document 1] Japanese Published Patent Application No. 2018-206747
[Patent Document 2] Japanese Published Patent Application No. 2022-070247

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, p. 17340-17348
[Non-Patent Document 2]T. Motohashi, et al., “Electronic phase diagram of the layered cobalt oxide system LiₓCoO₂ (0.0≤x≤1.0)”, Physical Review B, 80 (16); 165114
[Non-Patent Document 3] Zhaohui Chen et al., “Staging Phase Transitions in LiₓCoO₂”, Journal of The Electrochemical Society, 2002, 149 (12) A1604-A1609
[Non-Patent Document 4]A. Belsky, et al., “New developments in the Inorganic Crystal Structure Database (ICSD): accessibility in support of materials research and design”, Acta Cryst., (2002) B58 364-369.
[Non-Patent Document 5]J. Akimoto, Y. Gotoh, Y. Oosawa “Synthesis and structure refinement of LiCoO₂ single crystals” Journal of Solid State Chemistry (1998) 141, p. 298-302.
[Non-Patent Document 6]F. Izumi and K. Momma, “Three-Dimensional Visualization in Powder Diffraction” Solid State Phenom. 130, 15-20 (2007)
[Non-Patent Document 7]K. Momma and F. Izumi, “VESTA 3 for three-dimensional visualization of crystal, volumetric and morphology data” J. Appl. Cryst. (2011). 44, 1272-1276
[Non-Patent Document 8] Rasband, W. S., ImageJ, U. S. National Institutes of Health, Bethesda, Maryland, USA, http://rsb.info.nih.gov/ij/, 1997-2012.
[Non-Patent Document 9] Schneider, C. A., Rasband, W. S., Eliceiri, K. W. “NIH Image to ImageJ: 25 years of image analysis”. Nature Methods 9, 671-675, 2012.
[Non-Patent Document 10] Abramoff, M. D., Magelhaes, P. J., Ram, S. J. “Image Processing with ImageJ”. Biophotonics International, volume 11, issue 7, pp. 36-42, 2004.
[Non-Patent Document 11] Seto, Y. & Ohtsuka, M., “ReciPro: free and open-source multipurpose crystallographic software integrating a crystal model database and viewer, diffraction and microscopy simulators, and diffraction data analysis tools” (2022). J. Appl. Cryst. 55.

### SUMMARY OF THE INVENTION

### Problems to be Solved by the Invention

There is room for improvement in a variety of aspects of lithium-ion secondary batteries, such as discharge capacity, cycling performance, reliability, safety, and cost. For example, in order to inhibit a change in the crystal structure on the surface of a positive electrode active material, the surface of the positive electrode active material is coated with an inert oxide, in which case the coating film might inhibit insertion and extraction of lithium. Inhibiting insertion and extraction of lithium ions might reduce secondary battery characteristics, e.g., reduce rate performance and reduce charge/discharge capacity in a low-temperature environment.

In view of the above, an object of one embodiment of the present invention is to provide a positive electrode active material that can be used for a lithium-ion secondary battery and in which insertion and extraction of lithium ions are promoted. Another object is to provide a positive electrode active material or a composite oxide that inhibits a decrease in discharge capacity in a low-temperature environment. Another object is to provide a positive electrode active material or a composite oxide that inhibits a decrease in discharge capacity during rapid discharging. Another object is to provide a positive electrode active material or a composite oxide that inhibits a decrease in discharge capacity in charge/discharge cycles. Another object is to provide a positive electrode active material or a composite oxide having a crystal structure that is unlikely to be broken by repeated charging and discharging. Another object is to provide a positive electrode active material or a composite oxide enabling high discharge capacity. Another object is to provide a secondary battery or a vehicle with high safety or high reliability.

Another object of one embodiment of the present invention is to provide a positive electrode active material, a composite oxide, a power storage device, or a manufacturing method thereof.

The description of these objects does not preclude the existence of other objects. One embodiment of the present invention does not need to achieve all these objects. Other objects can be derived from the descriptions of the specification, the drawings, and the claims.

### Means for Solving the Problems

In order to solve the above objects, one embodiment of the present invention provides lithium cobalt oxide containing magnesium, nickel, aluminum, and titanium in a surface portion. In particular, magnesium, nickel, and titanium are preferably present in a region (referred to as an edge region) having a plane (also referred to as an edge plane or a plane other than a (001) plane of lithium cobalt oxide) where the diffusion path of lithium is exposed.
(1-1) One embodiment of the present invention is a battery which includes a positive electrode and in which the positive electrode includes lithium cobalt oxide; a surface portion of the lithium cobalt oxide includes magnesium, titanium, aluminum, and nickel; the surface portion is a region at less than or equal to 50 nm from a surface of the lithium cobalt oxide; and when the surface portion is subjected to STEM-EDX line analysis in a depth direction, a peak of the magnesium is closer to the surface of the lithium cobalt oxide than a peak of the aluminum.
(1-2) In (1-1) above, the lithium cobalt oxide preferably has a layered rock-salt crystal structure belonging to a space group R-3m; the surface portion preferably includes a basal region having a surface parallel to a (001) plane of the crystal structure and an edge region having a surface in a direction intersecting with the (001) plane; the edge region preferably includes the titanium; and when the surface portion is subjected to the STEM-EDX line analysis in the depth direction, the edge region preferably includes a region in which a distribution of the magnesium and a distribution of the titanium overlap with each other.
(1-3) In (1-2) above, the edge region preferably includes the nickel; and when the surface portion is subjected to the STEM-EDX line analysis in the depth direction, the edge region preferably includes a region in which the distribution of the titanium and a distribution of the nickel overlap with each other.
(1-4) Alternatively, in (1-1) above, the lithium cobalt oxide preferably has a layered rock-salt crystal structure belonging to a space group R-3m; the surface portion preferably includes a basal region having a surface parallel to a (001) plane of the crystal structure and an edge region having a surface in a direction intersecting with the (001) plane; the edge region preferably includes the titanium; and when the surface portion is subjected to the STEM-EDX line analysis in the depth direction, the edge region preferably includes a region in which a difference between a depth of a peak of a detection amount of the magnesium and a depth of a peak of a detection amount of the titanium is less than or equal to 3 nm.
(1-5) In (1-4) above, the edge region preferably includes the nickel; and when the surface portion is subjected to the STEM-EDX line analysis in the depth direction, the edge region preferably includes a region in which a difference between the depth of the peak of the detection amount of the titanium and a depth of a peak of a detection amount of the nickel is less than or equal to 3 nm.
(1-6) In any one of (1-2) to (1-5) above, an angle between a line normal to the surface of the edge region and a line perpendicular to the (001) plane is preferably greater than or equal to 500 and less than or equal to 90°, further preferably greater than or equal to 70° and less than or equal to 90°.
(1-7) In any one of (1-1) to (1-5) above, volume resistivity of powder of the lithium cobalt oxide is preferably higher than or equal to 1.0×10⁸ Ω·cm and lower than or equal to 1.0×10¹⁰ Ω·cm, further preferably higher than or equal to 5.0×10⁸ Ω·cm and lower than or equal to 1.5×10⁹ Ω·cm under a pressure of 64 MPa.
(1-8) In any one of (1-1) to (1-5) above, when the lithium cobalt oxide is subjected to particle size distribution analysis using a cross-sectional SEM image of the positive electrode including the lithium cobalt oxide, as a particle diameter of the lithium cobalt oxide, D50 is preferably greater than or equal to 1.98 μm and less than or equal to 2.26 μm and D90 is preferably greater than or equal to 4.37 μm and less than or equal to 5.51 μm.
(1-9) In any one of (1-1) to (1-5) above, the battery preferably includes an electrolyte including lithium hexafluorophosphate, ethylene carbonate, ethyl methyl carbonate, and dimethyl carbonate; and when a volume ratio between the ethylene carbonate, the ethyl methyl carbonate, and the dimethyl carbonate is x:y:100-x-y (where 5≤x≤35 and 0<y<65) with volumes of contents of the ethylene carbonate, the ethyl methyl carbonate, and the dimethyl carbonate being 100 vol %, discharge capacity at −20 °C is preferably greater than or equal to 95.0% of discharge capacity at 25 °C.
   (2-1) One embodiment of the present invention is a battery which includes a positive electrode and in which the positive electrode includes lithium cobalt oxide; a surface portion of the lithium cobalt oxide includes magnesium, titanium, aluminum, and nickel; the surface portion is a region at less than or equal to 50 nm from a surface of the lithium cobalt oxide; when the surface portion is subjected to STEM-EDX line analysis in a depth direction, a peak of the magnesium is closer to the surface of the lithium cobalt oxide than a peak of the aluminum; and when the battery charged until an open circuit voltage reaches higher than or equal to 4.50 V and lower than or equal to 4.60 V is subjected to discharging at a current of 6 mA/g per weight of the lithium cobalt oxide for one second, resistance DCIR obtained by dividing a difference between the open circuit voltage and a voltage during the discharging by the current is lower than or equal to 35Ω.
(2-2) In (2-1) above, the lithium cobalt oxide preferably has a layered rock-salt crystal structure belonging to a space group R-3m; the surface portion preferably includes a basal region having a surface parallel to a (001) plane of the crystal structure and an edge region having a surface in a direction intersecting with the (001) plane; the edge region preferably includes the titanium; and when the surface portion is subjected to the STEM-EDX line analysis in the depth direction, the edge region preferably includes a region in which a distribution of the magnesium and a distribution of the titanium overlap with each other.
(2-3) In (2-2) above, the edge region preferably includes the nickel; and when the surface portion is subjected to the STEM-EDX line analysis in the depth direction, the edge region preferably includes a region in which the distribution of the titanium and a distribution of the nickel overlap with each other.
(2-4) Alternatively, in (2-1) above, the lithium cobalt oxide preferably has a layered rock-salt crystal structure belonging to a space group R-3m; the surface portion preferably includes a basal region having a surface parallel to a (001) plane of the crystal structure and an edge region having a surface in a direction intersecting with the (001) plane; the edge region preferably includes the titanium; and when the surface portion is subjected to the STEM-EDX line analysis in the depth direction, the edge region preferably includes a region in which a difference between a depth of a peak of a detection amount of the magnesium and a depth of a peak of a detection amount of the titanium is less than or equal to 3 nm.
(2-5) In (2-4) above, the edge region preferably includes the nickel; and when the surface portion is subjected to the STEM-EDX line analysis in the depth direction, the edge region preferably includes a region in which a difference between the depth of the peak of the detection amount of the titanium and a depth of a peak of a detection amount of the nickel is less than or equal to 3 nm.
(2-6) In any one of (2-2) to (2-5) above, an angle between a line normal to the surface of the edge region and a line perpendicular to the (001) plane is preferably greater than or equal to 500 and less than or equal to 90°, further preferably greater than or equal to 70° and less than or equal to 90°.
(2-7) In any one of (2-1) to (2-5) above, volume resistivity of powder of the lithium cobalt oxide is preferably higher than or equal to 1.0×10⁸ Ω·cm and lower than or equal to 1.0×10¹⁰ Ω·cm, further preferably higher than or equal to 5.0×10⁸ Ω·cm and lower than or equal to 1.5×10⁹ Ω·cm under a pressure of 64 MPa.
(2-8) In any one of (2-1) to (2-5) above, when the lithium cobalt oxide is subjected to particle size distribution analysis using a cross-sectional SEM image of the positive electrode including the lithium cobalt oxide, as a particle diameter of the lithium cobalt oxide, D50 is preferably greater than or equal to 1.98 μm and less than or equal to 2.26 μm and D90 is preferably greater than or equal to 4.37 μm and less than or equal to 5.51 μm.
(2-9) In any one of (2-1) to (2-5) above, the battery preferably includes an electrolyte including lithium hexafluorophosphate, ethylene carbonate, ethyl methyl carbonate, and dimethyl carbonate; and when a volume ratio between the ethylene carbonate, the ethyl methyl carbonate, and the dimethyl carbonate is x:y:100-x-y (where 5≤x≤35 and 0<y<65) with volumes of contents of the ethylene carbonate, the ethyl methyl carbonate, and the dimethyl carbonate being 100 vol %, discharge capacity at −20 °C is preferably greater than or equal to 95.0% of discharge capacity at 25 °C.
(2-10) One embodiment of the present invention is a battery which includes a positive electrode and in which the positive electrode includes lithium cobalt oxide; a surface portion of the lithium cobalt oxide includes magnesium, titanium, aluminum, and nickel; the surface portion is a region at less than or equal to 50 nm from a surface of the lithium cobalt oxide; when the surface portion is subjected to STEM-EDX line analysis in a depth direction, a peak of the magnesium is closer to the surface of the lithium cobalt oxide than a peak of the aluminum; and when a test battery formed using the lithium cobalt oxide for a positive electrode, a lithium metal for a negative electrode, and an electrolyte solution in which 1 mol/L lithium hexafluorophosphate (LiPF₆) is a lithium salt and ethylene carbonate (EC) and diethyl carbonate (DEC) at EC:DEC=3:7 (volume ratio) and 2 wt % vinylene carbonate (VC) are mixed is subjected to constant current charging at a current value of 100 mA/g to a voltage of 4.60 V, subsequent constant voltage charging to a current value of 10 mA/g, and subsequent discharging at a current of 6 mA/g for one second in a 45 °C environment, resistance DCIR obtained by dividing a difference between a voltage before the discharging and a voltage during the discharging by the current is lower than or equal to 35 12.
(3-1) One embodiment of the present invention is a positive electrode active material which includes lithium cobalt oxide and in which the positive electrode active material includes magnesium, nickel, titanium, and aluminum; when STEM-EDX line analysis in a depth direction is performed from a surface of a particle of the positive electrode active material, the particle includes a region in which a position at which a concentration of the aluminum becomes maximum is closer to an inner portion than a position at which a concentration of the magnesium becomes maximum, a position at which a concentration of the nickel becomes maximum, and a position at which a concentration of the titanium becomes maximum; in the region, the position at which the concentration of the nickel becomes maximum and the position at which the concentration of the titanium becomes maximum are positioned at less than or equal to 3 nm from the position at which the concentration of the magnesium becomes maximum; and when the particle is subjected to EPMA analysis, in the inner portion of the particle, a ratio (Mg/Co) of the number of atoms of the magnesium to the number of atoms of cobalt is greater than or equal to 0.003 and less than or equal to 0.01, and a ratio (Ni/Co) of the number of atoms of the nickel to the number of the atoms of the cobalt is greater than or equal to 0.003 and less than or equal to 0.01.
(3-2) In (3-1) above, the lithium cobalt oxide preferably has a layered rock-salt crystal structure belonging to a space group R-3m; the above particle preferably includes a surface portion and the inner portion; the surface portion preferably includes a basal region having a surface parallel to a (001) plane of the crystal structure and an edge region having a surface in a direction intersecting with the (001) plane; and the above region is preferably included in the edge region.
(3-3) In (3-1) or (3-2) above, when the positive electrode active material is subjected to XPS analysis, the ratio (Mg/Co) of the number of the atoms of the magnesium to the number of the atoms of the cobalt is preferably greater than or equal to 0.40 and less than or equal to 1.50, a ratio (Ti/Co) of the number of atoms of the titanium to the number of the atoms of the cobalt is preferably greater than or equal to 0.05 and less than or equal to 0.20, and the ratio (Ni/Co) of the number of the atoms of the nickel to the number of the atoms of the cobalt is preferably greater than or equal to 0.05 and less than or equal to 0.20.
(3-4) Another embodiment of the present invention is a battery which includes a positive electrode and in which the positive electrode includes a positive electrode active material layer; the positive electrode active material layer includes a positive electrode active material particle including magnesium, titanium, nickel, aluminum, and lithium cobalt oxide; when STEM-EDX line analysis in a depth direction is performed from a surface of the positive electrode active material particle included in the positive electrode active material layer, the positive electrode active material particle includes a region in which a position at which a concentration of the aluminum becomes maximum is closer to an inner portion than a position at which a concentration of the magnesium becomes maximum, a position at which a concentration of the nickel becomes maximum, and a position at which a concentration of the titanium becomes maximum; in the region, the position at which the concentration of the nickel becomes maximum and the position at which the concentration of the titanium becomes maximum are positioned at less than or equal to 3 nm from the position at which the concentration of the magnesium becomes maximum; and when the positive electrode active material particle included in the positive electrode active material layer is subjected to EPMA analysis, in the inner portion of the positive electrode active material particle, a ratio (Mg/Co) of the number of atoms of the magnesium to the number of atoms of cobalt is greater than or equal to 0.003 and less than or equal to 0.01, and a ratio (Ni/Co) of the number of atoms of the nickel to the number of the atoms of the cobalt is greater than or equal to 0.003 and less than or equal to 0.01.
(3-5) In (3-4) above, the lithium cobalt oxide preferably has a layered rock-salt crystal structure belonging to a space group R-3m; the above particle preferably includes a surface portion and the inner portion; the surface portion preferably includes a basal region having a surface parallel to a (001) plane of the crystal structure and an edge region having a surface in a direction intersecting with the (001) plane; and the above region is preferably included in the edge region.
(3-6) In (3-4) or (3-5) above, when a plurality of the positive electrode active material particles included in the positive electrode active material layer are subjected to XPS analysis, the ratio (Mg/Co) of the number of the atoms of the magnesium to the number of the atoms of the cobalt is preferably greater than or equal to 0.40 and less than or equal to 1.50, a ratio (Ti/Co) of the number of atoms of the titanium to the number of the atoms of the cobalt is preferably greater than or equal to 0.05 and less than or equal to 0.20, and the ratio (Ni/Co) of the number of the atoms of the nickel to the number of the atoms of the cobalt is preferably greater than or equal to 0.05 and less than or equal to 0.20.

### Effect of the Invention

According to one embodiment of the present invention, a positive electrode active material or a composite oxide that can be used in a lithium-ion secondary battery and that inhibits a decrease in discharge capacity in a low-temperature environment can be provided. Alternatively, a positive electrode active material or a composite oxide that inhibits a decrease in discharge capacity during rapid discharging can be provided. Alternatively, a positive electrode active material or a composite oxide that inhibits a decrease in discharge capacity in charge/discharge cycles can be provided. Alternatively, a positive electrode active material or a composite oxide having a crystal structure that is unlikely to be broken by repeated charging and discharging can be provided. Alternatively, a positive electrode active material or a composite oxide enabling high discharge capacity can be provided. Alternatively, a secondary battery or a vehicle with high safety or high reliability can be provided.

According to another embodiment of the present invention, a positive electrode active material, a composite oxide, a power storage device, or a manufacturing method thereof can be provided.

The description of these effects does not preclude the existence of other effects. One embodiment of the present invention does not need to have all these effects. Other effects will be apparent from the descriptions of the specification, the drawings, the claims, and the like, and other effects can be derived from the descriptions of the specification, the drawings, the claims, and the like.

### BRIEF DESCRIPTION OF THE DRAWINGS

FIG. 1A is a cross-sectional view of a positive electrode active material, and FIG. 1B and FIG. 1C are diagrams showing distributions of additive elements in the positive electrode active material.

FIG. 2A and FIG. 2B are diagrams showing results of DSC analysis.

FIG. 3 is an example of a TEM image showing crystal orientations substantially aligned with each other.

FIG. 4A is an example of a STEM image showing crystal orientations substantially aligned with each other. FIG. 4B shows an FFT pattern of a region of a rock-salt crystal RS, and FIG. 4C shows an FFT pattern of a region of a layered rock-salt crystal LRS.

FIG. 5 is a diagram showing crystal structures of a positive electrode active material.

FIG. 6 is a diagram showing crystal structures of a conventional positive electrode active material.

FIG. 7 is a diagram showing XRD patterns calculated from crystal structures.

FIG. 8 is a diagram showing XRD patterns calculated from crystal structures.

FIG. 9A and FIG. 9B are diagrams showing XRD patterns calculated from crystal structures.

FIG. 10A, FIG. 10B, FIG. 10C, FIG. 10D, FIG. 10E, FIG. 10F, and FIG. 10G are diagrams showing positional relations of distributions according to EDX line analysis.

FIG. 11 is a cross-sectional view of a positive electrode active material.

FIG. 12 is a diagram showing a formation method of a positive electrode active material.

FIG. 13A to FIG. 13C are diagrams showing a formation method of a positive electrode active material.

FIG. 14A and FIG. 14B are diagrams showing a formation method of a positive electrode active material.

FIG. 15 is a diagram showing the appearance of a secondary battery.

FIG. 16A to FIG. 16C are diagrams showing a fabrication method of a secondary battery.

FIG. 17A to FIG. 17H are diagrams showing examples of electronic devices.

FIG. 18A to FIG. 18D are diagrams showing examples of electronic devices.

FIG. 19A to FIG. 19C are diagrams showing examples of electronic devices.

FIG. 20A to FIG. 20C are diagrams showing examples of vehicles.

FIG. 21A to FIG. 21D are calculation model diagrams.

FIG. 22A to FIG. 22F are surface SEM images of positive electrode active materials.

FIG. 23 is a graph showing results of XRD analysis of positive electrode active materials.

FIG. 24A and FIG. 24B are diagrams showing EPMA analysis points of positive electrode active materials.

FIG. 25A to FIG. 25C are diagrams showing results of cross-sectional STEM-EDX analysis of a positive electrode active material.

FIG. 26A and FIG. 26B are diagrams showing results of cross-sectional STEM-EDX analysis of a positive electrode active material.

FIG. 27A to FIG. 27D are diagrams showing results of cross-sectional STEM-EDX analysis of a positive electrode active material.

FIG. 28A to FIG. 28D are diagrams showing results of cross-sectional STEM-EDX analysis of a positive electrode active material.

FIG. 29A to FIG. 29C are diagrams showing results of cross-sectional STEM-EDX analysis of a positive electrode active material.

FIG. 30A and FIG. 30B are diagrams showing results of cross-sectional STEM-EDX analysis of a positive electrode active material.

FIG. 31A to FIG. 31D are diagrams showing results of cross-sectional STEM-EDX analysis of a positive electrode active material.

FIG. 32A to FIG. 32D are diagrams showing results of cross-sectional STEM-EDX analysis of a positive electrode active material.

FIG. 33A to FIG. 33C are diagrams showing results of cross-sectional STEM-EDX analysis of a positive electrode active material.

FIG. 34A and FIG. 34B are diagrams showing results of cross-sectional STEM-EDX analysis of a positive electrode active material.

FIG. 35A to FIG. 35D are diagrams showing results of cross-sectional STEM-EDX analysis of a positive electrode active material.

FIG. 36A to FIG. 36D are diagrams showing results of cross-sectional STEM-EDX analysis of a positive electrode active material.

FIG. 37A to FIG. 37C are diagrams showing results of cross-sectional STEM-EDX analysis of a positive electrode active material.

FIG. 38A and FIG. 38B are diagrams showing results of cross-sectional STEM-EDX analysis of a positive electrode active material.

FIG. 39A to FIG. 39D are diagrams showing results of cross-sectional STEM-EDX analysis of a positive electrode active material.

FIG. 40A to FIG. 40D are diagrams showing results of cross-sectional STEM-EDX analysis of a positive electrode active material.

FIG. 41A to FIG. 41C are diagrams showing results of cross-sectional STEM-EDX analysis of a positive electrode active material.

FIG. 42A and FIG. 42B are diagrams showing results of cross-sectional STEM-EDX analysis of a positive electrode active material.

FIG. 43A to FIG. 43D are diagrams showing results of cross-sectional STEM-EDX analysis of a positive electrode active material.

FIG. 44A to FIG. 44D are diagrams showing results of cross-sectional STEM-EDX analysis of a positive electrode active material.

FIG. 45A to FIG. 45C are diagrams showing results of cross-sectional STEM-EDX analysis of a positive electrode active material.

FIG. 46A to FIG. 46D are diagrams showing results of cross-sectional STEM-EDX analysis of a positive electrode active material.

FIG. 47A to FIG. 47D are diagrams showing results of cross-sectional STEM-EDX analysis of a positive electrode active material.

FIG. 48A to FIG. 48C are diagrams showing results of cross-sectional STEM-EDX analysis of a positive electrode active material.

FIG. 49A and FIG. 49B are diagrams showing results of cross-sectional STEM-EDX analysis of a positive electrode active material.

FIG. 50A to FIG. 50E are diagrams showing results of cross-sectional STEM-EDX analysis of a positive electrode active material.

FIG. 51A to FIG. 51E are diagrams showing results of cross-sectional STEM-EDX analysis of a positive electrode active material.

FIG. 52A and FIG. 52B are cross-sectional SEM images of positive electrodes.

FIG. 53A and FIG. 53B are diagrams showing image analysis of cross-sectional SEM images.

FIG. 54A and FIG. 54B show charge/discharge curves in low-temperature charge/discharge tests.

FIG. 55A and FIG. 55B show charge/discharge curves in low-temperature charge/discharge tests.

FIG. 56A and FIG. 56B show charge/discharge curves in low-temperature charge/discharge tests.

FIG. 57A and FIG. 57B show charge/discharge curves in low-temperature charge/discharge tests.

FIG. 58 shows charge/discharge curves in low-temperature charge/discharge tests.

FIG. 59 is a graph showing results of charge rate tests.

FIG. 60A and FIG. 60B are graphs showing results of charge rate tests.

FIG. 61 is a graph showing results of discharge rate tests.

FIG. 62A and FIG. 62B are graphs showing results of discharge rate tests.

FIG. 63A and FIG. 63B are graphs showing results of charge/discharge cycling tests.

FIG. 64A and FIG. 64B are graphs showing results of charge/discharge cycling tests.

FIG. 65 is a graph showing results of charge/discharge cycling tests.

FIG. 66A and FIG. 66B are graphs showing results of charge/discharge cycling tests.

FIG. 67 is a graph showing results of charge/discharge cycling tests.

FIG. 68A and FIG. 68B are graphs showing results of charge/discharge cycling tests.

FIG. 69A and FIG. 69B are graphs showing results of charge/discharge cycling tests.

FIG. 70A and FIG. 70B are graphs showing results of charge/discharge cycling tests.

FIG. 71A and FIG. 71B are graphs showing results of charge/discharge cycling tests.

FIG. 72A and FIG. 72B are graphs showing results of charge/discharge cycling tests.

FIG. 73A and FIG. 73B are graphs showing results of charge/discharge cycling tests.

FIG. 74A and FIG. 74B are graphs showing results of charge/discharge cycling tests.

FIG. 75A and FIG. 75B are graphs showing results of charge/discharge cycling tests.

FIG. 76A and FIG. 76B are graphs showing results of charge/discharge cycling tests.

FIG. 77A and FIG. 77B are graphs showing results of charge/discharge cycling tests.

FIG. 78A and FIG. 78B are graphs showing results of charge/discharge cycling tests.

FIG. 79A and FIG. 79B are graphs showing results of charge/discharge cycling tests.

FIG. 80A and FIG. 80B are diagrams showing changes in charge/discharge curves in charge/discharge cycling tests.

FIG. 81 is a graph showing results of XRD analysis of positive electrode active materials in a high-voltage charged state.

FIG. 82A and FIG. 82B are graphs showing results of XRD analysis of positive electrode active materials in a high-voltage charged state.

### MODE FOR CARRYING OUT THE INVENTION

Examples of embodiments for carrying out the present invention will be described below with reference to the drawings and the like. Note that the present invention should not be interpreted as being limited to the examples of embodiments given below. Embodiments for carrying out the invention can be changed unless they deviate from the spirit of the present invention.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “-” (a minus sign) in front of the number instead of placing a bar over the number. Furthermore, an individual direction that shows an orientation in a crystal is denoted with “[ ]”, a set direction that shows all of the equivalent orientations is denoted with “< >”, an individual plane that shows a crystal plane is denoted with “( )”, and a set plane having equivalent symmetry is denoted with “{ }”. A trigonal system represented by the space group R-3m is generally represented by a composite hexagonal lattice for easy understanding of the structure in some cases. In some cases, not only (hkl) but also (hkil) is used as the Miller index. Here, i is −(h+k). In this specification and the like, a crystal plane or the like in the space group R-3m is represented with use of a composite hexagonal lattice, unless otherwise specified.

The space group of a crystal structure is identified by XRD, electron diffraction, neutron diffraction, or the like. Thus, in this specification and the like, the term “being attributed to a space group”, “belonging to a space group”, or “being a space group” can be rephrased as being identified as the space group.

Furthermore, when the arrangement of anions is close to a cubic close-packed structure, the arrangement can be regarded as the cubic close-packed structure. The arrangement of anions forming the cubic close-packed structure refers to a state where, above voids between anions packed in the first layer, anions in the second layer are positioned, and anions in the third layer are placed at the positions that are right above voids between the anions in the second layer and are not right above the anions in the first layer. Accordingly, anions do not necessarily form a cubic lattice structure. In addition, actual crystals always have a defect and thus, analysis results are not necessarily consistent with the theory. For example, in an electron diffraction pattern or an FFT (Fast Fourier Transform) pattern of a TEM (Transmission Electron Microscope) image or the like, a spot may appear in a position different from a theoretical position. For example, anions can be regarded as forming a cubic close-packed structure when the difference in orientation from a theoretical position is less than or equal to 5° or less than or equal to 2.5°.

In this specification and the like, the term “particle” is sometimes used to describe the shape of an active material or a conductive material, which may be a spherical shape (with a circular cross section). In this specification and the like, an active material or a conductive material does not necessarily have a spherical shape and may have an elliptical cross-sectional shape, a rectangular cross-sectional shape, a trapezoidal cross-sectional shape, a triangular cross-sectional shape, a quadrangular cross-sectional shape with rounded corners, an asymmetrical cross-sectional shape, or the like; furthermore, a particle may have an indefinite shape.

In this specification and the like, description including a simple term “positive electrode active material” explains a plurality of positive electrode active material particles in some cases and explains one positive electrode active material particle in other cases, depending on an analysis method or the like. For example, when description relates to various observations by a TEM, various observations by a STEM (Scanning Transmission Electron Microscope), electron diffraction, STEM-EDX (Energy Dispersive X-ray Spectroscopy), or STEM-EELS (Electron Energy Loss Spectroscopy), the description is made on one positive electrode active material particle unless otherwise specified. Meanwhile, when description relates to analysis such as XPS, XRD, ICP-MS (Inductively Coupled Plasma Mass Spectrometry), or GD-MS (Glow Discharge Mass Spectrometry), the description is made on a plurality of positive electrode active material particles unless the analysis target is otherwise specified. Note that the above description of a positive electrode active material and a positive electrode active material particle applies to the case where a material name such as lithium cobalt oxide is referred to; depending on the analysis method or the like, a plurality of lithium cobalt oxide particles are described in some cases, and one lithium cobalt oxide particle is described in other cases.

The theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material is represented by x in a compositional formula, e.g., x in LiₓMO₂ (here, Mis one or more selected from cobalt, nickel, and manganese). In the case of a positive electrode active material in a secondary battery, x=(theoretical capacity−charge capacity)/theoretical capacity can be satisfied. For example, in the case where a secondary battery including LiMO₂ as a positive electrode active material is charged to 219.2 mAh/g, the positive electrode active material can be represented by Li_{0.2}MO₂ or x=0.2. The expression “x in LiMO₂ is small” means, for example, 0.1<x≤0.24. The amount of lithium extracted from a positive electrode active material with respect to the theoretical capacity is sometimes represented by a charge depth. In this specification and the like, the charge depth of LiₓMO₂ is “1-x”.

For example, lithium cobalt oxide to be used for a positive electrode, which has been appropriately synthesized and almost satisfies the stoichiometric proportion, is LiCoO₂ with x=1. Lithium cobalt oxide contained in a secondary battery after its discharging ends can also be LiCoO₂ with x=1. Here, the expression “discharging ends” means that the voltage becomes lower than or equal to 3.00 V or lower than or equal to 2.50 V at a current lower than or equal to 100 mA/g, for example.

Charge capacity and/or discharge capacity used for calculation of x in LiₓMO₂ are/is preferably measured under the conditions where there is no influence or small influence of a short circuit and/or decomposition of an electrolyte solution or the like. For example, data of a secondary battery containing a sudden capacity change that seems to result from a short circuit should not be used for calculation of x.

The distribution of an element refers to a region where the element is successively detected by a successive analysis method to the extent that the detection value is no longer on the noise level. The region where the element is successively detected to the extent that the detection value is no longer on the noise level can be rephrased as, for example, a region where the element is surely detected when the analysis is performed a plurality of times.

A positive electrode active material to which an additive element is added is sometimes referred to as a composite oxide, a positive electrode member, a positive electrode material, a secondary battery positive electrode member, or the like.

In the case where the features of individual particles of a positive electrode active material are described in the following embodiments and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

The voltage (potential) of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a decrease in charge/discharge capacity due to repeated charging and discharging.

The description is made on the assumption that materials (such as a positive electrode active material, a negative electrode active material, an electrolyte, and a separator) included in a secondary battery have not been degraded unless otherwise specified. A decrease in discharge capacity due to aging treatment and burn-in treatment during the fabrication process of a secondary battery is not regarded as degradation. For example, a state where discharge capacity is greater than or equal to 97% of the rated capacity of a lithium-ion secondary battery cell and an assembled lithium-ion secondary battery (hereinafter, referred to as a lithium-ion secondary battery) can be regarded as anon-degraded state. The rated capacity conforms to JIS C 8711:2019 in the case of a lithium-ion secondary battery for a portable device. The rated capacities of other lithium-ion secondary batteries conform to JIS described above, JIS for electric vehicle propulsion, industrial use, and the like, standards defined by IEC, and the like.

In this specification and the like, in some cases, materials that are included in a secondary battery and that have not been degraded are referred to as initial products or materials in an initial state, and materials that have been degraded (have discharge capacity less than 97% of the rated capacity of the secondary battery) are referred to as products in use, materials in a used state, products that are already used, or materials in an already-used state.

### Embodiment 1

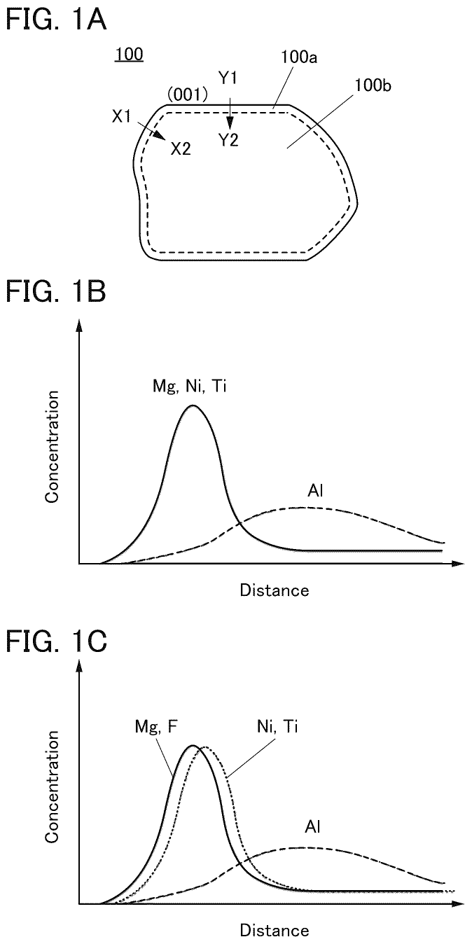

In this embodiment, a positive electrode active material of one embodiment of the present invention will be described with reference to FIG. 1 to FIG. 11.

The positive electrode active material of one embodiment of the present invention includes one or more of “lithium cobalt oxide to which magnesium and titanium are added”, “lithium cobalt oxide to which magnesium, titanium, and fluorine are added”, “lithium cobalt oxide to which magnesium, nickel, and titanium are added”, “lithium cobalt oxide to which magnesium, nickel, titanium, and fluorine are added”, “lithium cobalt oxide to which magnesium, nickel, aluminum, and titanium are added”, and “lithium cobalt oxide to which magnesium, nickel, aluminum, titanium, and fluorine are added”. In other words, the positive electrode active material of one embodiment of the present invention includes one or more of “lithium cobalt oxide containing magnesium and titanium”, “lithium cobalt oxide containing magnesium, titanium, and fluorine”, “lithium cobalt oxide containing magnesium, nickel, and titanium”, “lithium cobalt oxide containing magnesium, nickel, titanium, and fluorine”, “lithium cobalt oxide containing magnesium, nickel, aluminum, and titanium”, and “lithium cobalt oxide containing magnesium, nickel, aluminum, titanium, and fluorine”. In particular, the positive electrode active material of one embodiment of the present invention preferably contains lithium cobalt oxide to which magnesium, nickel, aluminum, titanium, and fluorine are added (lithium cobalt oxide containing magnesium, nickel, aluminum, titanium, and fluorine). Note that in this specification, “lithium cobalt oxide to which magnesium and titanium are added” is not only referred to as “lithium cobalt oxide containing magnesium and titanium” as described above, but also sometimes referred to as a “positive electrode active material containing magnesium, titanium, and lithium cobalt oxide”, a “positive electrode active material particle containing magnesium, titanium, and lithium cobalt oxide”, or the like. A region of the positive electrode active material of one embodiment of the present invention where the additive elements are present is described with reference to FIG. 1A, FIG. 1B, and FIG. 1C.

FIG. 1A shows a cross section of a positive electrode active material 100 of one embodiment of the present invention. FIG. 1B is a schematic view of element distributions of the case of measurement from a surface toward an inner portion in analysis of a cross section including the surface and surface portion of the positive electrode active material 100. Measurement from a surface toward an inner portion is also referred to as measurement in a depth direction, and arrows X1-X2 and Y1-Y2 in FIG. 1A are examples of the depth direction.

As illustrated in FIG. 1A, the positive electrode active material 100 includes a surface portion 100a and an inner portion 100b. The dashed line in FIG. 1A denotes a boundary between the surface portion 100a and the inner portion 100b. In the drawing, (001) represents a (001) plane of LiMO₂. LiMO₂ belongs to the space group R-3m.

In this specification and the like, the surface portion 100a of the positive electrode active material 100 refers to a region at less than or equal to 50 nm, preferably less than or equal to 35 nm, further preferably less than or equal to 20 nm from the surface toward the inner portion, most preferably a region at less than or equal to 10 nm from the surface toward the inner portion in a direction perpendicular or substantially perpendicular to the surface. Note that “substantially perpendicular” refers to a state where an angle is greater than or equal to 80° and less than or equal to 100°. A plane generated by a split and/or a crack can be regarded as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

In the case where the positive electrode active material 100 has a layered rock-salt crystal structure belonging to the space group R-3m, the surface portion 100a includes a basal region and an edge region.

The basal region has a surface parallel to the (001) plane (the surface is also referred to as a surface having the (001) orientation), and the basal region refers to a region at less than or equal to 50 nm, preferably less than or equal to 35 nm, further preferably less than or equal to 20 nm, most preferably less than or equal to 10 nm from the surface toward the inner portion in a direction perpendicular or substantially perpendicular to the surface. Here, “parallel” means that an angle between a line perpendicular to a first plane (the (001) plane) and a line normal to a second plane (a surface of the positive electrode active material 100) is greater than or equal to 0° and less than 10°, preferably greater than or equal to 0° and less than or equal to 5°, further preferably greater than or equal to 0° and less than or equal to 2.5°.

The edge region is a region other than the basal region in the surface portion 100a. In other words, the edge region has a surface exposed in a direction intersecting with the (001) plane (the surface is also referred to as a surface having an orientation other than the (001) orientation), and the edge region refers to a region at less than or equal to 50 nm, preferably less than or equal to 35 nm, further preferably less than or equal to 20 nm, most preferably less than or equal to 10 nm from the surface toward the inner portion in a direction perpendicular or substantially perpendicular to the surface. Here, “intersect” means that an angle between the line perpendicular to the first plane (the (001) plane) and the line normal to the second plane (the surface of the positive electrode active material 100) is greater than or equal to 100 and less than or equal to 90°, preferably greater than or equal to 300 and less than or equal to 90°, further preferably greater than or equal to 500 and less than or equal to 90°.

The surface of the positive electrode active material 100 refers to a surface of a positive electrode active material particle including the surface portion 100a and the inner portion 100b. Thus, a metal oxide that is attached to the particle surface and that does not contain a lithium site contributing to charging and discharging, such as aluminum oxide, or a carbonate, a hydroxy group, or the like that is chemically adsorbed after formation of the positive electrode active material is not included in the positive electrode active material 100. Note that the attached metal oxide refers to, for example, a metal oxide whose crystal structure orientation is not aligned with that of the inner portion 100b, i.e., a metal oxide that does not have continuity with the inner portion 100b in terms of regular arrangement of atoms. In other words, a region (e.g., a region having a rock-salt crystal structure) of an oxide having continuity with the inner portion 100b of the positive electrode active material 100 in terms of regular arrangement of atoms is included in the positive electrode active material 100.

Furthermore, an electrolyte, an organic solvent, a binder, a conductive material, and a compound originating from any of these that are attached to the positive electrode active material 100 are not included either in the positive electrode active material 100.

Although not illustrated, the positive electrode active material 100 may have a crystal grain boundary. A crystal grain boundary refers to, for example, a portion where particles of the positive electrode active material 100 adhere to each other, or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM image, a cross-sectional STEM image, or the like, i.e., a structure including another atom between lattices, a cavity, or the like. A crystal grain boundary can be regarded as a plane defect. The vicinity of a crystal grain boundary refers to a region at less than or equal to 10 nm from the crystal grain boundary.

### <Contained Element>

The positive electrode active material 100 contains lithium, a transition metal M, oxygen, and an additive element. The transition metal M is one or more selected from cobalt, nickel, and manganese. Alternatively, the positive electrode active material 100 includes a composite oxide (LiMO₂) which contains lithium and the transition metal M and to which the additive element is added. Note that the positive electrode active material 100 of one embodiment of the present invention has a distribution of the additive element or a crystal structure described later. Therefore, the composition is not strictly limited to Li:M:O=1:1:2 (atomic ratio).

A positive electrode active material of a lithium-ion secondary battery needs to contain a transition metal that can be oxidized or reduced in order to maintain a neutrally charged state even when lithium ions are inserted and extracted. It is preferable that the positive electrode active material 100 of one embodiment of the present invention mainly contain cobalt as the transition metal M taking part in an oxidation-reduction reaction. When cobalt accounts for greater than or equal to 75 at %, preferably greater than or equal to 90 at %, further preferably greater than or equal to 95 at % of the transition metal M contained in the positive electrode active material 100, there are many advantages such as relatively easy synthesis, easy handling, and excellent cycling performance, which is preferable.

When cobalt accounts for greater than or equal to 75 at %, preferably greater than or equal to 90 at %, further preferably greater than or equal to 95 at % of the transition metal M of the positive electrode active material 100, the stability when much lithium is released by charging is higher than that of a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel(III) accounts for the majority of the transition metal M, and a layer formed of octahedrons of nickel and oxygen is likely to be distorted. Thus, a concern that the crystal structure might break in charge/discharge cycles grows. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal M, such as lithium nickel oxide.

As the additive element contained in the positive electrode active material 100, one or two or more selected from magnesium, titanium, nickel, aluminum, fluorine, zirconium, vanadium, iron, manganese, chromium, niobium, arsenic, zinc, silicon, sulfur, phosphorus, and boron is preferably used.

That is, the positive electrode active material 100 can include “lithium cobalt oxide to which magnesium and titanium are added”, “lithium cobalt oxide to which magnesium, titanium, and fluorine are added”, “lithium cobalt oxide to which magnesium, nickel, and titanium are added”, “lithium cobalt oxide to which magnesium, nickel, titanium, and fluorine are added”, “lithium cobalt oxide to which magnesium, nickel, aluminum, and titanium are added”, “lithium cobalt oxide to which magnesium, nickel, aluminum, titanium, and fluorine are added”, or the like.

The additive element preferably forms a solid solution with the positive electrode active material 100. Thus, in STEM-EDX (Energy Dispersive X-ray Spectroscopy) line analysis, for example, it is preferable that the depth at which the detection amount of the additive element increases be at a deeper position, i.e., be closer to the inner portion of the positive electrode active material 100, than the depth at which the detection amount of the transition metal M increases.

In this specification and the like, the depth at which the detection amount of an element increases in STEM-EDX line analysis refers to the depth at which a measured value, which can be determined not to be a noise in terms of intensity, spatial resolution, and the like, is successively obtained.

These additive elements further stabilize the crystal structure of the positive electrode active material 100 as described later.

Note that as the additive elements, not all of fluorine, zirconium, vanadium, iron, manganese, chromium, niobium, arsenic, zinc, silicon, sulfur, phosphorus, and boron need to be contained.

When the positive electrode active material 100 is substantially free from manganese, for example, the above advantages such as relatively easy synthesis, easy handling, and excellent cycling performance are enhanced. The weight of manganese contained in the positive electrode active material 100 is preferably less than or equal to 600 ppm, further preferably less than or equal to 100 ppm, for example.

The positive electrode active material 100 contains the above-described additive element in the surface portion 100a. It is further preferable that a plurality of additive elements be contained. The concentration(s) of one or two or more selected from the additive elements is/are preferably higher in the surface portion 100a than in the inner portion 100b. Alternatively, the detection amount(s) of one or two or more selected from the additive elements is/are preferably larger in the surface portion 100a than in the inner portion 100b. The one or two or more selected from the additive elements contained in the positive electrode active material 100 preferably have a concentration gradient.

In some cases, it is further preferable that the additive elements contained in the positive electrode active material 100 be differently distributed. For example, in some cases, it is further preferable that peaks of the detection amounts of the additive elements in the surface portion 100a be at different depths from the surface or the reference point in EDX line analysis described later. The peak of the detection amount here refers to a local maximum value (the maximum value) of the detection amount in the surface portion 100a or at less than or equal to 50 nm from the surface. The detection amount refers to, for example, the number of counts of a characteristic X-ray in EDX line analysis.

### [Titanium]

When titanium is present in the surface portion 100a as the additive element, insertion and extraction of lithium ions into and from the positive electrode active material 100 can be promoted.

Although titanium is stable in octahedral sites with six coordinated oxygen atoms in an oxide, titanium oxide and lithium titanate cannot have a stable layered rock-salt crystal structure. For example, the rutile crystal structure is the most stable for TiO₂, and Li₄Ti₅O₁₂ has a spinel crystal structure. Thus, when a slight amount of titanium forms a solid solution with the surface portion 100a having a layered rock-salt crystal structure or a rock-salt crystal structure, defects are generated in part of the crystal structure in the surface portion 100a.

It is known that lithium cobalt oxide has a large band gap and high resistance in a discharged state (i.e., a state where x in LiₓCoO₂ is 1). Thus, introduction of a defect due to titanium to part of the surface portion 100a can reduce the band gap and reduce the resistance to a preferable degree.

In an oxide, Co³⁺ is the most stable for cobalt, whereas Ti⁴⁺ is the most stable for titanium. Thus, in the periphery of titanium, less charge is applied to lithium ions than in the periphery of cobalt. Furthermore, a defect is sometimes induced at a cation site in the vicinity of Ti⁴⁺ and reduces diffusion resistance of cations, especially lithium ions. Thus, the diffusion resistance of lithium ions is reduced in the periphery of titanium. Note that in the periphery of titanium, part of cobalt is Co²⁺ in some cases owing to the influence of the presence of titanium.

Accordingly, when titanium is present in the surface portion 100a, the diffusion resistance of lithium ions at the interface between an electrolyte solution and the positive electrode active material 100 can be low. Moreover, it is presumable that titanium present in the surface portion 100a does not excessively reduce the electric resistance (e.g., powder resistance) of the positive electrode active material 100. The positive electrode active material 100 preferably has somewhat high electric resistance to contribute to safety at the time of a short circuit of a secondary battery.

Too small an amount of titanium fails to sufficiently elicit the above effect of promoting insertion and extraction of lithium ions. Meanwhile, too large an amount of titanium may form a different phase (e.g., MgTiO₃ with an ilmenite crystal structure) with another additive element such as magnesium. Furthermore, when formation of the different phase takes magnesium, the concentration of magnesium in the surface portion 100a whose crystal structure matches that of the inner portion 100b is liable to be reduced. In the positive electrode active material 100 of one embodiment of the present invention, which is for charging with a high voltage exceeding 4.60 V (vs. Li/Li⁺), magnesium present in the surface portion 100a at a high concentration is indispensable for inhibition of a phase change. Thus, it is a great disadvantage that formation of a different phase takes magnesium. When the number of defects due to titanium increases too much, oxygen is liable to be easily released from the surface. Therefore, it is preferable that titanium be present together with magnesium, fluorine, and the like particularly at the surface of the surface portion 100a and in a region close to the surface of the surface portion 100a at a concentration lower than that of magnesium.

Specifically, Ti/Co in the entire positive electrode active material is preferably greater than or equal to 0.0001 (atomic ratio), further preferably greater than or equal to 0.001 (atomic ratio). The Ti/Co is preferably less than 0.0075 (atomic ratio), further preferably less than or equal to 0.004 (atomic ratio), still further preferably less than or equal to 0.003 (atomic ratio).

In EDX line analysis of the surface portion 100a, the maximum value of the titanium concentration of the case where the denominator is the sum of carbon, oxygen, fluorine, magnesium, sodium, aluminum, silicon, phosphorus, sulfur, calcium, titanium, iron, cobalt, nickel, gallium, zirconium, and molybdenum is preferably greater than or equal to 0.3 at % and less than or equal to 3 at %, further preferably greater than or equal to 0.5 at % and less than or equal to 2 at %.

In XPS analysis for analyzing surfaces of a plurality of particles of the positive electrode active material 100, the titanium concentration of the case where the denominator is the sum of carbon, oxygen, fluorine, magnesium, sodium, aluminum, silicon, phosphorus, sulfur, calcium, titanium, iron, cobalt, nickel, gallium, zirconium, and molybdenum is preferably higher than or equal to 0.5 at % and lower than or equal to 5.0 at %, further preferably higher than or equal to 1.0 at % and lower than or equal to 2.0 at %.

In EPMA analysis of the inner portion 100b as analysis of a cross section of a particle of the positive electrode active material 100, it is preferable that titanium not be detected (titanium be below the lower detection limit) or titanium be present at substantially the same level as the lower detection limit.

Although not particularly limited, a titanium source can be, for example, a titanium oxide such as TiO₂ and/or lithium titanate such as Li₂TiO₃, LiTiO₂, or Li₄Ti₅O₁₂. In the case where a heating step is performed after the titanium source is mixed, part of lithium might be evaporated during the heating, and thus, it is particularly preferable to use the above lithium titanate, which contains lithium.

The element that can be added to promote insertion and extraction of lithium ions is not limited to titanium. A different element may be added. Also in the case where an element other than titanium is used, it is preferable that the element be stable in octahedral sites with six coordinated oxygen atoms in an oxide but an oxide of lithium and the element not have a stable layered rock-salt crystal structure. The element is preferably stable when having an oxidation number larger than the oxidation number with which cobalt is stable. For example, niobium, manganese, tungsten, chromium, molybdenum, rhenium, tantalum, or the like can be used.

### [Distribution]

To achieve the above effect, the concentrations of at least magnesium (Mg), nickel (Ni), and titanium (Ni) of the additive elements are preferably higher in the surface portion 100a than in the inner portion 100b as illustrated in FIG. 1B. Alternatively, the detection amounts of at least magnesium (Mg), nickel (Ni), and titanium (Ni) of the additive elements are preferably larger in the surface portion 100a than in the inner portion 100b. Peaks of the detection amounts are preferably in a region of the surface portion 100a that is closer to the surface. For example, the peaks of the detection amounts are preferably at less than or equal to 3 nm from the surface or the reference point. It is preferable that the distribution of magnesium and the distribution of nickel have an overlapping region. The distributions of magnesium, nickel, and titanium are shown by one curve in FIG. 1B in order to avoid complexity of the drawing, but are not limited to a structure in which the above elements have the same distribution position and the same concentration. The peak of the detection amount of magnesium and that of the detection amount of nickel may be at the same depth, the peak of magnesium may be closer to the inner portion, or the peak of nickel may be closer to the inner portion. In other words, the peak of the detection amount of magnesium and that of the detection amount of nickel may be at the same depth, the peak of magnesium may be closer to the surface, or the peak of nickel may be closer to the surface.

The difference in depth between the peak of the detection amount of nickel and the peak of the detection amount of magnesium is preferably less than or equal to 3 nm, further preferably less than or equal to 1 nm. In addition, the half widths of the detection amounts are preferably small. Note that in this specification, a half width is a full width at half maximum.

Similarly, it is preferable that the distribution of magnesium and the distribution of titanium have an overlapping region. The peak of the detection amount of magnesium and that of the detection amount of titanium may be at the same depth, the peak of magnesium may be closer to the inner portion, or the peak of titanium may be closer to the inner portion. In other words, the peak of the detection amount of magnesium and that of the detection amount of titanium may be at the same depth, the peak of magnesium may be closer to the surface, or the peak of titanium may be closer to the surface. In other words, the difference in depth between the peak of the detection amount of titanium and the peak of the detection amount of magnesium is preferably less than or equal to 3 nm, further preferably less than or equal to 1 nm. In addition, the half widths of the detection amounts are preferably small.

Similarly, it is preferable that the distribution of titanium and the distribution of nickel have an overlapping region. The peak of the detection amount of titanium and that of the detection amount of nickel may be at the same depth, the peak of titanium may be closer to the inner portion, or the peak of nickel may be closer to the inner portion. The difference in depth between the peak of the detection amount of titanium and the peak of the detection amount of nickel is preferably less than or equal to 3 nm, further preferably less than or equal to 1 nm. In addition, the half widths of the detection amounts are preferably small.

That is, the distribution of magnesium, the distribution of nickel, and the distribution of titanium preferably overlap with each other. The difference in depth between the peak of the detection amount of titanium, the peak of the detection amount of nickel, and the peak of the detection amount of magnesium is preferably less than or equal to 3 nm, further preferably less than or equal to 1 nm. In addition, the half widths of the detection amounts are preferably small.

A region where the distributions of magnesium and nickel overlap with each other, a region where the distributions of magnesium and titanium overlap with each other, or a region where the distributions of magnesium, nickel, and titanium overlap with each other is preferably in the edge region where lithium ions are inserted and extracted in the surface portion 100a. That is, the distributions of the additive elements in the schematic diagram in FIG. 1B are preferably observed in the direction indicated by the arrow X1-X2 in FIG. 1A. By contrast, in the surface portion 100a, the above overlapping region is not necessarily required in the basal region. Note that the horizontal axis in FIG. 1B represents the distance from X1 (the direction of the arrow).

In some cases, the detection amount of nickel in the inner portion 100b is much smaller than that of nickel in the surface portion 100a or lower than or equal to 1 at %, or no nickel is detected in the inner portion 100b.

As in the case of magnesium, nickel, and titanium, the detection amount of fluorine is preferably larger in the surface portion 100a than in the inner portion. The peak of the detection amount of fluorine is preferably in a region of the surface portion 100a that is closer to the surface. For example, the peak of the detection amount is preferably at less than or equal to 3 nm from the surface or the reference point.

As example distributions of the additive elements in the positive electrode active material 100 of one embodiment of the present invention, distributions as illustrated in FIG. 1C may be exhibited by lithium cobalt oxide to which magnesium (Mg), nickel (Ni), aluminum (Al), titanium (Ti), and fluorine (F) are added. Here, it is shown that the peaks of the detection amounts of magnesium and fluorine are at the same depth (a first position), the peaks of the detection amounts of nickel and titanium are at the same depth (a second position), and the second position is closer to the inner portion than the first position. Note that here, the expression “peaks are at the same depth” means that the difference in position between two or more peaks as objects of a comparison is less than or equal to 0.3 nm.

The maximum value of the detection amount of at least aluminum (Al) among the additive elements is preferably closer to the inner portion of the positive electrode active material particle than the maximum values of the detection amounts of magnesium and titanium as shown in FIG. 1B and FIG. 1C. Although the distributions of magnesium and titanium and the distribution of aluminum may have an overlapping region as shown in FIG. 1B and FIG. 1C, they may have almost no overlapping region. The maximum value of the detection amount of aluminum may be in the surface portion 100a or may be deeper than the surface portion 100a. For example, a peak is preferably in a region at greater than or equal to 5 nm and less than or equal to 30 nm from the surface or the reference point toward the inner portion side.

When aluminum is distributed as described above, the layered rock-salt crystal structure of the positive electrode active material 100 can be more stable. For example, a change from a layered rock-salt crystal structure to a spinel crystal structure in the surface portion 100a of the positive electrode active material 100 is expected to be inhibited. Note that the spinel crystal structure generated in the layered rock-salt crystal structure is likely to move or spread along with transfer of charge of the transition metal M, for example. Defects such as a crystal grain boundary in the positive electrode active material 100 can serve as a diffusion path of lithium ions in the c-axis direction. The additive element such as aluminum can be contained in the vicinity of the defect.

Aluminum is distributed more inwardly than magnesium and titanium probably because the diffusion rate of aluminum is higher than that of magnesium. Meanwhile, the detection amount of aluminum is small in the region that is the closest to the surface presumably because aluminum can exist more stably in a region other than the region where magnesium or the like forms a solid solution at a high concentration.

To be specific, in a region having a layered rock-salt crystal structure belonging to the space group R-3m or a cubic rock-salt crystal structure, the distance between a cation and oxygen in a region where magnesium forms a solid solution at a high concentration is longer than the distance between a cation and oxygen in layered rock-salt LiAlO₂, and thus, aluminum is unlikely to stay stably. In the vicinity of cobalt, valence change due to substitution of Mg²⁺ for Li⁺ can be compensated for by Co³⁺ becoming Co²⁺, so that cation balance can be maintained. By contrast, aluminum is always trivalent and is thus presumed to be unlikely to stay stably in the vicinity of magnesium in a layered rock-salt structure. Moreover, for the same reason that aluminum is always trivalent, aluminum is presumed to be unlikely to stay stably in a rock-salt structure.

Note that the additive elements do not necessarily have similar concentration gradients and similar distributions throughout the surface portion 100a of the positive electrode active material 100.

The distributions of the additive elements at the surface of the basal region of the positive electrode active material 100 (also referred to as a surface having the (001) orientation) may be different from those at other surfaces. For example, the detection amount(s) of one or two or more selected from the additive elements may be smaller at the surface having the (001) orientation and the surface portion 100a thereof than at a surface having an orientation other than the (001) orientation. Specifically, the detection amount(s) of one or two or more elements among magnesium, nickel, and titanium may be small. Alternatively, at the surface having the (001) orientation and the surface portion 100a thereof, it is acceptable that one or two or more elements selected from the additive elements are not detected or the detection amount(s) of the element(s) is/are less than or equal to 1 at %. Specifically, it is acceptable that nickel is not detected or the detection amount thereof is less than or equal to 1 at %. Especially in the case of an analysis method, e.g., EDX, by which characteristic X-rays are detected, the energy of KO for cobalt is close to that of Kα for nickel, and it is thus difficult to detect a slight amount of nickel in a material whose main element is cobalt. Alternatively, the peaks of the detection amounts of one or two or more selected from the additive elements at the surface having the (001) orientation and the surface portion 100a thereof may be shallower from the surface than the peaks at the surface having an orientation other than the (001) orientation. Specifically, the peaks of the detection amounts of magnesium and aluminum may be shallower than the peaks at another surface.

In a layered rock-salt crystal structure belonging to R-3m, cations are arranged parallel to the (001) plane. In other words, MO₂ layers and lithium layers are alternately stacked parallel to the (001) plane. Accordingly, a diffusion path of lithium ions also exists parallel to the (001) plane.

The MO₂ layer is relatively stable and thus, the surface of the positive electrode active material 100 is more stable when having the (001) orientation. A main diffusion path of lithium ions in charging and discharging is not exposed at the (001) plane.

By contrast, a diffusion path of lithium ions is exposed at a surface having an orientation other than the (001) orientation. Thus, the surface having an orientation other than the (001) orientation and the surface portion 100a thereof easily lose stability because they are regions where extraction of lithium ions starts as well as important regions for maintaining a diffusion path of lithium ions. It is thus extremely important to reinforce the surface having an orientation other than the (001) orientation and the surface portion 100a thereof so that the crystal structure of the whole positive electrode active material 100 is maintained.

Accordingly, in the positive electrode active material 100 of another embodiment of the present invention, it is important that the distribution of the additive element at the surface having an orientation other than the (001) orientation and the surface portion 100a thereof is the distribution shown in FIG. 1B, for example. In particular, among the additive elements, nickel is preferably detected at the surface having an orientation other than the (001) orientation and the surface portion 100a thereof. By contrast, at the surface having the (001) orientation and the surface portion 100a thereof, the concentration of the additive element may be low as described above or the additive element may be absent.

In the formation method as described in an embodiment below, in which high-purity LiMO₂ is formed, the additive element is mixed afterwards, and heating is performed, the additive element spreads mainly through a diffusion path of lithium ions. Thus, the distribution of the additive element at the surface having an orientation other than the (001) orientation and the surface portion 100a thereof can easily fall within a preferred range.

### [Magnesium]

Magnesium is divalent, and a magnesium ion is more stable in lithium sites than in cobalt sites in a layered rock-salt crystal structure; thus, magnesium is likely to enter the lithium sites. An appropriate concentration of magnesium at the lithium sites of the surface portion 100a facilitates maintenance of the layered rock-salt crystal structure. This is presumably because magnesium at the lithium sites serves as a pillar supporting MO₂ layers. Moreover, the presence of magnesium can inhibit release of oxygen therearound in a state where x in LiₓCoO₂ is, for example, less than or equal to 0.24. The presence of magnesium is also expected to increase the density of the positive electrode active material 100. In addition, a high magnesium concentration in the surface portion 100a can be expected to increase the corrosion resistance to hydrofluoric acid generated by the decomposition of the electrolyte solution.

An appropriate concentration of magnesium can bring the above-described advantages without an adverse effect on insertion and extraction of lithium in charging and discharging. However, excessive magnesium might adversely affect insertion and extraction of lithium. Furthermore, the effect of stabilizing the crystal structure might be reduced. This is probably because magnesium enters the cobalt sites in addition to the lithium sites. Moreover, an excessive magnesium compound (e.g., an oxide or a fluoride) which does not enter the lithium site or the cobalt site might be segregated at the surface of the positive electrode active material or the like to serve as a resistance component of a secondary battery. As the magnesium concentration of the positive electrode active material increases, the discharge capacity of the positive electrode active material decreases in some cases. This is probably because excessive magnesium enters the lithium sites and the amount of lithium contributing to charging and discharging decreases.

Thus, the entire positive electrode active material 100 preferably contains an appropriate amount of magnesium. For example, the number of magnesium atoms is preferably greater than or equal to 0.002 times and less than or equal to 0.06 times (greater than or equal to 0.2% and less than or equal to 6.0%), further preferably greater than or equal to 0.005 times and less than or equal to 0.03 times (greater than or equal to 0.5% and less than or equal to 3.0%), still further preferably approximately 0.01 times (1.0%) the number of cobalt atoms. The amount of magnesium contained in the entire positive electrode active material 100 here may be, for example, a value obtained by element analysis on the entire positive electrode active material 100 with GD-MS, ICP-MS, or the like or may be a value based on the ratio of the raw materials mixed in the process of forming the positive electrode active material 100.

### [Nickel]

Nickel in a layered rock-salt crystal structure of LiMO₂ can be present at both the cobalt site and the lithium site. Since nickel has a lower oxidation-reduction potential than cobalt, the presence of nickel at the cobalt site can facilitate release of lithium and electrons during charging, for example. As a result, the charge/discharge speed is expected to be increased. Accordingly, at the same charge voltage, the charge/discharge capacity of the case of the transition metal M being nickel can be higher than that of the case of the transition metal M being cobalt.

In addition, when nickel is present at the lithium sites, a shift in the layered structure formed of octahedrons of cobalt and oxygen might be inhibited. Moreover, a change in volume in charging and discharging is inhibited. Furthermore, an elastic modulus becomes large, i.e., hardness increases. This is probably because nickel at the lithium sites also serves as a pillar supporting the MO₂ layers. Therefore, in particular, the crystal structure is expected to be more stable in a charged state at high temperatures, e.g., higher than or equal to 45 °C, which is preferable.

The distance between a cation and an anion of nickel oxide (NiO) is closer to the average of the distance between a cation and an anion of LiCoO₂ than those of rock-salt MgO and rock-salt CoO, and the orientations of NiO and LiCoO₂ are likely to be aligned with each other.

Ionization tendency is the lowest in nickel, followed in order by cobalt, aluminum, and magnesium (Mg>Al>Co>Ni). Therefore, it is considered that in charging, nickel is less likely to be dissolved into an electrolyte solution than the other elements described above. Accordingly, nickel is considered to have a high effect of stabilizing the crystal structure of the surface portion in a charged state.

Furthermore, in nickel, Ni²⁺ is the most stable among Ni²⁺, Ni³⁺, and Ni⁴⁺, and nickel has higher trivalent ionization energy than cobalt. Thus, it is known that a spinel crystal structure does not appear only with nickel and oxygen. Therefore, nickel is considered to have an effect of inhibiting a phase change from a layered rock-salt crystal structure to a spinel crystal structure.

Meanwhile, excessive nickel increases the influence of distortion due to the Jahn-Teller effect, which is not preferable. Moreover, excessive nickel might adversely affect insertion and extraction of lithium.

Thus, the entire positive electrode active material 100 preferably contains an appropriate amount of nickel. For example, in the positive electrode active material 100, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms is preferably greater than 0% and less than or equal to 4% of the number of cobalt atoms. Alternatively, the number of nickel atoms is preferably greater than 0% and less than or equal to 2% of the number of cobalt atoms. Alternatively, the number of nickel atoms is preferably greater than or equal to 0.05% and less than or equal to 7.5% of the number of cobalt atoms. Alternatively, the number of nickel atoms is preferably greater than or equal to 0.05% and less than or equal to 2% of the number of cobalt atoms. Alternatively, the number of nickel atoms is preferably greater than or equal to 0.1% and less than or equal to 7.5% of the number of cobalt atoms. Alternatively, the number of nickel atoms is preferably greater than or equal to 0.1% and less than or equal to 4% of the number of cobalt atoms. The amount of nickel described here may be a value obtained by element analysis on the entire positive electrode active material with GD-MS, ICP-MS, or the like or may be a value based on the ratio of the raw materials mixed in the process of forming the positive electrode active material, for example.

### [Aluminum]

Aluminum can be present at the cobalt site in a layered rock-salt crystal structure. Since aluminum is a trivalent representative element and its valence does not change, lithium around aluminum is less likely to move even in charging and discharging. Thus, aluminum and lithium around aluminum serve as pillars to inhibit a change in the crystal structure. This would inhibit degradation of the positive electrode active material 100 if force of expansion and contraction of the positive electrode active material 100 in the c-axis direction operates owing to insertion and extraction of lithium ions, i.e., owing to a change in charge depth or charge rate, as described later.

Furthermore, aluminum has an effect of inhibiting dissolution of cobalt around aluminum and improving continuous charging tolerance. Moreover, an Al—O bond is stronger than a Co—O bond and thus release of oxygen around aluminum can be inhibited. These effects improve thermal stability. Therefore, a secondary battery that includes the positive electrode active material 100 containing aluminum as the additive element can have higher safety. In addition, the positive electrode active material 100 having a crystal structure that is unlikely to be broken by repeated charging and discharging can be provided.

Meanwhile, excessive aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% of the number of cobalt atoms. Alternatively, the number of aluminum atoms is preferably greater than or equal to 0.1% and less than or equal to 4% of the number of cobalt atoms. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

### [Fluorine]

When fluorine, which is a monovalent anion, is substituted for part of oxygen in the surface portion 100a, the lithium extraction energy is lowered. This is because the oxidation-reduction potential of cobalt ions associated with lithium extraction differs depending on whether fluorine exists. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs between these cases. It can thus be said that when fluorine is substituted for part of oxygen in the surface portion 100a of the positive electrode active material 100, lithium ions near fluorine are likely to be extracted and inserted smoothly. Thus, a secondary battery including the positive electrode active material 100 can have improved charge/discharge performance, improved large current performance, or the like. When fluorine is present at the surface portion 100a including the surface that is in contact with an electrolyte solution, or when a fluoride is attached to the surface, an overreaction between the positive electrode active material 100 and the electrolyte solution can be suppressed. In addition, the corrosion resistance to hydrofluoric acid can be effectively increased.

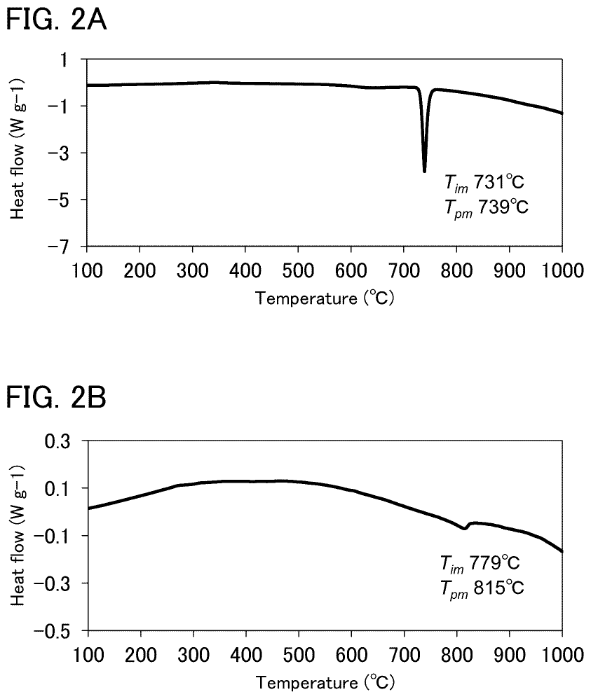

Here, differential scanning calorimetry measurement (DSC measurement) of a fluoride and a mixture is described with reference to FIG. 2A and FIG. 2B. In either diagram, the horizontal axis represents the temperature of a sample and the vertical axis represents the difference from reference heat flow. Although the apparatus and conditions of the DSC measurement are not particularly limited, the measurement was performed using the apparatus and conditions described below in this embodiment.
DSC apparatus: EVO2 DSC8271 produced by Rigaku Corporation
Temperature rising rate: 20 °C/min
   The obtained measurement results were subjected to background correction using analysis software Thermo prus EVO, and the initial melting temperature Tᵢₘ, the melting peak temperature Tₚₘ, and the melting termination temperature Tₑₘ as extrapolated temperatures were calculated. Heat Flow was heat flow per weight of a sample.

FIG. 2A shows the DSC measurement results of a mixture obtained by mixing lithium fluoride and magnesium fluoride as fluorides such that LiF:MgF₂=1:3 (molar ratio). FIG. 2B shows the DSC measurement results of the above mixture to which lithium cobalt oxide (C-10N produced by NIPPON CHEMICAL INDUSTRIAL CO., LTD.) was added. LiCoO₂, LiF, and MgF₂ were mixed such that LiCoO₂:LiF:MgF₂=100:0.33:1 (molar ratio).

As shown in FIG. 2A, the initial melting temperature Tᵢₘ, the melting peak temperature Tₚₘ, and the melting termination temperature Tₑm of the mixture of lithium fluoride and magnesium fluoride were 731 °C, 739 °C, and 746 °C, respectively. As shown in FIG. 2B, the Tᵢₘ, Tₚm, and Tₑm of the mixture of lithium cobalt oxide, lithium fluoride, and magnesium fluoride were 779 °C, 815 °C, and 826 °C, respectively.

Thus, the temperature of the heating following the mixing of the additive element is preferably higher than or equal to 731 °C, further preferably higher than or equal to 826 °C. The temperature of the heating may be higher than or equal to 800 °C between the above temperatures. A higher heating temperature is preferable because it facilitates the reaction, shortens the heating time, and enables high productivity; however, too high a heating temperature might cause decomposition of lithium cobalt oxide. Thus, the upper limit of the heating temperature is lower than the decomposition temperature of lithium cobalt oxide (1130 °C). At a temperature in the vicinity of the decomposition temperature, a slight amount of lithium cobalt oxide might be decomposed. Thus, the heating temperature is further preferably lower than or equal to 1000 °C.

### [Other Additive Elements]

The surface portion 100a preferably contains phosphorus, in which case a short circuit can be sometimes inhibited while a state with small x in LiₓCoO₂ is maintained. For example, a compound containing phosphorus and oxygen preferably exists in the surface portion 100a.

The positive electrode active material 100 preferably contains phosphorus, in which case the phosphorus reacts with hydrogen fluoride generated by the decomposition of the electrolyte solution or the electrolyte, which can reduce the hydrogen fluoride concentration in the electrolyte.

In the case where the electrolyte contains LiPF₆, hydrogen fluoride might be generated by hydrolysis. In addition, hydrogen fluoride might be generated by the reaction of poly(vinylidene fluoride) (PVDF) used as a component of a positive electrode and alkali. The decrease in hydrogen fluoride concentration in the electrolyte may inhibit corrosion of a current collector and/or separation of a coating portion 104 or may inhibit a reduction in adhesion properties due to gelation and/or insolubilization of PVDF.

The positive electrode active material 100 preferably contains magnesium and phosphorus, in which case the stability in a state with small x in LiₓCoO₂ is extremely high. When the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10% of the number of cobalt atoms. Alternatively, the number of phosphorus atoms is preferably greater than or equal to 1% and less than or equal to 8% of the number of cobalt atoms. Alternatively, the number of phosphorus atoms is preferably greater than or equal to 2% and less than or equal to 20% of the number of cobalt atoms. Alternatively, the number of phosphorus atoms is preferably greater than or equal to 2% and less than or equal to 8% of the number of cobalt atoms. Alternatively, the number of phosphorus atoms is preferably greater than or equal to 3% and less than or equal to 20% of the number of cobalt atoms. Alternatively, the number of phosphorus atoms is preferably greater than or equal to 3% and less than or equal to 10% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5% of the number of cobalt atoms. Alternatively, the number of magnesium atoms is preferably greater than or equal to 0.1% and less than or equal to 4% of the number of cobalt atoms. Alternatively, the number of magnesium atoms is preferably greater than or equal to 0.5% and less than or equal to 10% of the number of cobalt atoms. Alternatively, the number of magnesium atoms is preferably greater than or equal to 0.5% and less than or equal to 4% of the number of cobalt atoms. Alternatively, the number of magnesium atoms is preferably greater than or equal to 0.7% and less than or equal to 10% of the number of cobalt atoms. Alternatively, the number of magnesium atoms is preferably greater than or equal to 0.7% and less than or equal to 5% of the number of cobalt atoms. The phosphorus concentration and the magnesium concentration described here may each be a value obtained by element analysis on the entire positive electrode active material 100 using GD-MS, ICP-MS, or the like, or may be a value based on the ratio of the raw materials mixed in the process of forming the positive electrode active material 100, for example.

In the case where the positive electrode active material 100 has a crack, crack development can be inhibited by phosphorus, more specifically, a compound containing, for example, phosphorus and oxygen, being in the inner portion, e.g., a filling portion, of the positive electrode active material having the crack on its surface.

### [Synergistic Effect of a Plurality of Additive Elements]

When the surface portion 100a includes both magnesium and nickel, divalent nickel might be able to exist more stably in the vicinity of divalent magnesium. Thus, even when x in LiₓMO₂ is small, dissolution of magnesium can be inhibited. This can contribute to stabilization of the surface portion 100a.

For a similar reason, when the additive element is added to lithium cobalt oxide in the formation process, magnesium is preferably added in a step before a step of adding nickel. Alternatively, magnesium and nickel are preferably added in the same step. Magnesium has a large ion radius and thus is likely to remain in the surface portion of lithium cobalt oxide regardless of in which step magnesium is added, but nickel may be widely diffused to the inner portion of lithium cobalt oxide when magnesium is absent. Thus, when nickel is added before magnesium is added, nickel might be diffused to the inner portion of lithium cobalt oxide and a preferable amount of nickel might not remain in the surface portion.

When the surface portion 100a includes both nickel and titanium, the presence of tetravalent titanium in the vicinity of divalent nickel may further stabilize the surrounding crystal structure. Thus, even when x in LiₓMO₂ is small, dissolution of oxygen (O) can be inhibited. This can contribute to stabilization of the surface portion 100a.

Furthermore, in the case where the surface portion 100a includes magnesium, nickel, and titanium, the presence of nickel inhibits formation of a different phase such as MgTiO₃ with the ilmenite crystal structure. The ilmenite crystal structure has hexagonal close-packed anions and is different from a rock-salt crystal structure and a layered rock-salt crystal structure that are cubic close-packed structures; thus, a certain amount of activation energy is needed for the phase transition. NiO(II) is a compound having low chemical activity and thus has an effect of inhibiting formation of MgTiO₃.

For the reasons described above, nickel exerts its particularly powerful effect of inhibiting formation of a different phase in the case where, at the time of adding the additive elements to lithium cobalt oxide in the fabrication process, titanium is added in a step after steps of adding magnesium and nickel.

Additive elements that are differently distributed are preferably contained at a time, in which case the crystal structure of a wider region can be stabilized. For example, a stable crystal structure can be obtained in a wide region in the case where the positive electrode active material 100 contains, in the surface portion 100a, magnesium, nickel, and titanium distributed in a region closer to the surface and aluminum distributed in a region deeper than magnesium, nickel, and titanium, as compared with the case where only magnesium, nickel, and titanium are contained and the case where only aluminum is contained. In the case where the positive electrode active material 100 contains the additive elements that are differently distributed as described above, the surface can be sufficiently stabilized by magnesium, nickel, or the like; thus, aluminum is not necessary for the surface. It is preferable that aluminum be widely distributed in a deeper region. For example, aluminum is preferably continuously detected in a region at greater than or equal to 0 nm and less than or equal to 100 nm, further preferably greater than or equal to 0.5 nm and less than or equal to 50 nm, still further preferably greater than or equal to 1 nm and less than or equal to 25 nm from the surface in the depth direction. It is preferable that aluminum be widely distributed in such a manner, in which case the crystal structure in a wider region can be stabilized.

When a plurality of the additive elements are contained as described above, the effects of the additive elements can contribute synergistically to further stabilization of the surface portion 100a. In particular, magnesium, nickel, aluminum, and titanium are preferably contained, in which case a high effect of stabilizing the composition and the crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only MgO or a structure in which MgO and MO(II) form a solid solution. Thus, the surface portion 100a needs to contain at least the transition metal M typified by cobalt, also contain lithium in a discharged state, and have the path through which lithium is inserted and extracted.

To ensure the sufficient path through which lithium is inserted and extracted, the concentration of cobalt is preferably higher than that of magnesium in the surface portion 100a. For example, when measurement by XPS is performed from the surface of the positive electrode active material 100, the ratio Mg/Co of the number of magnesium atoms Mg to the number of cobalt atoms Co is preferably greater than or equal to 0.4 and less than or equal to 1.5. The concentration of cobalt is preferably higher than that of titanium in the surface portion 100a, and the ratio Ti/Co of the number of titanium atoms Ti to the number of cobalt atoms Co is preferably greater than or equal to 0.05 and less than or equal to 0.2. The concentration of cobalt is preferably higher than that of nickel in the surface portion 100a, and the ratio Ni/Co of the number of nickel atoms Ni to the number of cobalt atoms Co is preferably greater than or equal to 0.05 and less than or equal to 0.2. The concentration of cobalt is preferably higher than that of aluminum in the surface portion 100a. The concentration of cobalt is preferably higher than that of fluorine in the surface portion 100a.

Moreover, excessive nickel might hinder diffusion of lithium; thus, the concentration of magnesium is preferably higher than that of nickel in the surface portion 100a. For example, when measurement by XPS is performed from the surface of the positive electrode active material 100, the number of nickel atoms is preferably less than or equal to 1/6 of that of magnesium atoms.

It is preferable that some additive elements, in particular, magnesium, nickel, and aluminum have higher concentrations in the surface portion 100a than in the inner portion 100b and exist randomly at low concentrations also in the inner portion 100b. When magnesium and aluminum exist at the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are contained, a synergistic effect of inhibiting dissolution of magnesium can be expected in a manner similar to the above.

It is preferable that the crystal structure continuously change from the inner portion 100b toward the surface owing to the above-described concentration gradient of the additive element. Alternatively, it is preferable that the crystal orientations of the surface portion 100a and the inner portion 100b be substantially aligned with each other.

For example, the crystal structure preferably changes continuously from the inner portion 100b that has a layered rock-salt crystal structure toward the surface and the surface portion 100a that have a rock-salt crystal structure or both a rock-salt crystal structure and a layered rock-salt crystal structure. Alternatively, the crystal orientation of the surface portion 100a that has a rock-salt crystal structure or has features of both a rock-salt crystal structure and a layered rock-salt crystal structure is preferably substantially aligned with the crystal orientation of the inner portion 100b that has a layered rock-salt crystal structure.

Note that in this specification and the like, a layered rock-salt crystal structure, which belongs to the space group R-3m, of a composite oxide containing lithium and a transition metal such as cobalt refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may exist. In some cases, a layered rock-salt crystal structure can be regarded as a structure in which a lattice of a rock-salt crystal is distorted.

A rock-salt crystal structure refers to a structure in which a cubic crystal structure such as a crystal structure belonging to the space group Fm-3m is included and cations and anions are alternately arranged. Note that a cation or anion vacancy may exist.

Having features of both a layered rock-salt crystal structure and a rock-salt crystal structure can be determined with use of electron diffraction, a TEM image, a cross-sectional STEM image, or the like.

There is no distinction among cation sites in a rock-salt crystal structure; meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point (000), the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged exists in an electron diffraction pattern. A bright spot common between the rock-salt and layered rock-salt crystal structures has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium exists in part of the layers with low luminance, i.e., the lithium layers.

Anions of a layered rock-salt crystal and anions of a rock-salt crystal form a cubic close-packed structure (face-centered cubic lattice structure). Anions of an O3′ type crystal and a monoclinic O1(15) crystal, which are described later, are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. An anion on the {111} plane of a cubic crystal structure has a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that the space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, in the layered rock-salt crystal, the O3′ type crystal, and the rock-salt crystal, a state where the orientations of the cubic close-packed structures formed of anions are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as topotaxy.

The crystal orientations in two regions being substantially aligned with each other can be determined, for example, from a TEM image, a STEM image, a HAADF-STEM (High-angle Annular Dark Field Scanning TEM) image, an ABF-STEM (Annular Bright-Field Scanning Transmission Electron Microscope) image, an electron diffraction pattern, or the like. They can be determined also from an FFT pattern of a TEM image or an FFT pattern of a STEM image or the like. Furthermore, XRD, neutron diffraction, and the like can be used for determination.

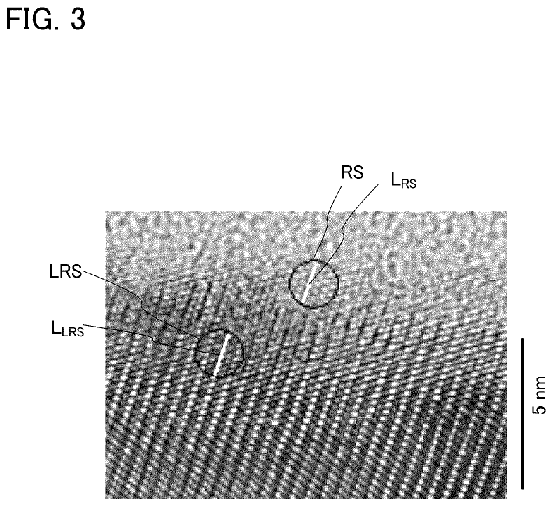

FIG. 3 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a composite hexagonal lattice of a layered rock-salt crystal structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 3) is less than or equal to 5° or less than or equal to 2.5° in the TEM image, it can be determined that the crystal planes are substantially aligned with each other, that is, orientations of the crystals are substantially aligned with each other. Similarly, when the angle between the dark lines is less than or equal to 5° or less than or equal to 2.5°, it can be determined that orientations of the crystals are substantially aligned with each other.

In a HAADF-STEM image, a contrast proportional to the atomic number is obtained, and an element having a larger atomic number is observed to be brighter. For example, in the case of lithium cobalt oxide that has a layered rock-salt crystal structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots in the direction perpendicular to the c-axis, and arrangement of lithium atoms and oxygen atoms is observed as dark lines or a low-luminance region. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is less than or equal to 5° or less than or equal to 2.5° in a HAADF-STEM image, it can be determined that arrangements of the atoms are substantially aligned with each other, that is, orientations of the crystals are substantially aligned with each other. Similarly, when the angle between the dark lines is less than or equal to 5° or less than or equal to 2.5°, it can be determined that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be determined as in a HAADF-STEM image.

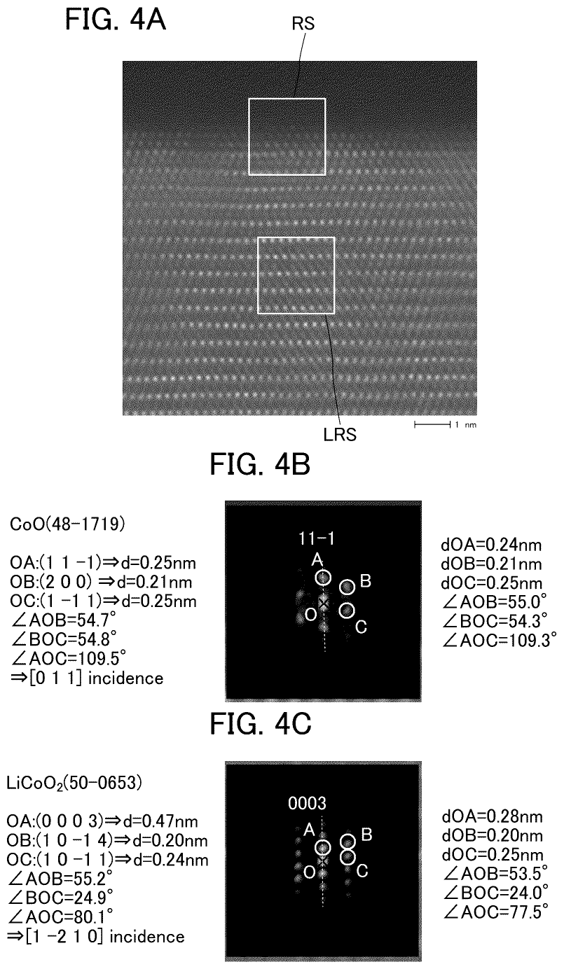

FIG. 4A shows an example of a STEM image in which orientations of the layered rock-salt crystal LRS and the rock-salt crystal RS are substantially aligned with each other. FIG. 4B shows an FFT pattern of a region of the rock-salt crystal RS, and FIG. 4C shows an FFT pattern of a region of the layered rock-salt crystal LRS. In FIG. 4B and FIG. 4C, the composition, the JCPDS card number, and d values and angles calculated from the JCPDS card data are shown on the left. The measured values are shown on the right. A spot denoted by O is zero-order diffraction.

A spot denoted by A in FIG. 4B is derived from 11-1 reflection of a cubic structure. A spot denoted by A in FIG. 4C is derived from 0003 reflection of a layered rock-salt crystal structure. It is found from FIG. 4B and FIG. 4C that the direction of the 11-1 reflection of the cubic structure and the direction of the 0003 reflection of the layered rock-salt crystal structure are substantially aligned with each other. That is, it is found that a straight line that passes through AO in FIG. 4B is substantially parallel to a straight line that passes through AO in FIG. 4C. Here, the terms “substantially aligned” and “substantially parallel” mean that the angle is less than or equal to 5° or less than or equal to 2.5°.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal may be substantially aligned with each other. In that case, it is preferred that these reciprocal lattice points be spot-shaped, that is, they not be connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt crystal structure are substantially aligned with each other as described above, a spot that is not derived from the 0003 reflection of the layered rock-salt crystal structure may be observed, depending on the incident direction of the electron beam, on a reciprocal lattice space different from the direction of the 0003 reflection of the layered rock-salt crystal structure. For example, a spot denoted by B in FIG. 4C is derived from 10-14 reflection of the layered rock-salt crystal structure. This is sometimes observed at a position where the difference in orientation from the reciprocal lattice point derived from the 0003 reflection of the layered rock-salt crystal structure (A in FIG. 4C) is greater than or equal to 520 and less than or equal to 560 (i.e., ∠AOB is greater than or equal to 520 and less than or equal to 56°) and d is greater than or equal to 0.19 nm and less than or equal to 0.21 nm. Note that these indices are just examples, and the spot does not necessarily correspond with them and may be, for example, a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 4B is derived from 200 reflection of the cubic structure. This diffraction spot is sometimes observed at a position where the difference in orientation from the spot derived from the 11-1 reflection of the cubic structure (A in FIG. 4B) is greater than or equal to 540 and less than or equal to 560 (i.e., ∠AOB is greater than or equal to 54° and less than or equal to 56°). These indices are just examples, and the spot does not necessarily correspond with them. For example, the spot may be a reciprocal lattice point equivalent to 11-1 and 200 of the cubic structure.

It is known that in a layered rock-salt positive electrode active material, such as lithium cobalt oxide, the (0003) plane and a plane equivalent thereto and the (10-14) plane and a plane equivalent thereto are likely to appear as crystal planes. Thus, to observe the (0003) plane with a TEM or the like, for example, a positive electrode active material particle in which a crystal plane that is presumably the (0003) plane is observed with a SEM or the like is preferably selected first; then, the positive electrode active material particle is preferably processed to be thin using an FIB (Focused Ion Beam) or the like such that the (0003) plane can be observed with the TEM or the like with an electron beam thereof entering in [12-10]. To determine whether crystal orientations are aligned, the particle is preferably processed to be thin so that the (0003) plane of the layered rock-salt crystal structure is easily observed.

### <Crystal Structure>

<<x in LiₓMO₂ being 1>>

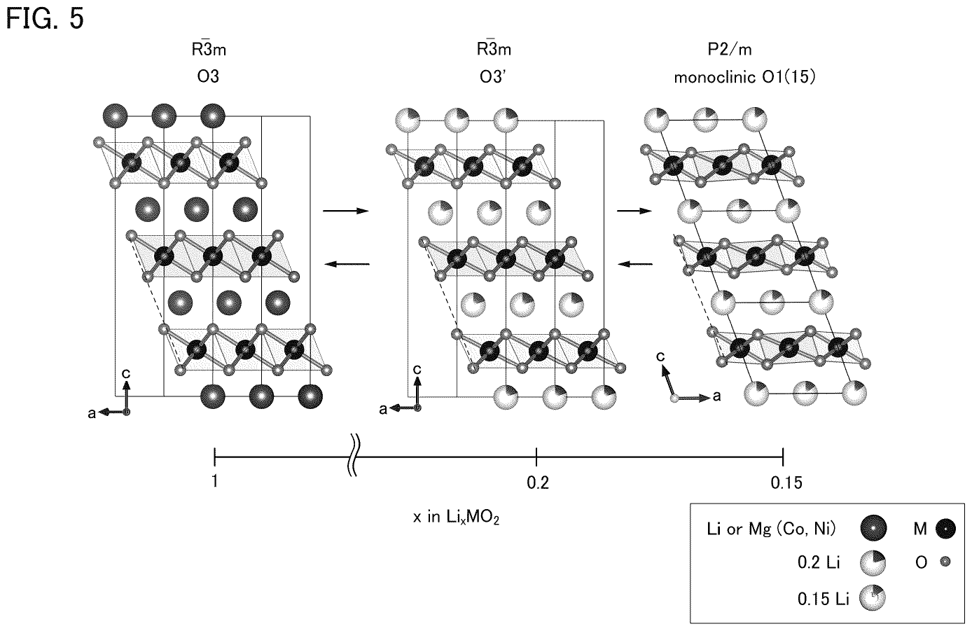

The positive electrode active material 100 of one embodiment of the present invention has a layered rock-salt crystal structure belonging to the space group R-3m in a discharged state, i.e., in the case where x in LiₓMO₂ is 1. A composite oxide having a layered rock-salt crystal structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure. In FIG. 5, the layered rock-salt crystal structure is denoted by R-3m O3. In the R-3m O3 type structure, the lattice constants are as follows: a=2.81610, b=2.81610, c=14.05360, α=90.0000, β=90.0000, and γ=120.0000; the coordinates of lithium, cobalt, and oxygen in a unit cell are represented by Li (0, 0, 0), Co (0, 0, 0.5), and O (0, 0, 0.23951), respectively (Non-Patent Document 5).

Meanwhile, the surface portion 100a of the positive electrode active material 100 of one embodiment of the present invention preferably has a function of reinforcing the layered structure, which is formed of octahedrons of the transition metal M and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of release of oxygen and/or a structural change of the surface portion 100a and the inner portion 100b of the positive electrode active material 100 such as a shift in the layered structure formed of octahedrons of the transition metal M and oxygen, and/or inhibiting oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25 °C). For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted first in charging, and is a region that tends to have a lower lithium concentration than the inner portion 100b. It can be said that bonds between atoms are partly cut on the surface of the particle of the positive electrode active material 100 included in the surface portion 100a. Therefore, the surface portion 100a is regarded as a region which is likely to be unstable and in which degradation of the crystal structure is likely to begin. For example, it is presumable that a shift in the crystal structure of the layered structure formed of octahedrons of the transition metal M and oxygen in the surface portion 100a has an influence on the inner portion 100b to cause a shift in the crystal structure of the layered structure in the inner portion 100b, leading to degradation of the crystal structure in the whole positive electrode active material 100. Meanwhile, if the surface portion 100a can have sufficient stability, the layered structure, which is formed of octahedrons of the transition metal M and oxygen, of the inner portion 100b is unlikely to be broken even when x in LiₓMO₂ is small, e.g., less than or equal to 0.24. Furthermore, a shift in layers, which are formed of octahedrons of the transition metal M and oxygen, of the inner portion 100b can be inhibited.

In the inner portion 100b of the positive electrode active material 100, the density of defects including dislocation is preferably low. In the positive electrode active material 100, the crystallite size measured by XRD is preferably large. In other words, the inner portion 100b preferably has high crystallinity. Furthermore, the positive electrode active material 100 preferably has a smooth surface. These features are important factors for assuring the reliability of the positive electrode active material 100 used for a secondary battery. A secondary battery can have a high upper limit of a charge voltage when including a highly reliable positive electrode active material and thereby can have high charge/discharge capacity.

Dislocation in the inner portion 100b can be observed with a TEM, for example. Defects such as dislocation are sometimes not observed in a specific 1-μm-square region of an observation sample in the case where the density of defects including dislocation is sufficiently low. Note that dislocation is a kind of crystal defect and is different from a vacancy defect.

The larger the crystallite size is, the more easily the O3′ type crystal structure is maintained and contraction of the c-axis length is inhibited in the state where x in LiₓCoO₂ is small as described later.

It is presumed that the crystallite size measured by XRD is larger when fewer defects including dislocation are observed with a TEM.

An XRD diffraction pattern for calculation of the crystallite size is preferably obtained in a state of the positive electrode active material alone, or may be obtained in a state of a positive electrode including a current collector, a binder, a conductive material, and the like in addition to the positive electrode active material. Note that the positive electrode active material may have orientation in the positive electrode owing to, for example, pressure application in a fabrication process. With a high degree of orientation, the crystallite size might fail to be calculated accurately; thus, it is further preferable to obtain an XRD diffraction pattern in the following manner: a positive electrode active material layer is extracted from the positive electrode, the binder and the like in the positive electrode active material layer are removed to some extent using a solvent or the like, and a sample holder is filled with the resultant positive electrode active material, for example. In another method, a powder sample may be attached onto a reflection-free silicon plate to which grease is applied, for example.

The crystallite size can be calculated using ICSD coll. code. 172909 as literature data of lithium cobalt oxide and a diffraction pattern that is obtained with Bruker D8 ADVANCE, for example, under the following conditions: CuKα₁ is used as an X-ray, the 2θ is from 15° to 90°, an increment is 0.005, and a detector is LYNXEYE XE-T. Analysis can be conducted using DIFFRAC.TOPAS ver. 6 as crystal structure analysis software, and exemplary settings are as follows.
Emission Profile: CuKa5.lam
Background: Chebychev polynomial of degree 5

### Instrument

Primary radius: 280 mm
Secondary radius: 280 mm
Linear PSD 2Th angular range: 2.9
   FDS angle: 0.3

### Full Axial Convolution

Filament length: 12 mm
Sample length: 15 mm
Receiving Slit length: 12 mm
Primary Sollers: 2.5
Secondary Sollers: 2.5

### Corrections

Specimen displacement: Refine
LP Factor: 0

A value of LVol-IB, which is a crystallite size obtained by correction with reference to the integral width calculated by the above method, is preferably employed as a crystallite size. When Preferred Orientation that is calculated is less than 0.8, the degree of orientation of a sample is too high; thus, this sample is not suitable for calculation of a crystallite size in some cases.

<<State where x in LiₓMO₂ is Small>>

The crystal structure in a state where x in LiₓMO₂ is small of the positive electrode active material 100 of one embodiment of the present invention is different from that of a conventional positive electrode active material because the positive electrode active material 100 has the above-described additive element distribution and/or crystal structure in a discharged state. Here, “x is small” means 0.1<x≤0.24.

A conventional positive electrode active material and the positive electrode active material 100 of one embodiment of the present invention are compared and changes in crystal structures owing to a change in x in LiₓMO₂ will be described with reference to FIG. 5 to FIG. 9.

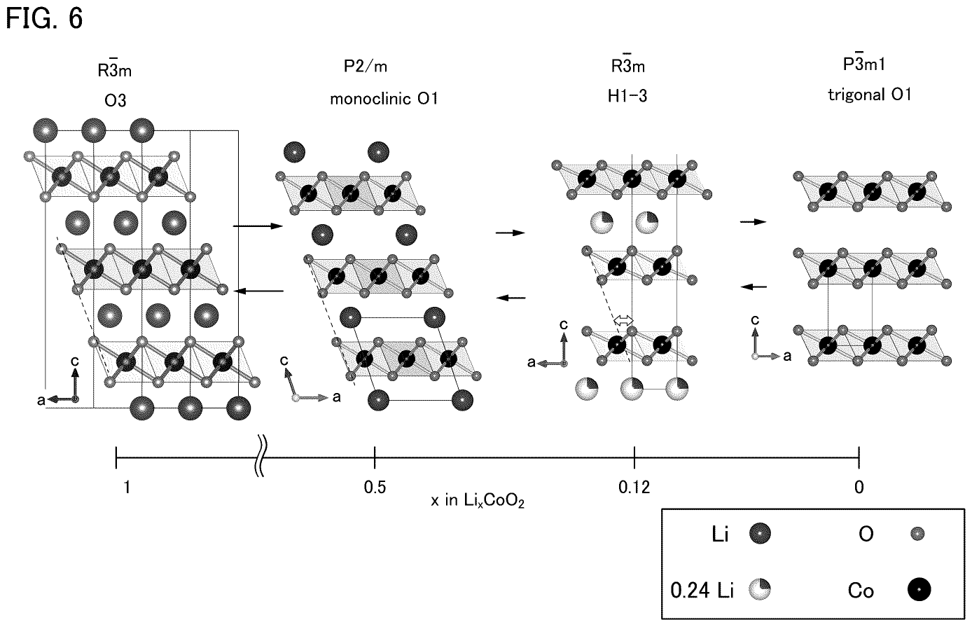

A change in the crystal structure of the conventional positive electrode active material is illustrated in FIG. 6. The conventional positive electrode active material illustrated in FIG. 6 is lithium cobalt oxide (LiCoO₂) containing no additive element. A change in the crystal structure of lithium cobalt oxide containing no additive element is described in Non-Patent Document 1 to Non-Patent Document 3 and the like.

FIG. 6 illustrates the crystal structure of lithium cobalt oxide with x=1 in LiₓCoO₂, which is denoted by R-3m O3. In this crystal structure, lithium occupies octahedral sites and a unit cell includes three CoO₂ layers. Thus, this crystal structure is referred to as an 03 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry due to lithium arrangement and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x=0 has the trigonal crystal structure belonging to the space group P-3 ml and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal O1 type structures and LiCoO₂ structures such as an R-3m O3 type structure are alternately stacked. Thus, this crystal structure is referred to as an H1-3 type crystal structure in some cases. Note that since insertion and extraction of lithium do not necessarily uniformly occur in the positive electrode active material in reality, the lithium concentrations can vary; thus, the H1-3 type crystal structure is started to be observed when x is approximately 0.25 experimentally. The number of cobalt atoms per unit cell in the actual H1-3 type crystal structure is twice that in other structures. However, in this specification including FIG. 6, the c-axis of the H1-3 type crystal structure is half that of the unit cell for easy comparison with the other crystal structures.

For the H1-3 type crystal structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be determined by the Rietveld analysis of XRD patterns, for example. In this case, a unit cell is selected such that the value of GOF (goodness of fit) is small.

When charging that makes x in LiₓCoO₂ be less than or equal to 0.24 and discharging are repeated, the crystal structure of conventional lithium cobalt oxide repeatedly changes between the R-3m O3 structure in a discharged state and the H1-3 type crystal structure (i.e., an unbalanced phase change).

However, there is a large shift in the CoO₂ layers between these two crystal structures. As denoted by the dotted lines and the arrows in FIG. 6, the CoO₂ layer in the H1-3 type crystal structure largely shifts from that in the R-3m O3 type structure in a discharged state. Such a dynamic structural change can adversely affect the stability of the crystal structure.

The difference in volume between the two crystal structures is also large. Thus, the difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be less than or equal to 0.24 and discharging are repeated, the crystal structure of conventional lithium cobalt oxide is gradually broken. The broken crystal structure triggers degradation of the cycling performance. This is because the broken crystal structure has a smaller number of sites where lithium can exist stably and makes it difficult to insert and extract lithium.

By contrast, in the positive electrode active material 100 of one embodiment of the present invention shown in FIG. 5, a change in the crystal structure between a discharged state 30 with x in LiₓMO₂ being 1 and a state with x being less than or equal to 0.24 is smaller than that in a conventional positive electrode active material. Specifically, a shift in the MO₂ layers between the state with x being 1 and the state with x being less than or equal to 0.24 can be small. Furthermore, a change in the volume in the case where the positive electrode active materials having the same number of cobalt atoms are compared can be small. Thus, the positive electrode active material 100 of one embodiment of the present invention can have a crystal structure that is unlikely to be broken even when charging that makes x be less than or equal to 0.24 and discharging are repeated, and can enable excellent cycling performance. In addition, the positive electrode active material 100 of one embodiment of the present invention with x in LiₓMO₂ being less than or equal to 0.24 can have a more stable crystal structure than a conventional positive electrode active material with x in LiₓMO₂ being less than or equal to 0.24. Thus, the positive electrode active material 100 of one embodiment of the present invention with x in LiₓMO₂ being kept at less than or equal to 0.24 inhibits a short circuit. This is preferable because the safety of the secondary battery is improved.

FIG. 5 shows crystal structures of the inner portion 100b of the positive electrode active material 100 in a state where x in LiₓMO₂ is 1, in a state where x is approximately 0.2, and in a state where x is approximately 0.15. The inner portion 100b, accounting for the majority of the volume of the positive electrode active material 100, largely contributes to charging and discharging and can be thus regarded as a portion where a shift in MO₂ layers and a volume change matter most.

The positive electrode active material 100 with x being 1 has the R-3m O3 crystal structure, which is the same as that of conventional lithium cobalt oxide.

However, in a state where x is less than or equal to 0.24, e.g., approximately 0.2 or approximately 0.15, which makes conventional lithium cobalt oxide have the H1-3 type crystal structure, the positive electrode active material 100 has a crystal structure different from the H1-3 type crystal structure.

The positive electrode active material 100 of one embodiment of the present invention with x being approximately 0.2 has a trigonal crystal structure belonging to the space group R-3m. The symmetry of the CoO₂ layers of this structure is the same as that of O3. Thus, this crystal structure is referred to as an O3′ type crystal structure. In FIG. 5, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811 (A), typically c=13.781 (A).

The positive electrode active material 100 of one embodiment of the present invention with x being approximately 0.15 has a monoclinic crystal structure belonging to the space group P2/m in some cases. This structure includes one CoO₂ layer in a unit cell. Here, lithium in the positive electrode active material 100 is approximately 15 at % of that in a discharged state. Thus, this crystal structure is referred to as a monoclinic O1(15) type crystal structure. In FIG. 5, this crystal structure is denoted by P2/m monoclinic O1(15).

In the unit cell of the monoclinic O1(15) type crystal structure, the coordinates of cobalt and oxygen can be represented as follows:
Co1 (0.5, 0, 0.5),
Co2 (0, 0.5, 0.5),
O1 (X_{O1}, 0, Z_{O1}),
within the ranges of 0.23≤X_{O1}≤0.24 and 0.61≤Z_{O1}≤0.65, and
O2 (X_{O2}, 0.5, Z_{O2}),
within the ranges of 0.75≤X_{O2}≤0.78 and 0.68≤Z_{O2}≤0.71. In addition, the lattice constant of
the unit cell is as follows:
a=4.880±0.05 Å,
b=2.817±0.05 Å,
c=4.839±0.05 Å,
α=90°,
β=109.6±0.1°, and
γ=90°.

This crystal structure can have the lattice constants even when belonging to the space group R-3m if a certain error is allowed. In that case, the coordinates of cobalt and oxygen in the unit cell can be represented as follows:
Co (0, 0, 0.5) and
O (0, 0, Zo),
within the range of 0.21≤Z_{O}≤0.23.

In addition, the lattice constant of the unit cell is as follows:
a=2.817±0.02 Å, and
c=13.68±0.1 Å.

In both of the O3′ type crystal structure and the monoclinic O1(15) type crystal structure, an ion of cobalt, nickel, magnesium, or the like occupies a site coordinated to six oxygen atoms. Light elements such as lithium and magnesium sometimes occupy a site coordinated to four oxygen atoms.

As denoted by dotted lines in FIG. 5, the CoO₂ layers hardly shift between the R-3m O3 type crystal structure in a discharged state, the O3′ type crystal structure, and the monoclinic O1(15) type crystal structure.

The R-3m O3 type crystal structure in a discharged state and the O3′ type crystal structure that contain the same number of cobalt atoms have a difference in volume of 2.5% or less, specifically 2.2% or less, typically 1.8%.

The R-3m O3 type crystal structure in a discharged state and the monoclinic O1(15) type crystal structure that contain the same number of cobalt atoms have a difference in volume of 3.3% or less, specifically 3.0% or less, typically 2.5%.

Table 1 shows the difference in volume per cobalt atom between the R-3m O3 type structure in a discharged state, the O3′ type structure, the monoclinic O1(15) type structure, the H1-3 type structure, and the trigonal O1 type structure. For the lattice constants of the R-3m O3 type crystal structure in a discharged state and the trigonal O1 type crystal structure in Table 1, which were used for the calculation, ICSD coll. code. O72909 and 88721 can be referred to. For the lattice constants of the H1-3 type structure, Non-Patent Document 3 can be referred to. In the case of the O3′ type structure and the monoclinic O1(15) type structure, the lattice constants thereof can be calculated from the experimental values of XRD.

TABLE 1

| | | | | | Volume of | Volume | Volume change |
|---|---|---|---|---|---|---|---|
| | Lattice constant | | | | unit cell | per Co | percentage |
| Crystal structure | a (Å) | b (Å) | c (Å) | β (°) | (Å³) | atom (Å³) | (%) |
| R-3m O3 (LiCoO₂) | 2.8156 | 2.8156 | 14.0542 | 90 | 96.49 | 32.16 | — |
| O3′ | 2.818 | 2.818 | 13.78 | 90 | 94.76 | 31.59 | 1.8 |
| Monoclinic O1(15) | 4.881 | 2.817 | 4.839 | 109.6 | 62.69 | 31.35 | 2.5 |
| H1-3 | 2.82 | 2.82 | 26.92 | 90 | 185.4 | 30.90 | 3.9 |
| Trigonal O1 (CoO_{1.92}) | 2.8048 | 2.8048 | 4.2509 | 90 | 28.96 | 28.96 | 10.0 |

As described above, in the positive electrode active material 100 of one embodiment of the present invention, a change in the crystal structure caused when x in LiₓMO₂ is small, i.e., when a large amount of lithium is extracted, is smaller than that in a conventional positive electrode active material. In addition, a change in the volume of the case where the positive electrode active materials having the same number of cobalt atoms are compared is reduced. Thus, the crystal structure of the positive electrode active material 100 is unlikely to be broken even when charging that makes x be less than or equal to 0.24 and discharging are repeated. Thus, the positive electrode active material 100 inhibits a decrease in charge/discharge capacity in charge/discharge cycles. Furthermore, the positive electrode active material 100 can stably use a larger amount of lithium than a conventional positive electrode active material and thus enables high discharge capacity per weight and per volume. Thus, with the use of the positive electrode active material 100, a secondary battery with high discharge capacity per weight and per volume can be fabricated.

The positive electrode active material 100 is confirmed to have the O3′ type crystal structure in some cases when x in LiₓMO₂ is greater than or equal to 0.15 and less than or equal to 0.24, and is assumed to have the O3′ type crystal structure even when x is greater than 0.24 and less than or equal to 0.27. In addition, the positive electrode active material 100 is confirmed to have the monoclinic O1(15) type crystal structure in some cases when x in LiₓMO₂ is greater than 0.1 and less than or equal to 0.2, typically greater than or equal to 0.15 and less than or equal to 0.17. However, the crystal structure is affected by not only x in LiₓMO₂ but also the number of charge/discharge cycles, a charge current and a discharge current, temperature, an electrolyte, and the like, so that the range of x is not limited to the above.

Thus, when x in LiₓMO₂ is greater than 0.1 and less than or equal to 0.24, the positive electrode active material 100 may have only the O3′ type crystal structure, only the monoclinic O1(15) type crystal structure, or both of them. Not all particles of the inner portion 100b of the positive electrode active material 100 necessarily have the O3′ type crystal structure and/or the monoclinic O1(15) type crystal structure. The positive electrode active material may have another crystal structure or may be partly amorphous.

In order to make x in LiₓMO₂ small, charging at a high charge voltage is necessary in general. Thus, the state where x in LiₓMO₂ is small can be rephrased as a state where charging at a high charge voltage has been performed. For example, when CC/CV charging is performed at 25 °C and a voltage higher than or equal to 4.60 V with reference to the potential of a lithium metal, the H1-3 type crystal structure appears in a conventional positive electrode active material. Thus, a charge voltage higher than or equal to 4.60 V can be regarded as a high charge voltage with reference to the potential of a lithium metal. In this specification and the like, unless otherwise specified, a charge voltage is shown with reference to the potential of a lithium metal.

Thus, in other words, the positive electrode active material 100 of one embodiment of the present invention is preferable because the positive electrode active material 100 can maintain the R-3m O3 type crystal structure having symmetry even when charging at a high charge voltage, e.g., higher than or equal to 4.6 V at 25 °C, is performed.

In the positive electrode active material 100, when the charge voltage is increased, the H1-3 type crystal structure is eventually observed in some cases. As described above, the crystal structure is affected by the number of charge/discharge cycles, a charge current and a discharge current, temperature, an electrolyte, and the like, so that the positive electrode active material 100 of one embodiment of the present invention may sometimes have the O3′ type crystal structure even at a lower charge voltage, e.g., a charge voltage higher than or equal to 4.50 V and lower than 4.60 V at 25 °C. Similarly, the positive electrode active material 100 may sometimes have the monoclinic O1(15) type crystal structure when charging is performed at a voltage higher than or equal to 4.65 V and lower than or equal to 4.7 V at 25 °C.

In the case where graphite is used as a negative electrode active material in a secondary battery, for example, the voltage of the secondary battery is lower than the above-mentioned voltage by the potential of graphite. The potential of graphite is approximately 0.05 V to 0.20 V with reference to the potential of a lithium metal. Therefore, in the case of a secondary battery using graphite as a negative electrode active material, a similar crystal structure is obtained at a voltage corresponding to the difference between the voltage of the case where a lithium metal is used as the negative electrode active material and the potential of the graphite.

Although a chance of the existence of lithium is the same in all lithium sites in the O3′ and monoclinic O1(15) type structures in FIG. 5, one embodiment of the present invention is not limited thereto. Lithium may exist unevenly in only some of the lithium sites; for example, lithium may symmetrically exist as in the monoclinic O1 type structure (Li_{0.5}CoO₂) shown in FIG. 6. The distribution of lithium can be analyzed by neutron diffraction, for example.

Each of the O3′ type crystal structure and the monoclinic O1(15) type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide charged to be Li_{0.06}NiO₂; however, pure lithium cobalt oxide or a layered rock-salt positive electrode active material containing a large amount of cobalt is known not to have the CdCl₂ type crystal structure generally.

### <<Crystal Grain Boundary>>

It is further preferable that the additive element contained in the positive electrode active material 100 of one embodiment of the present invention have the above-described distribution and be at least partly unevenly distributed at a crystal grain boundary and the vicinity thereof.

In this specification and the like, an uneven distribution means that the concentration of an element in a certain region differs from that in another region. This may be rephrased as segregation, precipitation, unevenness, deviation, or a mixture of a high-concentration portion and a low-concentration portion.

For example, the concentration of magnesium at a crystal grain boundary and the vicinity thereof in the positive electrode active material 100 is preferably higher than that in the other regions in the inner portion 100b. In addition, the concentration of fluorine at a crystal grain boundary and the vicinity thereof is preferably higher than that in the other regions in the inner portion 100b. In addition, the concentration of nickel at a crystal grain boundary and the vicinity thereof is preferably higher than that in the other regions in the inner portion 100b. In addition, the concentration of aluminum at a crystal grain boundary and the vicinity thereof is preferably higher than that in the other regions in the inner portion 100b.

A crystal grain boundary is a plane defect. Thus, a crystal grain boundary is likely to be unstable and a change in the crystal structure is likely to start at the crystal grain boundary as in the surface of the particle. Thus, the higher the concentration of the additive element at the crystal grain boundary and the vicinity thereof is, the more effectively the change in the crystal structure can be reduced.

When the magnesium concentration and the fluorine concentration are high at a crystal grain boundary and the vicinity thereof, the magnesium concentration and the fluorine concentration in the vicinity of a surface generated by a crack are also high even when the crack is generated along the crystal grain boundary of the positive electrode active material 100 of one embodiment of the present invention. Thus, the positive electrode active material after generation of a crack can also have an increased corrosion resistance to hydrofluoric acid. In addition, the positive electrode active material including a crack can inhibit a side reaction between the electrolyte solution and the positive electrode active material.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as an overreaction with the electrolyte solution.

The particle diameter of the positive electrode active material 100 can be measured with a laser diffraction particle size distribution analyzer, for example. As the particle diameter of the positive electrode active material 100 measured by a laser diffraction particle size distribution analyzer, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

Note that D50 is a particle diameter when the cumulative amount is 50% in a cumulative curve obtained as a result of the particle size distribution measurement. Similarly, D10 is a particle diameter when the cumulative amount is 10% in a cumulative curve obtained as a result of the particle size distribution measurement, and D90 is a particle diameter when the cumulative amount is 90% in a cumulative curve obtained as a result of the particle size distribution measurement.

A positive electrode is preferably formed using a mixture of particles having different particle diameters, in which case the electrode density can be increased, leading to a secondary battery with a high energy density. The positive electrode active material 100 with a relatively small particle diameter is expected to enable high charge/discharge rate performance. The positive electrode active material 100 with a relatively large particle diameter is expected to enable excellent charge/discharge cycling performance and maintenance of high discharge capacity.

### <Analysis Method>

Whether or not a given positive electrode active material is the positive electrode active material 100 of one embodiment of the present invention, which has the O3′ type crystal structure and/or monoclinic O1(15) type crystal structure when x in LiₓMO₂ is small, can be determined by analyzing a positive electrode including the positive electrode active material with small x in LiMO₂ by XRD, electron diffraction, neutron diffraction, electron spin resonance (ESR), nuclear magnetic resonance (NMR), or the like.

XRD is particularly preferably employed, in which case the symmetry of a transition metal such as cobalt in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

In the case where the crystallite size is measured by powder XRD, the measurement is preferably performed while the influence of orientation of positive electrode active material particles due to pressure application or the like is removed. For example, it is preferable that the positive electrode active material be taken out from a positive electrode obtained by disassembling a secondary battery, the positive electrode active material be made into a powder sample, and then the measurement be performed.

As described above, the positive electrode active material 100 of one embodiment of the present invention has a feature of a small change in the crystal structure between when x in LiMO₂ is 1 and when x is less than or equal to 0.24. A material 50% or more of which has the crystal structure that will be largely changed by high-voltage charging is not preferable because the material cannot withstand repetition of high-voltage charging and discharging.

It should be noted that the O3′type crystal structure or the monoclinic O1(15) type crystal structure is not obtained in some cases only by addition of the additive element. For example, when x in LiₓMO₂ is less than or equal to 0.24, lithium cobalt oxide containing magnesium and fluorine or lithium cobalt oxide containing magnesium and aluminum has the O3′ type crystal structure and/or the monoclinic O1(15) type crystal structure at 60% or more in some cases, and has the H1-3 type crystal structure at 50% or more in other cases, depending on the concentrations and distributions of the additive elements.

In the case where x is too small, e.g., less than or equal to 0.1, or under the condition where charge voltage is higher than 4.90 V, even the positive electrode active material 100 of one embodiment of the present invention sometimes has the H1-3 type crystal structure or the trigonal O1 type crystal structure. Thus, determining whether or not a positive electrode active material is the positive electrode active material 100 of one embodiment of the present invention requires analysis of the crystal structure by XRD and other methods and data such as charge capacity or charge voltage.

Note that the crystal structure of a positive electrode active material in a state with small x may be changed by exposure to the air. For example, the O3′ type crystal structure and the monoclinic O1(15) type crystal structure change into the H1-3 type crystal structure in some cases. For that reason, all samples subjected to analysis of crystal structures are preferably handled in an inert atmosphere such as an argon atmosphere.

Whether the distribution of the additive element contained in a positive electrode active material is in the above-described state can be determined by, for example, analysis using XPS, EDX, an electron probe microanalyzer (EPMA (also referred to as electron probe microanalysis)), or the like.

The crystal structure of the surface portion 100a, the crystal grain boundary, or the like can be analyzed by electron diffraction of a cross section of the positive electrode active material 100, for example.

### <<Charge Method>>

Charging for determining whether or not a composite oxide is the positive electrode active material 100 of one embodiment of the present invention can be performed on a coin cell (CR2032 type with a diameter of 20 mm and a height of 3.2 mm) that is fabricated as a test battery using the composite oxide and a lithium metal respectively for a positive electrode and a counter electrode, for example. The coin cell includes an electrolyte solution, a separator, a positive electrode can, and a negative electrode can.

More specifically, a positive electrode can be formed by application of slurry in which the positive electrode active material, a conductive material, and a binder are mixed to a positive electrode current collector made of aluminum foil.

A lithium metal can be used for the counter electrode. When the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in the electrolyte solution, 1 mol/L lithium hexafluorophosphate (LiPF₆) can be used, and for the electrolyte solution, ethylene carbonate (EC) and diethyl carbonate (DEC) at EC:DEC=3:7 (volume ratio) and 2 wt % vinylene carbonate (VC) that are mixed can be used.

As the separator, a 25-μm-thick polypropylene porous film can be used.

Stainless steel(SUS) can be used for the positive electrode can and the negative electrode can.

Note that the above coin cell (test battery) may be fabricated using a positive electrode taken out from a battery (e.g., a battery in the initial state provided in a commercially available product) by disassembly, and charging may be performed to determine whether or not the positive electrode active material 100 of one embodiment of the present invention described below is used.

The coin cell fabricated under the above conditions is charged with a given voltage (e.g., 4.50 V, 4.55 V, 4.60 V, 4.65 V, 4.70 V, 4.75 V, or 4.80 V). The charge method is not particularly limited as long as charging with a given voltage can be performed for sufficient time. In the case of CCCV charging, for example, CC charging can be performed at a current higher than or equal to 20 mA/g and lower than or equal to 100 mA/g. CV charging can be terminated at a current higher than or equal to 2 mA/g and lower than or equal to 10 mA/g. To observe a phase change of the positive electrode active material, charging with such a small current value is preferably performed. Meanwhile, in the case where a current does not reach higher than or equal to 2 mA/g and lower than or equal to 10 mA/g even when CV charging is performed for a long time, the CV charging may be terminated after the sufficient time passes from the start because the current is probably consumed not for charging the positive electrode active material but for decomposing the electrolyte solution. The sufficient time in that case can be longer than or equal to 1.5 hours and shorter than or equal to 3 hours. The temperature is set to 25 °C or 45 °C. After charging is performed in this manner, the coin cell is disassembled in a glove box with an argon atmosphere to take out the positive electrode, whereby the positive electrode active material with a given charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After the charging is completed, the positive electrode is preferably taken out and subjected to the analysis immediately. Specifically, the positive electrode is preferably subjected to the analysis within one hour after the completion of the charging, further preferably 30 minutes after the completion of the charging.

In the case where the crystal structure in a charged state after performing charging and discharging a plurality of times is analyzed, the conditions of the charging and discharging that are performed a plurality of times may be different from the above-described charge conditions. For example, the charging can be performed in the following manner: constant current charging to a given voltage (e.g., 4.60 V, 4.65 V, 4.70 V, 4.75 V, or 4.80 V) at a current value greater than or equal to 20 mA/g and less than or equal to 100 mA/g is performed and then, constant voltage charging is performed until the current value becomes greater than or equal to 2 mA/g and less than or equal to 10 mA/g. As the discharging, constant current discharging can be performed at higher than or equal to 20 mA/g and lower than or equal to 100 mA/g to 2.50 V.

Also in the case where the crystal structure in a discharged state after the charging and discharging are performed a plurality of times is analyzed, constant current discharging can be performed at a current value greater than or equal to 20 mA/g and less than or equal to 100 mA/g to 2.50 V, for example.

### <<Xrd>>

The apparatus and conditions for the XRD measurement are not particularly limited. For example, the measurement can be performed using the following apparatus and conditions.
XRD apparatus: D8 ADVANCE produced by Bruker AXS
X-ray: CuKα₁ radiation
Output: 40 kV, 40 mA
Angle of divergence: Div. Slit, 0.5°
Detector: LynxEye
Scanning method: 2θ/θ continuous scan
Measurement range (2θ): from 15° to 90°
Step width (2θ): 0.01°
Counting time: one second/step
Rotation of sample stage: 15 rpm

In the case where the measurement sample is powder, the sample can be set by, for example, being put in a glass sample holder or being sprinkled on a reflection-free silicon plate to which grease is applied. In the case where the measurement sample is a positive electrode, the positive electrode can be set by being attached to a substrate with a double-sided adhesive tape such that the position of the positive electrode active material layer and the measurement plane required by the apparatus are aligned.

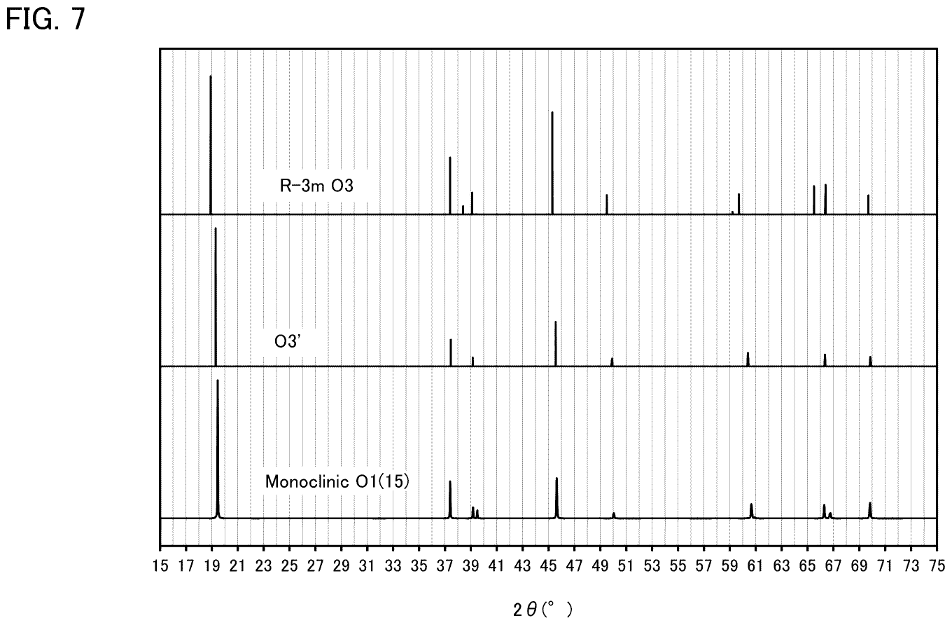

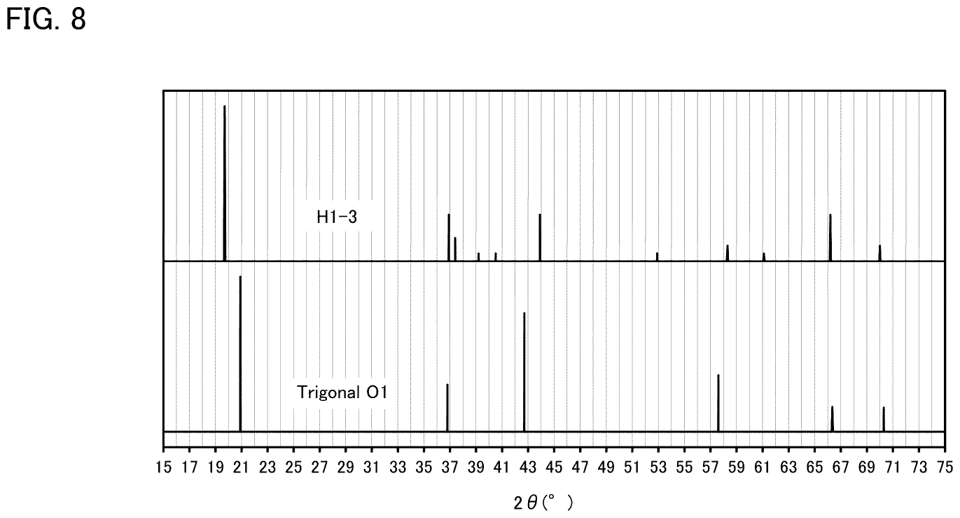

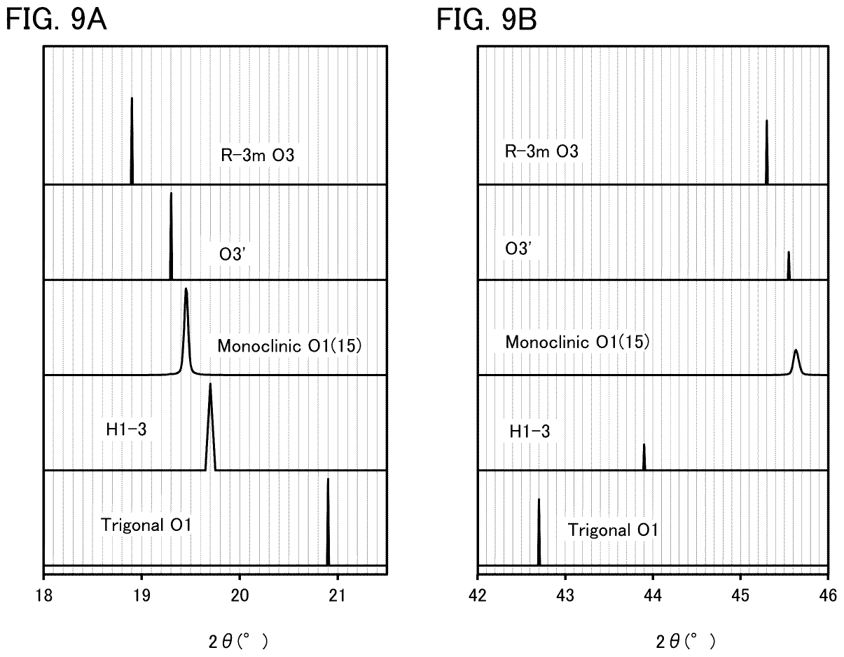

FIG. 7, FIG. 8, FIG. 9A, and FIG. 9B show ideal powder XRD patterns with CuKα₁ radiation that are calculated from models of the O3′ type crystal structure, the monoclinic O1(15) type crystal structure, and the H1-3 type crystal structure. For comparison, ideal XRD patterns calculated from the LiCoO₂ O₃ crystal structure with x=1 in LiₓMO₂ and the trigonal O1 crystal structure with x=0 are also shown. FIG. 9A and FIG. 9B each show the XRD patterns of the O3′ type crystal structure, the monoclinic O1(15) type crystal structure, and the H1-3 type crystal structure, and FIG. 9A and FIG. 9B are enlarged diagrams showing, respectively, the 20 range of 180 to 210 and the 20 range of 42° to 46°. The patterns of LiCoO₂ (O₃) and CoO₂ (O1) were made from crystal structure data obtained from the ICSD (see Non-Patent Document 4) with Reflex Powder Diffraction, which is a module of Materials Studio (BIOVIA). The 20 range was from 15° to 75°, the step size was 0.01, the wavelength X1 was 1.540562×10⁻¹⁰ m, the wavelength X2 was not set, and a single monochromator was used. The pattern of the H1-3 type crystal structure was similarly made from the crystal structure data disclosed in Non-Patent Document 3. The patterns of the O3′ type crystal structure and the monoclinic O1(15) type crystal structure were obtained in the following manner: the crystal structures were estimated from the XRD pattern of the positive electrode active material, fitting was performed with TOPAS ver. 3 (crystal structure analysis software produced by Bruker Corporation), and the XRD patterns were made in a manner similar to that for other structures.

As shown in FIG. 7, FIG. 9A, and FIG. 9B, the O3′ type crystal structure exhibits diffraction peaks at 2θ=19.25±0.12° (greater than or equal to 19.130 and less than 19.37°) and 20=45.47±0.100 (greater than or equal to 45.37° and less than 45.57°).

Furthermore, the monoclinic O1(15) type crystal structure exhibits diffraction peaks at 2θ=19.47±0.100 (greater than or equal to 19.370 and less than or equal to 19.57°) and 2θ=45.62+0.050 (greater than or equal to 45.57° and less than or equal to 45.67°).

However, as shown in FIG. 8, FIG. 9A, and FIG. 9B, the H1-3 type crystal structure and the trigonal O1 type structure do not exhibit peaks at these positions. Thus, it can be said that exhibiting peaks at greater than or equal to 19.130 and less than 19.370 and/or greater than or equal to 19.370 and less than or equal to 19.570 and at greater than or equal to 45.37° and less than 45.57° and/or greater than or equal to 45.57° and less than or equal to 45.67° in a state with small x in LiₓCoO₂ is the feature of the positive electrode active material 100 of one embodiment of the present invention.

It can also be said that in the positive electrode active material 100 of one embodiment of the present invention, the position of an XRD diffraction peak exhibited by the crystal structure with x=1 is close to that of an XRD diffraction peak exhibited by the crystal structure with x≤0.24. More specifically, it can be said that at 20 greater than or equal to 420 and less than or equal to 46°, the difference in 20 between the main diffraction peak exhibited by the crystal structure with x=1 and the main diffraction peak exhibited by the crystal structure with x≤0.24 is less than or equal to 0.7°, preferably less than or equal to 0.5°.

Although the positive electrode active material 100 of one embodiment of the present invention sometimes has the O3′ type crystal structure and/or the monoclinic O1(15) type crystal structure when x in LiₓCoO₂ is small, not all particles necessarily have the O3′ type crystal structure and/or the monoclinic O1(15) type crystal structure. The positive electrode active material may have another crystal structure, or may be partly amorphous. Note that when the XRD patterns are subjected to the Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% can enable sufficiently good cycling performance.

In addition, the H1-3 type crystal structure and the O1 type crystal structure preferably account for less than 50% in the Rietveld analysis performed in a similar manner. Alternatively, the H1-3 type crystal structure and the O1 type crystal structure preferably account for less than or equal to 34%. It is further preferable that substantially no H1-3 type crystal structure and substantially no O1 type crystal structure be observed.

Furthermore, even after 100 or more cycles of charging and discharging after the measurement starts, the O3′ type crystal structure and/or the monoclinic O1(15) type crystal structure preferably account(s) for greater than or equal to 35%, further preferably greater than or equal to 40%, still further preferably greater than or equal to 43% when the Rietveld analysis is performed.

Sharpness of a diffraction peak in an XRD pattern indicates the degree of crystallinity. It is thus preferable that the diffraction peaks after charging be sharp or in other words, have a small half width. For example, the half width is preferably small. Even peaks that are derived from the same crystal phase have different half widths depending on the XRD measurement conditions or the 2θ value. In the case of the above-described measurement conditions, the peak observed at 2θ greater than or equal to 43° and less than or equal to 46° preferably has a half width less than or equal to 0.2°, further preferably less than or equal to 0.15°, still further preferably less than or equal to 0.12°. Not all peaks need to fulfill the requirement. A crystal phase can be regarded as having high crystallinity when one or more peaks fulfill the requirement. Such high crystallinity sufficiently contributes to stability of the crystal structure after charging.

The crystallite size of the O3′ type crystal structure and the monoclinic O1(15) type crystal structure of the positive electrode active material 100 decreases to approximately 1/20 of that of LiCoO₂ (O3) in a discharged state. Thus, a clear peak of the O3′ type crystal structure and/or the monoclinic O1(15) type crystal structure can be observed when x in LiₓCoO₂ is small, even under the same XRD measurement conditions as those of a positive electrode before charging and discharging. By contrast, conventional LiCoO₂ has a small crystallite size and exhibits a broad and small peak even when it can partly have a structure similar to the O3′ type crystal structure and/or the monoclinic O1(15) type crystal structure. The crystallite size can be calculated from the half width of the XRD peak.

As described above, the influence of the Jahn-Teller effect is preferably small in the positive electrode active material 100 of one embodiment of the present invention. The positive electrode active material 100 may contain a transition metal such as nickel or manganese as the additive element in addition to cobalt as long as the influence of the Jahn-Teller effect is small.

For example, the value of a-axis/c-axis tends to significantly change between nickel concentrations of 5% and 7.5%, and the distortion of the a-axis becomes large at a nickel concentration of 7.5%. This distortion may be derived from the Jahn-Teller distortion of trivalent nickel. Therefore, among the transition metals M contained in the positive electrode active material 100, nickel is preferably at lower than 7.5 at %.

It is also indicated that the lattice constant changes differently at manganese concentrations of 5% or higher and does not follow the Vegard's law. Thus, among the transition metals M contained in the positive electrode active material 100, manganese is preferably at lower than or equal to 4 at %.

The nickel concentration and the manganese concentration in the surface portion 100a are not limited to the above ranges. In other words, the concentrations in the surface portion 100a may be higher than the above concentrations.

Examination of preferable ranges of the lattice constants of the positive electrode active material of one embodiment of the present invention based on the above revealed that, in the layered rock-salt crystal structure of the positive electrode active material 100 in a discharged state or a state where charging and discharging are not performed, which can be estimated from the XRD patterns, the lattice constant of the a-axis is preferably greater than 2.814×10⁻¹⁰ m and less than 2.817×10⁻¹⁰ m, and the lattice constant of the c-axis is preferably greater than 14.05×10⁻¹⁰ m and less than 14.07×10⁻¹⁰ m. The state where charging and discharging are not performed may be, for example, the state of powder before the formation of a positive electrode of a secondary battery.

Alternatively, in the layered rock-salt crystal structure of the positive electrode active material 100 in the discharged state or the state where charging and discharging are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in the discharged state or the state where charging and discharging are not performed is subjected to XRD analysis, a first peak is observed at 20 greater than or equal to 18.50° and less than or equal to 19.30° and a second peak is observed at 20 greater than or equal to 38.00° and less than or equal to 38.80°, in some cases.

### <<Resistance DCIR>>

In <<Charge method>> above, as charging for determining whether or not a composite oxide is the positive electrode active material 100 of one embodiment of the present invention, charging performed on a coin cell (CR2032 type with a diameter of 20 mm and a height of 3.2 mm) fabricated using a lithium counter electrode is described. With a coin cell fabricated in a similar manner, resistance DCIR can be measured to be low, which is a feature of the positive electrode active material 100 of one embodiment of the present invention.

The coin cell fabricated under the conditions that are the same as those in <<Charge method>> above is charged with a given voltage (e.g., 4.50 V, 4.55 V, 4.60 V, 4.65 V, 4.70 V, 4.75 V, or 4.80 V). The charge method is not particularly limited as long as charging with a given voltage can be performed for sufficient time. In the case of CCCV charging, for example, CC charging can be performed at a current higher than or equal to 20 mA/g and lower than or equal to 100 mA/g. CV charging can be terminated at a current higher than or equal to 2 mA/g and lower than or equal to 10 mA/g.

The charged coin cell is left to stand in a resting state (a state in which neither charging nor discharging is performed) for 10 minutes, and then, resistance DCIR (Direct Current Internal Resistance; also referred to as DC resistance) is measured. In the resistance DCIR measurement, discharging is performed at a current higher than or equal to 2 mA/g and lower than or equal to 10 mA/g per weight of the positive electrode active material (lithium cobalt oxide), e.g., a current of 6 mA/g, for one second, and the resistance DCIR can be calculated by dividing the difference between the open circuit voltage before the discharging and the voltage during the discharging by the above current (e.g., 6 mA/g).

For example, in the case where the open circuit voltage before the discharging (after the charging) is higher than or equal to 4.50 V and lower than or equal to 4.60 V, the resistance DCIR of the coin cell including the positive electrode active material 100 of one embodiment of the present invention is preferably lower than or equal to 60Ω, further preferably lower than or equal to 50Ω, still further preferably lower than or equal to 40Ω, yet still further preferably lower than or equal to 35Ω. Note that the series of measurements of resistance DCIR is preferably performed in a 45 °C environment.

### <<Xps>>

In an inorganic oxide, a region from the surface to a depth of approximately 1 nm to 8 nm (normally, less than or equal to 5 nm) can be analyzed by XPS using monochromatic aluminum Kα radiation as an X-ray source; thus, the concentrations of elements in a region at approximately half the depth of the surface portion 100a can be quantitatively analyzed by XPS. By changing the extracting angle of photoelectrons with respect to a measured surface (also referred to as an extraction angle or a detector angle), the depth of the analysis region can be changed; for example, in the case where the extraction angle is 45°, a region from the surface to a depth of approximately 5 nm can be analyzed, and in the case where the extraction angle is 15°, a region from the surface to a depth of approximately 2 nm can be analyzed. By the measurement under a plurality of conditions with different detection depths in XPS analysis as described above, the distribution of the additive element in the depth direction of the surface portion 100a can be estimated. Note that by combination with digging of a measured surface by Ar ion sputtering, the distribution of the additive element to approximately several micrometers in the depth direction can also be measured. As the XPS apparatus, an apparatus such as QuanteraII QuanteraSXM manufactured by ULVAC-PHI, Inc. can be used, for example.

In the above measurement, the bonding states of the elements can be analyzed by narrow scanning. In many cases, the quantitative accuracy of XPS is approximately ±1 at %, and the lower detection limit is approximately 0.1 at % to 1 at % but depends on the element.

In the positive electrode active material 100 of one embodiment of the present invention, the concentration(s) of one or two or more selected from the additive elements is/are preferably higher in the surface portion 100a than in the inner portion 100b. This means that the concentration(s) of one or two or more selected from the additive elements in the surface portion 100a is/are preferably higher than the average concentration of the selected element(s) in the entire positive electrode active material 100. For this reason, for example, it can be said that it is preferable that the concentration(s) of one or two or more additive elements selected from the surface portion 100a, which is measured by XPS or the like, be higher than the average concentration of the additive element(s) in the entire positive electrode active material 100, which is measured by ICP-MS, GD-MS, or the like. For example, the concentration of magnesium of at least part of the surface portion 100a, which is measured by XPS or the like, is preferably higher than the average concentration of magnesium of the entire positive electrode active material 100. The concentration of titanium of at least part of the surface portion 100a is preferably higher than the average concentration of titanium of the entire positive electrode active material 100. The concentration of nickel of at least part of the surface portion 100a is preferably higher than the average concentration of nickel of the entire positive electrode active material 100. The concentration of aluminum of at least part of the surface portion 100a is preferably higher than the average concentration of aluminum of the entire positive electrode active material 100. The concentration of fluorine of at least part of the surface portion 100a is preferably higher than the average concentration of fluorine of the entire positive electrode active material 100.

The surface and the surface portion 100a of the positive electrode active material 100 of one embodiment of the present invention do not contain a carbonate, a hydroxy group, or the like that is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantification of the elements contained in the positive electrode active material, correction may be performed to exclude carbon, hydrogen, excessive oxygen, excessive fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The ratio of the additive element to cobalt is preferably used, in which case comparison can be performed while reducing the influence of a carbonate or the like that is chemically adsorbed after formation of the positive electrode active material. For example, in the XPS analysis, the ratio Mg/Co of the number of magnesium (Mg) atoms to the number of cobalt (Co) atoms is preferably greater than or equal to 0.4 and less than or equal to 1.5. In the XPS analysis, the ratio Ti/Co of the number of titanium (Ti) atoms to the number of cobalt (Co) atoms is preferably greater than or equal to 0.05 and less than or equal to 0.20. In the XPS analysis, the ratio Ni/Co of the number of nickel (Ni) atoms to the number of cobalt (Co) atoms is preferably greater than or equal to 0.05 and less than or equal to 0.20. In ICP-MS analysis, Mg/Co is preferably greater than or equal to 0.002 and less than or equal to 0.06.

It is further preferable that aluminum be widely distributed in a deep region, e.g., a region at a depth greater than or equal to 5 nm and less than or equal to 50 nm from the surface or the reference point. Therefore, it is further preferable that the concentration of aluminum be lower than or equal to 1 at % or no aluminum be detected by XPS or the like while aluminum be detected by analysis on the entire positive electrode active material 100 by ICP-MS, GD-MS, or the like.

In the XPS analysis, monochromatic aluminum Kα radiation can be used as an X-ray, for example. An extraction angle is, for example, 45°. For example, the measurement can be performed using the following apparatus and conditions.
Measurement apparatus: QuanteraII produced by ULVAC-PHI, Inc.
X-ray source: monochromatic Al Kα (1486.6 eV)
   Detection area: 100 μmφ
   Detection depth: a range at approximately 4 nm to 5 nm from a surface (detector angle: 45°)
   Measurement spectrum: wide scanning, narrow scanning of each detected element

In addition, when the positive electrode active material 100 of one embodiment of the present invention is analyzed by XPS, a peak indicating the binding energy of fluorine with another element is preferably at greater than or equal to 682 eV and less than 688 eV.

Furthermore, when the positive electrode active material 100 of one embodiment of the present invention is analyzed by XPS, a peak indicating the binding energy of magnesium with another element is preferably at greater than or equal to 1302 eV and less than 1306 eV, further preferably at approximately 1304 eV.

Furthermore, when the positive electrode active material 100 of one embodiment of the present invention is analyzed by XPS, a peak indicating the binding energy of titanium with another element is preferably at greater than or equal to 455 eV and less than 460 eV, and Ti is preferably tetravalent.

Furthermore, when the positive electrode active material 100 of one embodiment of the present invention is analyzed by XPS, a peak indicating the binding energy of nickel with another element is preferably at greater than or equal to 855 eV and less than 859 eV, and is preferably shifted to the higher energy side to exceed 854 eV, which is assumed to be the binding energy of Ni²⁺—O.

### <<Edx>>

One or two or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using an FIB or the like and analyzing the cross section using EDX, EPMA, or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive element in the surface portion 100a, the inner portion 100b, the vicinity of a crystal grain boundary, and the like of the positive electrode active material 100 can be quantitatively analyzed. By EDX line analysis, the concentration distribution and the maximum value of the additive element can be analyzed. Analysis in which a thinned sample is used, such as STEM-EDX, is preferably used to analyze the concentration distribution in the depth direction from the surface towards the center in a specific region of the positive electrode active material without the influence of the distribution in the front-back direction.

Since the positive electrode active material 100 is a compound containing oxygen and a transition metal into and from which lithium can be inserted and extracted, an interface between a region where oxygen and the transition metal M(Co, Ni, Mn, Fe, or the like) that is oxidized or reduced due to insertion and extraction of lithium exist and a region where oxygen and the transition metal Mdo not exist is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

In STEM-EDX line analysis or the like, it is sometimes difficult to precisely determine the surface because a steep change in a graph of the detection amount of a characteristic X-ray of an element is not seen in principle or due to a measurement error. Therefore, in the case where a depth direction is referred to in STEM-EDX line analysis or the like, a point where the detection amount of the characteristic X-ray of the transition metal M is equal to 50% of the sum of the average value M_{AVE} of the detection amounts of the characteristic X-ray of the transition metal M in the inner portion and the average value M_{BG} of the detection amounts of the characteristic X-ray of the transition metal M of the background or a point where the detection amount of the characteristic X-ray of oxygen is equal to 50% of the sum of the average value O_{AVE} of the detection amounts of the characteristic X-ray of oxygen in the inner portion and the average value O_{BG} of the detection amounts of the characteristic X-ray of oxygen of the background is regarded as the reference point. When the point where the detection amount of the characteristic X-ray of the transition metal M is equal to 50% of the sum of the average value of the detection amounts of the characteristic X-ray of the transition metal M in the inner portion and the average value of the detection amounts of the characteristic X-ray of the transition metal M of the background is different from the point where the detection amount of the characteristic X-ray of oxygen is equal to 50% of the sum of the average value of the detection amounts of the characteristic X-ray of oxygen in the inner portion and the average value of the detection amounts of the characteristic X-ray of oxygen of the background, the difference is probably due to the influence of a carbonate, a metal oxide containing oxygen, or the like, which is attached to the surface; thus, in such a case, the point where the detection amount of the characteristic X-ray of the transition metal M is equal to 50% of the sum of the average value M_{AVE} of the detection amounts of the characteristic X-ray of the transition metal Min the inner portion and the average value M_{BG} of the detection amounts of the characteristic X-ray of the transition metal M of the background can be employed as the reference point. In the case of a positive electrode active material containing a plurality of the transition metals M, the reference point can be determined using M_{AVE} and M_{BG} of the element whose detection amount of the characteristic X-ray in the inner portion is the largest. Note that in this specification and the like, the background in STEM-EDX line analysis refers to, for example, the detection amount of a characteristic X-ray of an element to be measured in a portion that can be obviously regarded as the outside of a particle to be measured, in STEM-EDX line analysis performed from the outside of the particle to be measured to the inside thereof or from the inside to the outside so as to pass through the surface of the particle.

The average value M_{BG} of the detection amounts of the characteristic X-ray of the transition metal M of the background can be calculated by averaging the detection amounts in the range at greater than or equal to 2 nm, preferably greater than or equal to 3 nm, outside the positive electrode active material, apart from the vicinity of the portion at which the detection amount of the characteristic X-ray of the transition metal M begins to increase, for example. The average value M_{AVE} of the detection amounts of the characteristic X-ray of the transition metal Min the inner portion can be calculated by averaging the detection amounts in the range at greater than or equal to 2 nm, preferably greater than or equal to 3 nm in the region in which the detection amounts of the characteristic X-rays of the transition metal M and oxygen are saturated and stabilized, e.g., the portion at a depth larger than, by greater than or equal to 30 nm, preferably greater than 50 nm, the depth of the region in which the detection amount of the characteristic X-ray of the transition metal M begins to increase. The average value O_{BG} of the detection amounts of the characteristic X-ray of oxygen of the background and the average value O_{AVE} of the detection amounts of the characteristic X-ray of oxygen in the inner portion can be calculated in a similar manner.

The surface of the positive electrode active material 100 in, for example, a cross-sectional STEM image is a boundary between a region where an image derived from the crystal structure of the positive electrode active material is observed and a region where the image is not observed, and is determined as the outermost surface of a region where an atomic column derived from an atomic nucleus of, among metal elements which constitute the positive electrode active material, a metal element that has a larger atomic number than lithium is confirmed.

A peak in STEM-EDX line analysis refers to a local maximum value of a projecting shape appearing in the graph of the characteristic X-ray intensity of each element or the maximum value of the characteristic X-ray of each element. A conceivable noise in STEM-EDX line analysis is, for example, a measured value having a half width smaller than or equal to spatial Resolution®, e.g., smaller than or equal to R/2.

The adverse effect of a noise can be reduced by scanning the same portion a plurality of times under the same conditions. For example, an integrated value obtained by performing scanning six times can be used as the detection value of each element. The number of times of scanning is not limited to six and an average of measured values obtained by performing scanning seven or more times can be used as the detection value of each element.

STEM-EDX line analysis can be performed as follows, for example. First, a protective film is deposited by evaporation over the surface of a positive electrode active material. For example, carbon can be deposited by evaporation with an ion sputtering apparatus (MC1000, produced by Hitachi High-Tech Corporation).

Next, the positive electrode active material is thinned to fabricate a STEM cross-section sample. For example, the positive electrode active material can be thinned with an FIB-SEM apparatus (XVision 200TBS, produced by Hitachi High-Tech Corporation). Here, picking up can be performed by an MPS (micro probing system), and as an example of the conditions of the finishing processing, an acceleration voltage can be 10 kV.

The STEM-EDX line analysis can be performed using, for example, a STEM apparatus (HD-2700 produced by Hitachi High-Tech Corporation) and Octane T Ultra W produced by EDAX Inc as an EDX detector. Example conditions of the EDX line analysis using HD-2700 produced by Hitachi High-Tech Corporation are as follows: the emission current of the STEM apparatus is set to be higher than or equal to 6 μA and lower than or equal to 10 μA, and a portion of the thinned sample, which is not so deep and has little unevenness, is measured. The magnification is approximately 150,000 times, for example. The EDX line analysis can be performed under conditions where drift correction is performed, the line width is 42 nm, the pitch is 0.2 nm, and the number of frames is 6 or more.

To increase the spatial resolution in STEM-EDX line analysis, the beam diameter of an electron beam (also referred to as a beam diameter or a probe diameter) is preferably small. The beam diameter in STEM-EDX line analysis is preferably less than or equal to 0.3 nm, further preferably less than or equal to 0.2 nm, still further preferably less than or equal to 0.1 nm. To increase the analysis sensitivity in STEM-EDX line analysis, a beam current of an electron beam (also referred to as a probe current) is preferably increased. Thus, the apparatus used for STEM-EDX line analysis preferably includes a spherical aberration corrector (Cs collector) that can make a beam diameter small and increase a beam current.

When EDX area analysis or EDX point analysis of the positive electrode active material 100 of one embodiment of the present invention is performed, the concentration of each additive element, particularly one or more of magnesium, nickel, and titanium, in the surface portion 100a is preferably higher than the concentration of the element in the inner portion 100b. Alternatively, the detection amount of each additive element, particularly one or more of magnesium, nickel, and titanium, in the surface portion 100a is preferably higher than the detection amount of the element in the inner portion 100b.

For example, when EDX area analysis or EDX point analysis of the positive electrode active material 100 containing magnesium as the additive element is performed, the magnesium concentration in the surface portion 100a is preferably higher than the magnesium concentration in the inner portion 100b. When the EDX line analysis is performed, the peak of the magnesium concentration in the surface portion 100a is preferably present at a depth less than or equal to 3 nm, further preferably less than or equal to 1 nm, still further preferably less than or equal to 0.5 nm from the surface of the positive electrode active material 100 or the reference point toward the center. In addition, the magnesium concentration preferably attenuates, at a depth of 1 nm from the peak top, to less than or equal to 60% of the peak. In addition, the magnesium concentration preferably attenuates, at a depth of 2 nm from the peak top, to less than or equal to 30% of the peak. For another example, when EDX area analysis or EDX point analysis of the positive electrode active material 100 containing magnesium as the additive element is performed, the detection amount of the characteristic X-ray of magnesium in the surface portion 100a is preferably higher than the detection amount of the characteristic X-ray of magnesium in the inner portion 100b. When the EDX line analysis is performed, the peak of the detection amount of the characteristic X-ray of magnesium in the surface portion 100a is preferably present at a depth less than or equal to 3 nm, further preferably less than or equal to 1 nm, still further preferably less than or equal to 0.5 nm from the surface of the positive electrode active material 100 or the reference point toward the center. In addition, the detection amount of the characteristic X-ray of magnesium preferably attenuates, at a depth of 1 nm from the peak top, to less than or equal to 60% of the peak. In addition, the detection amount of the characteristic X-ray of magnesium preferably attenuates, at a depth of 2 nm from the peak top, to less than or equal to 30% of the peak. Here, a peak top of a concentration refers to a local maximum value of a projecting shape appearing in a concentration distribution graph of each element or the position where the local maximum value appears. A peak top of a detection amount refers to a local maximum value of a projecting shape appearing in a detection amount distribution graph of each element or the position where the local maximum value appears.

When the EDX line analysis is performed, the maximum value of the magnesium concentration (the detection amount of magnesium/the sum of the detection amounts of magnesium, oxygen, cobalt, fluorine, aluminum, titanium, and nickel) in the surface portion 100a is preferably greater than or equal to 0.5 Atomic % and less than or equal to 10 Atomic %, further preferably greater than or equal to 1 Atomic % and less than or equal to 7 Atomic % or greater than or equal to 1 Atomic % and less than or equal to 5 Atomic %.

When the EDX line analysis is performed, the maximum value of the titanium concentration (the detection amount of titanium/the sum of the detection amounts of magnesium, oxygen, cobalt, fluorine, aluminum, titanium, and nickel) in the surface portion 100a is preferably greater than or equal to 0.2 Atomic % and less than or equal to 10 Atomic %, further preferably greater than or equal to 0.5 Atomic % and less than or equal to 6 Atomic % or greater than or equal to 0.5 Atomic % and less than or equal to 5 Atomic %.

When the EDX line analysis is performed, the maximum value of the nickel concentration (the detection amount of nickel/the sum of the detection amounts of magnesium, oxygen, cobalt, fluorine, aluminum, titanium, and nickel) in the surface portion 100a is preferably greater than or equal to 0.2 Atomic % and less than or equal to 5 Atomic %, further preferably greater than or equal to 0.5 Atomic % and less than or equal to 4 Atomic % or greater than or equal to 0.5 Atomic % and less than or equal to 3 Atomic %.

When the EDX line analysis is performed, the maximum value of the fluorine concentration (the detection amount of fluorine/the sum of the detection amounts of magnesium, oxygen, cobalt, fluorine, aluminum, titanium, and nickel) in the surface portion 100a is preferably greater than or equal to 0.5 Atomic % and less than or equal to 10 Atomic %, further preferably greater than or equal to 1 Atomic % and less than or equal to 6 Atomic %.

When the positive electrode active material 100 contains magnesium and fluorine as the additive elements, the distribution of fluorine preferably includes a region that overlaps with the distribution of magnesium. For example, the difference in the depth direction between the peak of the concentration or detection amount of fluorine and the peak of the concentration or detection amount of magnesium is preferably less than or equal to 10 nm, further preferably less than or equal to 3 nm, still further preferably less than or equal to 1 nm, still further preferably less than or equal to 0.5 nm, still further preferably less than or equal to 0.3 nm.

In the positive electrode active material 100 containing nickel as the additive element, the peak of the concentration or detection amount of nickel in the surface portion 100a is preferably present at a depth less than or equal to 3 nm, further preferably less than or equal to 1 nm, still further preferably less than or equal to 0.5 nm from the surface of the positive electrode active material 100 or the reference point toward the center. When the positive electrode active material 100 contains magnesium and nickel, the distribution of nickel preferably includes a region overlapping with the distribution of magnesium. For example, the difference in the depth direction between the peak of the concentration or detection amount of nickel and the peak of the concentration or detection amount of magnesium is preferably less than or equal to 3 nm, further preferably less than or equal to 1 nm.

In the positive electrode active material 100 containing titanium as the additive element, the peak of the concentration or detection amount of titanium in the surface portion 100a is preferably present at a depth less than or equal to 3 nm, further preferably less than or equal to 1 nm, still further preferably less than or equal to 0.5 nm from the surface of the positive electrode active material 100 or the reference point toward the center. When the positive electrode active material 100 contains magnesium and titanium, the distribution of titanium preferably includes a region overlapping with the distribution of magnesium. For example, the difference in the depth direction between the peak of the concentration or detection amount of titanium and the peak of the concentration or detection amount of magnesium is preferably less than or equal to 3 nm, further preferably less than or equal to 1 nm.

In the case where the positive electrode active material 100 contains aluminum as the additive element, in the EDX line analysis, the peak of the concentration or detection amount of magnesium, nickel, or fluorine is preferably closer to the surface than the peak of the concentration or detection amount of aluminum in the surface portion 100a. In other words, the peak of the concentration or detection amount of aluminum in the surface portion 100a is preferably closer to the inner portion than the peak of the concentration or detection amount of magnesium, nickel, or fluorine. For example, the peak of the concentration or detection amount of aluminum is preferably present at a depth greater than or equal to 0.5 nm and less than or equal to 50 nm, further preferably greater than or equal to 5 nm and less than or equal to 50 nm from the surface of the positive electrode active material 100 or the reference point toward the center.

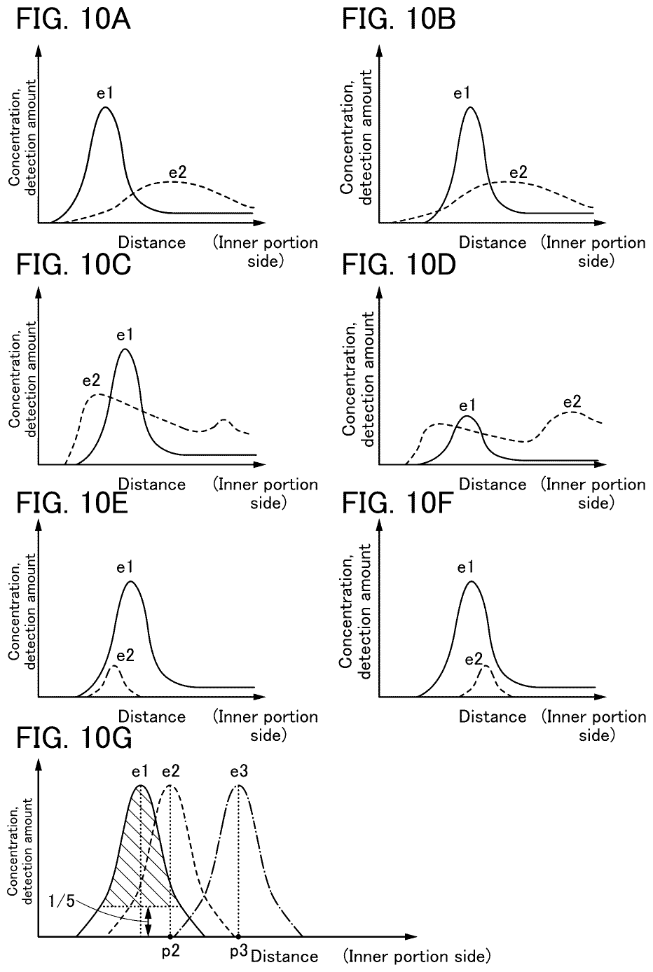

Here, the way of expressing the positional relation of the distributions of elements subjected to EDX line analysis is described with reference to FIG. 10A to FIG. 10G. FIG. 10A to FIG. 10F are schematic diagrams showing the distributions of concentrations or detection amounts (also referred to as count values) of a first element e1 and a second element e2. FIG. 10G is a schematic diagram showing the distributions of concentrations or detection amounts of the first element e1, the second element e2, and a third element e3.

For example, the case where the distributions of concentrations or detection amounts of the first element e1 and the second element e2 have shapes as shown in FIG. 10A is described with the expression “the position where the concentration or detection amount of the second element e2 is the maximum is closer to the inner portion than the position where the concentration or detection amount of the first element e1 is the maximum”. For example, the case where the distributions of concentrations or detection amounts of the first element e1 and the second element e2 have shapes as shown in FIG. 10B is described with the expression “the position where the concentration or detection amount of the second element e2 is the maximum is closer to the inner portion than the position where the concentration or detection amount of the first element e1 is the maximum”. For example, the case where the distributions of the concentrations or detection amounts of the first element e1 and the second element e2 have shapes as shown in FIG. 10C is described with the expression “the position where the concentration or detection amount of the first element e1 is the maximum is closer to the inner portion than the position where the concentration or detection amount of the second element e2 is the maximum”. For example, the case where the distributions of the concentrations or detection amounts of the first element e1 and the second element e2 have shapes as shown in FIG. 10D is described with the expression “the position where the concentration or detection amount of the second element e2 is the maximum is closer to the inner portion than the position where the concentration or detection amount of the first element e1 is the maximum”. For example, the case where the distributions of the concentrations or detection amounts of the first element e1 and the second element e2 have shapes as shown in FIG. 10E is described with the expression “the position where the concentration or detection amount of the first element e1 is the maximum is closer to the inner portion than the position where the concentration or detection amount of the second element e2 is the maximum”. For example, the case where the distributions of the concentrations or detection amounts of the first element e1 and the second element e2 have shapes as shown in FIG. 10F is described with the expression “the position where the concentration or detection amount of the second element e2 is the maximum is closer to the inner portion than the position where the concentration or detection amount of the first element e1 is the maximum”.

The expression “distributions have an overlapping region” is described with the case where the distributions of the concentrations or detection amounts of the first element e1, the second element e2, and the third element e3 are in the positional relation as shown in FIG. 10G as an example. In this specification, the expression “distributions of two elements have an overlapping region” means that the position of the maximum value in the distribution of the concentration or detection amount of at least one element is located within the range where the concentration or detection amount of the other element is higher than or equal to 1/5 of the maximum value in the distribution of the concentration or detection amount of the other element, for example. Note that in the case where the background detection intensity in the EDX line analysis is higher than or equal to “1/5 of the maximum value”, “1/5 of the maximum value” in the above sentence is “the background detection intensity (also referred to as lower detection limit)”.

For example, in the case of the positional relation as shown in FIG. 10G, the position (P2) of the maximum value in the distribution of the concentration or detection amount of the second element e2 is located within the range (a hatched region in the diagram) where the concentration or detection amount of the first element e1 is higher than or equal to ⅕ of the maximum value (or the lower detection limit) in the distribution of the concentration or detection amount of the first element e1; thus, this is described with the expression “the distribution of the first element e1 and the distribution of the second element e2 have an overlapping region”. The position (P3) of the maximum value in the distribution of the concentration or detection amount of the third element e3 is not located within the range (a hatched region in the diagram) where the concentration or detection amount of the first element e1 is higher than or equal to 1/5 of the maximum value (or the lower detection limit) in the distribution of the concentration or detection amount of the first element e1; thus, this cannot be described with the expression “the distribution of the first element e1 and the distribution of the third element e3 have an overlapping region”.

In the case of the positional relation as shown in FIG. 10G, it can be said that the distribution of the second element e2 and the distribution of the third element e3 are closer to the inner portion than the distribution of the first element e1. Alternatively, it can be said that the distribution of the second element e2 and the distribution of the third element e3 are localized closer to the inner portion than the distribution of the first element e1.

In the case where the positive electrode active material 100 contains magnesium, titanium, nickel, and aluminum, a battery fabricated using the positive electrode active material 100 can achieve both “high cycling performance” such that discharge capacity degradation by repetition of high-voltage charging (e.g., charging with an upper limit of 4.60 V) and discharging can be inhibited, and “excellent low-temperature characteristics” enabling high discharge capacity at low temperatures (e.g., 0 °C, −20 °C, and −40 °C).

When the positive electrode active material 100 is subjected to EDX line, area, or point analysis, the ratio (Mg/Co) of the number of magnesium Mg atoms to the number of cobalt Co atoms at the peak of the magnesium concentration is preferably greater than or equal to 0.05 and less than or equal to 0.6, further preferably greater than or equal to 0.1 and less than or equal to 0.4. The ratio (Al/Co) of the number of aluminum Al atoms to the number of cobalt Co atoms at the peak of the aluminum concentration is preferably greater than or equal to 0.05 and less than or equal to 0.6, further preferably greater than or equal to 0.1 and less than or equal to 0.45. The ratio (Ni/Co) of the number of nickel Ni atoms to the number of cobalt Co atoms at the peak of the nickel concentration is preferably greater than or equal to 0 and less than or equal to 0.2, further preferably greater than or equal to 0.01 and less than or equal to 0.1. The ratio (F/Co) of the number of fluorine F atoms to the number of cobalt Co atoms at the peak of the fluorine concentration is preferably greater than or equal to 0 and less than or equal to 1.6, further preferably greater than or equal to 0.1 and less than or equal to 1.4.

When the positive electrode active material 100 is subjected to line analysis or area analysis, the ratio (A/Co) of the number of atoms of an additive element A to the number of cobalt Co atoms in the vicinity of a crystal grain boundary is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30.

In the case where the additive element is magnesium, for example, when the positive electrode active material 100 is subjected to line analysis or area analysis, the ratio (Mg/Co) of the number of magnesium atoms to the number of cobalt atoms in the vicinity of a crystal grain boundary is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30. When the ratio is within the above range in a plurality of portions, e.g., three or more portions, of the positive electrode active material 100, it can be said that the additive element is not attached to the surface of the positive electrode active material 100 in a narrow range but widely distributed at a preferable concentration in the surface portion 100a of the positive electrode active material 100.

### <<Epma>>

The concentration of an additive element contained in the positive electrode active material 100 can be analyzed using EPMA as well as using EDX. In analysis of an element that is present in a slight amount in a sample, EPMA has higher detection capability (in other words, the lower detection limit is lower) than EDX. Thus, EPMA is preferably used when a region in which an additive element is present in a slight amount is analyzed.

In EPMA analysis, a cross section of the positive electrode active material 100 is exposed by mechanical polishing, ion polishing, FIB, or the like, and the cross section is analyzed. As an apparatus for EPMA, an electron probe microanalyzer, JXA-iHP200F produced by JEOL Ltd., can be used, for example.

Using a wavelength-dispersive detector, EPMA has higher capability of detecting slight amounts of elements than EDX using an energy-dispersive detector. On the other hand, the spatial resolution in the EPMA analysis is inferior to that in EDX (in particular, STEM-EDX). Therefore, STEM-EDX is suitable for analysis focusing on the detailed distribution of an additive element in the surface portion 100a of the positive electrode active material 100, and the EPMA analysis is suitable for analysis of a slight amount of an additive element in the inner portion 100b. Since the analysis methods of EPMA and EDX are different from each other, the concentration values obtained when the same region is analyzed by the analysis methods are not the same in some cases.

Slight amounts of magnesium and nickel are preferably contained as the additive elements in the inner portion 100b of the positive electrode active material 100. For example, in EPMA analysis, the ratio Mg/Co of the number of magnesium (Mg) atoms to the number of cobalt (Co) atoms in the inner portion 100b is preferably greater than or equal to 0.003 and less than or equal to 0.01. In EPMA analysis, the ratio Ni/Co of the number of nickel (Ni) atoms to the number of cobalt (Co) atoms in the inner portion 100b is preferably greater than or equal to 0.003 and less than or equal to 0.01. Meanwhile, in EPMA analysis, the number of titanium atoms in the inner portion 100b is preferably below the lower detection limit. Note that the lower detection limit of the number of titanium atoms is 0.2 at % in the case where an inner portion of lithium cobalt oxide is analyzed with JXA-iHP200F, for example.

### <<Raman Spectroscopy>>

As described above, at least part of the surface portion 100a of the positive electrode active material 100 of one embodiment of the present invention preferably has a rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a STEM image and a nanobeam electron diffraction pattern described later, a bright spot cannot be detected when cobalt that is substituted at a lithium site, cobalt that exists at a site coordinated to four oxygen atoms, or the like does not appear with a certain frequency in the depth direction in observation. Meanwhile, Raman spectroscopy is analysis that observes a vibration mode of a bond such as a Co—O bond, so that even when the number of Co—O bonds is small, the peak of a wave number of a corresponding vibration mode can be observed in some cases. Furthermore, since Raman spectroscopy can measure a range with an area of several square micrometers and a depth of approximately 1 μm of a surface portion, states that exist only at the surface of a particle can be observed with high sensitivity.

When a laser wavelength is 532 nm, for example, peaks (vibration mode: E_{g}, A_{1g}) of layered rock-salt LiCoO₂ are observed at 470 cm⁻¹ to 490 cm⁻¹ and at 580 cm⁻¹ to 600 cm⁻¹. Meanwhile, a peak (vibration mode: A_{1g}) of cubic CoOₓ (0<x<1) (rock-salt Co_{1-y}O (0<y<1) or spinel Co₃O₄) is observed at 665 cm⁻¹ to 685 cm⁻¹.

Thus, in the case where the integrated intensity at 470 cm⁻¹ to 490 cm⁻¹, the integrated intensity at 580 cm⁻¹ to 600 cm⁻¹, and the integrated intensity at 665 cm⁻¹ to 685 cm⁻¹ are represented by I1, I2, and I3, respectively, the value of I3/I2 is preferably greater than or equal to 1% and less than or equal to 10%, further preferably greater than or equal to 3% and less than or equal to 9%.

In the case where a cubic crystal structure such as a rock-salt crystal structure is observed in the above-described range, it can be said that the surface portion 100a of the positive electrode active material 100 has a rock-salt crystal structure in an appropriate range.

### <<Nanobeam Electron Diffraction Pattern>>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., from the surface to a depth of 1 nm). This is because a diffusion path of lithium can be ensured and a function of stabilizing a crystal structure can be increased in the case where the additive element such as magnesium exists in the lithium layer while the outermost surface has a layered rock-salt crystal structure as compared with the case where the outermost surface is covered with a rock-salt crystal structure.

Therefore, for example, when a nanobeam electron diffraction pattern of a region from the surface to a depth less than or equal to 1 nm and a nanobeam electron diffraction pattern of a region at a depth greater than or equal to 3 nm and less than or equal to 10 nm are obtained, the difference between lattice constants calculated from the patterns is preferably small.

For example, the difference between lattice constants calculated from a measured portion from the surface to a depth less than or equal to 1 nm and a measured portion at a depth greater than or equal to 3 nm and less than or equal to 10 nm is preferably less than or equal to 0.1 Å for the a-axis and less than or equal to 1.0 Å for the c-axis. The difference is further preferably less than or equal to 0.05 Å for the a-axis and further preferably less than or equal to 0.6 Å for the c-axis. The difference is still further preferably less than or equal to 0.04 Å for the a-axis and still further preferably less than or equal to 0.3 Å for the c-axis.

### <<Surface Roughness and Specific Surface Area>>

The positive electrode active material 100 of one embodiment of the present invention preferably has a smooth surface with little unevenness. A smooth surface with little unevenness indicates that a fusing agent described later is fully effective and the surfaces of the additive element source and lithium cobalt oxide melt. Thus, a smooth surface with little unevenness is a factor indicating a favorable distribution of the additive element in the surface portion 100a.

A smooth surface with little unevenness can be determined from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like, so that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. This surface roughness refers to the surface roughness in at least 400 nm of the particle periphery of the positive electrode active material.

On the surface of the particle of the positive electrode active material 100 of this embodiment, root-mean-square (RMS) surface roughness, which is an index of roughness, is preferably less than 3 nm, further preferably less than 1 nm, still further preferably less than 0.5 nm.

The image processing software used for the noise processing, the interface extraction, or the like is not particularly limited, and for example, “ImageJ” described in Non-Patent Document 8 to Non-Patent Document 10 can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area S_{R} measured by a constant-volume gas adsorption method to an ideal specific surface area Sᵢ.

The ideal specific surface area Sᵢ is calculated on the assumption that all the particles have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio S_{R}/Sᵢ of the actual specific surface area S_{R} to the ideal specific surface area Sᵢ obtained from the median diameter D50 is preferably less than or equal to 2.1.

Alternatively, the level of the surface smoothness of the positive electrode active material 100 can be quantified from its cross-sectional SEM image by the following method.

First, a surface SEM image of the positive electrode active material 100 is obtained. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., “ImageJ”). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The quantified value is referred to as a grayscale value. By obtaining a grayscale value, the unevenness of the positive electrode active material can be evaluated quantitatively.

In addition, a variation in luminance in a target region can also be represented with a histogram. A histogram shows the distribution of gradation levels in a target region and is also referred to as a luminance histogram. A luminance histogram enables visually easy-to-understand evaluation of unevenness of the positive electrode active material.

In the case where the positive electrode active material 100 of one embodiment of the present invention is evaluated, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

<Particle Size Distribution Analysis with Cross-Sectional SEM Image of Positive Electrode>

The particle size distribution of the positive electrode active material 100 can also be calculated from the cross-sectional SEM image of the positive electrode active material 100 by the following method.

First, an analysis region is cut out from the obtained cross-sectional SEM image. For example, as a range with a sufficient area for image analysis, a range of greater than or equal to 50 μm x greater than or equal to 100 μm can be cut out; however, one embodiment of the present invention is not limited thereto. A smaller area or a larger area may be cut out depending on factors such as the size of the positive electrode active material.

Note that a function of image processing software may be used to cut out the cross-sectional SEM image. For example, ImageJ may be used as the image processing software and the image may be cut out by the crop function of Image J.

Next, a first image cut out by the image processing software is binarized and subjected to particle analysis.

ImageJ can be used as the image processing software, for example. The binarization processing is described below. First, the first image represented by a 256-level grayscale is used as a frequency graph excluding black (a value of 0) and white (a value of 255). Then, at the maximum peak in the frequency graph, a half width at half maximum on the low-level side (HWHM_L) and a half width at half maximum on the high-level side (HWHM_H) are calculated. Next, the minimum value a of a range on the low-level side having a width that is twice HWHM_L and the maximum value b of a range on the high-level side having a width that is twice HWHM_H are determined from the value at the peak top (maximum frequency) of the maximum peak.

Next, binarization processing is performed such that the range of values less than a is white, the range of values from a to b, inclusive, is black, and the range of values greater than b is white. Specifically, the binarization as Threshold (a, b) is performed with Threshold function of ImageJ. After that, random bright spots that are probably attributed to the conductive material are removed under the conditions of Gray Morphology (radius=3, operator=open, type=circle) and Gray Morphology (radius=1, operator=close, type=circle), so that a second image can be obtained.

Next, particles with a particle size (projected area) greater than or equal to 0.5 μm² and less than or equal to 700 μm² are detected using the second image by the Analyze Particles function of ImageJ, whereby the area S of each particle is obtained. Next, the diameter r of each particle is calculated on the basis of the area S of each particle (Formula 1).

[Formula 1]

r=2×\sqrt{(S/π)} (1)

In this manner, the particle size distribution can be calculated from the cross-sectional SEM image. Performing the above analysis is referred to as performing particle size distribution analysis using a cross-sectional SEM image of a positive electrode.

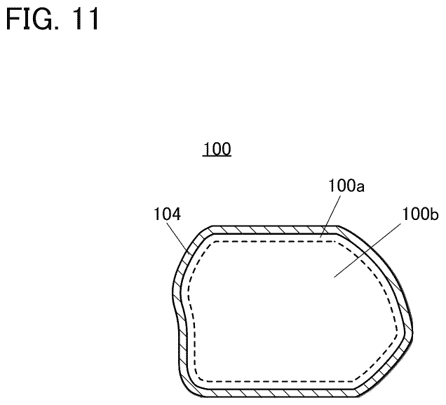

A coating portion may be attached to at least part of the surface of the positive electrode active material 100. FIG. 11 illustrates an example of the positive electrode active material 100 to which the coating portion 104 is attached.

The coating portion 104 is preferably formed by deposition of decomposition products of an electrolyte and an organic electrolyte solution due to charging and discharging, for example. A coating portion originating from an electrolyte solution, which is on the surface of the positive electrode active material 100, is expected to improve charge/discharge cycling performance particularly when charging making x in LiₓCoO₂ be less than or equal to 0.24 is repeated. This is because an increase in impedance of the surface of the positive electrode active material is inhibited or dissolution of cobalt is inhibited, for example. The coating portion 104 preferably contains carbon, oxygen, and fluorine, for example. The coating portion can have high quality easily when the electrolyte solution includes LiBOB and/or SUN (suberonitrile), for example. Accordingly, the coating portion 104 preferably contains one or two or more selected from boron, nitrogen, sulfur, and fluorine to possibly have high quality. The coating portion 104 does not necessarily cover the positive electrode active material 100 entirely. For example, the coating portion 104 covers greater than or equal to 50%, preferably greater than or equal to 70%, further preferably greater than or equal to 90% of the surface of the positive electrode active material 100.

### <<Powder Resistance Measurement>>

The positive electrode active material 100 of one embodiment of the present invention has a stable crystal structure even at a high voltage. The stable crystal structure of the positive electrode active material in a charged state can inhibit a decrease in charge/discharge capacity due to repeated charging and discharging. In <<XRD>> above, the positive electrode active material 100 having excellent characteristics as described above is described as having a feature of having the O3′ type crystal structure and/or the monoclinic O1(15) type crystal structure when x in LiₓCoO₂ is small. In <<EDX>> above, the preferable distributions of the additive elements in the STEM-EDX analysis of the positive electrode active material 100 are described. Furthermore, the positive electrode active material 100 of one embodiment of the present invention also has a feature in the volume resistivity of powder.

As the feature of the positive electrode active material 100 of one embodiment of the present invention, the volume resistivity of the powder of the positive electrode active material 100 is preferably higher than or equal to 1.0×10⁸ Ω·cm and lower than or equal to 1.0×10¹⁰ Ω·cm, further preferably higher than or equal to 5.0×10⁸ Ω·cm and lower than or equal to 1.5×10⁹ Ω·cm under a pressure of 64 MPa.

The positive electrode active material 100 with the above volume resistivity has a stable crystal structure at a high voltage. Thus, the volume resistivity of the powder of the positive electrode active material 100 falling within the above-described range can indicate the favorable formation of the surface portion 100a, which is an important factor for a stable crystal structure of the positive electrode active material in a charged state.

A method for measuring the volume resistivity of the powder of the positive electrode active material 100 of one embodiment of the present invention is described.

For measurement of the volume resistivity of the powder, a device portion including terminals for resistance measurement and a mechanism for applying pressure to the powder serving as a measurement target are preferably provided. The terminals for resistance measurement are preferably four terminals (also referred to as four probes). As such a measurement apparatus that includes the terminals for resistance measurement and the mechanism for applying pressure to the powder as a measurement target (sample), for example, MCP-PD51 produced by Mitsubishi Chemical Analytech Co., Ltd. can be used. As the resistance measurement device, the low resistance meter Loresta-GP or the high resistance meter Hiresta-GP can be used. The Loresta-GP can be used for measurement of a low-resistance sample, and the Hiresta-GP can be used for measurement of a high-resistance sample. Note that the measurement environment is preferably a stable environment such as a dry room. In the environment of a dry room, the temperature is preferably 25 °C and the dew point is preferably lower than or equal to −40 °C, for example. When the measurement is performed in a high-humidity environment, the electric resistance may be lowered by the influence of moisture in the air, so that an original physical property value cannot be obtained in some cases.

The measurement of the volume resistivity of the powder using the above-described measurement apparatus is described. First, a powder sample is set in a measurement unit. The measurement unit has a structure in which the powder sample and the terminals for resistance measurement are in contact with each other, and pressure can be applied to the powder sample. A structure for measuring the volume of a powder sample in the measurement unit is also included. Specifically, the measurement unit includes a cylindrical space, and the powder sample is set in the space. In the structure for measuring the volume of the powder sample, the volume occupied by the powder set in the space can be measured by measuring the height of the powder.

In the measurement of the volume resistivity of the powder, the electric resistance and volume of the powder under pressure are measured. The pressure applied to the powder can be varied. For example, the electric resistance and volume of the powder can be measured under pressures of 16 MPa, 25 MPa, 38 MPa, 51 MPa, and 64 MPa. The volume resistivity of the powder can be calculated from the values of the measured electric resistance and volume of the powder.

In the case where the above-described measurement under a pressure of 64 MPa is performed and the volume resistivity of the powder of the positive electrode active material 100 of one embodiment of the present invention is measured to be higher than or equal to 1.0×10⁸ Ω·cm and lower than or equal to 1.0×10¹⁰ Ω·cm, good cycling performance is obtained in a charge/discharge cycling test under the high charge voltage condition, and better cycling performance is obtained in the charge/discharge cycling test under the high charge voltage condition in the case where the volume resistivity is measured to be higher than or equal to 5.0×10⁸ Ω·cm and lower than or equal to 1.5×10⁹ Ω·cm.

In this specification and the like, unless otherwise specified, the volume resistivity measured as described above is the volume resistivity of the powder.

### <<Ion Chromatography>>

A method of ion chromatography measurement of the powder of the positive electrode active material 100 of one embodiment of the present invention is described. In the ion chromatography measurement, a pretreatment step of dissolving the powder of the positive electrode active material 100 in acid to obtain a measurement solution and a measurement step of measuring the solution are performed.

There is no particular limitation on the apparatus and conditions for ion chromatography. The measurement can be performed with the apparatus and conditions as described below, for example. As an apparatus for ion chromatography, an ion chromatography system Dionex ICS-2100 produced by Thermo Fisher Scientific Inc. can be used, for example.

An example of the pretreatment for ion chromatography is described. Two hundred and fifty milligrams of powder of the positive electrode active material 100 and 2 ml of a 0.05-M H₂SO₄ aqueous solution are prepared, put into a glass container with a lid, and mixed, whereby a first mixture solution is obtained. For the mixing, an ultrasonic wave is preferably applied for approximately one hour. After that, the container is left to stand at normal temperature for 12 hours or longer. After that, 1 ml of a filtrate obtained by filtration of the first mixed solution and 9 ml of pure water are mixed, whereby a second mixed solution is obtained. In this manner, pretreatment of the powder of the positive electrode active material 100 can be performed.

Next, ion chromatography is performed using the second mixed solution obtained in the above pretreatment. Anion analysis and cation analysis are preferably performed in ion chromatography.

An example of the anion analysis conditions is shown below. The anion analysis can be performed at 35 °C with the use of a Dionex IonPac AG20 column (2×50 mm) and a Dionex IonPac AS20 column (2×250 mm). The eluent is preferably a KOH aqueous solution and the flow rate is preferably 0.44 ml/min. Note that gradient measurement is preferably performed such that the concentration of the KOH aqueous solution is gradually increased. A conductivity detector can be used as the detector, and a calibration curve can be created with an anion mixed standard solution produced by Kanto Chemical Co., Inc.

An example of the cation analysis conditions is shown below. The cation analysis can be performed at 30 °C with the use of a Dionex IonPac CG16 column (3×50 mm) and a Dionex IonPac CS16 column (3×250 mm). The eluent is preferably a methanesulfonic acid (MSA) aqueous solution and the flow rate is preferably 0.36 ml/min. Note that isocratic measurement is preferably performed with the concentration of the MSA aqueous solution kept constant. A conductivity detector can be used as the detector, and a calibration curve can be created with a cation mixed standard solution produced by Kanto Chemical Co., Inc.

The ion chromatography measurement described above allows quantitative measurement of fluorine (F), chlorine (Cl), or the like in the anion analysis, for example, and allows quantitative measurement of lithium (Li), magnesium (Mg), cobalt (Co), nickel (Ni), or the like in the cation analysis, for example.

In the ion chromatography measurement of the powder of the positive electrode active material 100 of one embodiment of the present invention, the weight of fluorine is preferably greater than or equal to 100 ppm and less than or equal to 1000 ppm, further preferably greater than or equal to 100 ppm and less than or equal to 200 ppm with respect to the weight of the powder.

This embodiment can be used in combination with the other embodiments.

### Embodiment 2

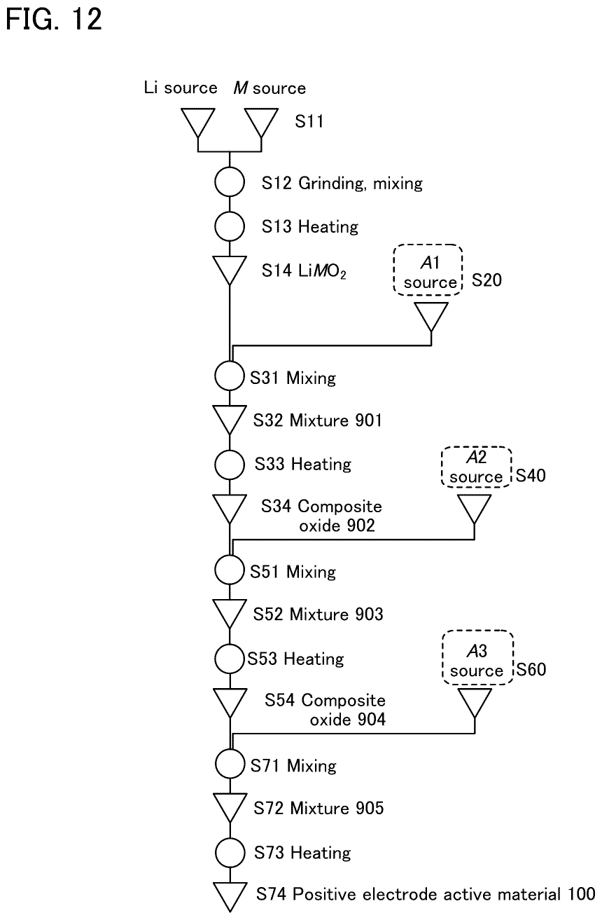

This embodiment will describe an example of a formation method of the positive electrode active material 100 of one embodiment of the present invention with reference to FIG. 12 to FIG. 14.

The way of adding an additive element is important in forming the positive electrode active material 100 having the distribution of the additive element, the composition, and/or the crystal structure that are/is described in the above embodiment. At the same time, favorable crystallinity of the inner portion 100b is also important.

Thus, in the formation process of the positive electrode active material 100, preferably, lithium cobalt oxide is synthesized first, then an additive element source is mixed, and heat treatment is performed.

In a method of synthesizing lithium cobalt oxide containing an additive element by mixing an additive element source concurrently with a cobalt source and a lithium source, it is difficult to increase the concentration of the additive element in the surface portion 100a. In addition, after lithium cobalt oxide is synthesized, only mixing an additive element source without performing heating causes the additive element to be just attached to the lithium cobalt oxide without forming a solid solution therewith. It is difficult to distribute the additive element favorably without sufficient heating. Thus, it is preferable that the lithium cobalt oxide be synthesized, then the additive element source be mixed, and heat treatment be performed. The heat treatment after mixing of the additive element source may be referred to as annealing.

However, annealing at an excessively high temperature causes cation mixing, which increases the possibility of entry of the additive element such as magnesium into the cobalt sites. Magnesium that exists at the cobalt sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed together with the additive element source. A material having a lower melting point than lithium cobalt oxide can be regarded as a material functioning as a fusing agent. For example, a fluorine compound such as lithium fluoride is suitable. Addition of a fusing agent lowers the melting points of the additive element source and lithium cobalt oxide. Lowering the melting points makes it easier to distribute the additive element favorably at a temperature at which cation mixing is less likely to occur.

### <<Formation Method 1 of Positive Electrode Active Material>>

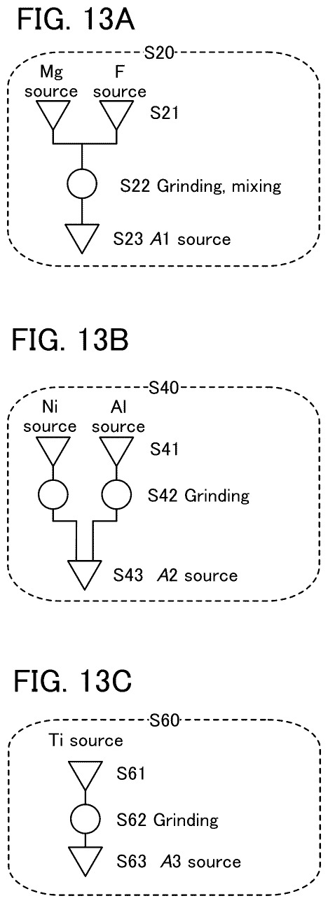

A formation method 1 of the positive electrode active material 100 is described with reference to FIG. 12 to FIG. 13C.

### <Step S11>

In Step S11 shown in FIG. 12, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used and for example, cobalt hydroxide, cobalt oxide such as tricobalt tetraoxide, or the like can be used.

The cobalt source preferably has a high purity and is preferably a material having a purity higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with increased capacity and/or increased reliability can be obtained.

Furthermore, the cobalt source preferably has high crystallinity and for example, the cobalt source preferably includes single crystal grains. The crystallinity of the cobalt source can be evaluated with a TEM image, a STEM image, a HAADF-STEM image, an ABF-STEM image, or the like or by X-ray diffraction, electron diffraction, neutron diffraction, or the like. Note that the above methods for evaluating crystallinity can also be employed to evaluate the crystallinity of other materials in addition to the cobalt source.

### <Step S12>

Next, in Step S12 shown in FIG. 12, the lithium source and the cobalt source are ground and mixed to form a mixed material. The grinding and mixing can be performed by a dry method or a wet method. A wet method is preferred because it can crush a material into a smaller size. When a wet method is employed, a solvent is prepared. As the solvent, a ketone such as acetone, an alcohol such as ethanol or isopropanol, an ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% in the grinding and mixing. With the use of dehydrated acetone with the above-described purity, impurities that might be mixed can be reduced.

A ball mill, a bead mill, or the like can be used as a means of the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 shown in FIG. 12, the above mixed material is heated. The heating is preferably performed at higher than or equal to 800 °C and lower than or equal to 1100 °C, further preferably at higher than or equal to 900 °C and lower than or equal to 1000 °C, still further preferably at approximately 950 °C. An excessively low temperature might lead to insufficient decomposition and melting of the lithium source and the cobalt source. Meanwhile, an excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to one hour and shorter than or equal to 100 hours, further preferably longer than or equal to two hours and shorter than or equal to 20 hours.

The temperature rising rate is preferably higher than or equal to 80 °C/h and lower than or equal to 250 °C/h, although depending on the end-point temperature of the heating. For example, in the case of heating at 1000 °C for 10 hours, the temperature rising rate is preferably 200 °C/h.

The heating is preferably performed in an atmosphere with little water such as a dry-air atmosphere and for example, the dew point of the atmosphere is preferably lower than or equal to −50 °C, further preferably lower than or equal to −80 °C. In this embodiment, the heating is performed in an atmosphere with a dew point of −93 °C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, for example, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, a method may be employed in which the pressure in the reaction chamber is reduced, the reaction chamber is then filled (which may also be referred to as purged) with oxygen, and the entry and exit of the oxygen from the reaction chamber are prevented. For example, the pressure in the reaction chamber may be reduced to −970 hPa and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A container holding an object to be heated at the time of heating is preferably a crucible made of aluminum oxide or a setter (also referred to as a saggar) made of aluminum oxide. A crucible made of aluminum oxide has a material property that hardly allows the entry of impurities. In this embodiment, a setter made of aluminum oxide with a purity of 99.9% is used. Note that the heating is preferably performed with the crucible or the setter covered with a lid, in which case volatilization of a material can be prevented. Furthermore, as materials of the crucible and the setter, mullite-cordierite may be used.

A crucible that has been used a plurality of times is preferred to a new crucible. In this specification and the like, a new crucible refers to a crucible that is subjected to a heating step two or less times while a material containing lithium, the transition metal M, and/or the additive element is contained therein. A crucible that has been used a plurality of times refers to a crucible that is subjected to a heating step three or more times while a material containing lithium, the transition metal M, and/or the additive element is contained therein. The reason is that, in the case where a new crucible is used, some materials such as lithium fluoride are liable to be absorbed by, diffused in, transferred to, and/or attached to a sagger. Loss of some materials due to such phenomena increases a concern that an element is not distributed in a preferable range particularly in the surface portion of the positive electrode active material. In contrast, such a risk is low in the case of a crucible that has been used a plurality of times.

The heated material is ground as needed and may be made to pass through a sieve. Before collection of the heated material, the material may be moved from the crucible to a mortar. As the mortar, an aluminum oxide mortar can be suitably used. An aluminum oxide mortar has a material property that hardly allows release of impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### <Step S14>

Through the above steps, lithium cobalt oxide (LiCoO₂) shown in Step S14 in FIG. 12 can be synthesized.

Although the example is described in which the composite oxide is formed by a solid phase method as in Step S11 to Step S14, the composite oxide may be formed by a coprecipitation method. Alternatively, the composite oxide may be formed by a hydrothermal method.

Note that lithium cobalt oxide synthesized in advance may be used in Step S14. In this case, Step S11 to Step S13 can be skipped. When Step S15 is performed on the lithium cobalt oxide synthesized in advance, lithium cobalt oxide with a smooth surface can be obtained.

### <Step S20>

Next, as shown in Step S20, the additive element is preferably added to the lithium cobalt oxide. Because the formation method of the positive electrode active material described in this embodiment separates addition of the additive elements into a plurality of steps, in the flowchart shown in FIG. 12, the additive element to be added first is referred to as A1, the additive element to be added second is referred to as A2, and the additive element to be added third is referred to as A3. The step of adding the additive element A1 is described with reference to FIG. 13A.

### <Step S21>

In Step S21 shown in FIG. 13A, an additive element source (A1 source) to be added to the lithium cobalt oxide is prepared. A lithium source may be prepared in addition to the A1 source.

As the additive element A1, any of the additive elements described in the above embodiment can be used. Specifically, one or two or more selected from magnesium, fluorine, nickel, aluminum, titanium, zirconium, vanadium, iron, manganese, chromium, niobium, arsenic, zinc, silicon, sulfur, phosphorus, and boron can be used.

When magnesium is selected as the additive element, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ or CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ or CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848 °C.

Magnesium fluoride can be used as both the fluorine source and the magnesium source. Lithium fluoride can be used also as the lithium source. Another example of the lithium source that can be used in Step S21 is lithium carbonate.

The fluorine source may be a gas, and fluorine (F₂), carbon fluoride, sulfur fluoride, oxygen fluoride (e.g., OF₂, O₂F₂, O₃F₂, O₄F₂, O₅F₂, O₆F₂, or O₂F), nitrogen trifluoride (NF₃), or the like may be used and mixed in the atmosphere in a heating step described later. Two or more of these fluorine sources may be used.

In the formation method 1 of a positive electrode active material described with reference to FIG. 12 and FIG. 13C, magnesium and fluorine are used as the additive element A1. Lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of lowering the melting point is maximized. Meanwhile, when the proportion of lithium fluoride increases, the cycling performance might be degraded because of an excessive amount of lithium. Therefore, the molar ratio of lithium fluoride to magnesium fluoride is preferably LiF:MgF₂=x:1 (0×1.9), further preferably LiF:MgF₂=x:1 (0.1≤x≤0.5), still further preferably LiF:MgF₂=x:1 (x=0.33 or the neighborhood thereof). Note that in this specification and the like, the neighborhood means a value greater than 0.9 times and less than 1.1 times a given value.

### <Step S22>

Next, in Step S22 shown in FIG. 13A, the magnesium source and the fluorine source are ground and mixed. Any of the conditions for the grinding and mixing that are described for Step S12 can be selected to perform Step S22.

### <Step S23>

Next, in Step S23 shown in FIG. 13A, the materials ground and mixed in the above step are collected, so that the A1 source can be obtained. Note that the A1 source in Step S23 contains a plurality of starting materials and can be referred to as a mixture.

As for the particle diameter of the mixture, D50 (median diameter) is preferably greater than or equal to 600 nm and less than or equal to 10 μm, further preferably greater than or equal to 1 μm and less than or equal to 5 μm. Also when one kind of material is used as the additive element source, D50 (median diameter) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of a lithium cobalt oxide particle uniformly in a later step of mixing with the lithium cobalt oxide. The mixture is preferably attached uniformly to the surface of the lithium cobalt oxide particle, in which case the additive element is easily distributed or dispersed uniformly in the surface portion 100a of the composite oxide after heating.

### <Step S31>

Next, in Step S31 shown in FIG. 12, the lithium cobalt oxide and the A1 source are mixed. The ratio of the number of cobalt atoms Co in the lithium cobalt oxide to the number of magnesium atoms Mg contained in the A1 source is preferably Co:Mg=100:y (0.1≤y≤6), further preferably M:Mg=100:y (0.3≤y≤3).

The conditions of the mixing in Step S31 are preferably milder than those of the mixing in Step S12 in order not to damage the shapes of the lithium cobalt oxide particles. For example, conditions with a lower rotational frequency or a shorter time than those for the mixing in Step S12 are preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for one hour. The mixing is performed in a dry room the dew point of which is higher than or equal to −100 °C and lower than or equal to −10 °C.

### <Step S32>

Next, in Step S32 in FIG. 12, the materials mixed in the above step are collected, whereby a mixture 901 is obtained. At the time of the collection, the materials may be crushed as needed and then made to pass through a sieve.

### <Step S33>

Then, in Step S33 shown in FIG. 12A, the mixture 901 is heated. Any of the heating conditions described for Step S13 can be selected for this heating. The heating time is preferably longer than or equal to two hours. Here, the pressure in a furnace may be higher than atmospheric pressure to make the oxygen partial pressure of the heating atmosphere high. This is because an insufficient oxygen partial pressure of the heating atmosphere might cause reduction of cobalt or the like and prevent the lithium cobalt oxide or the like from maintaining a layered rock-salt crystal structure.

Here, a supplementary explanation of the heating temperature is provided. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements included in the lithium cobalt oxide and the additive element source occurs, and may be lower than the melting temperatures of these materials. It is known that in the case of an oxide as an example, solid phase diffusion occurs at a temperature 0.757 times the melting temperature Tₘ (the Tamman temperature T_{d}). Accordingly, the heating temperature in Step S33 is higher than or equal to 650 °C.

Needless to say, the reaction more easily proceeds at a temperature higher than or equal to the temperature at which one or two or more selected from the materials contained in the mixture 901 are melted. For example, in the case where LiF and MgF₂ are included as the additive element sources, the lower limit of the heating temperature in Step S33 is preferably higher than or equal to 742 °C because the eutectic point of LiF and MgF₂ is around 742 °C.

As for a mixture 903 obtained by mixing at LiCoO₂:LiF:MgF₂=100:0.33:1 (molar ratio), the initial melting temperature Tᵢₘ was 779 °C, the melting peak temperature Tₚₘ was 815 °C, and the melting termination temperature Tₑₘ was 826 °C in differential scanning calorimetry measurement (DSC measurement). Therefore, the lower limit of the heating temperature is further preferably higher than or equal to 826 °C.

A higher heating temperature is preferable because it facilitates the reaction, shortens the heating time, and enables high productivity.

The upper limit of the heating temperature is lower than the decomposition temperature of the lithium cobalt oxide (1130 °C). At a temperature in the vicinity of the decomposition temperature, a slight amount of the lithium cobalt oxide might be decomposed. In addition, at the time of heating the mixture 903, the partial pressure of fluorine or a fluoride originating from the fluorine source or the like is preferably controlled to be within an appropriate range. When the temperature is too high, the fluoride is reduced by evaporation. For example, the vapor pressure of the lithium fluoride increases rapidly from 900 °C. Thus, the heating temperature is preferably lower than or equal to 1000 °C, further preferably lower than or equal to 950 °C, still further preferably lower than or equal to 900 °C, yet still further preferably lower than or equal to 850 °C. When evaporation of the lithium fluoride is inhibited, the surface portion 100a including fluorine and lithium at high concentrations can be obtained. When the surface portion 100a includes sufficient lithium, there is an advantage that a different phase (e.g., MgTiO₃) is less likely to be generated at the time of adding titanium in a later step.

In view of the above, the heating temperature in Step S33 is preferably higher than or equal to 650 °C and lower than or equal to 1130 °C, further preferably higher than or equal to 650 °C and lower than or equal to 1000 °C, still further preferably higher than or equal to 650 °C and lower than or equal to 950 °C, yet still further preferably higher than or equal to 650 °C and lower than or equal to 900 °C. Furthermore, the heating temperature is preferably higher than or equal to 742 °C and lower than or equal to 1130 °C, further preferably higher than or equal to 742 °C and lower than or equal to 1000 °C, still further preferably higher than or equal to 742 °C and lower than or equal to 950 °C, yet still further preferably higher than or equal to 742 °C and lower than or equal to 900 °C. Furthermore, the heating temperature is preferably higher than or equal to 826 °C and lower than or equal to 1100 °C, further preferably higher than or equal to 826 °C and lower than or equal to 1130 °C, still further preferably higher than or equal to 826 °C and lower than or equal to 1000 °C, yet still further preferably higher than or equal to 826 °C and lower than or equal to 950 °C, yet still further preferably higher than or equal to 826 °C and lower than or equal to 900 °C.

In addition, at the time of heating the mixture 901, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to this function, the heating temperature can be lowered to a temperature lower than the decomposition temperature of the lithium cobalt oxide, e.g., higher than or equal to 742 °C and lower than or equal to 950 °C, which allows distribution of the additive element such as magnesium in the surface portion and formation of a positive electrode active material having favorable characteristics.

However, since LiF in a gas state has a specific gravity less than that of oxygen, the heating might volatilize or sublimate LiF. In the case where LiF is volatilized, LiF in the mixture 903 decreases. As a result, the function of a fusing agent is degraded. Therefore, the heating needs to be performed while volatilization of LiF is inhibited. Note that even when LiF is not used as the fluorine source or the like, Li at the surface of LiCoO₂ and F of the fluorine source might react to produce LiF, which might be volatilized. Therefore, such inhibition of volatilization is needed also when a fluoride having a higher melting point than LiF is used.

In view of this, the mixture 901 is preferably heated in an atmosphere containing LiF, i.e., the mixture 901 is preferably heated in a state where the partial pressure of LiF in the heating furnace is high. Such heating can inhibit volatilization of LiF in the mixture 901.

The heating in this step is preferably performed such that the particles of the mixture 901 are not adhered to each other. Adhesion of the particles of the mixture 901 during the heating might decrease the area of contact with oxygen in the atmosphere and block a path of diffusion of the additive element (e.g., fluorine), thereby worsening the distribution of the additive element (e.g., magnesium and fluorine) in the surface portion.

It is considered that a uniform distribution of the additive element (e.g., fluorine) in the surface portion leads to a smooth positive electrode active material with little unevenness. Thus, it is preferable that the particles of the mixture 901 not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled during the heating. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 901 can be heated in an atmosphere containing LiF with the container in which the mixture 901 is put covered with a lid.

A supplementary explanation of the heating time is provided. The heating time depends on conditions such as the heating temperature and the size and composition of the lithium cobalt oxide in Step S14. In the case where the lithium cobalt oxide is small, it is sometimes preferable that the heating be performed at a lower temperature or for a shorter time than in the case where the lithium cobalt oxide is large.

In the case where the lithium cobalt oxide in Step S14 in FIG. 12A has a median diameter (D50) of approximately 12 μm, the heating temperature is preferably higher than or equal to 650 °C and lower than or equal to 950 °C, for example. The heating time is preferably longer than or equal to three hours and shorter than or equal to 60 hours, further preferably longer than or equal to 10 hours and shorter than or equal to 30 hours, still further preferably approximately 20 hours, for example. Note that the time for lowering the temperature after the heating is preferably longer than or equal to 10 hours and shorter than or equal to 50 hours, for example.

In the case where the lithium cobalt oxide in Step S14 has a median diameter (D50) of approximately 7 μm, the heating temperature is preferably higher than or equal to 650 °C and lower than or equal to 950 °C, for example. The heating time is preferably longer than or equal to one hour and shorter than or equal to 10 hours, further preferably approximately five hours, for example. Note that the time for lowering the temperature after the heating is preferably longer than or equal to 10 hours and shorter than or equal to 50 hours, for example.

### <Step S34>

Next, the heated material is collected in Step S34 shown in FIG. 12, in which crushing is performed as needed; thus, a composite oxide 902 is obtained.

### <Step S40>

Next, in Step S40 shown in FIG. 12, an additive element source (A2 source) is prepared. As the additive element A2, any of the additive elements mentioned in description of Step S21 can be used. In the formation method 1 of a positive electrode active material described with reference to FIG. 12 to FIG. 13C, nickel and aluminum are used as the additive element A2. As a nickel source included in a second additive element source, nickel oxide, nickel hydroxide, or the like can be used. As an aluminum source included in the second additive element source, aluminum oxide, aluminum hydroxide, or the like can be used. As shown in Step S41 to Step S43 in FIG. 13B, the nickel source and the aluminum source can be ground to serve as the A2 source. For the conditions of grinding, the conditions of Step S22 can be referred to.

### <Step S51>

Next, in Step S51 shown in FIG. 12, the composite oxide 902 and the A2 source are mixed. For the mixing conditions, the description of Step S31 can be referred to.

In the mixing of the composite oxide 902 and the A2 source, the number of nickel atoms contained in the second additive element source (A2 source) is preferably greater than or equal to 0.05% and less than or equal to 4.0%, further preferably greater than or equal to 0.20% and less than or equal to 2.0%, still further preferably greater than or equal to 0.20% and less than or equal to 1.0% with respect to the number of cobalt atoms contained in the lithium cobalt oxide in Step S14. For example, in the case of using nickel hydroxide as the nickel source, the number of moles of nickel hydroxide contained in the second additive element source is preferably greater than or equal to 0.05 and less than or equal to 4.0 (higher than or equal to 0.05 mol % and lower than or equal to 4.0 mol %), further preferably greater than or equal to 0.20 and less than or equal to 2.0 (higher than or equal to 0.20 mol % and lower than or equal to 2.0 mol %), still further preferably greater than or equal to 0.20 and less than or equal to 1.0 (higher than or equal to 0.20 mol % and lower than or equal to 1.0 mol %) with the number of moles of the lithium cobalt oxide in Step S10 assumed as 100.

The number of aluminum atoms contained in the second additive element source (A2 source) is preferably greater than or equal to 0.05% and less than or equal to 4.0%, further preferably greater than or equal to 0.20% and less than or equal to 2.0%, still further preferably greater than or equal to 0.20% and less than or equal to 1.0% with respect to the number of cobalt atoms contained in the lithium cobalt oxide in Step S14. For example, in the case of using aluminum hydroxide as the aluminum source, the number of moles of aluminum hydroxide contained in the second additive element source is preferably greater than or equal to 0.05 and less than or equal to 4.0 (higher than or equal to 0.05 mol % and lower than or equal to 4.0 mol %), further preferably greater than or equal to 0.20 and less than or equal to 2.0 (higher than or equal to 0.20 mol % and lower than or equal to 2.0 mol %), still further preferably greater than or equal to 0.20 and less than or equal to 1.0 (higher than or equal to 0.20 mol % and lower than or equal to 1.0 mol %) with the number of moles of the lithium cobalt oxide in Step S10 assumed as 100.

### <Step S52>

Next, in Step S52 in FIG. 12, the materials mixed in the above step are collected, whereby the mixture 903 is obtained. At the time of the collection, the materials may be crushed as needed and then made to pass through a sieve.

### <Step S53>

Then, in Step S53 shown in FIG. 12, the mixture 903 is heated. For the heating conditions, the description of Step S33 can be referred to.

### <Step S54>

Next, the heated material is collected in Step S54 shown in FIG. 12, in which crushing is performed as needed; thus, a composite oxide 904 is obtained.

### <Step S60>

Next, in Step S60 shown in FIG. 12, an additive element source (A3 source) is prepared. As the additive element A3, any of the additive elements mentioned in description of Step S21 can be used. In the formation method 1 of a positive electrode active material described with reference to FIG. 12 to FIG. 13C, titanium is used as the additive element A3. As a titanium source, lithium titanate, titanium oxide, titanium hydroxide, or the like can be used. As shown in Step S61 to Step S63 in FIG. 13C, the titanium source can be ground to serve as the A3 source. For the conditions of grinding, the conditions of Step S22 can be referred to.

### <Step S71>

Next, in Step S71 shown in FIG. 12, the composite oxide 904 and the A3 source are mixed. For the mixing conditions, the description of Step S31 can be referred to.

### <Step S72>

Next, in Step S72 in FIG. 12, the materials mixed in the above step are collected, whereby a mixture 905 is obtained. At the time of the collection, the materials may be crushed as needed and then made to pass through a sieve.

### <Step S73>

Then, in Step S73 shown in FIG. 12, the mixture 905 is heated. For the heating conditions, the description of Step S33 can be referred to.

### <Step S74>

Next, the heated material is collected in Step S74 shown in FIG. 12, in which crushing is performed as needed; thus, the positive electrode active material 100 is obtained. Here, the collected particles are preferably made to pass through a sieve. Through the above process, the positive electrode active material 100 of one embodiment of the present invention can be formed. The positive electrode active material of one embodiment of the present invention has a smooth surface.

The positive electrode active material 100, whose surface is smooth, may be less likely to be physically broken by pressure application or the like than a positive electrode active material whose surface is not smooth. For example, the positive electrode active material 100 is unlikely to be broken in a test involving pressure application such as a nail penetration test, which can result in high safety.

[Initial heating]

It is sometimes further preferable that in the formation method described above, heating be also performed after the synthesis of the lithium cobalt oxide but before the mixing of the additive element. This heating is referred to as initial heating.

Owing to the influence of lithium extraction from part of the surface portion 100a of the lithium cobalt oxide by the initial heating, the distribution of the additive element becomes more favorable.

Specifically, the distributions of the additive elements can be easily made different from each other by the initial heating in the following mechanism. First, lithium is extracted from part of the surface portion 100a by the initial heating. Next, additive element sources such as a nickel source, an aluminum source, and a magnesium source and lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase containing Co²⁺, which is obtained by reduction due to lithium deficiency, Mg²⁺, and Ni²⁺ is formed. Note that this phase is formed in part of the surface portion 100a, and thus is sometimes not clearly observed in an image obtained with an electron microscope, such as a STEM image, and an electron diffraction pattern.

Among the additive elements, nickel is likely to form a solid solution and is diffused to the inner portion 100b in the case where the surface portion 100a is layered rock-salt lithium cobalt oxide, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100 and the surface portion 100a thereof.

Furthermore, in such a rock-salt crystal structure, the bond distance between a metal Me and oxygen (Me-O distance) tends to be longer than that in a layered rock-salt crystal structure.

For example, the Me-O distance is 2.09 Å and 2.11 Å in rock-salt Ni_{0.5}Mg_{0.5}O and rock-salt MgO, respectively. Even when a spinel phase is formed in part of the surface portion 100a, the Me-O distance is 2.0125 Å and 2.02 Å in spinel NiAl₂O₄ and spinel MgAl₂O₄, respectively. In each case, the Me-O distance is longer than 2 Å. Note that 1 Å=10⁻¹⁰ m.

Meanwhile, in a layered rock-salt crystal structure, the bond distance between oxygen and a metal other than lithium is shorter than the above-described distance. For example, the Al—O distance is 1.905 Å (the Li—O distance is 2.11 Å) in layered rock-salt LiAlO₂. In addition, the Co—O distance is 1.9224 Å (the Li—O distance is 2.0916 Å) in layered rock-salt LiCoO₂.

According to Shannon's ionic radii (Shannon et al., Acta A 32 (1976) 751.), the ion radius of hexacoordinated aluminum and the ion radius of hexacoordinated oxygen are 0.535 Å and 1.4 Å, respectively, and the sum of these values is 1.935 Å.

From the above, aluminum is considered to be present at a site other than a lithium site more stably in a layered rock-salt crystal structure than in a rock-salt crystal structure. Thus, in the surface portion 100a, aluminum is more likely to be distributed in, than in a region having a rock-salt phase and being close to the surface, a region having a layered rock-salt phase at a larger depth and/or the inner portion 100b.

Moreover, the initial heating can potentially have an effect of increasing the crystallinity of the layered rock-salt crystal structure of the inner portion 100b.

However, the initial heating is not necessarily performed. In some cases, by controlling atmosphere, temperature, time, or the like in another heating step, e.g., annealing, the positive electrode active material 100 having the O3′ type structure when x in LiₓCoO₂ is small can be formed.

### <<Formation Method 2 of Positive Electrode Active Material>>

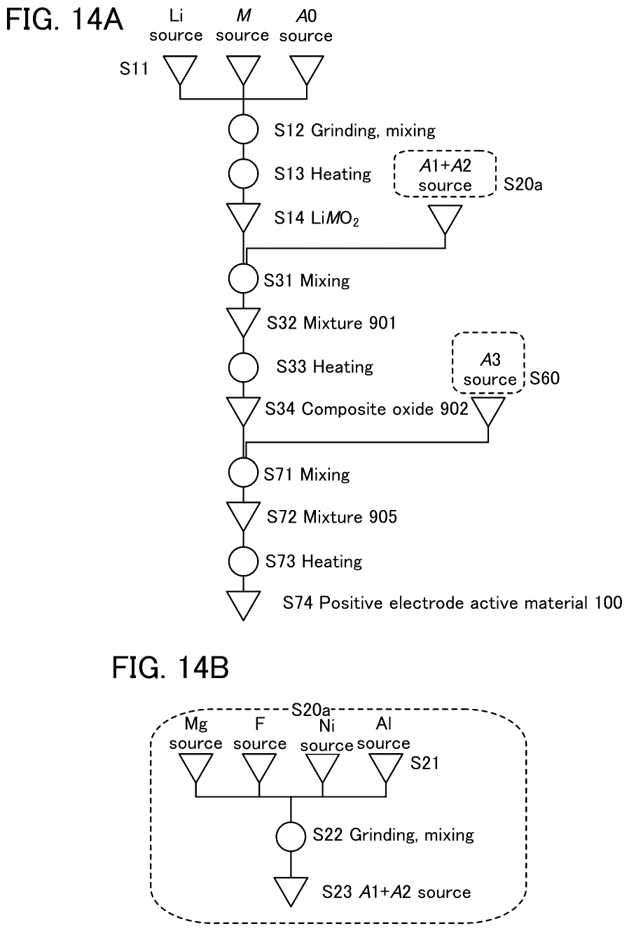

Next, as one embodiment of the present invention, a formation method 2 of a positive electrode active material, which is different from the formation method 1 of a positive electrode active material, is described with reference to FIG. 14A and FIG. 14B. The formation method 2 of a positive electrode active material is different from the formation method 1 mainly in the number of times of adding the additive element. For the description except for the above, the description of the formation method 1 can be referred to.

Although Formation method 1 of positive electrode active material has described the formation method in which the addition of the additive element is performed only after formation of LiMO2, the present invention is not limited to the above-described method. The addition of the additive element may be performed at another timing or may be performed a plurality of times. The timing of the addition may be different between the elements.

For example, the additive element may be added to the lithium source and the cobalt source in Step S11, i.e., at the stage of the starting materials of the composite oxide. The additive element source added at this time is shown as an AO source in FIG. 14A. Then, lithium cobalt oxide containing the additive element can be obtained in Step S13. In that case, there is no need to separately perform Step S11 to Step S14 and Step S21 to Step S23. This method can be regarded as being simple and highly productive.

Lithium cobalt oxide that contains some of the additive elements in advance may be used. When lithium cobalt oxide to which magnesium and fluorine are added is used, for example, Step S11 to Step S14 and part of Step S20 can be skipped. This method can be regarded as being simple and highly productive.

In addition, the additive element may be added to lithium cobalt oxide to which magnesium and fluorine are added in advance.

Formation method 1 of positive electrode active material has described the formation method in which magnesium and fluorine are used as A1, nickel and aluminum are used as A2, and the elements are added at different timings; however, magnesium, fluorine, nickel, and aluminum may be added at the same time. FIG. 14A and FIG. 14B illustrate a method for adding these elements at the same time as Step S20a. This formation method can also reduce the number of mixing and heating steps and thus can be regarded as being simple and highly productive.

This embodiment can be used in combination with the other embodiments.

### Embodiment 3

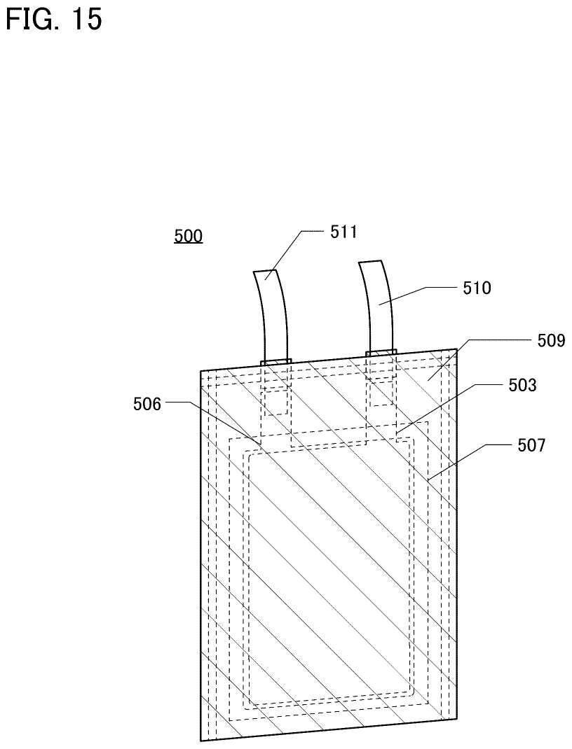

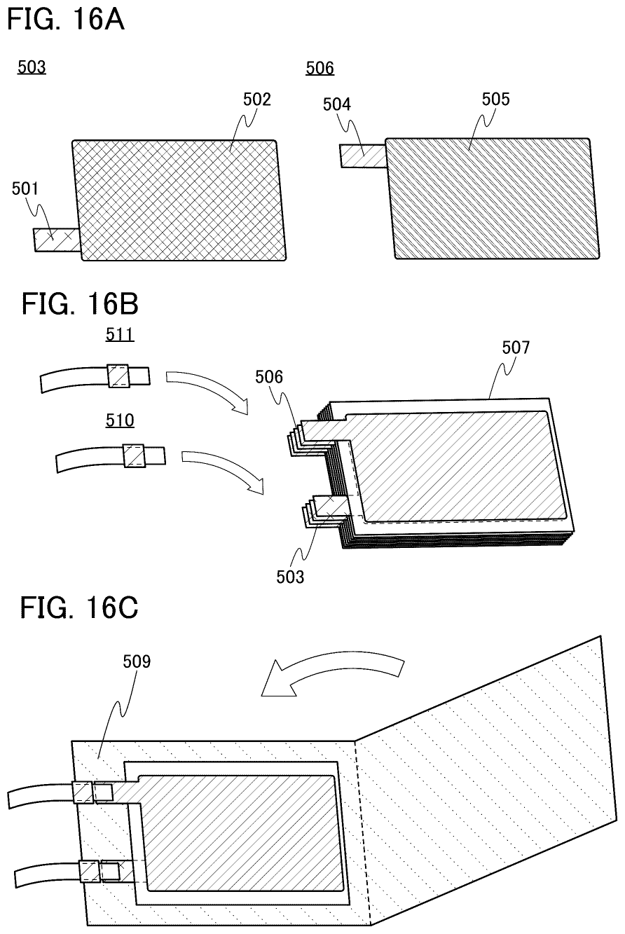

In this embodiment, examples of a secondary battery of one embodiment of the present invention are described with reference to FIG. 15 and FIG. 16.

### <Structure Example of Secondary Battery>

Hereinafter, a secondary battery illustrated in FIG. 15 in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive material (which can be rephrased as a conductive additive) and a binder. As the positive electrode active material, the positive electrode active material formed by the formation method described in the above embodiment is used.

The positive electrode active material described in any of the above embodiments and another positive electrode active material may be mixed to be used.

Examples of the another positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As the another positive electrode active material, it is preferable to mix lithium nickel oxide (LiNiO₂ or LiNi₁₋ₓO₂ (0<x<1) (M=Co, Al, the like)) with a lithium-containing material that has a spinel crystal structure and contains manganese, such as LiMn₂O₄. This composition can improve the characteristics of the secondary battery.

### <Conductive Material>

A conductive material is also referred to as a conductivity-imparting agent or a conductive additive, and a carbon material is used. The conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

An active material layer such as a positive electrode active material layer or a negative electrode active material layer preferably contains a conductive material.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive material.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be fabricated by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of six-membered rings of carbon atoms. The two-dimensional structure formed of the six-membered rings of carbon atoms may be referred to as a carbon sheet. A graphene compound may include a functional group. The graphene compound is preferably bent. The graphene compound may be rounded like carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of six-membered rings of carbon atoms. The reduced graphene oxide functions by itself but may have a stacked-layer structure of a plurality of sheets. The reduced graphene oxide preferably includes a portion where the carbon concentration is higher than 80 Atomic % and the oxygen concentration is higher than or equal to 2 Atomic % and lower than or equal to 15 Atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistance surface contact. Furthermore, a graphene compound sometimes has extremely high conductivity even with a small thickness, and thus a small amount of a graphene compound allows a conductive path to be efficiently formed in an active material layer. Hence, the use of the graphene compound as a conductive material can increase the area where the active material and the conductive material are in contact with each other. The graphene compound preferably covers 80% or more of the area of the active material. Note that a graphene compound preferably clings to at least part of an active material particle. A graphene compound preferably overlays at least part of an active material particle. The shape of a graphene compound preferably conforms to at least part of the shape of an active material particle. The shape of an active material particle means, for example, an uneven surface of a single active material particle or an uneven surface formed by a plurality of active material particles. A graphene compound preferably surrounds at least part of an active material particle. A graphene compound may have a hole.

In the case where an active material particle with a small particle diameter, e.g., 1 μm or less, is used, the specific surface area of the active material particle is large and thus more conductive paths for connecting the active material particles are needed. In such a case, it is preferable to use a graphene compound that can efficiently form a conductive path even with a small amount.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have rapid charge and rapid discharge characteristics in some cases. In addition, a mobile electronic device or the like is required to have rapid charge characteristics in some cases. Rapid charging and discharging refer to charging and discharging at, for example, 200 mA/g, 400 mA/g, or 1000 mA/g or more per weight of the positive electrode active material.

A plurality of graphenes or graphene compounds are formed to partly coat a plurality of particulate positive electrode active materials or adhere to the surfaces of the plurality of particulate positive electrode active materials, so that the plurality of graphenes or graphene compounds preferably make surface contact with the particulate positive electrode active materials.

Here, the plurality of graphenes or graphene compounds can be bonded to each other to form a net-like graphene compound sheet (hereinafter, referred to as a graphene compound net or a graphene net). A graphene net that covers the active material can function as a binder for bonding the active materials. Accordingly, the amount of the binder can be reduced, or the binder does not have to be used, which can increase the proportion of the active material in the electrode volume and the electrode weight. That is, the discharge capacity of the secondary battery can be increased.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiO, (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

The content of the conductive material with respect to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of the battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The battery obtained by the manufacturing method of one embodiment of the present invention can have high capacity density and stability, and is effective as an in-vehicle battery.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, a water-soluble polymer is preferably used. As the water-soluble polymer, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, poly(vinylidene fluoride) (PVDF), polyacrylonitrile (PAN), ethylene-propylene-diene polymer, polyvinyl acetate, or nitrocellulose is preferably used.

As the binder, two or more of the above materials may be used in combination.

### [Current Collector]

The current collector can be formed using a material that has high conductivity, such as a metal like stainless steel, gold, platinum, aluminum, or titanium, or an alloy thereof. It is preferred that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material and/or a carbon-based material can be used.

For the negative electrode active material, an element that enables charge/discharge reactions by an alloying reaction and a dealloying reaction with lithium can be used. For example, a material containing one or two or more selected from silicon, tin, gallium, aluminum, germanium, lead, antimony, bismuth, silver, zinc, cadmium, indium, and the like can be used. Such elements have higher charge/discharge capacity than carbon. In particular, silicon has a high theoretical capacity of 4200 mAh/g. For this reason, silicon is preferably used for the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge/discharge reactions by an alloying reaction and a dealloying reaction with lithium, a compound containing the element, and the like may be referred to as an alloy-based material.

In this specification and the like, SiO refers, for example, to silicon monoxide. SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (higher than or equal to 0.05 V and lower than or equal to 0.30 V vs. Li/Li⁺) when lithium ions are inserted into the graphite (while a lithium-graphite intercalation compound is formed). For this reason, a lithium-ion secondary battery can have a high operating voltage. In addition, graphite is preferred because of its advantages such as a relatively high charge/discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high charge/discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. In the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can also be used as the negative electrode active material. For example, a transition metal oxide that does not form an alloy with lithium, such as cobalt oxide (CoO), nickel oxide (NiO), or iron oxide (FeO), may be used for the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

### [Negative Electrode Current Collector]

For the negative electrode current collector, a material similar to that of the positive electrode current collector can be used. Note that a material that does not alloy with carrier ions of lithium or the like is preferably used for the negative electrode current collector.

### [Electrolyte]

As one mode of an electrolyte, an electrolyte solution containing a solvent and an electrolyte dissolved in the solvent can be used. The electrolyte solution contains the solvent and a lithium salt. As the solvent of the electrolyte solution, an aprotic organic solvent is preferably used; for example, one kind of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, sultone, and the like can be used, or two or more kinds thereof can be used in an appropriate combination at an appropriate ratio.

When ethylene carbonate (EC) and diethyl carbonate (DEC) are contained in the electrolyte solution, it is possible to use a mixed organic solvent in which the volume ratio between ethylene carbonate and diethyl carbonate is x:100-x (where 20≤x≤40) on the assumption that the total content of ethylene carbonate and diethyl carbonate is 100 vol %. More specifically, a mixed organic solvent containing EC and DEC at EC:DEC=30:70 (volume ratio) can be used.

In the case where ethylene carbonate (EC), ethyl methyl carbonate (EMC), and dimethyl carbonate (DMC) are contained in the electrolyte solution, it is possible to use a mixed organic solvent in which the volume ratio between ethylene carbonate, ethyl methyl carbonate, and dimethyl carbonate is x:y:100-x-y (where 5≤x≤35 and 0<y<65) on the assumption that the total content of ethylene carbonate, ethyl methyl carbonate, and dimethyl carbonate is 100 vol %. More specifically, a mixed organic solvent containing EC, EMC, and DMC at EC:EMC:DMC=30:35:35 (volume ratio) can be used.

Furthermore, in the electrolyte solution, a mixed organic solvent containing a fluorinated cyclic carbonate (also referred to as a cyclic carbonate fluoride in some cases) or a fluorinated chain carbonate (also referred to as a chain carbonate fluoride in some cases) can be used. The above mixed organic solvent preferably contains both a fluorinated cyclic carbonate and a fluorinated chain carbonate. A fluorinated cyclic carbonate and a fluorinated chain carbonate are preferred because they each include a substituent with an electron-withdrawing property and thereby lower the solvation energy of a lithium ion. Accordingly, a fluorinated cyclic carbonate and a fluorinated chain carbonate are suitable for the electrolyte solution, and a mixed organic solvent containing these carbonates is suitable.

As the fluorinated cyclic carbonate, fluoroethylene carbonate (FEC or F1EC), difluoroethylene carbonate (DFEC or F2EC), trifluoroethylene carbonate (F3EC), or tetrafluoroethylene carbonate (F4EC) can be used, for example. Note that DFEC has isomers such as a cis-4,5 isomer and a trans-4,5 isomer. Each of these fluorinated cyclic carbonates includes a substituent with an electron-withdrawing property and is thus presumed to allow the solvation energy of a lithium ion to be low. The substituent with an electron-withdrawing property in FEC is an F group.

An example of the fluorinated chain carbonate is methyl 3,3,3-trifluoropropionate. An abbreviation of methyl 3,3,3-trifluoropropionate is “MTFP”. The substituent with an electron-withdrawing property in MTFP is a CF₃ group.

FEC, which is a cyclic carbonate, has a high dielectric constant and thus has an effect of promoting dissociation of a lithium salt when used in an organic solvent. Meanwhile, since FEC includes a substituent having an electron-withdrawing property, a lithium ion is desolvated with FEC more easily than with ethylene carbonate (EC). Specifically, the solvation energy of a lithium ion is lower in FEC than in EC, which does not include a substituent with an electron-withdrawing property. Thus, lithium ions are likely to be extracted from surfaces of a positive electrode active material and a negative electrode active material, which can reduce an internal resistance of a secondary battery. In addition, FEC has a deep highest occupied molecular orbital (HOMO) level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is a chain carbonate, can have an effect of reducing the viscosity of an electrolyte solution or maintaining the viscosity at room temperature (typically, 25 °C) even at low temperatures (typically, 0 °C). Moreover, MTFP achieves a lower solvation energy than methyl propionate (abbreviated as “MP”), which does not include a substituent with an electron-withdrawing property, but may solvate a lithium ion when used for the electrolyte solution.

The above-described organic solvent is preferably highly purified and has low contents of dust particles or molecules other than the constituent molecules of the organic solvent (hereinafter also simply referred to as “impurities”, including oxygen (O2), water (H2O), or moisture). It is preferable that generation of a reaction by-product in synthesis be inhibited through appropriate purification. Specifically, the impurity in the electrolyte is at less than or equal to 100 ppm, preferably less than or equal to 50 ppm, further preferably less than 10 ppm. The concentration of moisture among the impurities can be detected by Karl Fischer titration.

Furthermore, it is preferable that peaks attributed to impurities in the above-described organic solvent be hardly observed by NMR measurement or the like. The expression “hardly observed” includes the case where the ratio of the integral area of the peak attributed to impurities to the integral area of the peak attributed to the main component (such a ratio is simply referred to as an integral ratio) is less than or equal to 0.005, preferably less than or equal to 0.002. An apparatus used for the NMR measurement is not particularly limited, and for example, “AVANCE III 400” by Bruker Corporation can be used. Among the five peaks of acetonitrile derived from acetonitrile-d3 used in a solvent in the 1H-NMR measurement, the center peak can be 1.94 ppm.

For example, in the case of MTFP, it is known that when 1H-NMR is measured using an acetonitrile-d3 solvent, four peaks appear at S greater than or equal to 3.29 ppm and less than or equal to 3.43 ppm. However, in the case where another peak appears in the vicinity of the above range, for example, another peak appears at S greater than or equal to 3.24 ppm and less than or equal to 3.29 ppm, the peak is probably derived from impurities. Accordingly, when the ratio (integral ratio) of the peak area at greater than or equal to 3.24 ppm and less than or equal to 3.29 ppm to the peak area at greater than or equal to 3.29 ppm and less than or equal to 3.43 ppm is less than or equal to 0.005, preferably less than or equal to 0.002, it can be said that peaks attributed to impurities can hardly be observed.

FEC and MTFP having such physical properties are preferably mixed at a volume ratio of x:100-x (where 5≤x≤30, preferably 10≤x≤20) on the assumption that the total content of a mixed organic solvent containing FEC and MTFP is 100 vol %. In other words, FEC and MTFP are preferably mixed such that the amount of MTFP is larger than that of FEC in the mixed organic solvent.

The use of one or more ionic liquids (ordinary temperature molten salts) that are unlikely to burn and volatize as the solvent of the electrolyte solution can prevent the secondary battery from exploding and/or igniting even when the secondary battery internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

### [Lithium Salt]

As the lithium salt (also referred to as electrolyte) dissolved in the above-described solvent, one kind of lithium salt such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), or LiN(C₂F₅SO₂)₂ can be used, or two or more kinds thereof can be used in an appropriate combination at an appropriate ratio. The lithium salt is preferably at greater than or equal to 0.5 mol/L and less than or equal to 3.0 mol/L with respect to the solvent. Using a fluoride such as LiPF₆ or LiBF₄ enables a lithium-ion secondary battery to have improved safety.

As the above-described electrolyte solution, it is preferable to use a highly purified electrolyte solution containing low contents of dust particles or elements other than the constituent elements of the electrolyte solution (hereinafter, also simply referred to as “impurities”). Specifically, the weight ratio of impurities to the electrolyte solution is less than or equal to 1 wt %, preferably less than or equal to 0.1 wt %, further preferably less than or equal to 0.01 wt %.

### [Additive Agent]

The electrolyte solution may contain an additive agent. An additive agent can inhibit a decomposition reaction of an electrolyte which might occur on a positive electrode surface or a negative electrode surface when a secondary battery operates at a high voltage and/or high temperatures. As the additive agent, for example, vinylene carbonate (VC), propane sultone (PS), TerT-butylbenzene (TBB), fluoroethylene carbonate (FEC), or lithium bis(oxalate)borate (LiBOB) is preferably used. It is particularly preferable to use LiBOB because it facilitates formation of a favorable coating film. VC or FEC is preferable because it forms a favorable coating film on a negative electrode at the time of aging the battery or charging the battery at the initial use, which improves the cycling performance.

As the additive agent, one kind or two or more kinds of dinitrile compounds can be used. Specific examples of a dinitrile compound include succinonitrile, glutaronitrile, adiponitrile (ADN), and ethylene glycol bis(propionitrile) ether (EGBE).

Furthermore, fluorobenzene may be added to the above organic solvent. The concentration of the additive agent in the whole electrolyte solution is, for example, higher than or equal to 0.1 wt % and lower than or equal to 5 wt %. PS or EGBE is preferable because it forms a favorable coating film on a positive electrode at the time of charging and discharging, which improves the cycling performance. FB is preferable because it improves the wettability of the organic solvent with respect to the positive electrode and the negative electrode. A dinitrile compound is preferable because its nitrile groups are oriented to the positive electrode and the negative electrode to hinder oxidative decomposition of the organic solvent, whereby resistance against a high voltage can be increased. Furthermore, in the case where the negative electrode includes a current collector containing copper, a dinitrile compound is preferable because it can inhibit dissolution of copper at the time of overdischarging. Considering the use of the secondary battery at a high voltage, a nitrile compound is preferably added.

### [Gel Electrolyte]

A polymer gel obtained by swelling a polymer with an electrolyte solution may be used as a gel electrolyte. When a polymer gel electrolyte is used, a semisolid electrolyte layer can be obtained, so that safety against liquid leakage and the like is improved. Moreover, the secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

### [Solid Electrolyte]

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like can be used. When the solid electrolyte is used, a separator and/or a spacer are/is not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a hydroxide-based material, a fluorine-based material, a polyamide-based material, a mixture thereof, or the like. As the ceramic-based material, for example, it is possible to use aluminum oxide particles, silicon oxide particles, magnesium oxide, or the like. As the hydroxide-based material, it is possible to use magnesium hydroxide, aluminum hydroxide, or the like. As the fluorine-based material, for example, it is possible to use PVDF, polytetrafluoroethylene, or the like. As the polyamide-based material, for example, it is possible to use nylon, aramid (meta-based aramid and para-based aramid), or the like.

When the separator is coated with the ceramic-based material, the oxidation resistance is improved; hence, degradation of the separator in high-voltage charging can be suppressed and thus the reliability of the secondary battery can be improved. When the separator is coated with the fluorine-based material, the separator is easily brought into close contact with the electrode, resulting in higher output characteristics. When the separator is coated with the polyamide-based material, in particular, aramid, heat resistance is improved; thus, the safety of the secondary battery can be improved.

For example, both surfaces of a polypropylene film may be coated with a mixed material of aluminum oxide and aramid. A surface of a polypropylene film that is in contact with the positive electrode may be coated with a mixed material of aluminum oxide and aramid, and a surface of the polypropylene film that is in contact with the negative electrode may be coated with the fluorine-based material.

The use of a separator having a multilayer structure makes it possible to maintain the safety of the secondary battery even when the total thickness of the separator is small, so that the discharge capacity per volume of the secondary battery can be increased.

### [Exterior Body]

For the exterior body of the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### <Laminated Secondary Battery and Fabrication Method Thereof>

FIG. 15 and FIG. 16 illustrate an example of an external view of a laminated secondary battery 500. FIG. 15 and FIG. 16 illustrate a positive electrode 503, a negative electrode 506, a separator 507, an exterior body 509, a positive electrode lead electrode 510, and a negative electrode lead electrode 511. The positive electrode 503 includes a positive electrode current collector 501 and a positive electrode active material layer 502, and the negative electrode 506 includes a negative electrode current collector 504 and a negative electrode active material layer 505. When the laminated secondary battery has flexibility and is used in an electronic device at least part of which is flexible, the secondary battery can be bent as the electronic device is bent. An example of a method for fabricating the laminated secondary battery will be described with reference to FIG. 16A to FIG. 16C.

First, the negative electrode 506, the separator 507, and the positive electrode 503 are stacked. FIG. 16B illustrates the negative electrode 506, the separator 507, and the positive electrode 503 that are stacked. Here, an example in which five negative electrodes and four positive electrodes are used is shown. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion indicated by a dashed line as illustrated in FIG. 16C. Then, the outer edges of the exterior body 509 are bonded to each other. The bonding is performed by thermocompression, for example. At this time, an unbonded region (hereinafter referred to as an inlet) is provided for part (or one side) of the exterior body 509 so that an electrolyte solution can be introduced later.

Next, an electrolyte solution (not illustrated) is introduced into the exterior body 509 from the inlet of the exterior body 509. The electrolyte solution is preferably introduced in a reduced pressure atmosphere or in an inert gas atmosphere. Lastly, the inlet is sealed by bonding. In this manner, the laminated secondary battery 500 can be fabricated.

When the positive electrode active material described in the above embodiment is used in the positive electrode 503, the secondary battery 500 can have high discharge capacity and excellent cycling performance.

This embodiment can be implemented in combination with any of the other embodiments.

### Embodiment 4

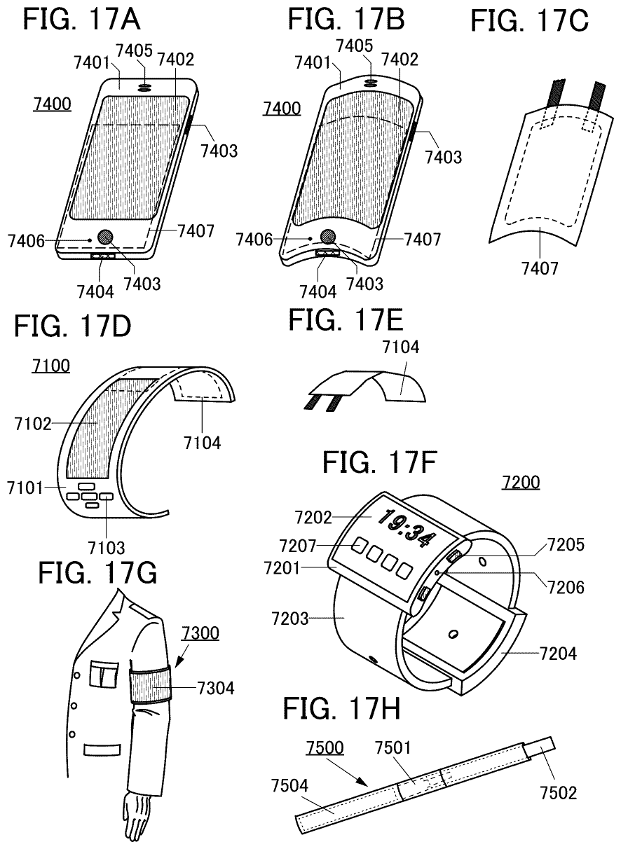

In this embodiment, examples of electronic devices each including the secondary battery of one embodiment of the present invention will be described with reference to FIG. 17A to FIG. 19C.

FIG. 17A to FIG. 17G illustrate examples of electronic devices each including the secondary battery containing the positive electrode active material described in the above embodiment. Examples of electronic devices each including a secondary battery include television devices (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside/outside wall surface of a house, a building, or the like or a curved interior/exterior surface of an automobile, for example.

FIG. 17A illustrates an example of a mobile phone. A mobile phone 7400 is provided with a display portion 7402 incorporated in a housing 7401, operation buttons 7403, an external connection port 7404, a speaker 7405, a microphone 7406, and the like. The mobile phone 7400 includes a secondary battery 7407. When the secondary battery of one embodiment of the present invention is used as the secondary battery 7407, a lightweight mobile phone with a long lifetime can be provided.

FIG. 17B illustrates the state where the mobile phone 7400 is curved. When the whole mobile phone 7400 is curved by the external force, the secondary battery 7407 included therein is also curved. FIG. 17C illustrates the bent secondary battery 7407. The secondary battery 7407 is a thin storage battery. The secondary battery 7407 is fixed in a state of being bent. The secondary battery 7407 includes a lead electrode electrically connected to a current collector.

FIG. 17D illustrates an example of a bangle display device. A portable display device 7100 includes a housing 7101, a display portion 7102, operation buttons 7103, and a secondary battery 7104. FIG. 17E illustrates the bent secondary battery 7104. When the display device is worn on a user's arm while the secondary battery 7104 is bent, the housing changes its shape and the curvature of part or the whole of the secondary battery 7104 is changed. The bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature of 40 mm or more to 150 mm or less. When the radius of curvature at the main surface of the secondary battery 7104 is in the range of 40 mm or more to 150 mm or less, the reliability can be kept high. When the secondary battery of one embodiment of the present invention is used as the secondary battery 7104, a lightweight portable display device with a long lifetime can be provided.

FIG. 17F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. For example, mutual communication with a headset capable of wireless communication enables hands-free calling.

Moreover, the portable information terminal 7200 includes the input/output terminal 7206, and data can be directly transmitted to and received from another information terminal via a connector. In addition, charging via the input/output terminal 7206 is possible. The charging operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 17E can be provided in the housing 7201 while being curved, or can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 17G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charging via the input/output terminal is possible. The charging operation may be performed by wireless power feeding without using the input/output terminal.

When the secondary battery of one embodiment of the present invention is used as the secondary battery included in the display device 7300, a lightweight display device with a long lifetime can be provided.

Examples of electronic devices each including the secondary battery with excellent cycling performance described in the above embodiment are described with reference to FIG. 17H to FIG. 19C.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment, and as secondary batteries of these products, small and lightweight stick type secondary batteries with high discharge capacity are desired in consideration of handling ease for users.

FIG. 17H is a perspective view of a device called a cigarette smoking device (electronic cigarette). In FIG. 17H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharging and/or overdischarging of the secondary battery 7504 may be electrically connected to the secondary battery 7504. The secondary battery 7504 illustrated in FIG. 17H includes an external terminal for connection to a charger. When the electronic cigarette 7500 is held, the secondary battery 7504 is a tip portion; thus, it is preferable that the secondary battery 7504 have a short total length and be lightweight. With the secondary battery of one embodiment of the present invention, which has high discharge capacity and excellent cycling performance, the small and lightweight electronic cigarette 7500 that can be used for a long time over a long period can be provided.

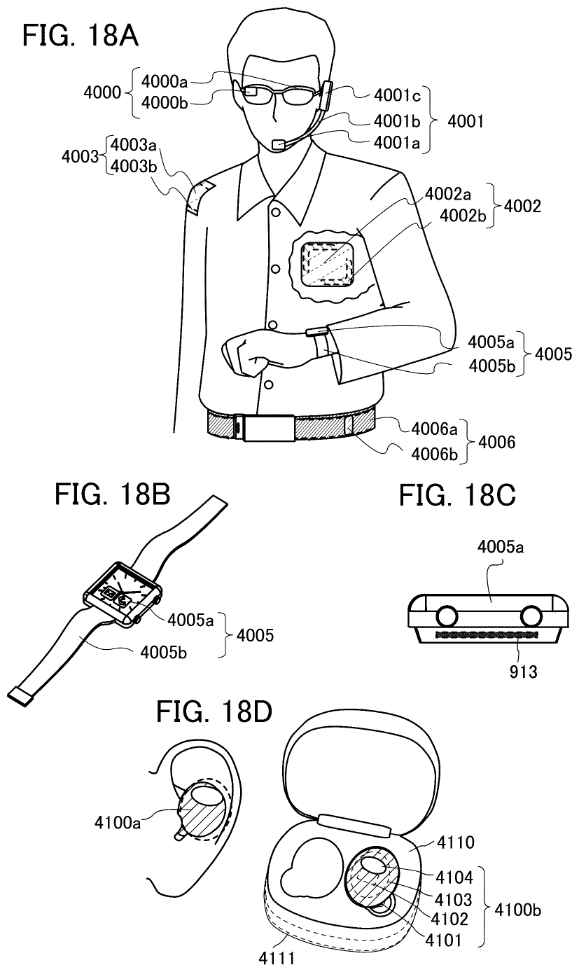

FIG. 18A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 18A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail and an incoming call.

The watch-type device 4005 is a wearable device that is to be wound around an arm directly; thus, a sensor that measures the pulse, the blood pressure, or the like of the user may be incorporated therein. Data on the exercise quantity and health of the user can be stored to be used for health maintenance.

FIG. 18B is a perspective view of the watch-type device 4005 that is detached from an arm.

FIG. 18C illustrates a side view. FIG. 18C illustrates a state where a secondary battery 913 is incorporated inside. The secondary battery 913 is the secondary battery described in Embodiment 4. The secondary battery 913, which is small and lightweight, is provided at a position overlapping with the display portion 4005a.

FIG. 18D illustrates an example of wireless earphones. The wireless earphones illustrated here consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charging, and the like are preferably included. Furthermore, a microphone may be included.

A case 4110 includes a secondary battery 4111. Moreover, a substrate where a circuit such as a wireless IC or a charge control IC is provided, and a terminal for charging are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to the main bodies 4100a and 4100b and played. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery of the foregoing embodiment or a cylindrical secondary battery, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

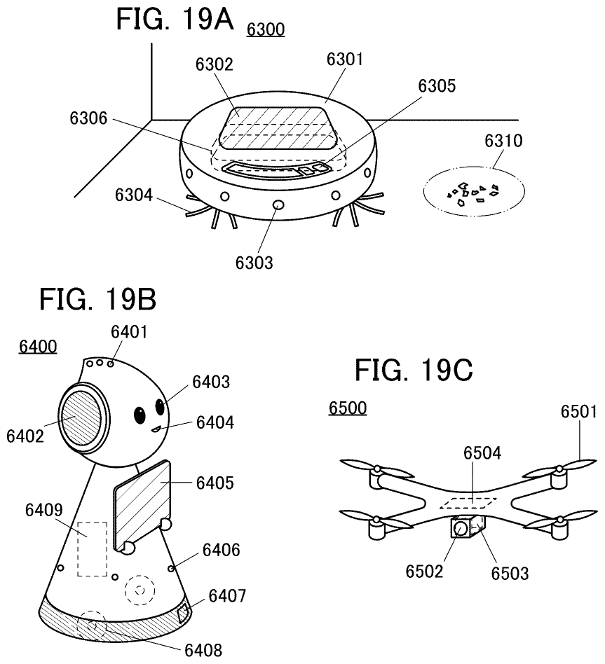

FIG. 19A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 19B illustrates an example of a robot. A robot 6400 illustrated in FIG. 19B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of capturing an image of the surroundings of the robot 6400. The obstacle sensor 6407 can detect whether there is an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 19C illustrates an example of a flying object. A flying object 6500 illustrated in FIG. 19C includes propellers 6501, a camera 6502, a secondary battery 6503, and the like and has a function of flying autonomously.

For example, image data captured by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with the other embodiments.

### Embodiment 5

In this embodiment, examples of vehicles each including a secondary battery containing the positive electrode active material of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

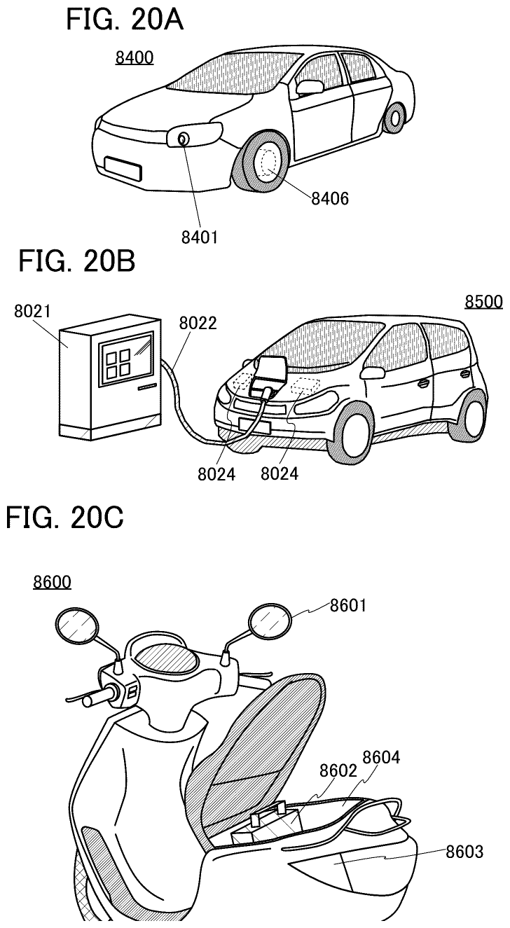

FIG. 20 illustrates examples of vehicles each including the secondary battery of one embodiment of the present invention. An automobile 8400 illustrated in FIG. 20A is an electric vehicle that runs on the power of an electric motor. Alternatively, the automobile 8400 is a hybrid electric vehicle capable of driving using either an electric motor or an engine as appropriate. The use of one embodiment of the present invention can achieve a high-mileage vehicle. The automobile 8400 includes the secondary battery. For example, the modules of the secondary battery can be arranged in a floor portion in the automobile to be used. The secondary battery can be used not only for driving an electric motor 8406, but also for supplying electric power to light-emitting devices such as a headlight 8401 and a room light (not illustrated).

The secondary battery can also supply power to a display device included in the automobile 8400, such as a speedometer or a tachometer. Furthermore, the secondary battery can supply power to a semiconductor device included in the automobile 8400, such as a navigation system.

An automobile 8500 illustrated in FIG. 20B can be charged when the secondary battery included in the automobile 8500 is supplied with electric power through external charge equipment by a plug-in system, a contactless power feeding system, and/or the like. FIG. 20B illustrates a state where a secondary battery 8024 included in the automobile 8500 is charged with the use of a ground-based charging apparatus 8021 through a cable 8022. In charging, a given method such as CHAdeMO (registered trademark) or Combined Charging System may be employed as a charge method, the standard of a connector, and the like as appropriate. The charging apparatus 8021 may be a charging station provided in a commerce facility or a power source in a house. For example, with the use of a plug-in technique, the secondary battery 8024 provided in the automobile 8500 can be charged by being supplied with electric power from outside. Charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 20C is an example of a motorcycle including the secondary battery of one embodiment of the present invention. A motor scooter 8600 illustrated in FIG. 20C includes a secondary battery 8602, side mirrors 8601, and direction indicators 8603. The secondary battery 8602 can supply electricity to the direction indicators 8603.

In the motor scooter 8600 illustrated in FIG. 20C, the secondary battery 8602 can be held in an under-seat storage 8604. The secondary battery 8602 can be stored in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycling performance and an increased discharge capacity. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power supply source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycling performance can be used over a long period; thus, the use amount of rare metals typified by cobalt can be reduced.

This embodiment can be implemented in appropriate combination with the other embodiments.

### Example 1

This example describes results of studying the case where Ni and Ti exist in LiCoO₂ by first-principles calculation.

### [First-Principles Calculation]

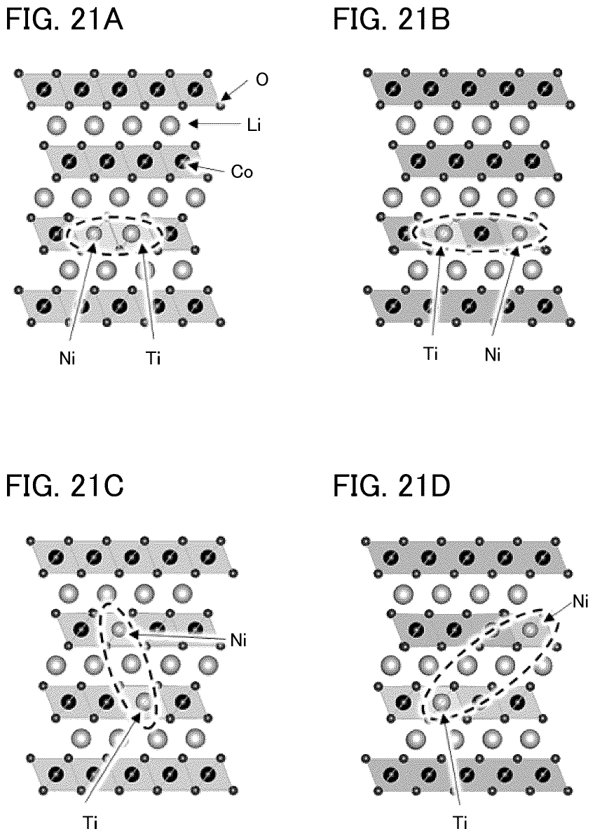

For examination of what positional relationship leads to stability in the case where Ni and Ti exist in LiCoO₂, structural stabilization calculation was performed on four calculation models shown in FIG. 21A to FIG. 21D to calculate stabilization energy.

Calculation models used for the first-principles calculation are described. The calculation model in FIG. 21A shows the case where a Ni atom and a Ti atom are adjacent to each other in the same transition metal layer (the case where the Ni atom and the Ti atom are close to each other in the same layer). The calculation model in FIG. 21B shows the case where a Ni atom and a Ti atom are adjacent to each other with a Co atom positioned therebetween in the same transition metal layer (the case where the Ni atom and the Ti atom are apart from each other in the same layer). The calculation model in FIG. 21C shows the case where a Ni atom and a Ti atom are close to each other in different transition metal layers (the case where the Ni atom and the Ti atom are close to each other in different layers). The calculation model in FIG. 21D shows the case where a Ni atom and a Ti atom are apart from each other in different transition metal layers (the case where the Ni atom and the Ti atom are apart from each other in different layers). Note that although FIG. 21A to FIG. 21D two-dimensionally illustrate the four calculation models for easy viewing, they are actually three-dimensional structural models constructed with the number of atoms being as shown in Table 2.

The calculation was performed under the conditions shown in Table 2.

TABLE 2

| Software | VASP | |
|---|---|---|
| Functional | GGA + U (DFT-D3(BJ)) | |
| Pseudopotential | PAW | |
| Cutoff energy (eV) | 600 | |
| U potential | Co | 4.91 |
| | Ni | 5.26 |
| | Ti | 0.00 |

| | |
|---|---|
| Number of atoms | Li: 48, Co: 46, 0: 96 |
| | Ni: 1, TE: 1 |
| k-pomts | 3 × 3 × 2 |
| Target for calculation | Lattice and atom position optimized |

As the calculation results, Table 3 shows relative energy with respect to the stabilization energy in the models shown in FIG. 21B to FIG. 21D, with reference to stabilization energy under 5 the conditions of the case shown in FIG. 21A where the atoms are close to each other in the same layer.

TABLE 3

| | | | Close in | Apart in |
|---|---|---|---|---|
| | Close in the | Apart in the | different | different |
| | same layer | same layer | layers | layers |
| Distance (nm) | 0.278 | 0.486 | 0.490 | 0.747 |
| Relative energy | 0.0 | 0.27 | 0.40 | 0.42 |
| (ev) | | | | |

The results of the above calculation revealed that, as shown in Table 3, the stabilization energy under the conditions of the case illustrated in FIG. 21A where the atoms are close to each other in the same layer is the lowest, indicating stability.

The distance between the Ni atom and the Ti atom in each model after structural stabilization is described. In the case illustrated in FIG. 21A where the Ni atom and the Ti atom are close to each other in the same layer, the distance between the Ni atom and the Ti atom is 0.278 nm. In the case illustrated in FIG. 21B where the Ni atom and the Ti atom are apart from each other in the same layer, the distance between the Ni atom and the Ti atom is 0.486 nm. In the case illustrated in FIG. 21C where the Ni atom and the Ti atom are close to each other in the same layer, the distance between the Ni atom and the Ti atom is 0.490 nm. In the case illustrated in FIG. 21D where the Ni atom and the Ti atom are close to each other in the same layer, the distance between the Ni atom and the Ti atom is 0.747 nm.

From the above calculation results, it can be said that the structure is more stable when the distance between the Ni atom and the Ti atom is shorter. That is, it is preferable that the distribution of nickel and the distribution of titanium have an overlapping region as described with reference to FIG. 1B, FIG. 1C, and the like, in which case the structure of the positive electrode active material 100 can be stabilized.

### Example 2

In this example, lithium cobalt oxide containing magnesium, nickel, aluminum, and titanium as additive elements was formed, and the characteristics thereof were evaluated.

### <Formation of Positive Electrode Active Material>

The formation of the positive electrode active material in this example will be described with reference to the formation method shown in FIG. 12 to FIG. 13C.

### <Sample 1 Å>

As the LiMO₂ in Step S14 in FIG. 12, commercially available lithium cobalt oxide (CELLSEED C-5H produced by NIPPON CHEMICAL INDUSTRIAL CO., LTD.) containing cobalt as the transition metal M and no additive element was prepared. The median diameter (D50) of CELLSEED C-5H obtained by measuring the particle size distribution with a laser diffraction particle size analyzer SALD-2200 was 7.0 m.

In accordance with Step S20 to Step S33 in FIG. 12, magnesium and fluorine were added as the additive element A1. First, as shown in Step S21 in FIG. 13A, magnesium fluoride (MgF₂) and lithium fluoride (LiF) were prepared as the magnesium source and the fluorine source, respectively. The LiF and MgF₂ were weighed such that LiF:MgF₂ was 1:3 (molar ratio). Then, the LiF and MgF₂ were mixed into dehydrated acetone, and mixing was performed at a rotational speed of 500 rpm for 20 hours (Step S22). In the mixing, a ball mill was used and a grinding medium was zirconium oxide balls. In a 45-mL-capacity container of the mixing ball mill, LiF and MgF₂ weighing approximately 10 g in total were put together with 20 mL of dehydrated acetone and 22 g of zirconium oxide balls (1 mmφ), and mixing was performed. After the mixing, the mixture was made to pass through a sieve with an aperture of 300 μm, whereby the additive element source (the A1 source) was obtained (Step S23).

Then, in Step S31, weighing was performed such that the number of moles of MgF₂ contained in the A1 source was 0.50 mol % with respect to the number of moles of the lithium cobalt oxide, and mixing with the lithium cobalt oxide was performed by a dry method. At this time, the lithium cobalt oxide and the additive element source (A1 source) weighing 10 g in total were put in a 45-mL-capacity container of a mixing ball mill together with 22 g of zirconium oxide balls (1 mmφ), and mixing was performed at a rotational speed of 150 rpm for one hour. These conditions are milder than those of the mixing (Step S22) in the production of the A1 source. After the mixing, the mixture was made to pass through a sieve with an aperture of 300 μm, whereby the mixture 901 was obtained (Step S32).

Subsequently, in Step S33, the mixture 901 was heated. The heating conditions were 850 °C and 10 hours. During the heating, the mixture 903 was in a crucible covered with a lid. The crucible was filled with an atmosphere containing oxygen and entry and exit of the oxygen were blocked (purging). By the heating, the composite oxide 902 containing Mg and F was obtained (Step S34).

Next, in accordance with Step S40 to Step S54, nickel and aluminum were added as the additive element A2. As shown in Step S41 and Step S43 in FIG. 13B, nickel hydroxide (Ni(OH)₂) that was subjected to a grinding step (Step S42) was prepared as the nickel source, and aluminum hydroxide (Al(OH)₃) that was subjected to the grinding step (Step S42) was prepared as the aluminum source. Weighing was performed such that the number of moles of the nickel hydroxide was 0.50 mol % with respect to the number of moles of the lithium cobalt oxide and the number of moles of the aluminum hydroxide was 0.25 mol % with respect to the number of moles of the lithium cobalt oxide, and mixing with the composite oxide 902 was performed by a dry method (Step S51). The conditions of the mixing were similar to those in Step S31. After the mixing, the mixture was made to pass through a sieve with an aperture of 300 μm, whereby the mixture 903 was obtained (Step S52).

Subsequently, in Step S53, the mixture 903 was heated. The heating conditions were 850 °C and two hours. During the heating, the mixture 903 was in a crucible covered with a lid. The crucible was filled with an atmosphere containing oxygen and entry and exit of the oxygen were blocked (purging). By the heating, the composite oxide 904 containing Mg, F, Ni, and A1 was obtained (Step S54).

Next, titanium was added as the additive element A3 in accordance with Step S60 to Step S74. As shown in Step S61 to Step S63 in FIG. 13C, lithium titanate (Li₂TiO₃) that was subjected to a grinding step (Step S62) was prepared as the titanium source. As a grinding medium, zirconium oxide balls were used. In a 45-mL-capacity container of a mixing ball mill, Li₂TiO₃ weighing approximately 5 g in total was put together with 20 mL of dehydrated acetone and 22 g of zirconium oxide balls (1 mm #), and stirring was performed at a rotational speed of 400 rpm for 12 hours. Finally, the mixture was made to pass through a sieve with an aperture of 300 μm, whereby the A3 source was obtained (Step S63).

Next, in Step S71, weighing was performed such that the number of moles of the A3 source was 0.1 mol % with respect to the number of moles of the lithium cobalt oxide, and mixing with the composite oxide 904 was performed. At this time, the composite oxide 904 and the additive element source (A3 source) weighing approximately 9.5 g in total were put in a 45-mL-capacity container of a mixing ball mill together with 22 g of zirconium oxide balls (1 mm #), and stirring was performed at a rotational speed of 150 rpm for one hour. These conditions are milder than those of the stirring in the production of the A1 source or the like. After mixing, the mixture was made to pass through a sieve with an aperture of 300 μm, whereby the mixture 905 was obtained (Step S72).

Subsequently, in Step S73, the mixture 905 was heated. The heating conditions were 850 °C and two hours. During the heating, the mixture 905 was in a crucible covered with a lid. The crucible was filled with an atmosphere containing oxygen and entry and exit of the oxygen were blocked (purging). By the heating, lithium cobalt oxide containing Mg, F, Ni, Al, and Ti was obtained (Step S74). The positive electrode active material 100 (composite oxide) obtained in this manner was used as Sample 1 Å.

### <Sample 1B>

A positive electrode active material formed in a manner similar to that of Sample 1A except that weighing was performed such that the number of moles of the A3 source was 0.25 mol % with respect to the number of moles of the lithium cobalt oxide and mixing with the composite oxide 904 was performed in Step S71 in FIG. 12 was used as Sample 1B.

### <Sample 1C>

A positive electrode active material formed in a manner similar to that of Sample 1A except that weighing was performed such that the number of moles of the A3 source was 0.50 mol % with respect to the number of moles of the lithium cobalt oxide and mixing with the composite oxide 904 was performed in Step S71 in FIG. 12 was used as Sample 1C.

### <Sample 2A>

A positive electrode active material formed in a manner similar to that of Sample 1A except that weighing was performed such that the number of moles of MgF₂ contained in the A1 source was 0.75 mol % with respect to the number of moles of the lithium cobalt oxide and mixing with the lithium cobalt oxide was performed by a dry method in Step S31 in FIG. 12 was used as Sample 2A.

### <Sample 3>

A positive electrode active material formed in a manner similar to that of Sample 2A except that Step S60 and the subsequent steps in FIG. 12 were not performed was used as Sample 3. That is, Sample 3 is the composite oxide 904 in FIG. 12.

### <Sample 4>

CELLSEED C-5H used in Step S14 in FIG. 12 was used as Sample 4. Sample 4 is a comparative example.

### <Sample 5A>

As the LiMO₂ in Step S14 in FIG. 12, commercially available lithium cobalt oxide (CELLSEED C-10N produced by NIPPON CHEMICAL INDUSTRIAL CO., LTD.) containing cobalt as the transition metal M and no additive element was prepared. The median diameter (D50) of CELLSEED C-10N obtained by measuring the particle size distribution with a laser diffraction particle size analyzer SALD-2200 was 12.5 μm. In the formation of Sample 5A, unlike in the formation of Sample 1A to Sample 3, the initial heating was performed before the lithium cobalt oxide prepared in Step S14 in FIG. 12 was mixed with the A1 source in Step S31. The initial heating was performed on the lithium cobalt oxide, which was put in a crucible covered with a lid, in a muffle furnace at 850 °C for two hours. Here, the muffle furnace was under the following conditions: the muffle furnace was filled with an oxygen atmosphere, and then no flowing was performed (O₂ purging).

In accordance with Step S20 to Step S33 in FIG. 12, magnesium and fluorine were added as the additive element A1. First, as shown in Step S21 in FIG. 13A, magnesium fluoride (MgF₂) was prepared as the magnesium source and lithium fluoride (LiF) and magnesium fluoride were prepared as the fluorine source. The LiF and MgF₂ were weighed such that LiF:MgF₂ was 1:3 (molar ratio). Then, the LiF and MgF₂ were mixed into dehydrated acetone, and mixing was performed at a rotational speed of 500 rpm for 20 hours (Step S22). In the mixing, a ball mill was used and a grinding medium was zirconium oxide balls. In a 45-mL-capacity container of the mixing ball mill, LiF and MgF₂ weighing approximately 10 g in total were put together with 20 mL of dehydrated acetone and 22 g of zirconium oxide balls (1 mm #), and mixing was performed. After the mixing, the mixture was made to pass through a sieve with an aperture of 300 μm, whereby the additive element source (the A1 source) was obtained (Step S23).

Then, in Step S31, weighing was performed such that the number of moles of MgF₂ contained in the A1 source was 1.0 mol % with respect to the number of moles of the lithium cobalt oxide, and mixing with the lithium cobalt oxide was performed by a dry method. At this time, the composite oxide and the additive element source (A1 source) weighing 118.5 g in total were put in a 500-mL-capacity container of a mixing ball mill together with 250 g of zirconium oxide balls (1 mm #), and mixing was performed at a rotational speed of 150 rpm for 23 minutes. These conditions are milder than those of the mixing (Step S22) in the production of the A1 source. After the mixing, the mixture was made to pass through a sieve with an aperture of 300 μm, whereby the mixture 901 was obtained (Step S32).

Subsequently, in Step S33, the mixture 901 was heated. The heating conditions were 900 °C and 20 hours. During the heating, the mixture 903 was in a crucible covered with a lid. The crucible was filled with an atmosphere containing oxygen and entry and exit of the oxygen were blocked (purging). By the heating, the composite oxide 902 containing Mg and F was obtained (Step S34).

Next, in accordance with Step S40 to Step S54, nickel and aluminum were added as the additive element A2. As shown in Step S41 and Step S43 in FIG. 13B, nickel hydroxide (Ni(OH)₂) that was subjected to a grinding step (Step S42) was prepared as the nickel source, and aluminum hydroxide (Al(OH)₃) that was subjected to the grinding step (Step S42) was prepared as the aluminum source. Weighing was performed such that the number of moles of the nickel hydroxide was 0.50 mol % with respect to the number of moles of the lithium cobalt oxide and the number of moles of the aluminum hydroxide was 0.50 mol % with respect to the number of moles of the lithium cobalt oxide, and mixing with the composite oxide 902 was performed by a dry method (Step S51). The conditions of the mixing were similar to those in Step S31. After the mixing, the mixture was made to pass through a sieve with an aperture of 300 μm, whereby the mixture 903 was obtained (Step S52).

Subsequently, in Step S53, the mixture 903 was heated. The heating conditions were 850 °C and 10 hours. During the heating, the mixture 903 was in a crucible covered with a lid. The crucible was filled with an atmosphere containing oxygen and entry and exit of the oxygen were blocked (purging). By the heating, the composite oxide 904 containing Mg, F, Ni, and Al was obtained (Step S54).

Next, titanium was added as the additive element A3 in accordance with Step S60 to Step S74. As shown in Step S61 to Step S63 in FIG. 13C, lithium titanate (Li₂TiO₃) that was subjected to a grinding step (Step S62) was prepared as the titanium source. As a grinding medium, zirconium oxide balls were used. In a 45-mL-capacity container of a mixing ball mill, Li₂TiO₃ weighing approximately 5 g in total was put together with 20 mL of dehydrated acetone and 22 g of zirconium oxide balls (1 mmφ), and stirring was performed at a rotational speed of 400 rpm for 12 hours. Finally, the mixture was made to pass through a sieve with an aperture of 300 μm, whereby the A3 source was obtained (Step S63).

Next, in Step S71, weighing was performed such that the number of moles of the A3 source was 0.1 mol % with respect to the number of moles of the lithium cobalt oxide, and mixing with the composite oxide 904 was performed. At this time, the composite oxide 904 and the additive element source (A3 source) weighing approximately 7.5 g in total were put in a 45-mL-capacity container of a mixing ball mill together with 22 g of zirconium oxide balls (1 mm #), and stirring was performed at a rotational speed of 150 rpm for one hour. These conditions are milder than those of the stirring in the production of the A1 source or the like. After mixing, the mixture was made to pass through a sieve with an aperture of 300 μm, whereby the mixture 905 was obtained (Step S72).

Subsequently, in Step S73, the mixture 905 was heated. The heating conditions were 850 °C and two hours. During the heating, the mixture 905 was in a crucible covered with a lid. The crucible was filled with an atmosphere containing oxygen and entry and exit of the oxygen were blocked (purging). By the heating, lithium cobalt oxide containing Mg, F, Ni, Al, and Ti was obtained (Step S74). The positive electrode active material (composite oxide) obtained in this manner was used as Sample 5A.

### <Sample 6>

A positive electrode active material formed in a manner similar to that of Sample 5A except that Step S60 and the subsequent steps in FIG. 12 were not performed was used as Sample 6.

### <Sample 7>

CELLSEED C-10N used in Step S14 in FIG. 12 was used as Sample 7. Sample 7 is a comparative example.

Table 4 shows the formation conditions of Sample 1A to Sample 7. Note that “mol %” in Table 4 represents the proportion of the number of moles to that of LiCoO₂. Furthermore, “-” in the table indicates that the treatment for adding the corresponding additive element was not performed.

TABLE 4

| | S14 | S20 | S40 | S60 |
|---|---|---|---|---|
| | LIM O2 | A1 source | A2 source | A3 source |
| Sample 1A | LiCoO₂ | LiF 0.17 mol % | Ni(OH)₂ 0.5 mol % | Li₂TiO₃ 0.1 mol % |
| Sample 1B | D50: 7.0 μm | MgF₂ 0.50 mol % | Al(OH)₃ 0.25 mol % | Li₂TiO₃ 0.25 mol % |
| Sample 1C | | | | Li₂TiO₃ 0.5 mol % |
| Sample 2A | | LiF 0.25 mol % | | Li₂TiO₃ 0.1 mol % |
| Sample 3 | | MgF₂ 0.75 mol % | | — |
| Sample 4 | | — | — | — |
| Sample 5A | LiCoO₂ | LiF 0.33 mol % | Ni(OH)₂ 0.5 mol % | Li₂TiO₃ 0.1 mol % |
| Sample 6 | D50: 12.5 μm | MgF₂ 1.0 mol % | Al(OH)₃ 0.5 mol % | — |
| Sample 7 | | — | — | — |

### <Powder Resistance Measurement>

The volume resistivity of powder of Sample 1A, Sample 1B, Sample 1C, Sample 2A, and Sample 4 was measured.

The volume resistivity of the powder was measured by the method described in Powder resistance measurement in Embodiment 1. As a measurement device, MCP-PD51 produced by Mitsubishi Chemical Analytech Co., Ltd. was used; Hiresta-GP was used for the measurement unit for the measurement of Sample 1A to Sample 2A, and Loresta-GP was used for the measurement unit for the measurement of Sample 4. The measurement was performed in an environment where the temperature was 25 °C and the dew point was lower than or equal to −40 °C.

The volume resistivity of the powder of each sample was obtained by measuring the electric resistance and volume of the powder under pressures of 16 MPa, 25 MPa, 38 MPa, 51 MPa, and 64 MPa. Table 5 shows the results.

TABLE 5

| | Pressure during measurement of powder resistance | | | | |
|---|---|---|---|---|---|
| | 13 MPa | 25 MPa | 38 MPa | 51 MPa | 64 MPa |
| Sample 1A | 4.04E+09 Ω · cm | 1.32E+09 Ω · cm | 6.23E+08 Ω · cm | 3.54E+08 Ω · cm | 2.29E+08 Ω · cm |
| Sample 1B | 1.87E+09 Ω · cm | 6.13E+08 Ω · cm | 2.83E+08 Ω · cm | 1.68E+08 Ω · cm | 1.12E+08 Ω · cm |
| Sample 1C | 1.42E+09 Ω · cm | 4.68E+08 Ω · cm | 2.22E+08 Ω · cm | 1.28E+08 Ω · cm | 8.21E+07 Ω · cm |
| Sample 2A | 1.60E+10 Ω · cm | 3.73E+09 Ω · cm | 1.62E+09 Ω · cm | 8.60E+08 Ω · cm | 5.16E+08 Ω · cm |
| Sample 4 | 6.10E+03 Ω · cm | 4.79E+03 Ω · cm | 4.38E+03 Ω · cm | 4.23E+03 Ω · cm | 4.15E+03 Ω · cm |

### <SEM Observation>

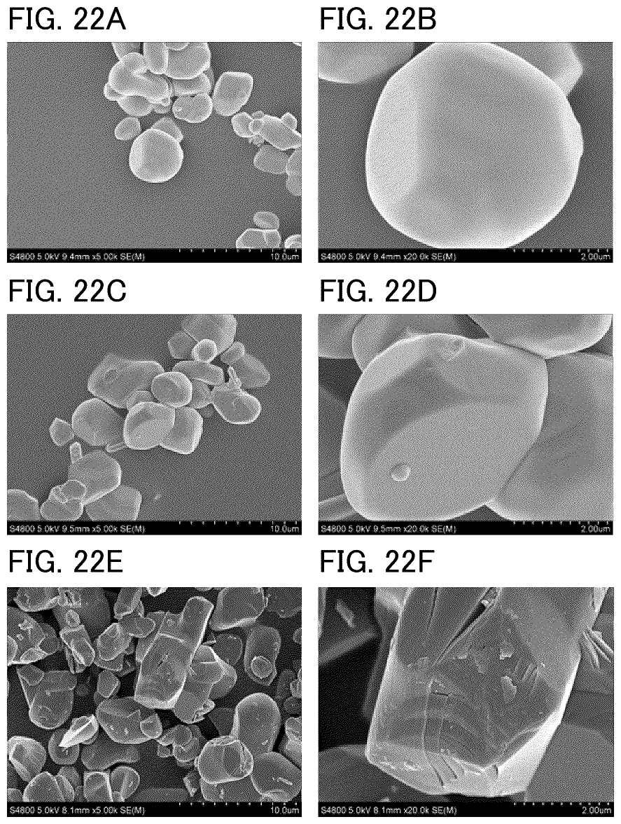

The surfaces of the powder of Sample 2A, Sample 3, and Sample 4 were observed with a SEM. FIG. 22A and FIG. 22B are SEM images of Sample 2A, FIG. 22C and FIG. 22D are SEM images of Sample 3, and FIG. 22E and FIG. 22F are SEM images of Sample 2A. An S4800 scanning electron microscope apparatus produced by Hitachi High-Tech Corporation was used for the SEM observation. The conditions were as follows: the acceleration voltage was 5 kV, and the magnification was 5000 times (FIG. 22A, FIG. 22C, and FIG. 22E) or 20000 times (FIG. 22B, FIG. 22D, and FIG. 22F).

As shown in FIG. 22A to FIG. 22F, Sample 2A and Sample 3 appear to have smoother particle surfaces and fewer adhering substances than Sample 4.

### <XRD>

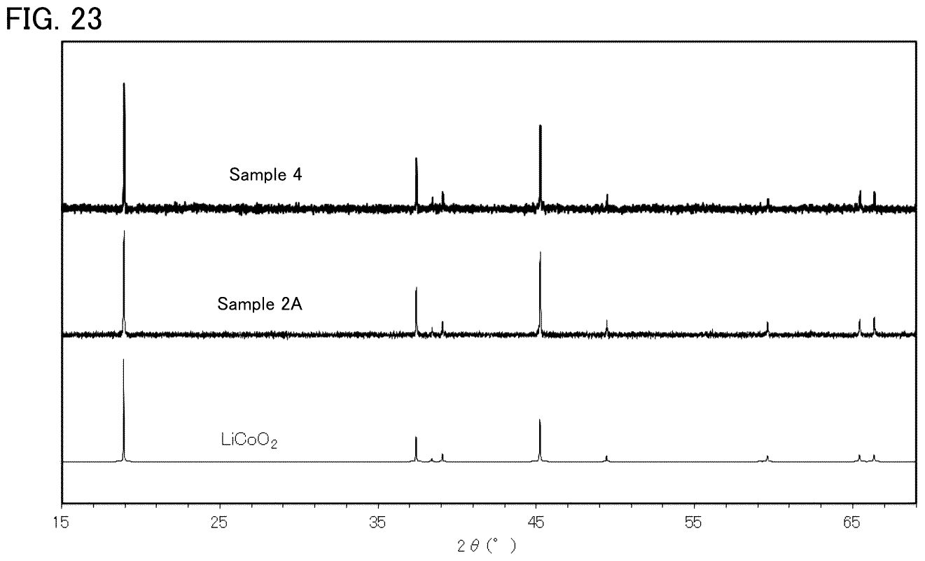

XRD measurement was performed on the powder of Sample 2A and Sample 4. For the conditions of the XRD measurement, the method described in <<XRD>> in Embodiment 1 was used. As a measurement apparatus, D8 ADVANCE manufactured by Bruker AXS was used. FIG. 23 shows the measurement results. Note that the XRD curve denoted by LiCoO₂ in the graph is a calculation value calculated from a crystal structure model of lithium cobalt oxide.

It is found from FIG. 23 that the XRD curves of Sample 2A and Sample 4 that are not yet used for secondary batteries have substantially the same shape as the XRD curve denoted by LiCoO₂.

### <Ion Chromatography>

Sample 2A and Sample 4 were subjected to ion chromatography measurement.

The volume resistivity of the powder was measured by the method described in <<Ion chromatography>> in Embodiment 1. As the measurement apparatus, an ion chromatography system Dionex ICS-2100 produced by Thermo Fisher Scientific Inc. was used.

Table 6 shows the results of ion chromatography. The values shown in the table indicate weight ppm of each element with respect to the sample weight (Sample 2A or Sample 4).

TABLE 6

| | Anion (weight ppm) | | Cation (weight ppm) | | | |
|---|---|---|---|---|---|---|
| Sample name | F | Cl | Li | Mg | Co | Ni |
| Sample 2A | 175.3 | 11.9 | 2785.9 | 559.5 | 9423.2 | 322.9 |
| Sample 4 | 2.2 | 4.2 | 3191.2 | 8.9 | 9487.6 | 0.0 |

### <XPS Analysis Result>

XPS analysis was performed on the particle surfaces of Sample 2A and Sample 4 prepared in the above manner. The measurement apparatus and conditions for XPS were as follows.
Measurement apparatus: QuanteraII produced by ULVAC-PHI, Inc.
X-ray source:monochromatic A Kα (1486.6 eV)
   Detection area: 100 μmφ
   Detection depth (Condition 1): a range from a surface to approximately 2 nm (detector angle: 15°)
   Detection depth (Condition 2): a range from a surface to approximately 5 nm (detector angle: 45°)

Measurement spectrum: wide scanning, narrow scanning of each detected element

The XPS analysis results are shown in Table 7 and Table 8.

TABLE 7

| | Detector angle | | | | | | | | | |
|---|---|---|---|---|---|---|---|---|---|---|
| | (detection depth) | Li | Co | Ti | O | C | F | S | Ca | Mg |
| Sample 2A | 15° (approximately 2 nm) | 9.1 at % | 11.2 at % | 1.4 at % | 47.4 at % | 9.3 at % | 6.3 at % | 0.6 at % | 0.5 at % | 11.9 at % |
| | 45° (approximately 5 nm) | 9.5 at % | 13.1 at % | 1.6 at % | 46.7 at % | 8.6 at % | 6.6 at % | 0.7 at % | 0.7 at % | 10.8 at % |
| Sample 4 | 15° (approximately 2 nm) | 14.3 at % | 20.1 at % | — | 52.8 at % | 9.1 at % | — | 0.3 at % | 0.3 at % | 1.4 at % |
| | 45° (approximately 5 nm) | 15.4 at % | 22.0 at % | — | 50.5 at % | 9.0 at % | — | 0.4 at % | 0.4 at % | 1.0 at % |
| | Detector angle | | | | | | | | | |
| | (detection depth) | Na | Zr | Ni | Si | Al | Mg/Co | F/Mg | Ni/Co | Ti/Co |
| Sample 2A | 15° (approximately 2 nm) | 1.2 at % | — | 1.1 at % | — | — | 1.06 | 0.53 | 0.10 | 0.12 |
| | 45° (approximately 5 nm) | 0.7 at % | — | 1.1 at % | — | — | 0.82 | 0.61 | 0.08 | 0.12 |
| Sample 4 | 15° (approximately 2 nm) | 0.7 at % | — | — | 0.8 at % | — | 0.07 | — | — | — |
| | 45° (approximately 5 nm) | 0.3 at % | — | — | 1.0 at % | — | 0.05 | — | — | — |

TABLE 8

| | Detector angle | | | | | | | | | |
|---|---|---|---|---|---|---|---|---|---|---|
| | (detection depth) | Li | Co | Ti | O | C | F | S | Ca | Mg |
| Sample 2A | 15° (approximately 2 nm) | | 12.3 at % | 1.5 at % | 52.1 at % | 10.2 at % | 6.9 at % | 0.7 at % | 0.6 at % | 13.1 at % |
| | 45° (approximately 5 nm) | | 14.5 at % | 1.8 at % | 51.6 at % | 9.5 at % | 7.3 at % | 0.8 at % | 0.8 at % | 11.9 at % |
| Sample 4 | 15° (approximately 2 nm) | | 22.2 at % | — | 58.3 at % | 10.1 at % | — | 0.3 at % | 0.3 at % | 1.5 at % |
| | 45° (approximately 5 nm) | | 24.3 at % | — | 55.8 at % | 9.9 at % | — | 0.4 at % | 0.4 at % | 1.1 at % |
| | Detector angle | | | | | | | | | |
| | (detection depth) | Na | Zr | Ni | Si | Al | Mg/Co | F/Mg | Ni/Co | Ti/Co |
| Sample 2A | 15° (approximately 2 nm) | 1.3 at % | — | 1.2 at % | — | — | 1.06 | 0.53 | 0.10 | 0.12 |
| | 45° (approximately 5 nm) | 0.8 at % | — | 1.2 at % | — | — | 0.82 | 0.61 | 0.08 | 0.12 |
| Sample 4 | 15° (approximately 2 nm) | 0.8 at % | — | — | 0.9 at % | — | 0.07 | — | — | — |
| | 45° (approximately 5 nm) | 0.3 at % | — | — | 1.1 at % | — | 0.05 | — | — | — |

As shown in Table 7 and Table 8, each of Sample 2A and Sample 4 had no significant difference between the concentrations of the elements analyzed under Condition 1 with a detector angle of 15° and the concentrations of the elements analyzed under Condition 2 with a detector angle of 45°.

Table 7 shows the concentrations (at %: atomic concentrations, which are sometimes denoted with Atomic %) of the elements on the assumption that the sum of the concentrations of lithium (Li), cobalt (Co), titanium (Ti), oxygen (O), carbon (C), fluorine (F), sulfur (S), calcium (Ca), magnesium (Mg), sodium (Na), zirconium (Zr), nickel (Ni), and aluminum (Al) is 100 at/o; in Sample 2A, the concentration of magnesium was 11.9 at % (Condition 1) and 10.8 at % (Condition 2), the concentration of fluorine was 6.3 at % (Condition 1) and 6.6 at % (Condition 2), the concentration of nickel was 1.1 at % (Condition 1) and 1.1 at % (Condition 2), the concentration of titanium was 1.4 at % (Condition 1) and 1.6 at % (Condition 2), and the concentration of aluminum was below the lower detection limit. Note that “-” in the tables indicates that the concentration was below the lower detection limit.

Note that the concentration of lithium in a positive electrode active material of a lithium-ion battery changes through charging and discharging. In view of this, Table 8 omits the values of lithium from the results in Table 7 and shows the concentrations of the elements on the assumption that the sum of the concentrations of cobalt (Co), titanium (Ti), oxygen (O), carbon (C), fluorine (F), sulfur (S), calcium (Ca), magnesium (Mg), sodium (Na), zirconium (Zr), nickel (Ni), and aluminum (Al) is 100 at %; in Sample 2A, the concentration of magnesium was 13.1 at % (Condition 1) and 11.9 at % (Condition 2), the concentration of fluorine was 6.9 at % (Condition 1) and 7.3 at % (Condition 2), the concentration of nickel was 1.2 at % (Condition 1) and 1.2 at % (Condition 2), the concentration of titanium was 1.5 at % (Condition 1) and 1.8 at % (Condition 2), and the concentration of aluminum was below the lower detection limit.

As shown in Table 7 and Table 8, in Sample 2A, the ratio (Mg/Co) of the number of magnesium atoms to the number of cobalt atoms was 1.06 (Condition 1) and 0.82 (Condition 2), the ratio (F/Co) of the number of fluorine atoms to the number of cobalt atoms was 0.53 (Condition 1) and 0.61 (Condition 2), the ratio (Ni/Co) of the number of nickel atoms to the number of cobalt atoms was 0.10 (Condition 1) and 0.08 (Condition 2), and the ratio (Ti/Co) of the number of titanium atoms to the number of cobalt atoms was 0.12 (Condition 1) and 0.12 (Condition 2).

### <EPMA Analysis Result>

Next, quantification of the additive elements in Sample 2A and Sample 4 was performed by EPMA. The measurement apparatus and conditions for EPAM were as follows.
Apparatus: JXA-iHP200F produced by JEOL Ltd.
Acceleration voltage: 10 kV
Beam diameter: approximately 3 μmφ

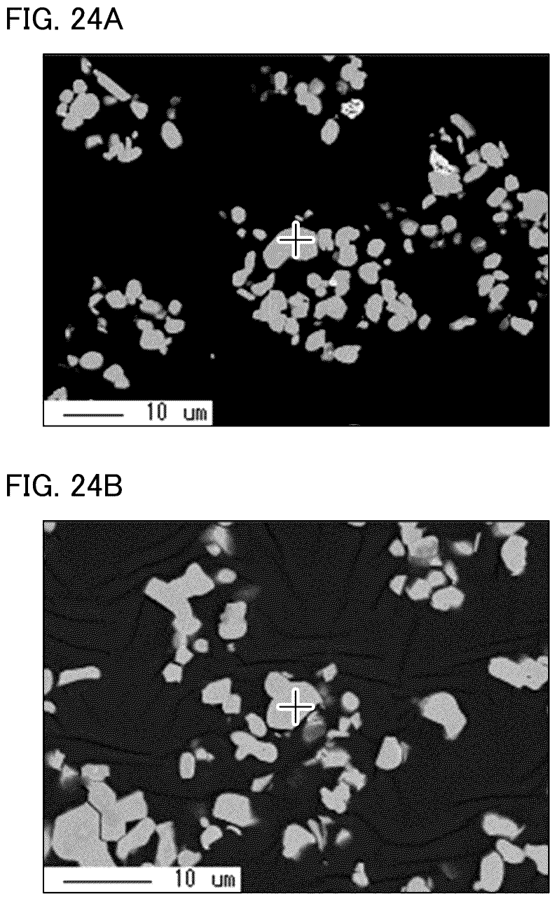

The samples were each embedded in a resin and processed by an ion polishing method to expose a cross section of the particle. FIG. 24A shows a cross-sectional SEM image of Sample 2A. In FIG. 24A, a region subjected to the EPMA analysis is indicated by a cross. Likewise, FIG. 24B shows a cross-sectional SEM image of Sample 4. In FIG. 24B, a region subjected to the EPMA analysis is indicated by a cross.

As shown in the diagrams, each of the measurement regions was the inner portion of the particle of the positive electrode active material. These cross sections were not those of thinned samples; the EPMA analysis was performed using the characteristic X-ray obtained from a region extending from the surface of the analysis sample to a depth of approximately 1 μm.

Table 9 and Table 10 show the EPMA analysis results.

TABLE 9

| | C | F | O | Mg | Al | Ti | Co | Ni |
|---|---|---|---|---|---|---|---|---|
| Sample 2A | 1.5 wt % | — | 33.5 wt % | 0.1 wt % | — | — | 60.0 wt % | 0.5 wt % |
| Sample 4 | 1.2 wt % | — | 34.7 wt % | — | — | — | 61.5 wt % | — |

| | Mg/Co | Ni/Co |
|---|---|---|
| Sample 2A | 0.0017 | 0.0083 |
| Sample 4 | — | — |

TABLE 10

| | C | F | O | Mg | Al | Ti | Co | Ni |
|---|---|---|---|---|---|---|---|---|
| Sample 2A | 3.8 at % | — | 64.5 at % | 0.2 at % | — | — | 31.3 at % | 0.2 at % |
| Sample 4 | 3.0 at % | — | 65.5 at % | — | — | — | 31.5 at % | — |

| | Mg/Co | Ni/Co |
|---|---|---|
| Sample 2A | 0.0064 | 0.0064 |
| Sample 4 | — | — |

Table 9 shows the concentrations (wt %: weight concentrations) of the elements on the assumption that the sum of the weight concentrations of carbon (C), fluorine (F), oxygen (O), magnesium (Mg), aluminum (Al), titanium (Ti), cobalt (Co), and nickel (Ni) is 100 wt %, and Table shows the concentrations (at %: atomic concentrations) of the elements on the assumption that the sum of the concentrations of carbon (C), fluorine (F), oxygen (O), magnesium (Mg), aluminum (Al), titanium (Ti), cobalt (Co), and nickel (Ni) is 100 at %. In Sample 2A, the concentration of magnesium was 0.2 at %, the concentration of nickel was 0.2 at %, and the concentrations of fluorine, titanium, and aluminum were below the lower detection limit. Note that “-” in the tables indicates that the concentration was below the lower detection limit. In Sample 4, the concentrations of magnesium, fluorine, nickel, titanium, and aluminum were below the lower detection limit.

As shown in Table 10, the ratio (Mg/Co) of the number of magnesium atoms to the number of cobalt atoms was 0.0064 and the ratio (Ni/Co) of the number of nickel atoms to the number of cobalt atoms was 0.0064.

As described above in this example, it was confirmed that in XPS analysis of the lithium cobalt oxide of one embodiment of the present invention, the ratio (Mg/Co) of the number of magnesium atoms to the number of cobalt atoms falls within the numerical range of 0.40 and 1.50, the ratio (Ti/Co) of the number of titanium atoms to the number of cobalt atoms falls within the numerical range of 0.05 to 0.20, and the ratio (Ni/Co) of the number of nickel atoms to the number of cobalt atoms falls within the numerical range of 0.05 to 0.20. It was also confirmed that in EPMA analysis, the ratio (Mg/Co) of the number of magnesium atoms to the number of cobalt atoms falls within the numerical range of 0.003 to 0.01 and the ratio (Ni/Co) of the number of nickel atoms to the number of cobalt atoms falls within the numerical range of 0.003 to 0.01. Note that although the measurement in the XPS analysis in this example was performed using the powder of the positive electrode active material, analysis of a positive electrode active material layer formed using the positive electrode active material presumably gives similar values of Mg/Co, Ti/Co, and Ni/Co.

### <STEM-EDX Analysis 1>

Sample 2A was subjected to cross-sectional STEM-EDX analysis.

As pretreatment before the analysis, Sample 2A was thinned by an FIB method (μ-sampling method).

STEM and EDX were performed with the following apparatuses under the following conditions.

### <<STEM Observation>>

Scanning transmission electron microscope: HD-2700 produced by Hitachi High-Tech Corporation
Observation condition, acceleration voltage: 200 kV
Magnification accuracy: ±3%

### <<EDX>>

Analysis method: energy dispersive X-ray spectroscopy (EDX)
Scanning transmission electron microscope: HD-2700 produced by Hitachi High-Tech Corporation
Acceleration voltage: 200 kV
Measurement mode: HR mode
Element analysis apparatus: two units of Octane T Ultra W installed
X-ray detector: Si drift detector
Energy resolution: approximately 130 eV
X-ray extraction angle: 25°
Solid angle: 2 sr
Number of capturing pixels: 512×400

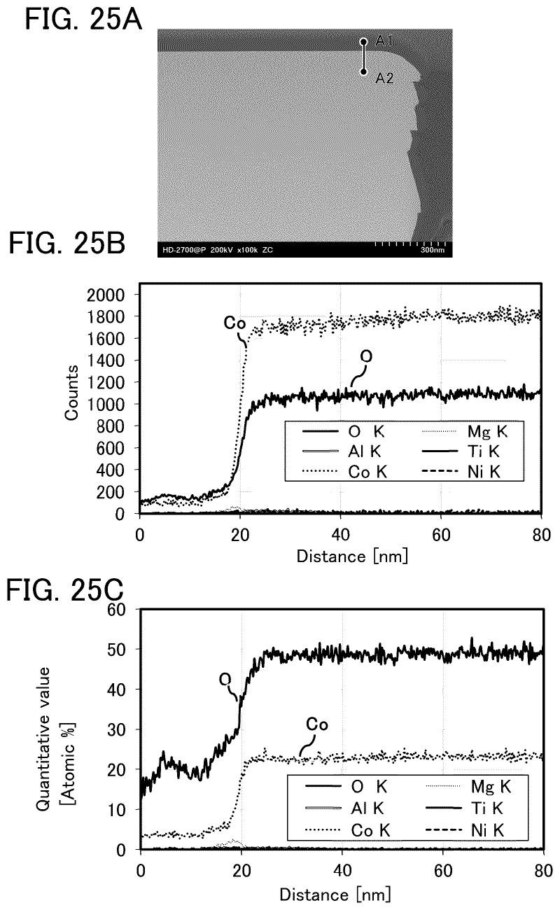

FIG. 25 to FIG. 47 show results of the cross-sectional STEM-EDX analysis performed on Sample 2A.

FIG. 25A is a cross-sectional STEM image of Sample 2A; FIG. 25B is a graph showing the results of the STEM-EDX line analysis along A1-A2 in FIG. 25A, in which the vertical axis represents the count value (Counts) of a characteristic X-ray; and FIG. 25C is a graph in which the vertical axis of the graph in FIG. 25B represents the quantitative value in Atomic % (atomic concentration). The position of the reference point of the particle surface was determined from the count value of the characteristic X-ray of cobalt (Co) by the method described in Embodiment 1, and the horizontal axes in FIG. 25B and FIG. 25C were each adjusted such that the reference point was positioned at 20 nm of the horizontal axis of the graph. The angle between a line perpendicular to the (001) plane and a line normal to the particle surface subjected to the STEM-EDX line analysis was approximately 0°.

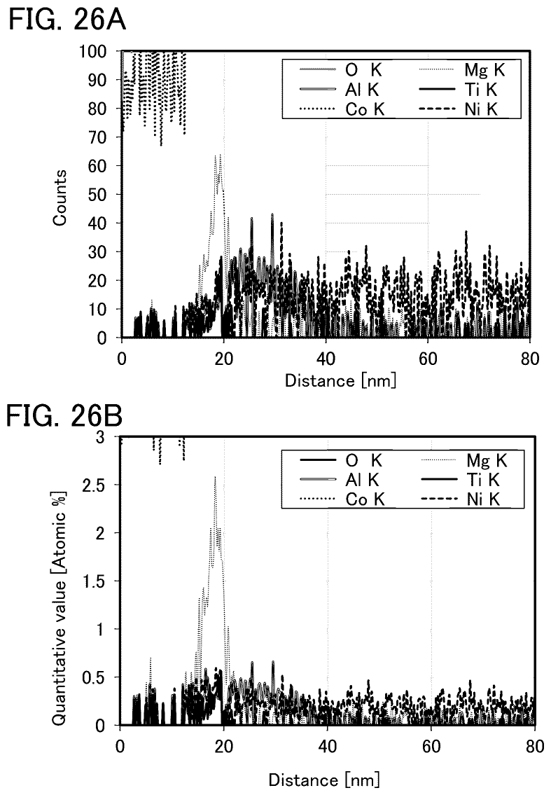

FIG. 26A is a graph obtained by enlarging the vertical axis of FIG. 25B, and FIG. 26B is a graph obtained by enlarging the vertical axis of FIG. 25C.

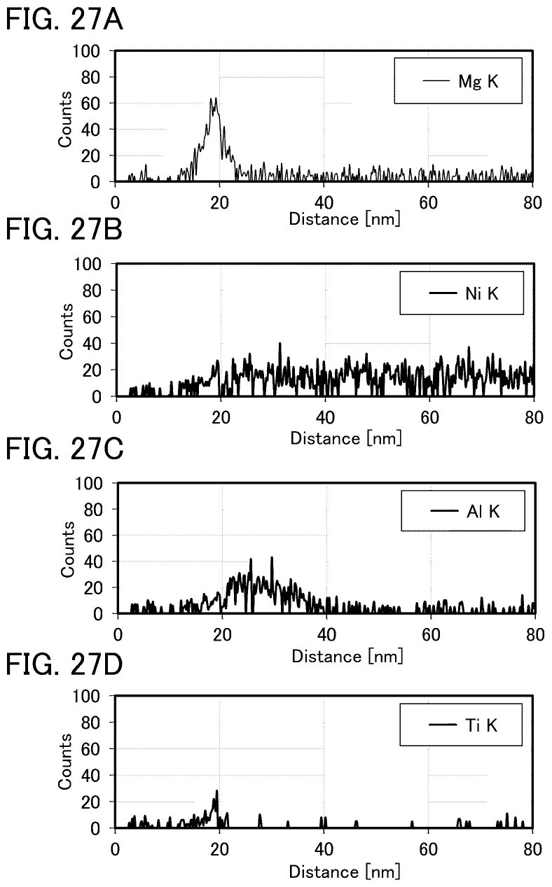

FIG. 27A shows the graph of magnesium (Mg K) extracted from FIG. 26A, FIG. 27B shows the graph of nickel (Ni K) extracted, FIG. 27C shows the graph of aluminum (Al K) extracted, and FIG. 27D shows the graph of titanium (Ti K) extracted.

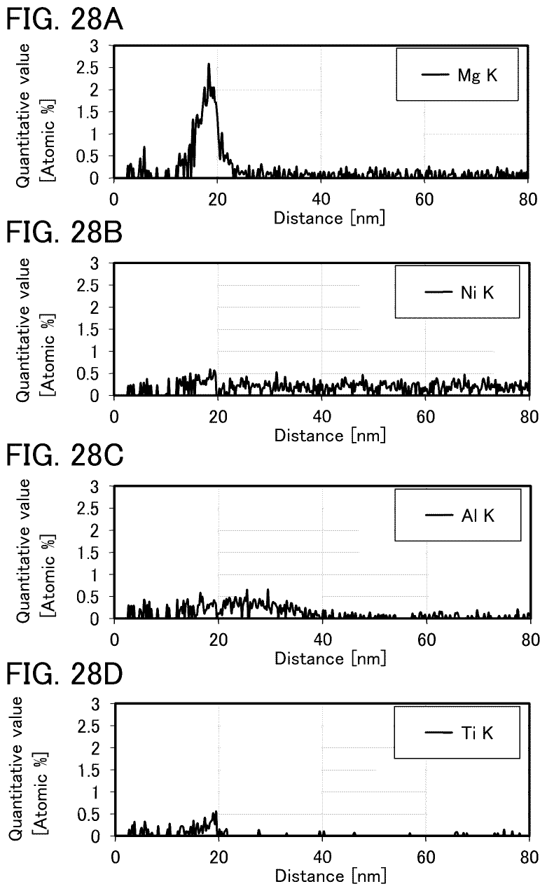

FIG. 28A shows the graph of magnesium (Mg K) extracted from FIG. 26B, FIG. 28B shows the graph of nickel (Ni K) extracted, FIG. 28C shows the graph of aluminum (Al K) extracted, and FIG. 28D shows the graph of titanium (Ti K) extracted.

The results of the STEM-EDX line analysis shown in FIG. 25B to FIG. 28D are those of the analysis of a basal region (basal region 1) of Sample 2A. A peak indicating a state where magnesium is unevenly distributed around the reference point of the surface was observed in the basal region, and the maximum value of the magnesium peak converted into a quantitative value (Atomic %) was approximately 2.5 Atomic %, exceeding 2.0 Atomic %. Furthermore, a peak indicating a state where aluminum is unevenly distributed was observed closer to the inner portion of the positive electrode active material particle than the above magnesium peak, and a state where the aluminum peak has a larger width than the above magnesium peak was observed. The maximum value of the aluminum peak converted into a quantitative value (Atomic %) was approximately 0.5 Atomic %. A peak indicating a state where titanium is unevenly distributed was observed at a position overlapping with the above magnesium, and the maximum value of the titanium peak converted into a quantitative value (Atomic %) was approximately 0.5 Atomic %. Note that the characteristic X-ray indicating the presence of nickel was not clearly observed in the basal region.

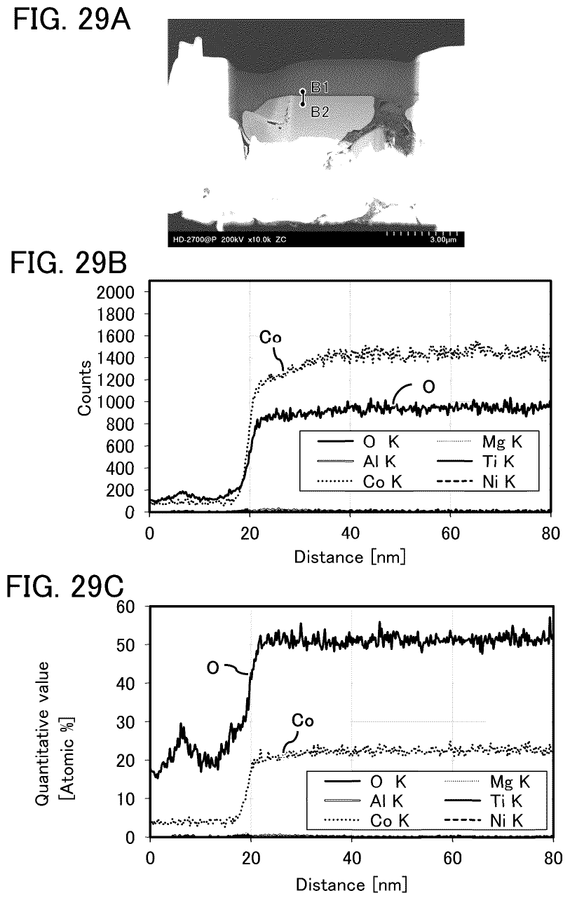

FIG. 29A is a cross-sectional STEM image of Sample 2A; FIG. 29B is a graph showing the results of the STEM-EDX line analysis along B1-B2 in FIG. 29A, in which the vertical axis represents the count value (Counts) of a characteristic X-ray; and FIG. 29C is a graph in which the vertical axis of the graph in FIG. 29B represents the quantitative value in Atomic %. The position of the reference point of the particle surface was determined from the count value of the characteristic X-ray of cobalt (Co) by the method described in Embodiment 1, and the horizontal axes in FIG. 29B and FIG. 29C were each adjusted such that the reference point was positioned at 20 nm of the horizontal axis of the graph. The angle between a line perpendicular to the (001) plane and a line normal to the particle surface subjected to the STEM-EDX line analysis was approximately 0°.

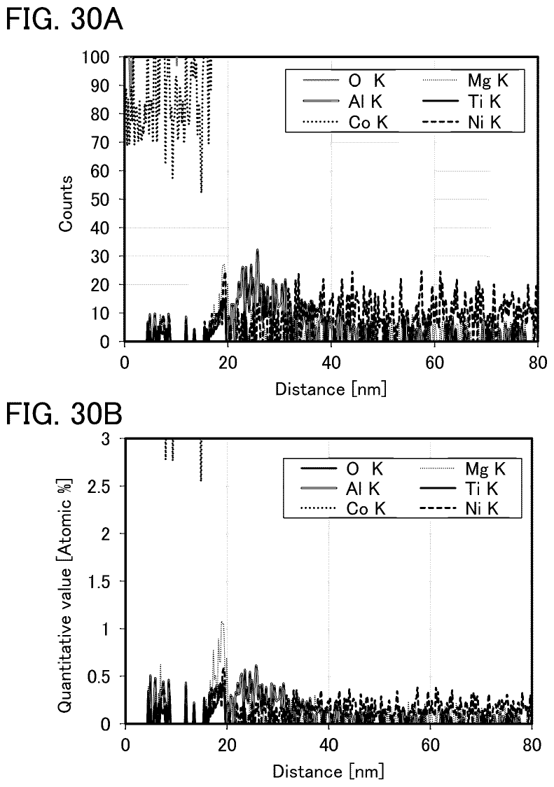

FIG. 30A is a graph obtained by enlarging the vertical axis of FIG. 29B, and FIG. 30B is a graph obtained by enlarging the vertical axis of FIG. 29C.

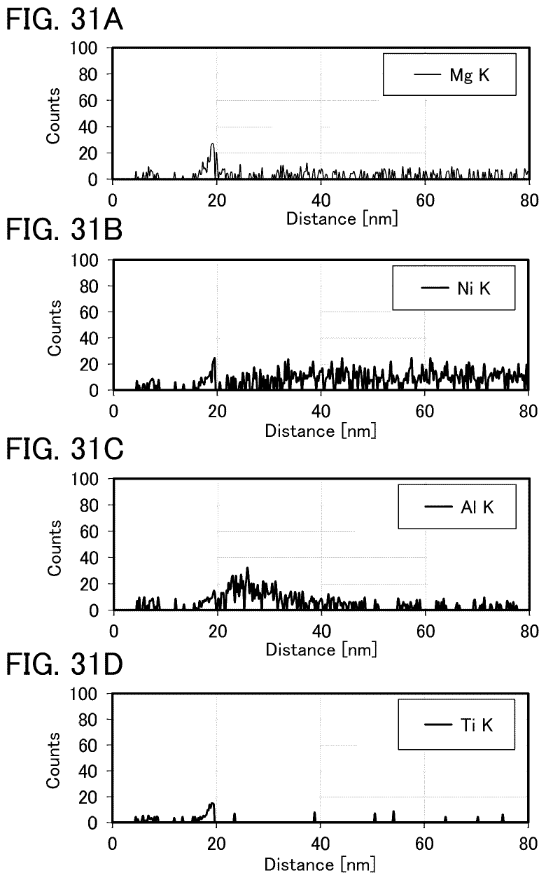

FIG. 31A shows the graph of magnesium (Mg K) extracted from FIG. 30A, FIG. 31B shows the graph of nickel (Ni K) extracted, FIG. 31C shows the graph of aluminum (Al K) extracted, and FIG. 31D shows the graph of titanium (Ti K) extracted.

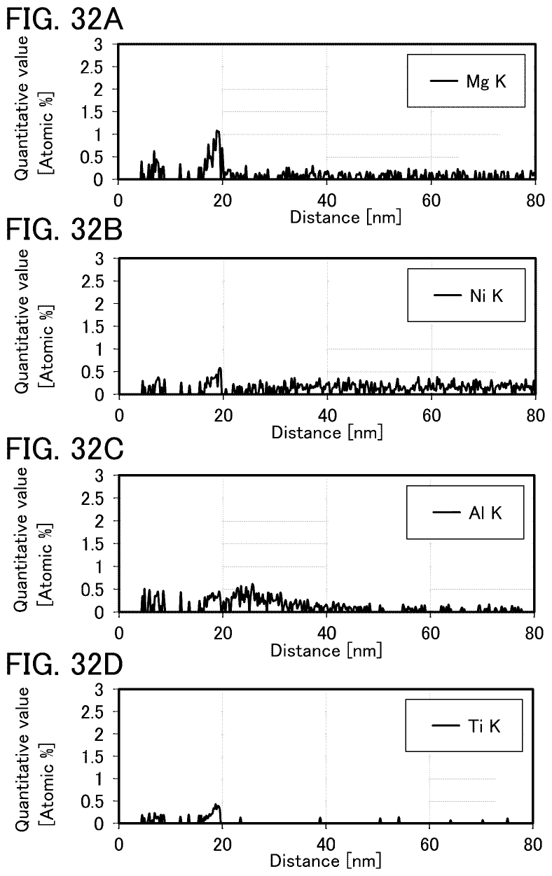

FIG. 32A shows the graph of magnesium (Mg K) extracted from FIG. 30B, FIG. 32B shows the graph of nickel (Ni K) extracted, FIG. 32C shows the graph of aluminum (Al K) extracted, and FIG. 32D shows the graph of titanium (Ti K) extracted.

The results of the STEM-EDX line analysis shown in FIG. 29B to FIG. 32D are those of the analysis of a basal region (basal region 2) of Sample 2A. Note that the analysis position shown in FIG. 29B to FIG. 32D is different from the analysis position shown in FIG. 25B to FIG. 28D. A peak indicating a state where magnesium is unevenly distributed around the reference point of the surface was observed in the basal region, and the maximum value of the magnesium peak converted into a quantitative value (Atomic %) was approximately 1.0 Atomic %, exceeding 0.5 Atomic %. Furthermore, a peak indicating a state where aluminum is unevenly distributed was observed closer to the inner portion of the positive electrode active material particle than the above magnesium peak, and a state where the aluminum peak has a larger width than the above magnesium peak was observed. The maximum value of the aluminum peak converted into a quantitative value (Atomic %) was approximately 0.5 Atomic %. A peak indicating a state where titanium is unevenly distributed was observed at a position overlapping with the above magnesium, and the maximum value of the titanium peak converted into a quantitative value (Atomic %) was approximately 0.4 Atomic %. Note that the characteristic X-ray indicating the presence of nickel was not clearly observed in the basal region.

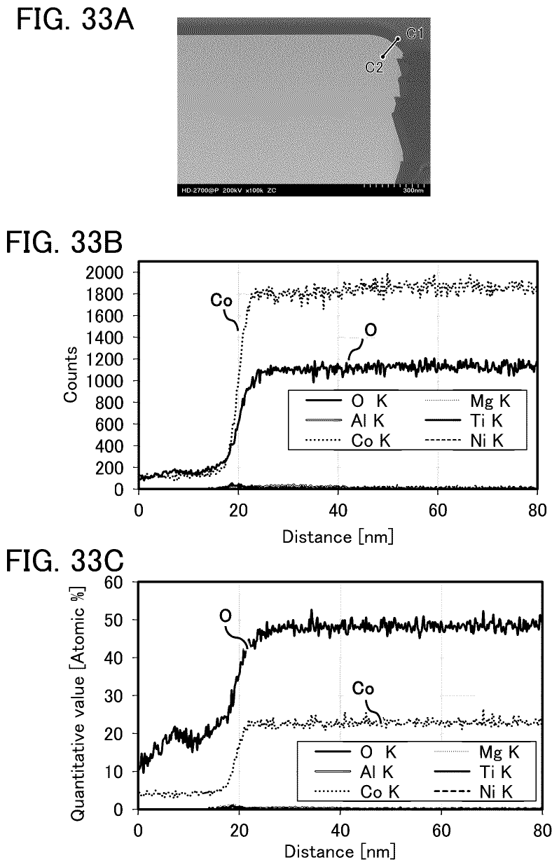

FIG. 33A is a cross-sectional STEM image of Sample 2A; FIG. 33B is a graph showing the results of the STEM-EDX line analysis along C1-C2 in FIG. 33A, in which the vertical axis represents the count value (Counts) of a characteristic X-ray; and in FIG. 33C, the position of the reference point of the particle surface was determined from the count value of the characteristic X-ray of cobalt (Co) by the method described in Embodiment 1, and the horizontal axis in the graph of FIG. 33B was adjusted such that the reference point was positioned at 20 nm of the horizontal axis of the graph. The angle between a line perpendicular to the (001) plane and a line normal to the particle surface subjected to the STEM-EDX line analysis was approximately 40°.

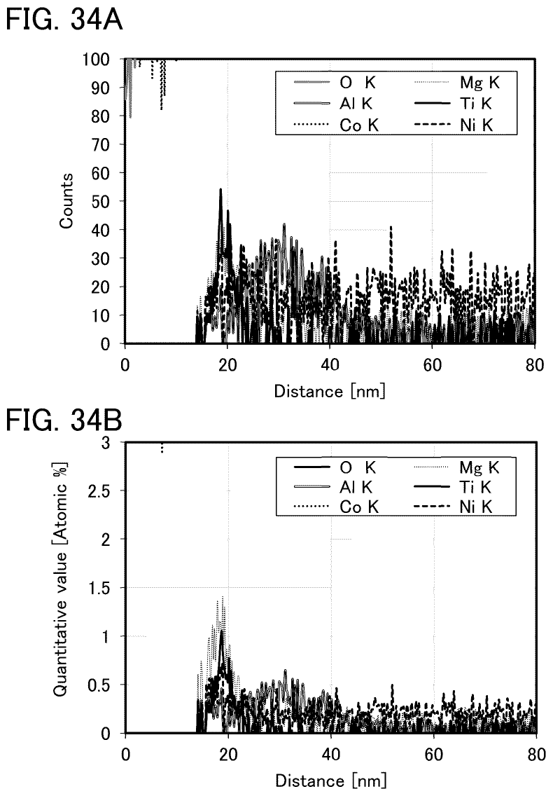

FIG. 34A is a graph obtained by enlarging the vertical axis of FIG. 33B, and FIG. 34B is a graph obtained by enlarging the vertical axis of FIG. 33C.

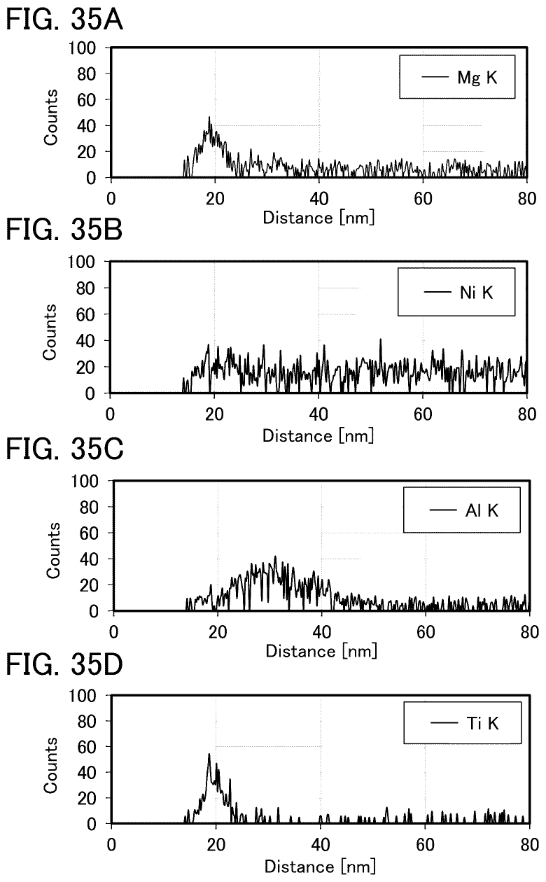

FIG. 35A shows the graph of magnesium (Mg K) extracted from FIG. 34A, FIG. 35B shows the graph of nickel (Ni K) extracted, FIG. 35C shows the graph of aluminum (Al K) extracted, and FIG. 35D shows the graph of titanium (Ti K) extracted.

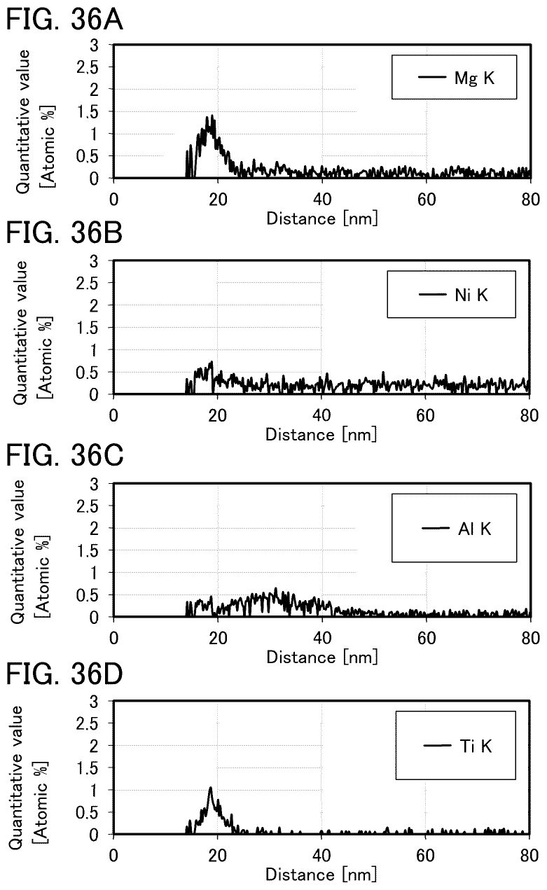

FIG. 36A shows the graph of magnesium (Mg K) extracted from FIG. 34B, FIG. 36B shows the graph of nickel (Ni K) extracted, FIG. 36C shows the graph of aluminum (Al K) extracted, and FIG. 36D shows the graph of titanium (Ti K) extracted.

The results of the STEM-EDX line analysis shown in FIG. 33B to FIG. 36D are those of the analysis of an edge region (edge region 1) of Sample 2A. A peak indicating a state where magnesium is unevenly distributed around the reference point of the surface was observed in the edge region, and the maximum value of the magnesium peak converted into a quantitative value (Atomic %) was approximately 1.4 Atomic %, exceeding 1.0 Atomic %. Furthermore, a peak indicating a state where aluminum is unevenly distributed was observed closer to the inner portion of the positive electrode active material particle than the above magnesium peak, and a state where the aluminum peak has a larger width than the above magnesium peak was observed. The maximum value of the aluminum peak converted into a quantitative value (Atomic %) was approximately 0.5 Atomic %. A peak indicating a state where titanium is unevenly distributed was observed at a position overlapping with the above magnesium, and the maximum value of the titanium peak converted into a quantitative value (Atomic %) was approximately 1.0 Atomic %, exceeding 0.5 Atomic %. Note that the characteristic X-ray indicating the presence of nickel was not clearly observed in the edge region.

Note that the difference between the depth of the peak of the detection amount of magnesium and the depth of the peak of the detection amount of titanium was 0.2 nm. Thus, the peak of the detection amount of magnesium and the peak of the detection amount of titanium in the edge region were less than or equal to 1 nm.

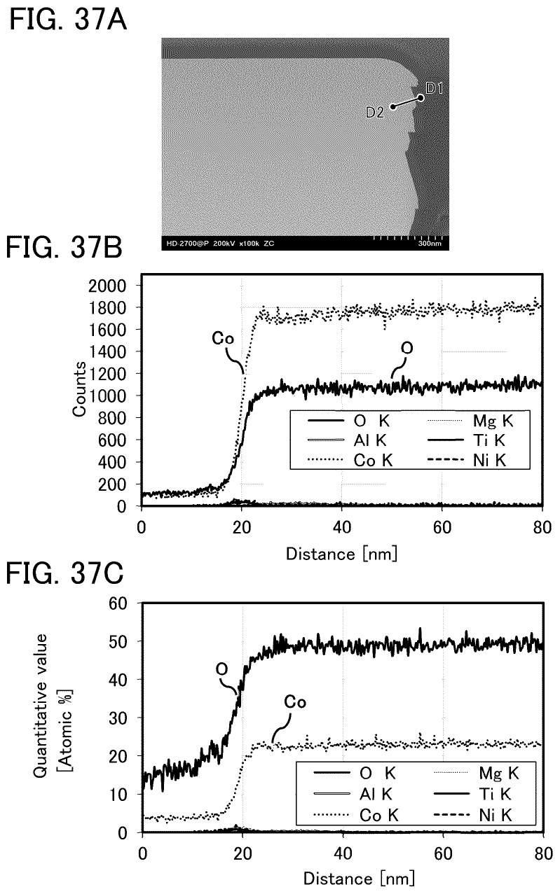

FIG. 37A is a cross-sectional STEM image of Sample 2A; FIG. 37B is a graph showing the results of the STEM-EDX line analysis along D1-D2 in FIG. 37A, in which the vertical axis represents the count value (Counts) of a characteristic X-ray; and FIG. 37C is a graph in which the vertical axis of the graph in FIG. 37B represents the quantitative value in Atomic %. The position of the reference point of the particle surface was determined from the count value of the characteristic X-ray of cobalt (Co) by the method described in Embodiment 1, and the horizontal axes in FIG. 37B and FIG. 37C were each adjusted such that the reference point was positioned at 20 nm of the horizontal axis of the graph. The angle between a line perpendicular to the (001) plane and a line normal to the particle surface subjected to the STEM-EDX line analysis was approximately 700 (72°).

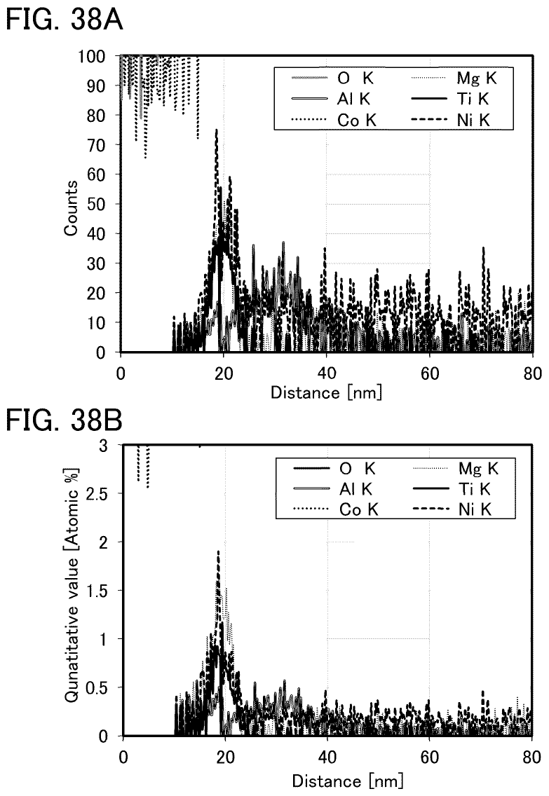

FIG. 38A is a graph obtained by enlarging the vertical axis of FIG. 37B, and FIG. 38B is a graph obtained by enlarging the vertical axis of FIG. 37C.

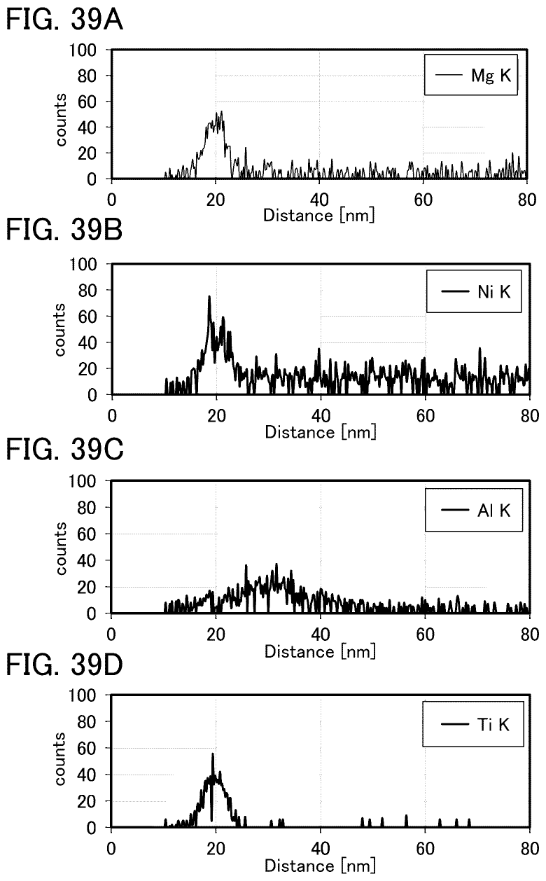

FIG. 39A shows the graph of magnesium (Mg K) extracted from FIG. 38A, FIG. 39B shows the graph of nickel (Ni K) extracted, FIG. 39C shows the graph of aluminum (Al K) extracted, and FIG. 39D shows the graph of titanium (Ti K) extracted.

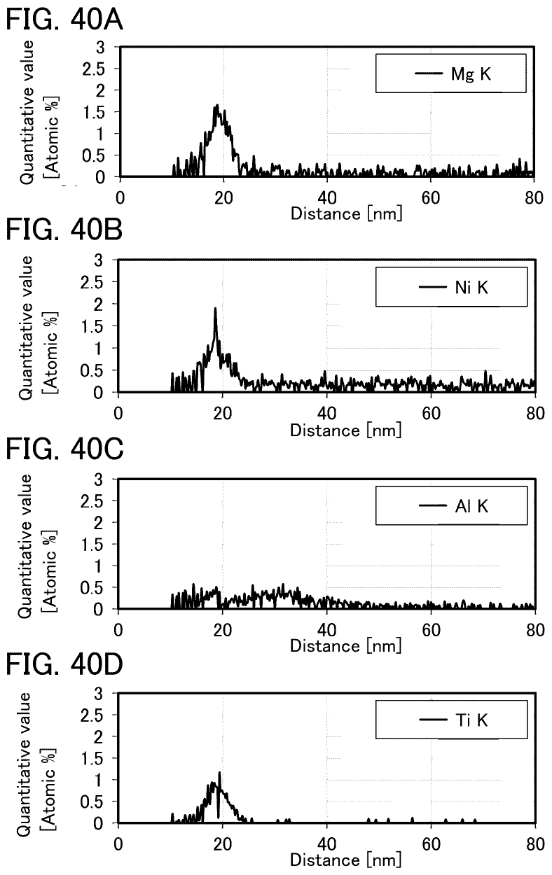

FIG. 40A shows the graph of magnesium (Mg K) extracted from FIG. 38B, FIG. 40B shows the graph of nickel (Ni K) extracted, FIG. 40C shows the graph of aluminum (Al K) extracted, and FIG. 40D shows the graph of titanium (Ti K) extracted.

The results of the STEM-EDX line analysis shown in FIG. 37B to FIG. 40D are those of the analysis of an edge region (edge region 2) of Sample 2A. Note that the analysis position shown in FIG. 37B to FIG. 40D is different from the analysis position shown in FIG. 33B to FIG. 36D. A peak indicating a state where magnesium is unevenly distributed around the reference point of the surface was observed in the edge region, and the maximum value of the magnesium peak converted into a quantitative value (Atomic %) was approximately 1.6 Atomic %, exceeding 1.0 Atomic %. Furthermore, a peak indicating a state where aluminum is unevenly distributed was observed closer to the inner portion of the positive electrode active material particle than the above magnesium peak, and a state where the aluminum peak has a larger width than the above magnesium peak was observed. The maximum value of the aluminum peak converted into a quantitative value (Atomic %) was approximately 0.5 Atomic %. A peak indicating a state where titanium is unevenly distributed was observed at a position overlapping with the above magnesium, and the maximum value of the titanium peak converted into a quantitative value (Atomic %) was approximately 1.0 Atomic %, exceeding 0.5 Atomic %. The characteristic X-ray indicating the presence of nickel was clearly observed in the edge region. A peak indicating a state where nickel is unevenly distributed was observed at a position overlapping with the above magnesium and the above titanium, and the maximum value of the nickel peak converted into a quantitative value (Atomic %) was approximately 2.0 Atomic %, exceeding 1.0 Atomic %.

Note that the difference between the depth of the peak of the detection amount of magnesium and the depth of the peak of the detection amount of titanium was 0.6 nm. The difference between the depth of the peak of the detection amount of magnesium and the depth of the peak of the detection amount of nickel was 0.2 nm. The difference between the depth of the peak of the detection amount of titanium and the depth of the peak of the detection amount of nickel was 0.6 nm. The peak of the detection amount of magnesium, the peak of the detection amount of titanium, and the peak of the detection amount of nickel were close to each other, and the difference in depth therebetween was at most less than or equal to 0.8 nm. Thus, the peak of the detection amount of magnesium, the peak of the detection amount of titanium, and the peak of the detection amount of nickel in the edge region were less than or equal to 1 nm.

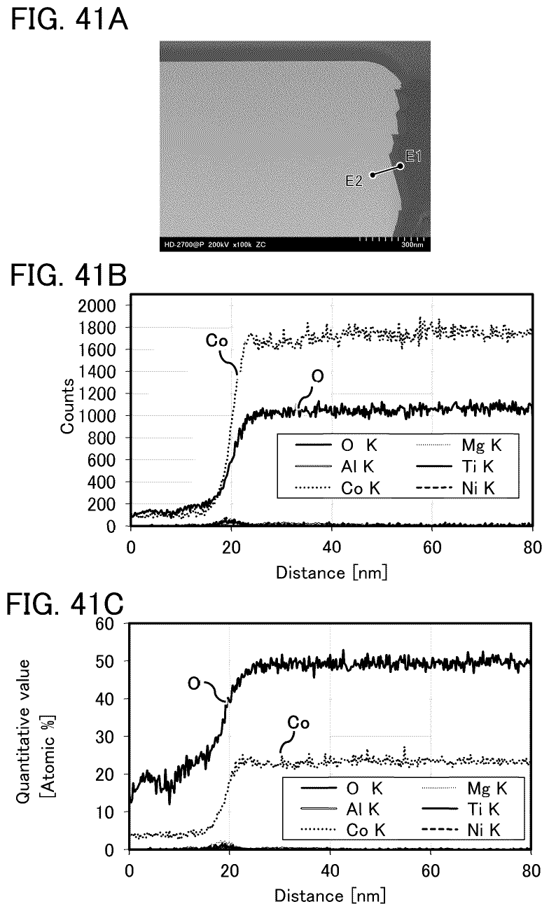

FIG. 41A is a cross-sectional STEM image of Sample 2A; FIG. 41B is a graph showing the results of the STEM-EDX line analysis along E1-E2 in FIG. 41A, in which the vertical axis represents the count value (Counts) of a characteristic X-ray; and FIG. 41C is a graph in which the vertical axis of the graph in FIG. 41B represents the quantitative value in Atomic %. The position of the reference point of the particle surface was determined from the count value of the characteristic X-ray of cobalt (Co) by the method described in Embodiment 1, and the horizontal axes in FIG. 41B and FIG. 41C were each adjusted such that the reference point was positioned at 20 nm of the horizontal axis of the graph. The angle between a line perpendicular to the (001) plane and a line normal to the particle surface subjected to the STEM-EDX line analysis was approximately 700 (73°).

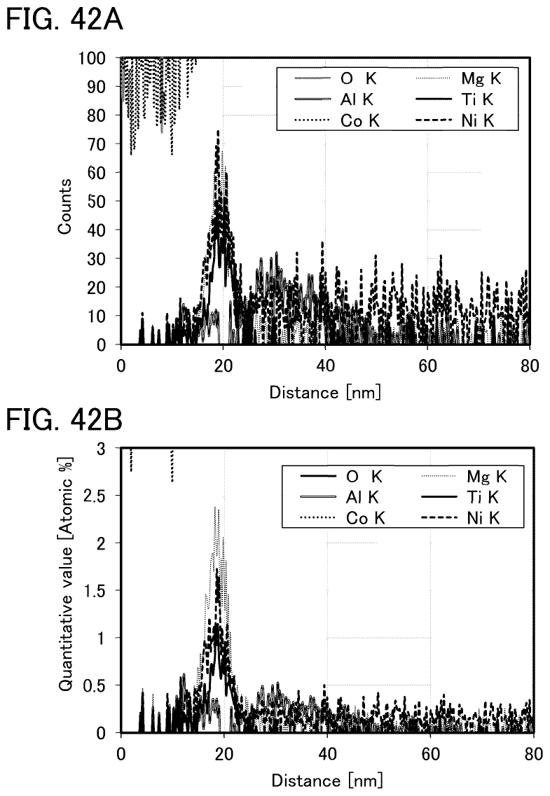

FIG. 42A is a graph obtained by enlarging the vertical axis of FIG. 41B, and FIG. 42B is a graph obtained by enlarging the vertical axis of FIG. 41C.

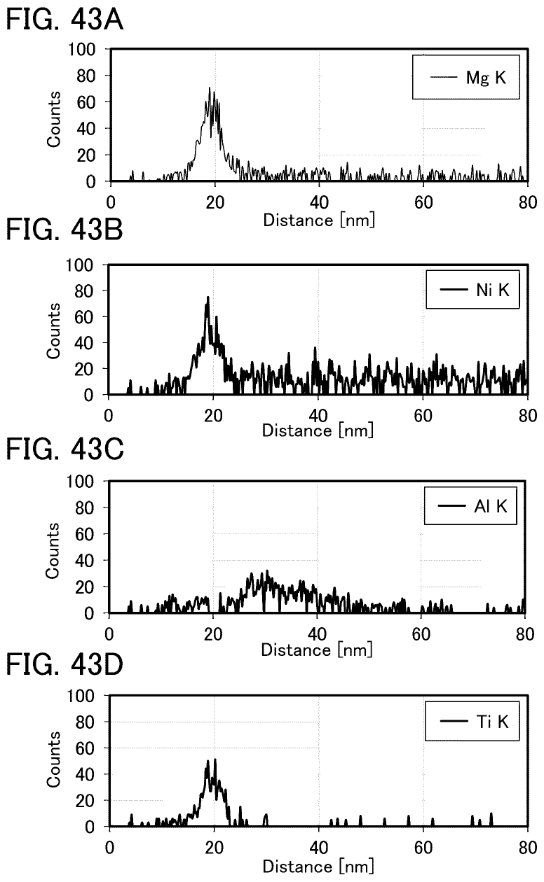

FIG. 43A shows the graph of magnesium (Mg K) extracted from FIG. 42A, FIG. 43B shows the graph of nickel (Ni K) extracted, FIG. 43C shows the graph of aluminum (Al K) extracted, and FIG. 43D shows the graph of titanium (Ti K) extracted.

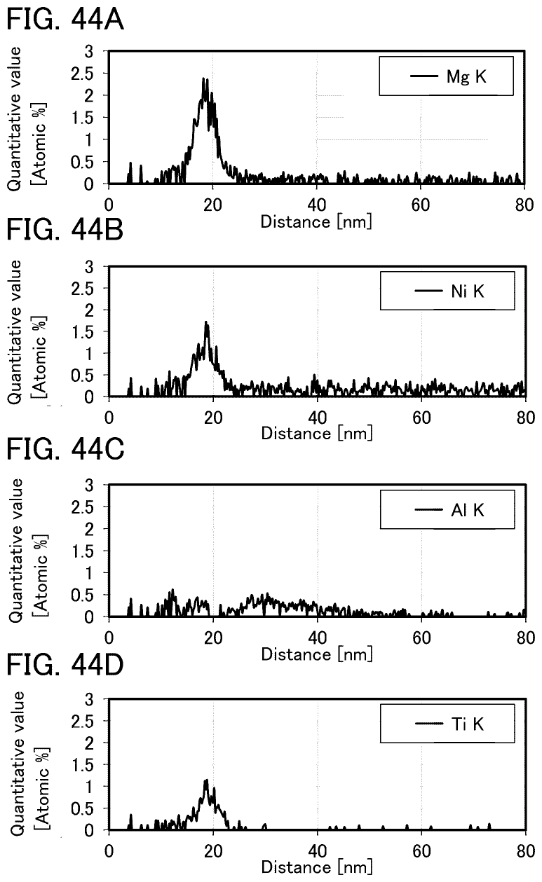

FIG. 44A shows the graph of magnesium (Mg K) extracted from FIG. 42B, FIG. 44B shows the graph of nickel (Ni K) extracted, FIG. 44C shows the graph of aluminum (Al K) extracted, and FIG. 44D shows the graph of titanium (Ti K) extracted.

The results of the STEM-EDX line analysis shown in FIG. 41B to FIG. 44D are those of the analysis of an edge region (edge region 3) of Sample 2A. Note that the analysis position shown in FIG. 41B to FIG. 44D is different from the analysis position shown in FIG. 33B to FIG. 36D and the analysis position shown in FIG. 37B to FIG. 40D. A peak indicating a state where magnesium is unevenly distributed around the reference point of the surface was observed in the edge region, and the maximum value of the magnesium peak converted into a quantitative value (Atomic %) was approximately 2.4 Atomic %, exceeding 2.0 Atomic %. Furthermore, a peak indicating a state where aluminum is unevenly distributed was observed closer to the inner portion of the positive electrode active material particle than the above magnesium peak, and a state where the aluminum peak has a larger width than the above magnesium peak was observed. The maximum value of the aluminum peak converted into a quantitative value (Atomic %) was approximately 0.5 Atomic %. A peak indicating a state where titanium is unevenly distributed was observed at a position overlapping with the above magnesium, and the maximum value of the titanium peak converted into a quantitative value (Atomic %) was approximately 1.2 Atomic %, exceeding 0.5 Atomic %. The characteristic X-ray indicating the presence of nickel was clearly observed in the edge region. A peak indicating a state where nickel is unevenly distributed was observed at a position overlapping with the above magnesium and the above titanium, and the maximum value of the nickel peak converted into a quantitative value (Atomic %) was approximately 1.7 Atomic %, exceeding 1.0 Atomic %.

Note that the difference between the depth of the peak of the detection amount of magnesium and the depth of the peak of the detection amount of titanium was 0.6 nm. The difference between the depth of the peak of the detection amount of magnesium and the depth of the peak of the detection amount of nickel was 0.4 nm. The difference between the depth of the peak of the detection amount of titanium and the depth of the peak of the detection amount of nickel was 0.2 nm. The peak of the detection amount of magnesium, the peak of the detection amount of titanium, and the peak of the detection amount of nickel were within the range of 0.6 nm. Thus, the peak of the detection amount of magnesium, the peak of the detection amount of titanium, and the peak of the detection amount of nickel in the edge region were less than or equal to 1 nm.

The quantitative values in Atomic % shown in FIG. 25C, FIG. 29C, FIG. 33C, FIG. 37C, FIG. 41C, and the like were calculated on the assumption that the sum of the detection amounts of carbon, nitrogen, oxygen, fluorine, magnesium, aluminum, silicon, calcium, titanium, manganese, cobalt, nickel, copper, gallium, and yttrium was 100% (Calculation Condition A). Table 11 shows the concentrations (Atomic %) of the elements recalculated on the assumption that the sum of the detection amounts of magnesium, oxygen, cobalt, fluorine, aluminum, titanium, and nickel was 100% (Calculation Condition B), based on the same analysis data.

TABLE 11

| | Mg | Al | Ti | Ni | Note |
|---|---|---|---|---|---|
| Basal region 1 | Approximately | Approximately | Approximately | — | Calculation |
| | 2.5 Atomic % | 0.5 Atomic % | 0.5 Atomic % | | Condition A |
| | Approximately | Approximately | Approximately | — | Calculation |
| | 4.3 Atomic % | 0.8 Atomic % | 0.8 Atomic % | | Condition B |
| Basal region 2 | Approximately | Approximately | Approximately | — | Calculation |
| | 1.0 Atomic % | 0.5 Atomic % | 0.4 Atomic % | | Condition A |
| | Approximately | Approximately | Approximately | — | Calculation |
| | 1.6 Atomic % | 0.7 Atomic % | 0.65 Atomic % | | Condition B |
| Edge region 1 | Approximately | Approximately | Approximately | — | Calculation |
| | 1.4 Atomic % | 0.5 Atomic % | 1.0 Atomic % | | Condition A |
| | Approximately | Approximately | Approximately | — | Calculation |
| | 2.1 Atomic % | 0.7 Atomic % | 1.5 Atomic % | | Condition B |
| Edge region 2 | Approximately | Approximately | Approximately | Approximately | Calculation |
| | 1.6 Atomic % | 0.5 Atomic % | 1.0 Atomic % | 2.0 Atomic % | Condition A |
| | Approximately | Approximately | Approximately | Approximately | Calculation |
| | 2.6 Atomic % | 0.7 Atomic % | 1.7 Atomic % | 3.0 Atomic % | Condition B |
| Edge region 3 | Approximately | Approximately | Approximately | Approximately | Calculation |
| | 2.4 Atomic % | 0.5 Atomic % | 1.2 Atomic % | 1.7 Atomic % | Condition A |
| | Approximately | Approximately | Approximately | Approximately | Calculation |
| | 3.6 Atomic % | 0.6 Atomic % | 1.6 Atomic % | 2.4 Atomic % | Condition B |

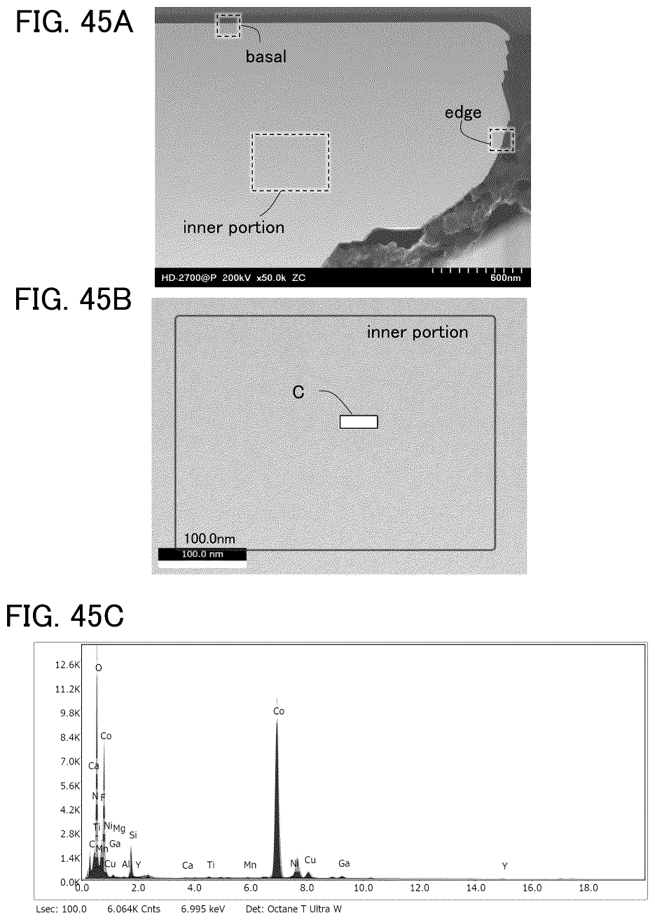

FIG. 45A is a cross-sectional STEM image of Sample 2A. Note that FIG. 45A is an enlarged cross-sectional STEM image of part of the cross-sectional STEM image shown in FIG. 29A. Each of FIG. 25A, FIG. 33A, FIG. 37A, and FIG. 41A is an enlarged cross-sectional STEM image of part of the cross-sectional STEM image shown in FIG. 29A and can also be regarded as an enlarged cross-sectional STEM image of part of the cross-sectional STEM image shown in FIG. 45A.

FIG. 45B is an enlarged cross-sectional STEM image of the dashed line rectangle portion denoted by “inner portion” in FIG. 45A, and is a cross-sectional STEM image showing the inner portion of Sample 2A. FIG. 45C shows an energy spectrum of an X-ray obtained in the solid line rectangle portion denoted by “C” in FIG. 451B; the horizontal axis represents the energy and the vertical axis represents the number of counts. The qualitative analysis performed by the software included with the STEM-EDX apparatus suggested the possibility that C, O, Mg, Al, Si, Ca, Ti, Mn, Go, Ni, Cu, Ga, and Y exist in the region. Note that Ga may have been derived from processing with an FIB apparatus.

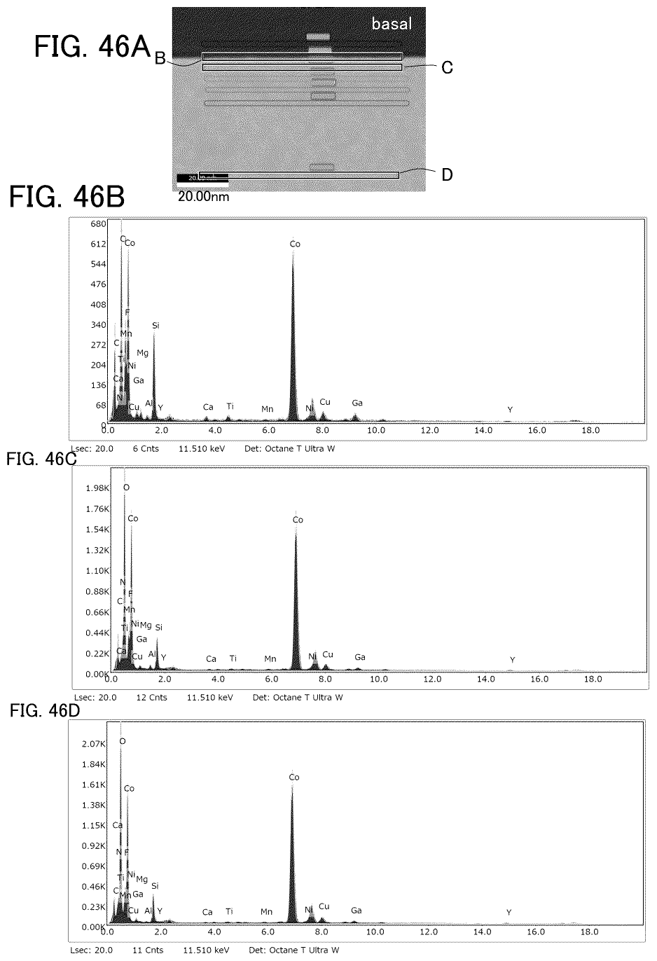

FIG. 46A is an enlarged cross-sectional STEM image of the dashed line rectangle portion denoted by “basal” in FIG. 45A, and is a cross-sectional STEM image showing a basal region of Sample 2A.

FIG. 46B shows an energy spectrum of an X-ray obtained in the solid line rectangle portion denoted by “B” in FIG. 46A (the range that is at a depth of approximately 2 nm from the surface of the surface portion and that has a width of approximately 75 nm); the horizontal axis represents the energy and the vertical axis represents the number of counts. The qualitative analysis performed by the software included with the STEM-EDX apparatus suggested the possibility that C, O, F, Mg, Al, Si, Ca, Ti, Mn, Co, Ni, Cu, Ga, and Y exist in the region. As the characteristic X-rays relating to the additive elements, the characteristic X-ray peaks derived from Mg, Al, and Ti were clearly observed in the rectangle portion. Note that Ga may have been derived from processing with an FIB apparatus.

FIG. 46C shows an energy spectrum of an X-ray obtained in the solid line rectangle portion denoted by “C” in FIG. 46A; the horizontal axis represents the energy and the vertical axis represents the number of counts. The qualitative analysis performed by the software included with the STEM-EDX apparatus suggested the possibility that C, O, Mg, Al, Si, Ca, Ti, Mn, Co, Ni, Cu, Ga, and Y exist in the region. Note that Ga may have been derived from processing with an FIB apparatus.

FIG. 46D shows an energy spectrum of an X-ray obtained in the solid line rectangle portion denoted by “D” in FIG. 46A; the horizontal axis represents the energy and the vertical axis represents the number of counts. The qualitative analysis performed by the software included with the STEM-EDX apparatus suggested the possibility that C, O, Mg, Al, Si, Ca, Ti, Mn, Co, Ni, Cu, Ga, and Y exist in the region. Note that Ga may have been derived from processing with an FIB apparatus.

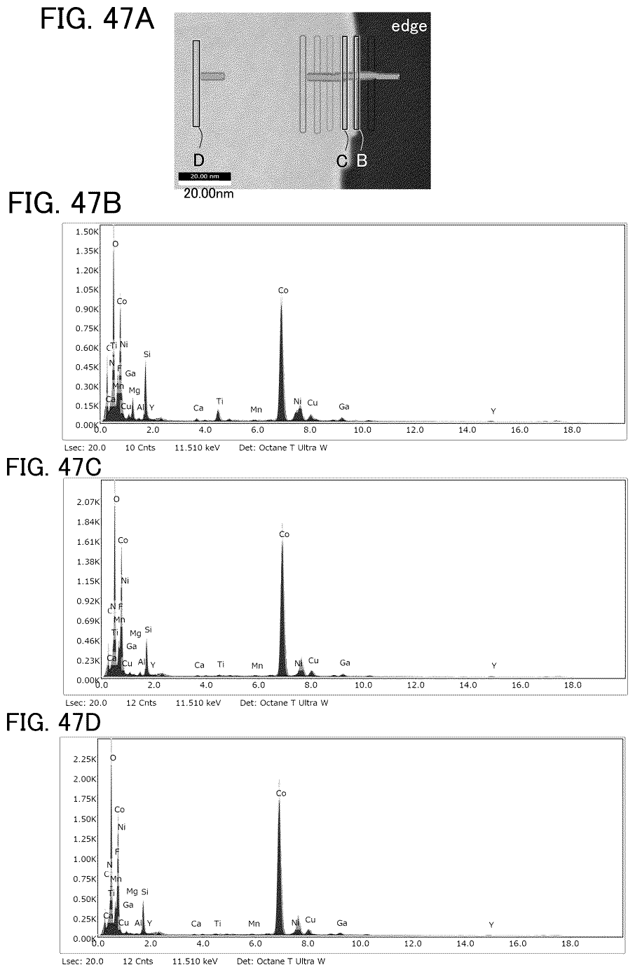

FIG. 47A is an enlarged cross-sectional STEM image of the dashed line rectangle portion denoted by “edge” in FIG. 45A, and is a cross-sectional STEM image showing an edge region of Sample 2A.

FIG. 47B shows an energy spectrum of an X-ray obtained in the solid line rectangle portion denoted by “B” in FIG. 47A (the range that is at a depth of approximately 2 nm from the surface of the surface portion and that has a width of approximately 40 nm); the horizontal axis represents the energy and the vertical axis represents the number of counts. The qualitative analysis performed by the software included with the STEM-EDX apparatus suggested the possibility that C, O, F, Mg, Al, Si, Ca, Ti, Mn, Co, Ni, Cu, Ga, and Y exist in the region. As the characteristic X-rays relating to the additive elements, the characteristic X-ray peaks derived from Mg, Al, Ni, and Ti were clearly observed in the rectangle portion. Note that Ga may have been derived from processing with an FIB apparatus.

FIG. 47C shows an energy spectrum of an X-ray obtained in the solid line rectangle portion denoted by “C” in FIG. 47A; the horizontal axis represents the energy and the vertical axis represents the number of counts. The qualitative analysis performed by the software included with the STEM-EDX apparatus suggested the possibility that C, O, Mg, Al, Si, Ca, Ti, Mn, Co, Ni, Cu, Ga, and Y exist in the region. Note that Ga may have been derived from processing with an FIB apparatus.

FIG. 47D shows an energy spectrum of an X-ray obtained in the solid line rectangle portion denoted by “D” in FIG. 47A; the horizontal axis represents the energy and the vertical axis represents the number of counts. The qualitative analysis performed by the software included with the STEM-EDX apparatus suggested the possibility that C, O, Mg, Al, Si, Ca, Ti, Mn, Co, Ni, Cu, Ga, and Y exist in the region. Note that Ga may have been derived from processing with an FIB apparatus.

### <STEM-EDX Analysis 2>

Sample 2A was subjected to cross-sectional STEM-EDX analysis using a STEM apparatus and an EDX apparatus different from those described above.

As pretreatment before the analysis, Sample 2A was thinned by an FIB method (g-sampling method).

STEM and EDX were performed with the following apparatuses under the following conditions.

### <<STEM Observation>>

Scanning transmission electron microscope: JEM-ARM200F NEOARM produced by JEOL Ltd.
Observation condition, acceleration voltage: 200 kV
Magnification accuracy: ±10%

### <<Edx>>

Analysis method: energy dispersive X-ray spectroscopy (EDX)
Scanning transmission electron microscope: JEM-ARM200F NEOARM produced by JEOL Ltd.
Acceleration voltage: 200 kV
Measurement mode: STEM mode
Element analysis apparatus: JED-2300T
X-ray detector: Si drift detector
Energy resolution: approximately 140 eV
X-ray extraction angle: approximately 30.5°
Solid angle: 2.2 sr
Number of capturing pixels: 256×256

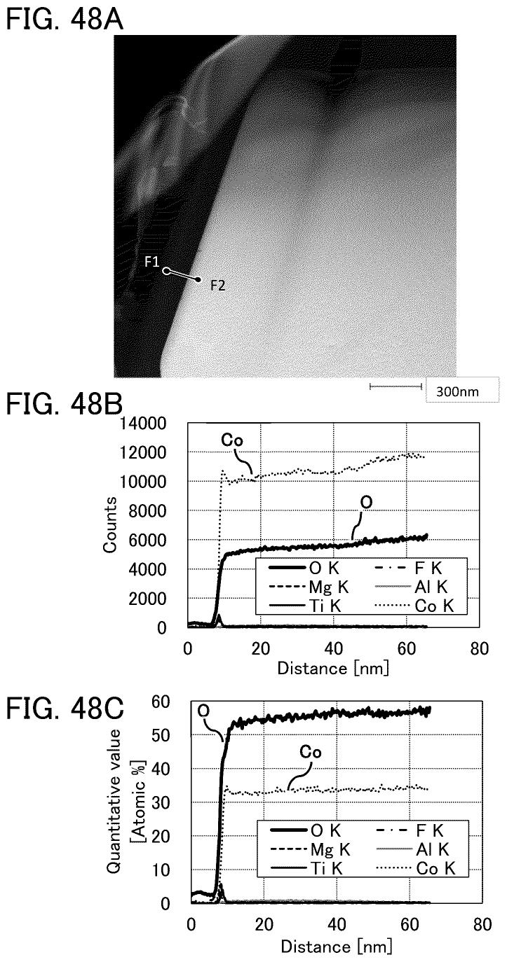

FIG. 48 to FIG. 51 show results of the cross-sectional STEM-EDX analysis performed on Sample 2A.

FIG. 48A is a cross-sectional STEM image of Sample 2A; FIG. 48B is a graph showing the results of the STEM-EDX line analysis along F1-F2 in FIG. 48A, in which the vertical axis represents the count value (Counts) of a characteristic X-ray; and FIG. 48C is a graph in which the vertical axis of the graph in FIG. 48B represents the quantitative value in Atomic %. On each of the horizontal axes in FIG. 48B and FIG. 48C, the reference point of the particle surface is assumed to be positioned at 8.7 nm. Note that the position of the reference point was determined from the count value of the characteristic X-ray of cobalt (Co) by the method described in Embodiment 1. The angle between a line perpendicular to the (001) plane and a line normal to the particle surface subjected to the STEM-EDX line analysis was approximately 70° (71°).

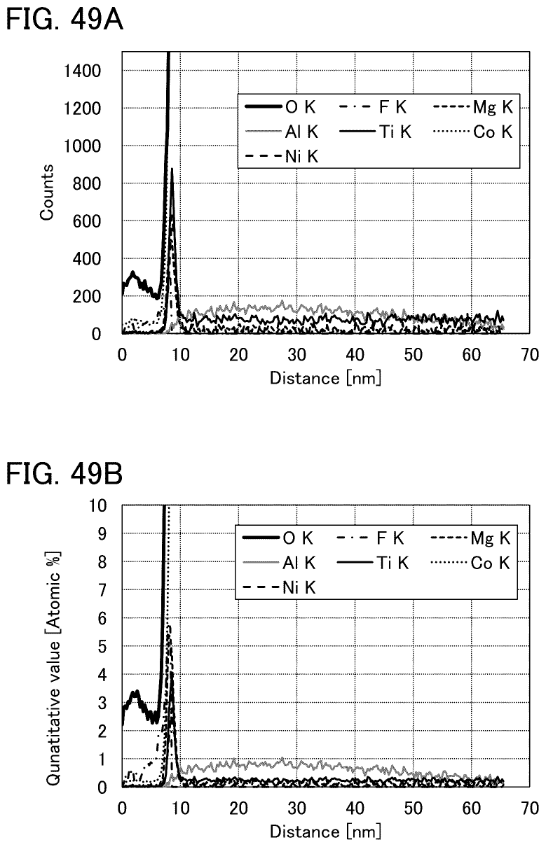

FIG. 49A is a graph obtained by enlarging the vertical axis of FIG. 48B, and FIG. 49B is a graph obtained by enlarging the vertical axis of FIG. 48C.

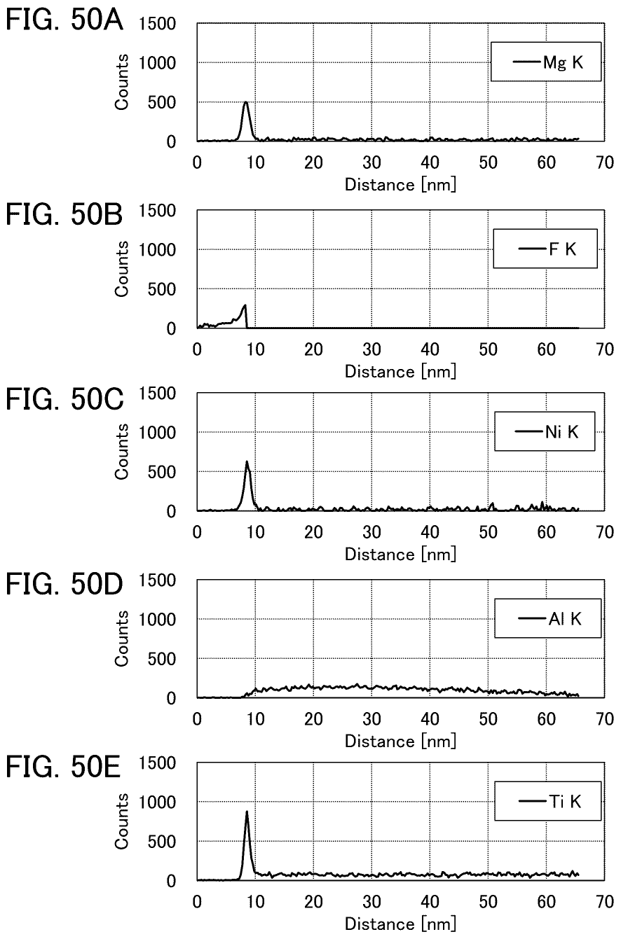

FIG. 50A shows the graph of magnesium (Mg K) extracted from FIG. 49A, FIG. 50B shows the graph of fluorine (F K) extracted, FIG. 50C shows the graph of nickel (Ni K) extracted, FIG. 50D shows the graph of aluminum (Al K) extracted, and FIG. 50E shows the graph of titanium (Ti K) extracted.

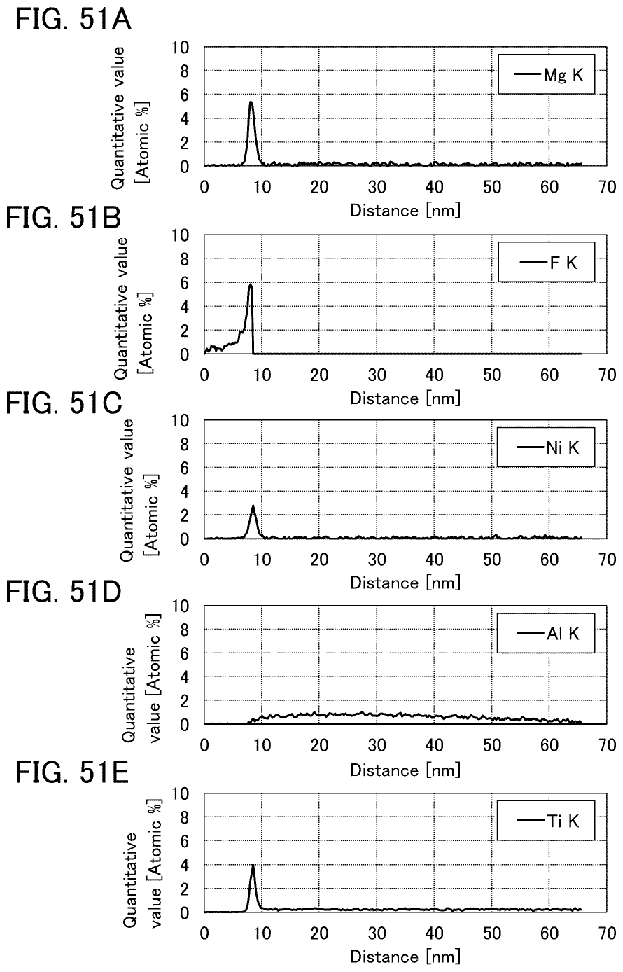

FIG. 51A shows the graph of magnesium (Mg K) extracted from FIG. 49B, FIG. 51B shows the graph of fluorine (F K) extracted, FIG. 51C shows the graph of nickel (Ni K) extracted, FIG. 51D shows the graph of aluminum (Al K) extracted, and FIG. 51E shows the graph of titanium (Ti K) extracted.

The results of the STEM-EDX line analysis shown in FIG. 48B to FIG. 51E are those of the analysis of an edge region (edge region 4) of Sample 2A. Note that the analysis sample shown in FIG. 48A to FIG. 51E is different from the analysis sample shown in FIG. 25B to FIG. 47D.

A peak indicating a state where magnesium is unevenly distributed around the reference point of the surface was observed in the edge region, and the maximum value of the magnesium peak converted into a quantitative value (Atomic %) was approximately 5.4 Atomic %, exceeding 2.0 Atomic %. Furthermore, a peak indicating a state where aluminum is unevenly distributed was observed closer to the inner portion of the positive electrode active material particle than the above magnesium peak, and a state where the aluminum peak has a larger width than the above magnesium peak was observed. The maximum value of the aluminum peak converted into a quantitative value (Atomic %) was approximately 1.0 Atomic %. A peak indicating a state where titanium is unevenly distributed was observed at a position overlapping with the above magnesium, and the maximum value of the titanium peak converted into a quantitative value (Atomic %) was approximately 4.0 Atomic %, exceeding 0.5 Atomic %. The characteristic X-ray indicating the presence of nickel was clearly observed in the edge region. A peak indicating a state where nickel is unevenly distributed was observed at a position overlapping with the above magnesium and the above titanium, and the maximum value of the nickel peak converted into a quantitative value (Atomic %) was approximately 2.8 Atomic %, exceeding 1.0 Atomic %. A peak indicating a state where fluorine is unevenly distributed was observed at a position overlapping with the above magnesium, and the maximum value of the fluorine peak converted into a quantitative value (Atomic %) was approximately 5.8 Atomic %, exceeding 0.5 Atomic %.

The difference between the depth of the peak of the detection amount of magnesium and the depth of the peak of the detection amount of titanium was 0.6 nm. The difference between the depth of the peak of the detection amount of magnesium and the depth of the peak of the detection amount of nickel was 0.6 nm. The difference between the depth of the peak of the detection amount of titanium and the depth of the peak of the detection amount of nickel was 0.0 nm. The peak of the detection amount of magnesium, the peak of the detection amount of titanium, and the peak of the detection amount of nickel were within the range of 0.6 nm.

The quantitative values in Atomic % shown in FIG. 48C and the like were calculated on the assumption that the sum of the detection amounts of carbon, oxygen, fluorine, magnesium, aluminum, silicon, phosphorus, sulfur, calcium, titanium, iron, cobalt, nickel, and gallium was 100% (Calculation Condition A). Table 12 shows the concentrations (Atomic %) of the elements recalculated on the assumption that the sum of the detection amounts of magnesium, oxygen, cobalt, fluorine, aluminum, titanium, and nickel was 100% (Calculation Condition B), based on the same analysis data.

TABLE 12

| | Mg | Al | Ti | Ni | Note |
|---|---|---|---|---|---|
| Edge region 4 | Approximately | Approximately | Approximately | Approximately | Calculation |
| | 5.4 Atomic % | 1.0 Atomic % | 4.0 Atomic % | 2.8 Atomic % | Condition A |
| | Approximately | Approximately | Approximately | Approximately | Calculation |
| | 6.1 Atomic % | 1.2 Atomic % | 5.3 Atomic % | 3.7 Atomic % | Condition B |

### <Laser Diffraction Particle Size Distribution Measurement>

The particle size distributions of Sample 1A to Sample 7 were measured with a laser diffraction particle size analyzer. As the results of measuring the particle size distributions, Table 13 shows D10, D50, and D90 of the samples.

TABLE 13

| | D10 | D50 | D90 |
|---|---|---|---|
| Sample 1A | 5.10 μm | 10.70 μm | 18.09 μm |
| Sample 1B | 5.39 μm | 11.11 μm | 18.39 μm |
| Sample 1C | 4.76 μm | 10.09 μm | 18.19 μm |
| Sample 2A | 6.33 μm | 12.40 μm | 20.35 μm |
| Sample 3 | 5.66 μm | 8.87 μm | 13.69 μm |
| Sample 4 | 2.76 μm | 7.03 μm | 15.34 μm |
| Sample 5A | 7.91 μm | 13.45 μm | 21.00 μm |
| Sample 6 | 7.78 μm | 14.37 μm | 24.20 μm |
| Sample 7 | 6.00 μm | 12.50 μm | 22.79 μm |

There is a difference between the particle size distribution values shown in Table 13 and the particle diameters observed in the SEM images of FIG. 22A and the like. This is probably because the particle size distribution measurement performs calculation including the size of a secondary particle in which a plurality of primary particles aggregate.

<Particle Size Distribution Analysis from Cross-Sectional SEM Image of Electrode>

As described above, the results of the laser diffraction particle size distribution measurement, in which not only the size of the primary particle but also the size of the secondary particle are measured, sometimes show a size different from the particle diameter observed in the SEM image of the particle. Moreover, the process of forming a positive electrode by application of the positive electrode active material includes steps that potentially change the particle diameter of the primary particle of the positive electrode active material, such as a kneading step and a pressing step. Thus, in this example, to calculate the particle size distribution of the positive electrode active material from a cross-sectional SEM image of the positive electrode, particle size distribution analysis using the cross-sectional SEM image of the positive electrode was performed by the method described in Embodiment 1.

### <Positive Electrode Formation 1>

Sample 2A described above, acetylene black (AB), and poly(vinylidene fluoride) (PVDF) were prepared as a positive electrode active material, a conductive material, and a binding agent, respectively. The PVDF prepared was one dissolved in N-methyl-2-pyrrolidone (NMP) with the weight ratio of PVDF to NMP being 5%. Then, slurry was formed by mixing the positive electrode active material, AB, and PVDF at the positive electrode active material:AB:PVDF=95:3:2 (weight ratio), and the slurry was applied on an aluminum positive electrode current collector. As a solvent of the slurry, NMP was used. After the application of the slurry on the positive electrode current collector, the solvent was volatilized.

After that, pressing treatment was performed with a roller press machine to increase the density of the positive electrode active material layer over the positive electrode current collector. As a pressing treatment condition, a linear pressure was 210 kN/m. Note that the temperature of each of an upper roll and a lower roll of the roller press machine was 120 °C.

Through the above steps, the positive electrode was obtained. The loading level of the positive electrode active material per area of the positive electrode was approximately 20.0 mg/cm². By such a formation method, the positive electrode including Sample 2A was formed. In a similar manner, a positive electrode including Sample 6 was formed.

### <Cross-Sectional SEM Observation>

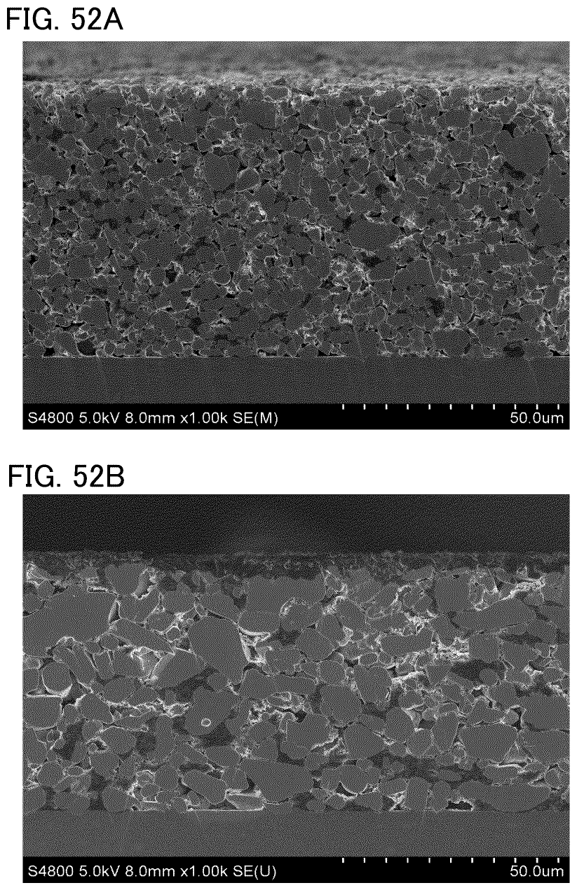

A cross section of the positive electrode formed in the above manner was exposed by ion milling processing, and cross-sectional SEM observation was performed. The SEM observation was performed with an S-4800 Scanning electron microscope manufactured by Hitachi High-Technologies Corporation. FIG. 52A shows a cross-sectional SEM image of the positive electrode including Sample 2A, and FIG. 52B shows a cross-sectional SEM image of the positive electrode including Sample 6.

### <Image Analysis>

Next, an analysis region is cut out from the obtained cross-sectional SEM image. For example, the region of the SEM image in FIG. 52A is cut out. In this example, a range of greater than or equal to 50 μm x greater than or equal to 100 μm was cut out as a range having a sufficient area for the image analysis; however, the range is not limited thereto. A smaller area or a larger area may be cut out depending on factors such as the size of the positive electrode active material.

Note that a function of image processing software may be used to cut out the cross-sectional SEM image. For example, ImageJ may be used as the image processing software and the image may be cut out by the crop function of Image J.

Next, a first image cut out by the image processing software was binarized and subjected to particle analysis.

ImageJ can be used as the image processing software, for example. The binarization processing is described below. The first image represented by a 256-level grayscale was used as a frequency graph excluding black (a value of 0) and white (a value of 255), and as the half width at half maximum (HWHM) of the maximum peak, HWHM on the low-level side (HWHM_L) and HWHM on the high-level side (HWHM_H) were obtained. Next, the minimum value a of a range on the low-level side having a width that is twice HWHM_L and the maximum value b of a range on the high-level side having a width that is twice HWHM_H were determined from the value at the peak top (maximum frequency) of the maximum peak.

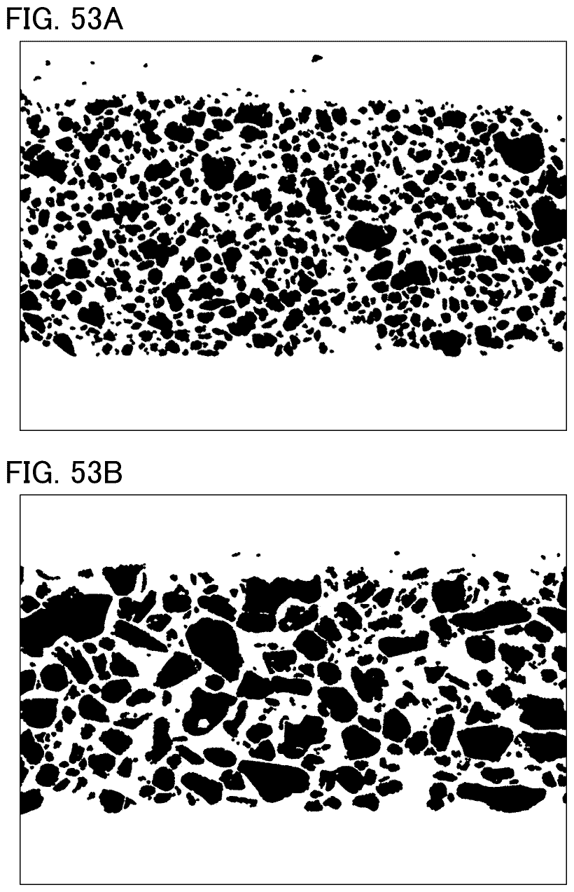

Next, binarization processing was performed such that the range of values less than a was white, the range of values from a to b, inclusive, was black, and the range of values greater than b was white. Specifically, the binarization as Threshold (a, b) was performed with Threshold function of ImageJ. After that, random bright spots that were probably attributed to the conductive material were removed under the conditions of Gray Morphology (radius=3, operator=open, type=circle) and Gray Morphology (radius=1, operator=close, type=circle), so that a second image was obtained. FIG. 53A shows the second image obtained by processing the image in FIG. 52A, and FIG. 53B shows the second image obtained by processing the image in FIG. 52B.

Next, particles with a particle size (projected area) greater than or equal to 0.5 μm² and less than or equal to 700 μm² were detected using the second image by the Analyze Particles function of ImageJ, whereby the area S of each particle was obtained. Next, the diameter r of each particle was calculated on the basis of the area S of each particle (Formula 1 in Embodiment 1).

In this manner, the particle size distributions were calculated from the cross-sectional SEM images in FIG. 53A and FIG. 53B. Table 14 shows D10, D50, and D90 of the calculated particle size distributions. Table 15 shows the results of analyzing particle size distributions from a plurality of cross-sectional SEM images in a similar manner, including the cross-sectional SEM images in FIG. 53A and FIG. 53B, and calculating the average value, the standard deviation, the maximum value in the range of 2a, and the minimum value in the range of 2a. Performing the above analysis is referred to as performing particle size distribution analysis using a cross-sectional SEM image of a positive electrode.

TABLE 14

| | D10 | D50 | D90 |
|---|---|---|---|
| Sample 2A | 0.95 μm | 2.04 μm | 4.80 μm |
| Sample 6 | 0.97 μm | 2.86 μm | 8.01 μm |

TABLE 15

| | | D10 | D50 | D90 |
|---|---|---|---|---|
| Sample 2A | Average value | 0.97 μm | 2.12 μm | 4.94 μm |
| | Standard | 0.03 μm | 0.07 μm | 0.28 μm |
| | deviation | | | |
| | 20 (maximum | 1.03 μm | 2.26 μm | 5.51 μm |
| | value) | | | |
| | 20 (minimum | 0.92 μm | 1.98 μm | 4.37 μm |
| | value) | | | |
| Sample 6 | Average value | 1.00 μm | 2.89 μm | 8.13 μm |
| | Standard | 0.05 μm | 0.24 μm | 0.56 μm |
| | deviation | | | |
| | 20 (maximum | 1.11 μm | 3.38 μm | 9.26 μm |
| | value) | | | |
| | 20 (minimum | 0.90 μm | 2.40 μm | 7.01 μm |
| | value) | | | |

As shown in Table 15, the particle size distribution of Sample 2A was calculated from the cross-sectional SEM images of the electrode to be as follows: D10 was greater than or equal to 0.92 μm and less than or equal to 1.03 μm, D50 was greater than or equal to 1.98 μm and less than or equal to 2.26 μm, and D90 was greater than or equal to 4.37 μm and less than or equal to 5.51 μm.

The particle size distribution of Sample 6 was calculated from the cross-sectional SEM images of the electrode to be as follows: D10 was greater than or equal to 0.90 μm and less than or equal to 1.11 μm, D50 was greater than or equal to 2.40 μm and less than or equal to 3.38 μm, and D90 was greater than or equal to 7.01 μm and less than or equal to 9.26 μm.

### Example 3

In this example, positive electrodes including Sample 1A, Sample 1B, Sample 1C, Sample 2A, Sample 3, Sample 4, Sample 5A, Sample 6, and Sample 7 formed in Example 2 were formed. Coin-type half cells were fabricated using the formed positive electrodes, and were subjected to discharge rate tests and charge/discharge cycling tests.

### <Positive Electrode Formation 2>

The positive electrodes including Sample 1A, Sample 1B, Sample 1C, Sample 2A, Sample 3, Sample 4, Sample 5A, Sample 6, and Sample 7 were formed by the same method as the positive electrodes formed in Example 2 (see Positive electrode formation 1) except that the loading level of the positive electrode active material was approximately 7.0 mg/cm².

By such a formation method, the positive electrode including Sample 1A, the positive electrode including Sample 1B, the positive electrode including Sample 1C, the positive electrode including Sample 2A, the positive electrode including Sample 3, the positive electrode including Sample 4, the positive electrode including Sample 5A, the positive electrode including Sample 6, and the positive electrode including Sample 7 were formed.

### <Fabrication of Half Cell>

Coin-type half cells each including any of the above positive electrodes, a lithium metal foil, a separator, an electrolyte, a coin cell positive electrode can, and a coin cell negative electrode can were fabricated.

As the electrolyte, an organic electrolyte solution (Electrolyte Solution A) obtained by dissolving lithium hexafluorophosphate (LiPF₆) at 1 mol/L in a mixed organic solvent containing EC (ethylene carbonate), EMC (ethyl methyl carbonate), and DMC (dimethyl carbonate) at EC:EMC:DMC=30:35:35 (volume ratio) was used.

As the separator, a porous polypropylene film was used.

### <Low-Temperature Charge/Discharge Test>

Charge/discharge performance of the half cells fabricated using Sample 1A to Sample 7 as described above was evaluated with the ambient temperature at the time of discharging changed.

CC-CV charging (charge current: 20 mA/g, upper limit voltage (also referred to as charge voltage): 4.30 V or 4.60 V, termination current: 2 mA/g) and CV discharging (discharge current: 20 mA/g, termination voltage: 2.50 V) were performed. The ambient temperature for the charging and discharging was as follows: the ambient temperature was 25 °C while the discharging was performed three times; then, the ambient temperature was changed to 0 °C, 25 °C, −20 °C, 25 °C, and −40 °C in this order, and the charging and discharging were performed once at each temperature. Note that the upper limit voltage of the charging was 4.30 V for Sample 4 and Sample 7, and 4.60 V for Sample 1A, Sample 1B, Sample 1C, Sample 2A, Sample 3, Sample 5A, and Sample 6. The upper limit voltage of the charging for Sample 4 and Sample 7 was set to 4.30 V because the charge/discharge capacity significantly degrades at 4.60 V to adversely affect the evaluation of the low-temperature characteristics.

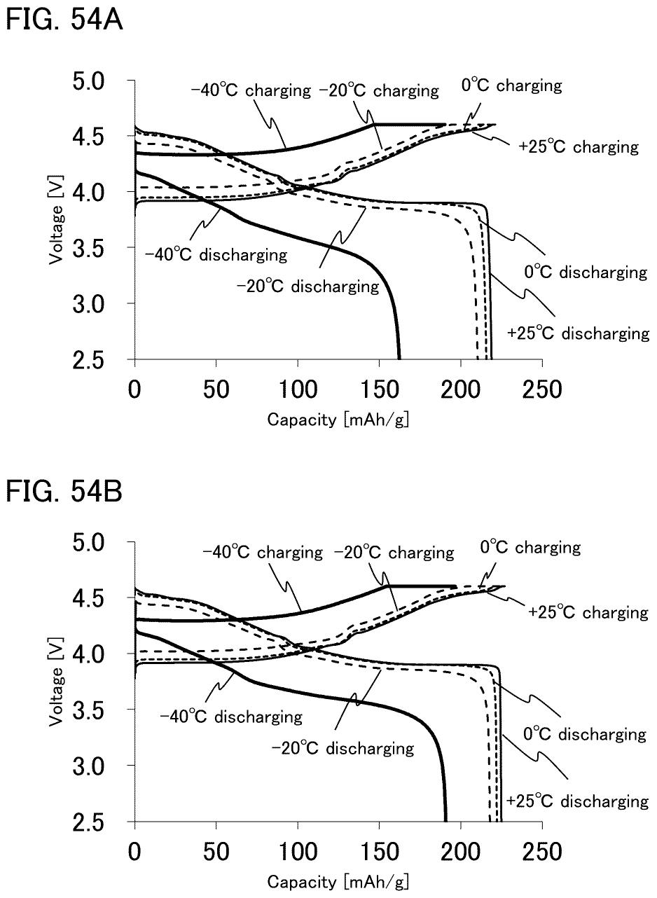

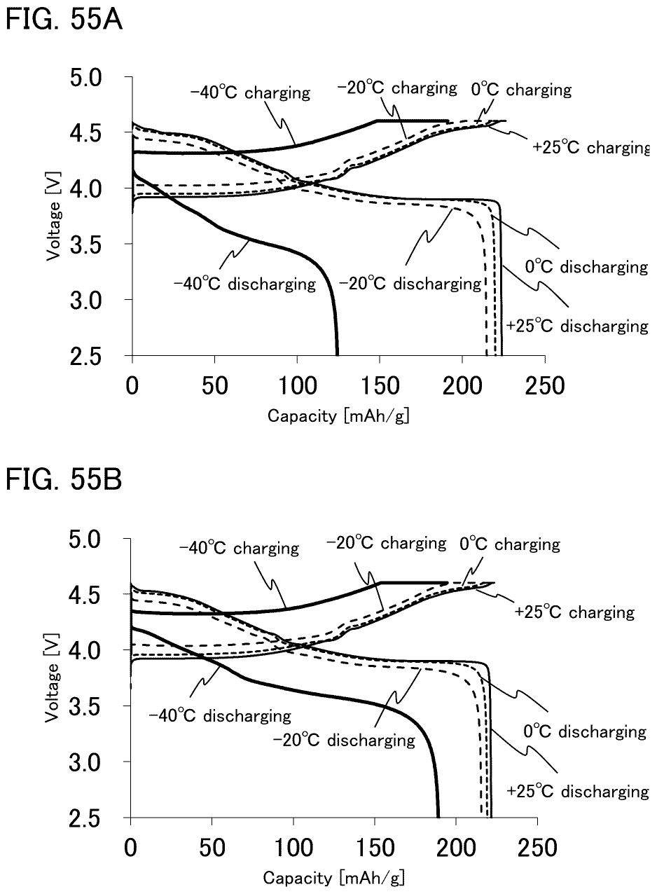

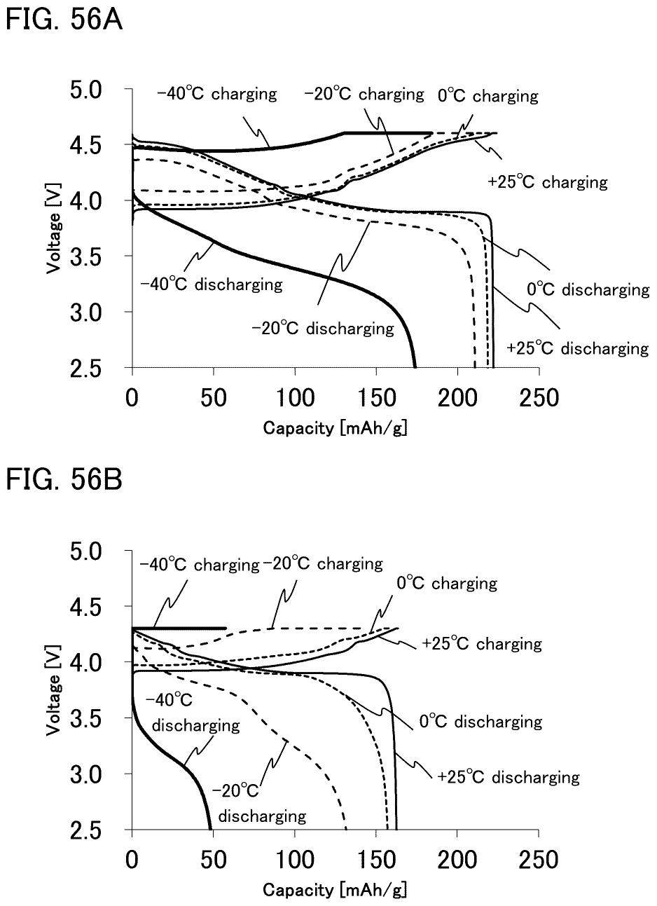

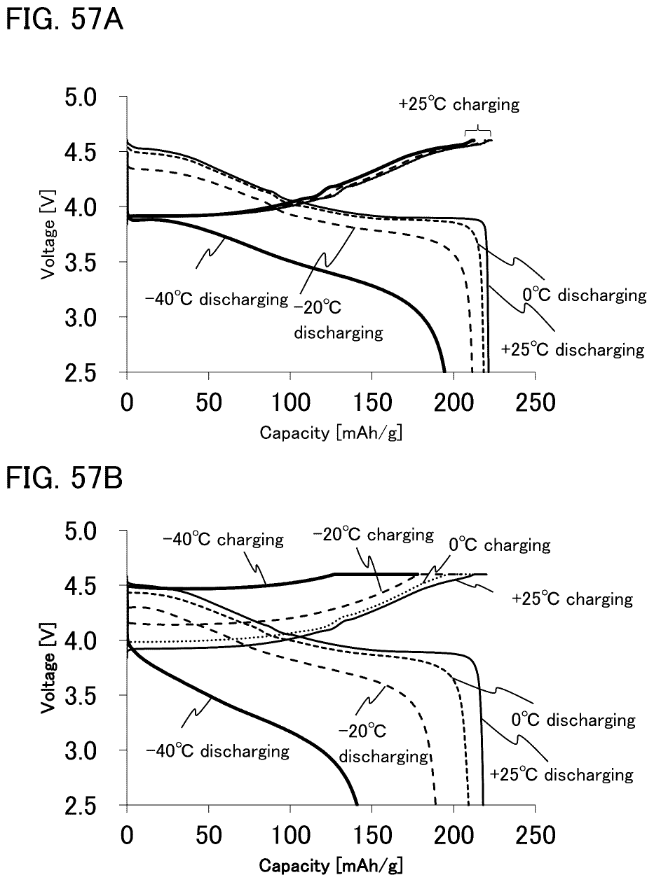

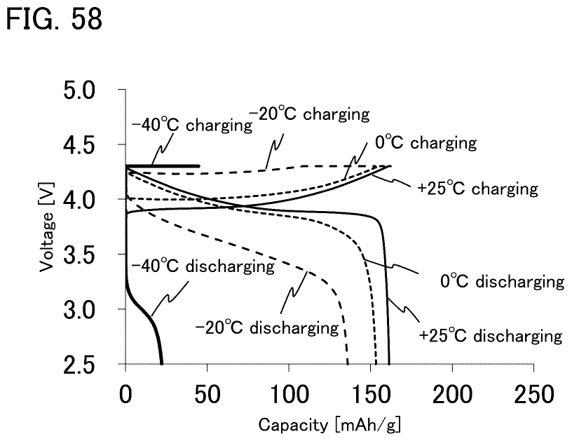

FIG. 54A shows charge/discharge curves of Sample 1A at the temperatures. FIG. 54B shows charge/discharge curves of Sample 1B at the temperatures. FIG. 55A shows charge/discharge curves of Sample 1C at the temperatures. FIG. 55B shows charge/discharge curves of Sample 2A at the temperatures. FIG. 56A shows charge/discharge curves of Sample 3 at the temperatures. FIG. 56B shows charge/discharge curves of Sample 4 at the temperatures. FIG. 57A shows charge/discharge curves of Sample 5A at the temperatures. Only in the measurement for Sample 5A, the ambient temperature during the charging was fixed to 25 °C, and only the ambient temperature during the discharging was varied. FIG. 57B shows charge/discharge curves of Sample 6 at the temperatures. FIG. 58 shows charge/discharge curves of Sample 7 at the temperatures.

In FIG. 54A to FIG. 58, charge/discharge curves at 25 °C are shown by solid lines, charge/discharge curves at 0 °C are shown by short dashed lines, charge/discharge curves at −20 °C are shown by long dashed lines, and charge/discharge curves at −40 °C are shown by thick solid lines. As these measurement results, Table 16 shows discharge capacity and Table 17 shows discharge energy. Note that discharge energy is the product of discharge capacity and the average discharge voltage in a discharge curve.

TABLE 16

| | Discharge capacity (mAh/g) | | | | Ratio to 25 °C (%) | | |
|---|---|---|---|---|---|---|---|
| | 25 °C | 0 °C | −20 °C | −40 °C | 0 °C | −20 °C | −40 °C |
| Sample 1A | 218.9 | 215.8 | 210.4 | 162.3 | 98.6 | 96.1 | 74.1 |
| Sample 1B | 225.0 | 222.2 | 217.9 | 190.9 | 98.8 | 96.9 | 84.8 |
| Sample 1C | 223.9 | 220.0 | 214.8 | 124.3 | 98.3 | 95.9 | 55.5 |
| Sample 2A | 221.5 | 219.1 | 215.5 | 189.0 | 98.9 | 97.3 | 85.3 |
| Sample 3 | 221.9 | 218.5 | 210.6 | 173.8 | 98.4 | 94.9 | 78.3 |
| Sample 4 | 162.6 | 157.1 | 131.6 | 48.2 | 96.6 | 81.0 | 29.6 |
| Sample 5A | 221.4 | 218.5 | 211.4 | 194.5 | 98.7 | 95.5 | 87.8 |
| Sample 6 | 218.1 | 209.1 | 189.0 | 140.9 | 95.9 | 86.7 | 64.6 |
| Sample 7 | 161.4 | 153.3 | 136.0 | 22.1 | 95.0 | 84.3 | 13.7 |

TABLE 17

| | Discharge energy (mWh/g) | | | | Ratio to 25 °C (%) | | |
|---|---|---|---|---|---|---|---|
| | 25 °C | 0 °C | −20 °C | −40 °C | 0 °C | −20 °C | −40 °C |
| Sample 1A | 900.7 | 884.9 | 848.1 | 598.4 | 98.2 | 94.2 | 66.4 |
| Sample 1B | 927.4 | 913.9 | 882.8 | 708.8 | 98.5 | 95.2 | 76.4 |
| Sample 1C | 923.5 | 905.0 | 870.0 | 450.2 | 98.0 | 94.2 | 48.8 |
| Sample 2A | 912.2 | 898.2 | 869.2 | 699.1 | 98.5 | 95.3 | 76.6 |
| Sample 3 | 912.6 | 893.0 | 836.1 | 599.7 | 97.8 | 91.6 | 65.7 |
| Sample 4 | 644.5 | 607.0 | 467.1 | 151.1 | 94.2 | 72.5 | 23.4 |
| Sample 5A | 911.2 | 892.1 | 836.2 | 680.9 | 97.9 | 91.8 | 74.7 |
| Sample 6 | 893.4 | 842.2 | 728.3 | 471.8 | 94.3 | 81.5 | 52.8 |
| Sample 7 | 638.2 | 594.0 | 483.8 | 65.5 | 93.1 | 75.8 | 10.3 |

From the above, it was revealed that the half cells fabricated using Sample 1A, Sample 1B, Sample 1C, Sample 2A, and Sample 5A containing titanium as the additive element have favorable discharge performance at low temperatures lower than or equal to 0 °C and their discharge capacity at −20 °C is greater than or equal to 95.0% of their discharge capacity at 25 °C. This is probably because titanium existing in the surface portion of the positive electrode active material has an effect of promoting insertion and extraction of lithium ions.

It was revealed that the half cells fabricated using Sample 1B and Sample 2A have a favorable discharge energy retention rate at low temperatures lower than or equal to 0 °C and their discharge energy at −20 °C is greater than or equal to 95.0% of their discharge energy at 25 °C. It was also revealed that their discharge energy at −40 °C is greater than or equal to 75.0% of their discharge energy at 25 °C.

The half cells fabricated using Sample 1B, Sample 2A, and Sample 5A achieved a discharge capacity greater than or equal to 80% of the discharge capacity at 25 °C even at −40 °C. This is probably because the positive electrode active material, which contains titanium in the edge region of the surface portion, was in a state where lithium ions easily enter and leave the positive electrode active material (charging and discharging are easily performed) as compared with the case where titanium is not contained. Note that in the case where the amount of titanium is excessive, an oxide of titanium and magnesium is formed on the surface of the positive electrode active material, and thus, a region including the oxide is probably in a state where entering and leaving of lithium ions are disturbed (charging and discharging are inhibited).

Note that in the case where magnesium is contained as the additive element, the chargeable and dischargeable capacity tends to decrease as the addition amount of magnesium increases; however, Sample 1B, Sample 2A, and Sample 5A, which achieved a discharge capacity greater than or equal to 80% of the discharge capacity at 25 °C even at −40 °C, achieved a high discharge capacity exceeding 220 mAh/g in the 25 °C measurement.

### Example 4

In this example, positive electrodes including Sample 2A, Sample 4, Sample 6, and Sample 7 formed in Example 2 were formed. Coin-type half cells were fabricated using the formed positive electrodes, and were subjected to discharge rate tests and charge/discharge cycling tests.

### <Positive Electrode Formation 3>

Positive electrodes including Sample 2A, Sample 4, Sample 6, and Sample 7 formed in Example 2 were formed. The positive electrodes were formed by the same method as the positive electrodes formed in Example 2 (see Positive electrode formation 1) except that the slurry was formed by mixing the positive electrode active material, acetylene black (AB) prepared as a conductive material, and polyvinylidene fluoride (PVDF) prepared as a binder at the positive electrode active material:AB:PVDF=96:2:2 (weight ratio), the conditions of the positive electrode active material loading level were different, and the conditions of the pressing after the application were different. The conditions of the pressing treatment were as follows: the first pressing (linear pressure: 210 kN/m) was followed by the second pressing (linear pressure: 1467 kN/m). Note that the temperature of each of the upper roll and the lower roll of the roller press machine was 120 °C.

Note that a positive electrode formed to have a positive electrode active material loading level of approximately 5 mg/cm² per area of the positive electrode, a positive electrode formed to have a positive electrode active material loading level of approximately 7 mg/cm² per area of the positive electrode, a positive electrode formed to have a positive electrode active material loading level of approximately 10 mg/cm² per area of the positive electrode, a positive electrode formed to have a positive electrode active material loading level of approximately 16 mg/cm² per area of the positive electrode, and a positive electrode formed to have a positive electrode active material loading level of approximately 21 mg/cm² per area of the positive electrode were prepared using Sample 2A, Sample 4, Sample 6, and Sample 7.

### <Fabrication of Half Cell>

Coin-type half cells each including any of the above positive electrodes, a lithium metal foil, a separator, an electrolyte, a coin cell positive electrode can, and a coin cell negative electrode can were fabricated. As the electrolyte, Electrolyte Solution B obtained by dissolving lithium hexafluorophosphate (LiPF₆) as a lithium salt at 1 mol/L in a mixed solvent in which ethylene carbonate (EC) and diethyl carbonate (DEC) were mixed at EC:DEC=3:7 (volume ratio) and to which 2 wt % vinylene carbonate (VC) as an additive agent was added was used.

As the separator, a porous polypropylene film was used.

### <Charge Rate Test>

Charge rate tests were performed using the half cells of Sample 2A and Sample 6 fabricated as described above. The half cells used in the charge rate tests were fabricated using positive electrodes formed using Sample 2A to have positive electrode active material loading levels of approximately 5 mg/cm², approximately 7 mg/cm², approximately 10 mg/cm², approximately 16 mg/cm², and approximately 21 mg/cm². The test conditions are described below.

First, charging and discharging were repeated twice (aging). In the charging, constant current charging at 0.2 C was performed to 4.60 V and then, constant voltage charging was performed at 4.60 V until the current value reached 0.02 C. As the discharging, constant current discharging at 0.2 C was performed to 2.5 V. A rest period of 10 minutes was allowed between the charging and the discharging. Note that as in the other tests, 1 C was set to 200 mA/g per weight of the positive electrode active material.

Next, charging and discharging were repeated eight times with the discharge conditions being the same as the charge conditions of the above-described aging, and the charge conditions being the same as the above description except for the current value. The current value at the time of the charging was 0.2 C for the first charging, 0.5 C for the second charging, 1 C for the third charging, 2 C for the fourth charging, 3 C for the fifth charging, 4 C for the sixth charging, and 5 C for the seventh charging. A rest period of 10 minutes was allowed between the charging and the discharging.

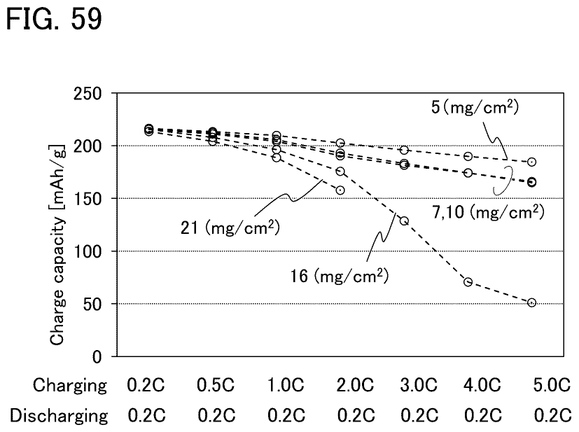

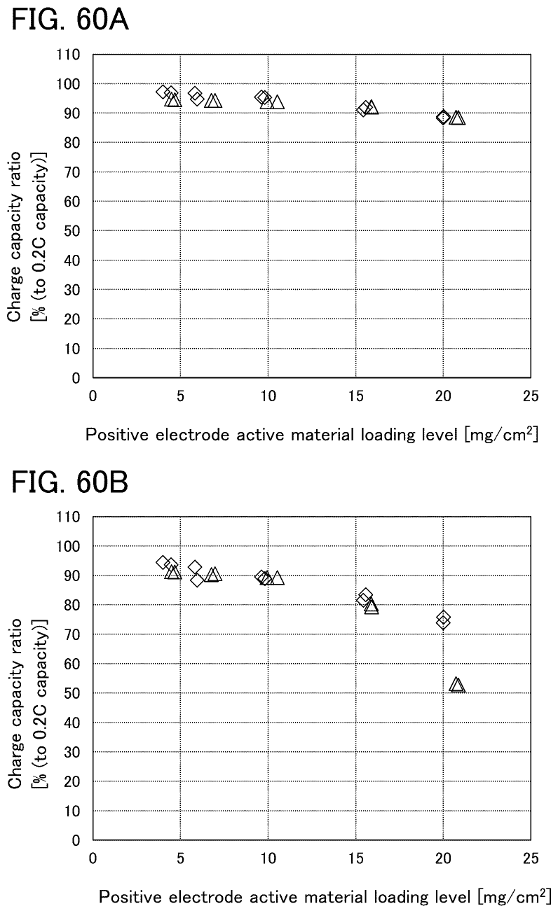

FIG. 59 shows the relationship between the charge conditions and the charge capacity in the above charge rate tests. FIG. 60A is a graph in which the value on the vertical axis represents the ratio of the charge capacity value of the third charging (1.0 C) on the assumption that the charge capacity value of the first charging (0.2 C) was 100% in the above charge rate tests, and the value on the horizontal axis represents the loading level of the electrode used in each half cell. FIG. 60B is a graph in which the value on the vertical axis represents the ratio of the charge capacity value of the fourth charging (2.0 C) on the assumption that the charge capacity value of the first charging (0.2 C) was 100% in the above charge rate tests, and the value on the horizontal axis represents the loading level of the electrode used in each half cell.

### <Discharge Rate Test>

Discharge rate tests were performed using the half cells fabricated as described above. The half cells used in the discharge rate tests were fabricated using positive electrodes formed using Sample 2A to have positive electrode active material loading levels of approximately 5 mg/cm², approximately 7 mg/cm², approximately 10 mg/cm², approximately 16 mg/cm², and approximately 21 mg/cm². The test conditions are described below.

First, charging and discharging were repeated twice (aging). The aging conditions are the same as those in the charge rate tests.

Next, charging and discharging were repeated eight times with the charge conditions being the same as the charge conditions of the above-described aging, and the discharge conditions being the same as the above description except for the current value. The current value at the time of the discharging was 0.2 C for the first discharging, 0.5 C for the second discharging, 1 C for the third discharging, 2 C for the fourth discharging, 3 C for the fifth discharging, 4 C for the sixth discharging, and 5 C for the seventh discharging. A rest period of 10 minutes was allowed between the charging and the discharging.

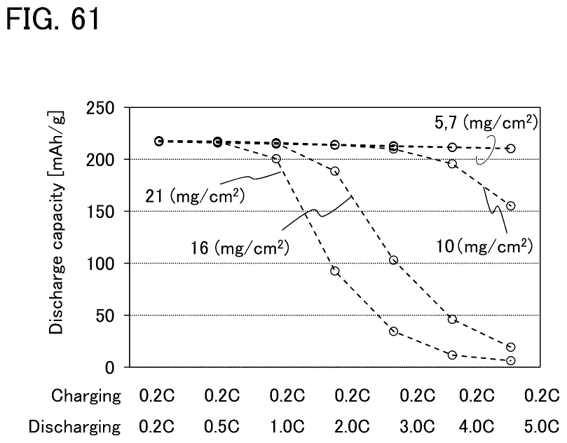

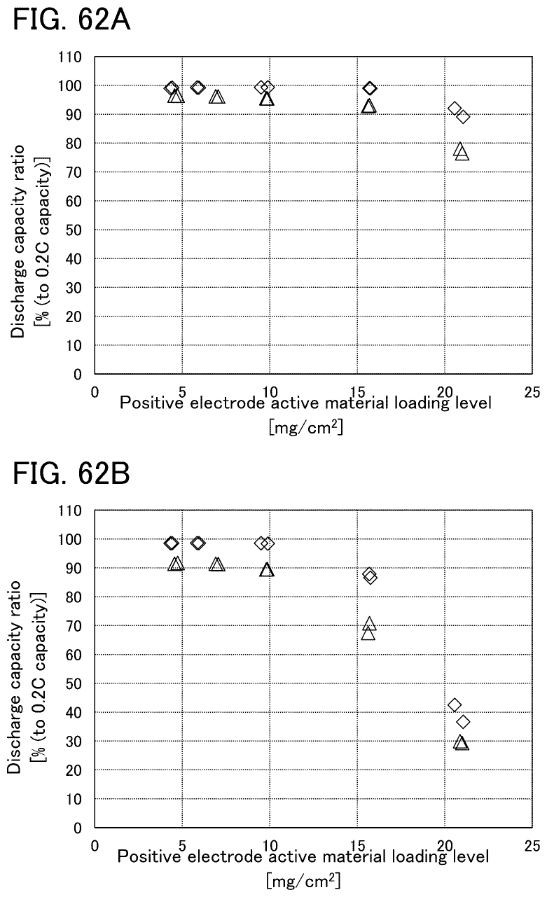

FIG. 61 shows the relationship between the discharge conditions and the discharge capacity in the above discharge rate tests. FIG. 62A is a graph in which the value on the vertical axis represents the ratio of the discharge capacity value of the third discharging (1.0 C) on the assumption that the discharge capacity value of the first discharging (0.2 C) was 100% in the above discharge rate tests, and the value on the horizontal axis represents the loading level of the electrode used in each half cell. FIG. 62B is a graph in which the value on the vertical axis represents the ratio of the discharge capacity value of the fourth discharging (2.0 C) on the assumption that the discharge capacity value of the first discharging (0.2 C) was 100% in the above discharge rate tests, and the value on the horizontal axis represents the loading level of the electrode used in each half cell.

As described above, it was confirmed that Sample 2A achieves better charge rate performance and discharge rate performance than Sample 6.

### Example 5

### <Positive Electrode Formation 4>

Positive electrodes including Sample 2A, Sample 4, Sample 6, and Sample 7 formed in Example 2 were formed. The positive electrodes were formed by the same method as the positive electrodes formed in Example 4 (see Positive electrode formation 3) except that acetylene black (AB) was prepared as a conductive material, polyvinylidene fluoride (PVDF) was prepared as a binder, and the loading level of the positive electrode active material was approximately 14.5 mg/cm².

### <Fabrication of Half Cell>

Coin-type half cells each including any of the above positive electrodes, a lithium metal foil, a separator, an electrolyte, a coin cell positive electrode can, and a coin cell negative electrode can were fabricated. As the electrolyte, Electrolyte Solution B in which 2 wt % vinylene carbonate (VC) was added as an additive agent to a mixed solvent obtained by mixing ethylene carbonate (EC) and diethyl carbonate (DEC) at EC:DEC=3:7 (volume ratio) and 1 mol/L lithium hexafluorophosphate (LiPF₆) was a lithium salt was used.

As the separator, a porous polypropylene film was used.

### <Charge/Discharge Cycling Test 1>

Charge/discharge cycling tests were performed using the half cell with Sample 2A and the half cell with Sample 6, which were fabricated in the above manner.

The charge/discharge cycling test conditions were as follows: in the charging, constant current charging at 0.5 C was performed to 4.58 V and then, constant voltage charging was performed until the current value reached 0.05 C. As the discharging, constant current discharging at 1 C was performed to 3.0 V. Note that here, 1 C was set to 200 mA/g. The temperature in the measurement environment was 45 °C. A post-charging rest period from the completion of charging to the start of discharging and a post-discharging rest period from the completion of discharging to the start of charging were each 10 minutes.

Note that in each charge/discharge cycle, the resistance DCIR was measured at the start of discharging. In the resistance DCIR measurement, discharging was performed at a current of 6 mA/g per weight of the positive electrode active material (lithium cobalt oxide) for one second, and the resistance DCIR can be calculated by dividing the difference between the open circuit voltage before the discharging and the voltage during the discharging by the above current (6 mA/g).

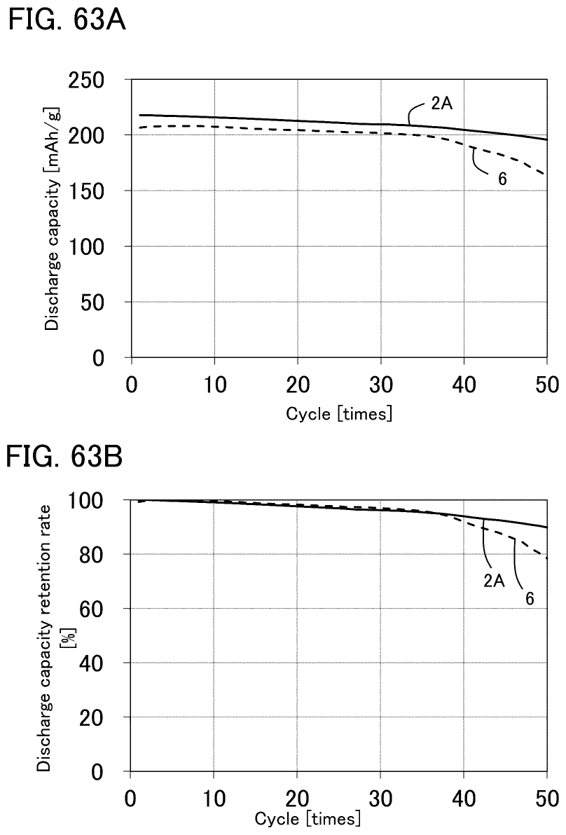

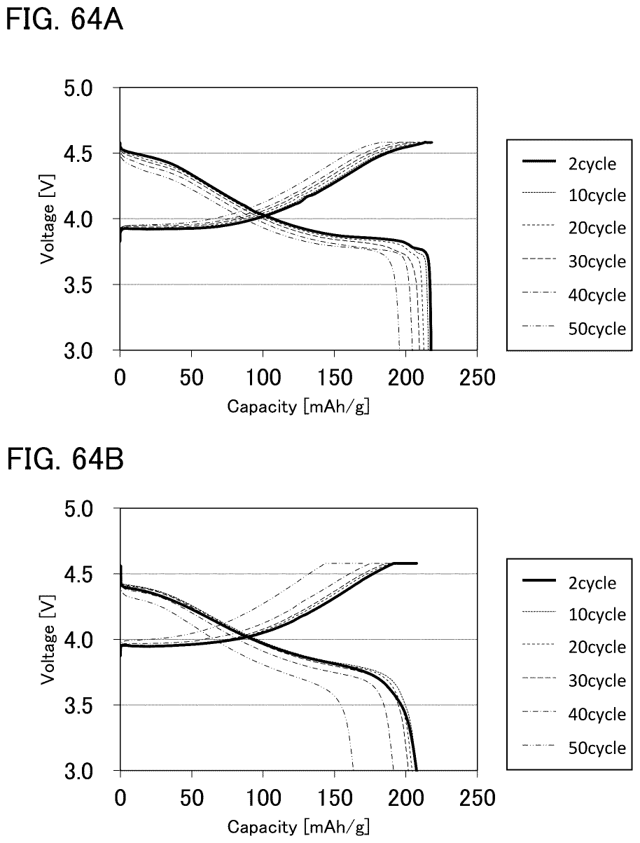

FIG. 63, FIG. 64, and Table 18 show the results of the charge/discharge cycling tests.

FIG. 63A is a graph showing the cycling performance of Sample 2A and Sample 6, and the vertical axis represents discharge capacity and the horizontal axis represents the number of cycles. FIG. 63B is a graph showing the discharge capacity in FIG. 63A as a discharge capacity retention rate. Note that the discharge capacity retention rate was calculated on the assumption that the discharge capacity value in the discharging that achieved the maximum discharge capacity in the charge/discharge cycling test was 100%.

FIG. 64A and FIG. 64B are graphs showing charge curves and discharge curves in the second cycle (2cycle), the 10th cycle (10cycle), the 20th cycle (20cycle), the 30th cycle (30cycle), the 40th cycle (40cycle), and the 50th cycle (50cycle) in the charge/discharge cycling tests, where the vertical axis represents voltage and the horizontal axis represents capacity. FIG. 64A shows charge curves and discharge curves of Sample 2A, and FIG. 64B shows charge curves and discharge curves of Sample 6.

Table 18 shows the discharge capacity and discharge capacity retention rates of the samples in the first cycle, the second cycle, the fifth cycle, the 10th cycle, the 20th cycle, the 25th cycle, the 30th cycle, the 40th cycle, and the 50th cycle in the above charge/discharge cycling tests.

TABLE 18

| | Sample 2A | | Sample 6 | |
|---|---|---|---|---|
| | | Discharge | | Discharge |
| | Discharge | capacity | Discharge | capacity |
| | capacity | retention rate | capacity | retention rate |
| Maximum | 217.80 mAh/g | 100.00% | 208.02 mAh/g | 100.00% |
| value | | | | |
| 1st cycle | 217.80 mAh/g | 100.00% | 206.49 mAh/g | 99.26% |
| 2nd cycle | 217.75 mAh/g | 99.97% | 207.41 mAh/g | 99.71% |
| 5th cycle | 217.11 mAh/g | 99.68% | 207.96 mAh/g | 99.97% |
| 10th cycle | 215.80 mAh/g | 99.08% | 207.46 mAh/g | 99.73% |
| 20th cycle | 212.60 mAh/g | 97.61% | 204.46 mAh/g | 98.29% |
| 25th cycle | 211.02 mAh/g | 96.88% | 203.02 mAh/g | 97.60% |
| 30th cycle | 209.57 mAh/g | 96.22% | 201.68 mAh/g | 96.95% |
| 40th cycle | 204.60 mAh/g | 93.94% | 191.29 mAh/g | 91.96% |
| 50th cycle | 195.67 mAh/g | 89.84% | 163.30 mAh/g | 78.50% |

In the above results of the charge/discharge cycling tests, Sample 2A and Sample 6 each exhibit favorable discharge capacity retention rates. When Sample 2A and Sample 6 are compared, the discharge capacity retention rates of Sample 2A after approximately 40 cycles are especially high, and even in the 40th cycle, the discharge capacity per weight of the positive electrode active material is 204.60 mAh/g, which is higher than or equal to 200 mAh/g. Even in the 50th cycle, the discharge capacity is 195.67 mAh/g, which is higher than or equal to 195 mAh/g.

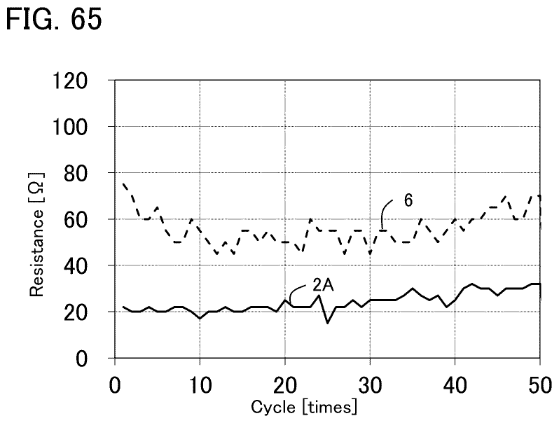

FIG. 65 and Table 19 show the resistance DCIR measured at the start of discharging in each cycle in the above charge/discharge cycling tests.

FIG. 65 is a graph in which the vertical axis represents resistance DCIR and the horizontal axis represents the number of cycles. Table 19 shows the open circuit voltage before resistance measurement (before discharging) and the resistance DCIR in the first cycle, the second cycle, the fifth cycle, the 10th cycle, the 20th cycle, the 25th cycle, the 30th cycle, the 40th cycle, and the 50th cycle, and the ratio of the resistance DCIR in each cycle to the resistance DCIR in the first cycle.

TABLE 19

| | Sample 2A | | | | | Sample 6 | | | | |
|---|---|---|---|---|---|---|---|---|---|---|
| | Open circuit | | Resistance | | Ratio to | Open circuit | | Resistance | | Ratio to |
| | voltage | | (DCIR) | | 1st cycle | voltage | | (DCIR) | | 1st cycle |
| 1st cycle | 4.58 | V | 22 | Ω | 100.0% | 4.56 | V | 75 | Ω | 100.0% |
| 2nd cycle | 4.58 | V | 20 | Ω | 90.9% | 4.56 | V | 70 | Ω | 93.3% |
| 5th cycle | 4.58 | V | 20 | Ω | 90.9% | 4.56 | V | 65 | Ω | 86.7% |
| 10th cycle | 4.58 | V | 17 | Ω | 77.3% | 4.56 | V | 55 | Ω | 73.3% |
| 20th cycle | 4.58 | V | 25 | Ω | 113.6% | 4.56 | V | 50 | Ω | 66.7% |
| 25th cycle | 4.58 | V | 15 | Ω | 68.2% | 4.56 | V | 55 | Ω | 73.3% |
| 30th cycle | 4.57 | V | 25 | Ω | 113.6% | 4.56 | V | 45 | Ω | 60.0% |
| 40th cycle | 4.57 | V | 25 | Ω | 113.6% | 4.56 | V | 60 | Ω | 80.0% |
| 50th cycle | 4.57 | V | 32 | Ω | 145.5% | 4.55 | V | 70 | Ω | 93.3% |

Like the comparison between Sample 2A and Sample 6 in the above discharge rate tests, which showed the favorable discharge rate performance of Sample 2A, the above-described results of measuring the resistance DCIR also show that Sample 2A tends to achieve a lower resistance DCIR than Sample 6. In the results of measuring the resistance DCIR, the open circuit voltages were higher than or equal to 4.50 V and lower than or equal to 4.60 V. That is, the measurement results show that Sample 2A achieves a resistance DCIR higher than or equal to 15Ω and lower than or equal to 32 1, i.e., lower than or equal to 35Ω, in a state where charging is performed until the opening circuit voltage reaches higher than or equal to 4.50 V and lower than or equal to 4.60 V. Meanwhile, the measurement results show that Sample 6 achieves a resistance DCIR higher than or equal to 45 12 and lower than or equal to 75 12 in a state where charging is performed until the opening circuit voltage reaches higher than or equal to 4.50 V.

Comparison between the resistance DCIR of Sample 2A and that of Sample 6 shows that the resistance DCIR of Sample 2A is particularly low at the initial stage of the cycling, especially in the first cycle.

Considered from both the measurement results in this example and the results of the powder resistance measurement in Example 2, it was revealed that Sample 2A, which contains magnesium, titanium, nickel, and aluminum as the additive elements, has a characteristically high powder resistance (electron transfer resistance) in the synthesis of the positive electrode active material and that the resistance relating to entering and leaving of lithium ions at the time of using Sample 2A for a positive electrode of a battery is characteristically low.

### <Charge/Discharge Cycling Test 2>

Charge/discharge cycling tests were performed using half cells fabricated using positive electrodes of Sample 2A, Sample 4, Sample 6, and Sample 7, each of which had a positive electrode active material loading level of approximately 14.5 mg/cm².

The charge/discharge cycling test conditions were as follows: in the charging, constant current charging at 0.5 C was performed to 4.60 V and then, constant voltage charging was performed until the current value reached 0.05 C. As the discharging, constant current discharging at 1 C was performed to 3.0 V. Note that here, 1 C was set to 200 mA/g. The temperature in the measurement environment was 45 °C. A post-charging rest period from the completion of charging to the start of discharging and a post-discharging rest period from the completion of discharging to the start of charging were each 10 minutes.

Note that in each charge/discharge cycle, the resistance DCIR was measured at the start of discharging. In the resistance DCIR measurement, discharging was performed at a current of 6 mA/g per weight of the positive electrode active material (lithium cobalt oxide) for one second, and the resistance DCIR can be calculated by dividing the difference between the open circuit voltage before the discharging and the voltage during the discharging by the above current (6 mA/g).

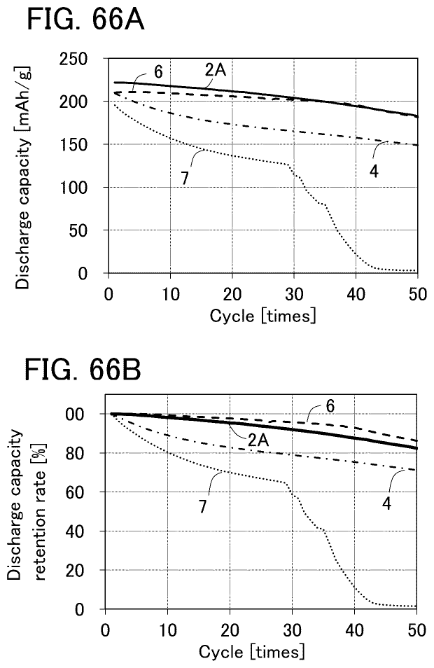

FIG. 66 shows the results of the charge/discharge cycling tests.

FIG. 66A is a graph showing the cycling performance of Sample 2A, Sample 4, Sample 6, and Sample 7, and the vertical axis represents discharge capacity and the horizontal axis represents the number of cycles. FIG. 66B is a graph showing the discharge capacity in FIG. 66A as a discharge capacity retention rate. Note that the discharge capacity retention rate was calculated on the assumption that the discharge capacity value in the discharging that achieved the maximum discharge capacity in the charge/discharge cycling test was 100%.

In the above results of the charge/discharge cycling tests, Sample 2A and Sample 6 each exhibit favorable discharge capacity and favorable discharge capacity retention rates as shown in Table 20.

TABLE 20

| | Sample 2A | | Sample 6 | |
|---|---|---|---|---|
| | | Discharge | | Discharge |
| | Discharge | capacity | Discharge | capacity |
| | capacity | retention rate | capacity | retention rate |
| Maximum | 221.77 mAh/g | 100.00% | 210.68 mAh/g | 100.00% |
| value | | | | |
| 1st cycle | 221.77 mAh/g | 100.00% | 209.88 mAh/g | 99.62% |
| 2nd cycle | 221.61 mAh/g | 99.93% | 210.49 mAh/g | 99.91% |
| 5th cycle | 220.55 mAh/g | 99.45% | 210.60 mAh/g | 99.96% |
| 10th cycle | 217.61 mAh/g | 98.12% | 209.26 mAh/g | 99.33% |
| 20th cycle | 211.50 mAh/g | 95.37% | 205.77 mAh/g | 97.67% |
| 25th cycle | 207.92 mAh/g | 93.75% | 203.62 mAh/g | 96.65% |
| 30th cycle | 203.89 mAh/g | 91.94% | 201.63 mAh/g | 95.70% |
| 40th cycle | 194.17 mAh/g | 87.55% | 195.66 mAh/g | 92.87% |
| 50th cycle | 182.56 mAh/g | 82.32% | 181.45 mAh/g | 86.12% |

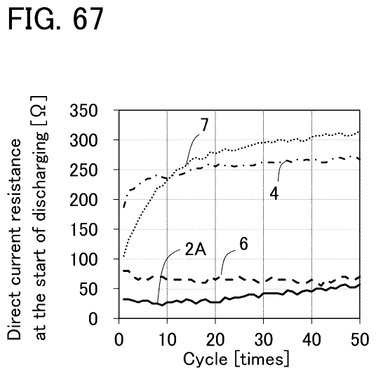

FIG. 67 shows the resistance DCIIR measured at the start of discharging in each cycle in the above charge/discharge cycling tests. Table 21 shows the open circuit voltage at the time of the resistance DCIR measurement and the resistance DCIIR for Sample 2A and Sample 6.

TABLE 21

| | Sample 2A | | | | | Sample 6 | | | | |
|---|---|---|---|---|---|---|---|---|---|---|
| | Open circuit | | Resistance | | Ratio to | Open circuit | | Resistance | | Ratio to |
| | voltage | | (DCIR) | | 1st cycle | voltage | | (DCIR) | | 1st cycle |
| 1th cycle | 4.59 | V | 32 | Ω | 100.0% | 4.57 | V | 80 | Ω | 100.0% |
| 2th cycle | 4.59 | V | 32 | Ω | 100.0% | 4.57 | V | 80 | Ω | 100.0% |
| 5th cycle | 4.59 | V | 30 | Ω | 93.8% | 4.58 | V | 70 | Ω | 87.5% |
| 10th cycle | 4.59 | V | 27 | Ω | 84.4% | 4.58 | V | 65 | Ω | 81.3% |
| 20th cycle | 4.59 | V | 27 | Ω | 84.4% | 4.58 | V | 65 | Ω | 81.3% |
| 25th cycle | 4.59 | V | 35 | Ω | 109.4% | 4.58 | V | 70 | Ω | 87.5% |
| 30th cycle | 4.59 | V | 42 | Ω | 131.3% | 3.88 | V | 60 | Ω | 75.0% |
| 40th cycle | 4.58 | V | 45 | Ω | 140.6% | 4.57 | V | 65 | Ω | 81.3% |
| 50th cycle | 4.58 | V | 57 | Ω | 178.1% | 4.57 | V | 70 | Ω | 87.5% |

Like the comparison between Sample 2A and Sample 6 in the above discharge rate tests, which showed the favorable discharge rate performance of Sample 2A, the above-described results of measuring the resistance DCIIR also show that Sample 2A tends to achieve a lower resistance DCIIR than Sample 6. The resistance DCIIR of Sample 4 and Sample 7 as comparative examples had a large value.

### Example 6

In Example 2, charge/discharge cycling tests were performed using Sample 1A to Sample 7 formed in Example 2.

### <Fabrication of Half Cell>

Coin-type half cells were each fabricated using any of the above positive electrodes including Sample 1A to Sample 7 formed in Example 2, a lithium metal foil, a separator, an electrolyte, a coin cell positive electrode can, and a coin cell negative electrode can. The fabrication conditions of the half cells were the same as those described in Example 2 except that Electrolyte Solution B was used instead of Electrolyte Solution A. Note that in Electrolyte Solution B, a mixture of ethylene carbonate (EC) and diethyl carbonate (DEC) at EC:DEC=3:7 (volume ratio) to which 2 wt % vinylene carbonate (VC) as an additive agent was added was used and 1 mol/L lithium hexafluorophosphate (LiPF₆) was used as an electrolyte of the electrolyte solution.

### <Charge/Discharge Cycling Test 3>

Charge/discharge cycling tests were performed using the above half cells. The number of samples of each of the half cells fabricated using Sample 1A to Sample 7 was N=2, and the half cells were each subjected to charge/discharge tests under two conditions (first and second test conditions).

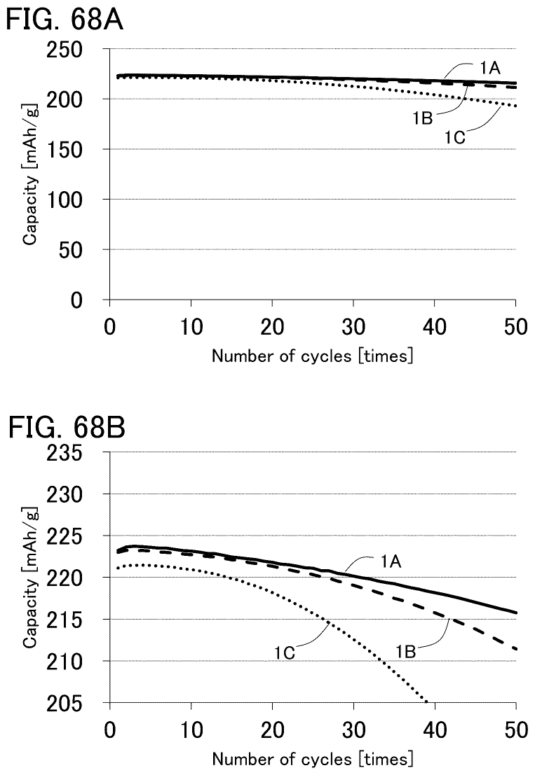

The first test conditions were as follows: in the charging, constant current charging at 0.5 C was performed to 4.60 V and then, constant voltage charging was performed until the current value reached 0.05 C. As the discharging, constant current discharging at 0.5 C was performed to 2.50 V. Note that here, 1 C was set to 200 mA/g. The temperature in the measurement environment was 25 °C. In the above manner, charging and discharging were repeated 50 times. FIG. 68A to FIG. 73B show the results of the charge/discharge cycling tests.

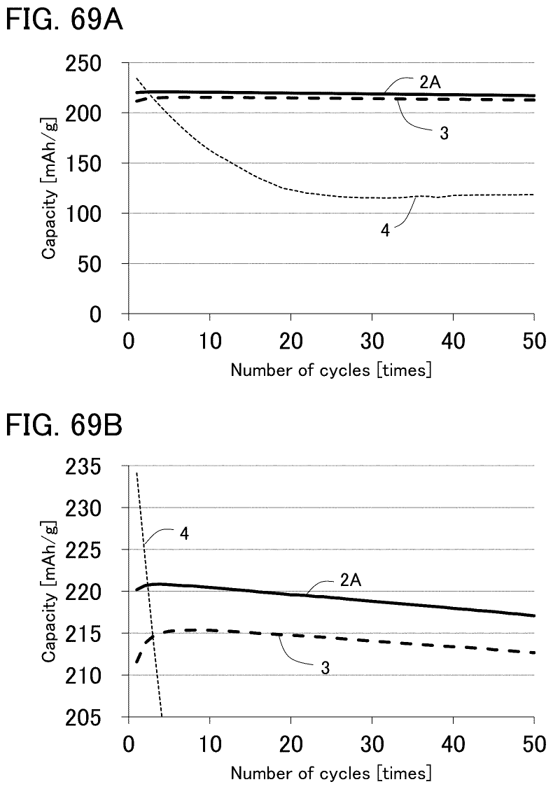

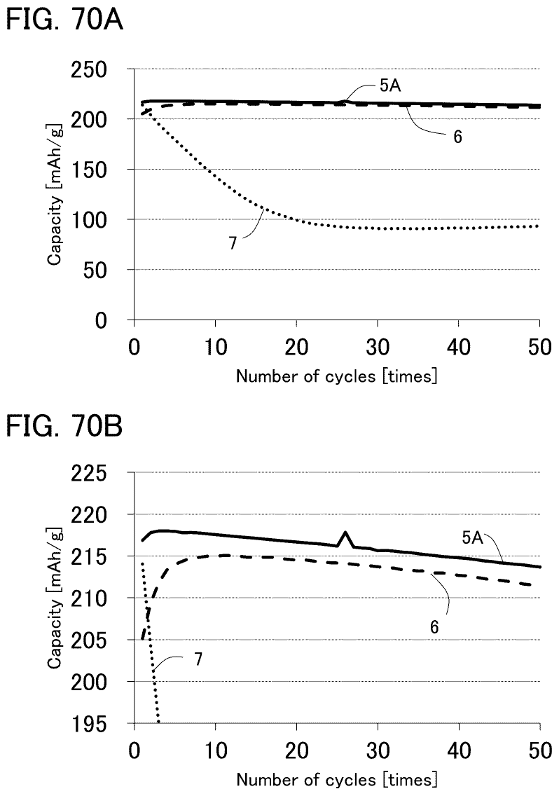

FIG. 68A is a graph showing discharge capacity and the number of cycles of the half cell including Sample 1A (solid line), the half cell including Sample 1B (dashed line), and the half cell sample including Sample 1C (dotted line). FIG. 69A is a graph showing discharge capacity and the number of cycles of the half cell including Sample 2A (solid line), the half cell including Sample 3 (dashed line), and the half cell sample including Sample 4 (dotted line). FIG. 70A is a graph showing discharge capacity and the number of cycles of the half cell including Sample 5A (solid line), the half cell including Sample 6 (dashed line), and the half cell sample including Sample 7 (dotted line).

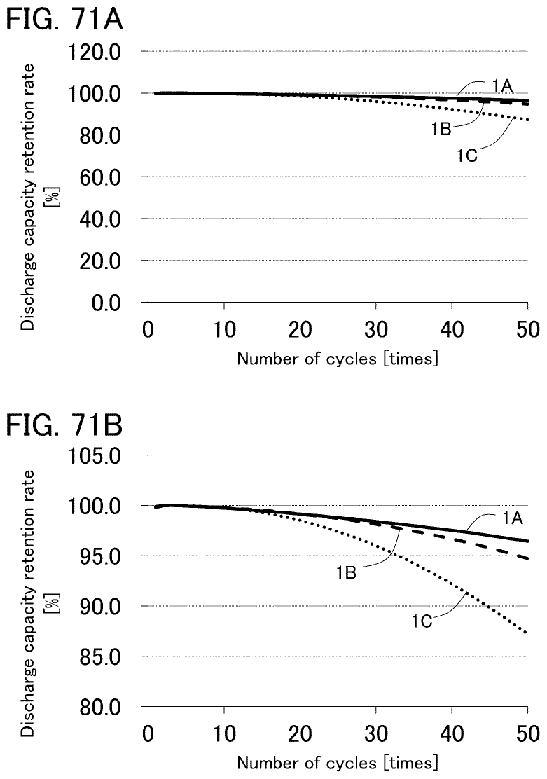

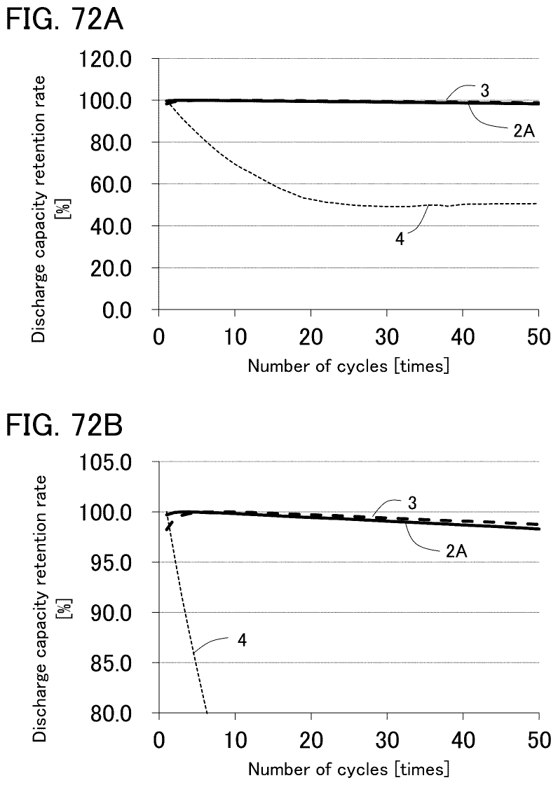

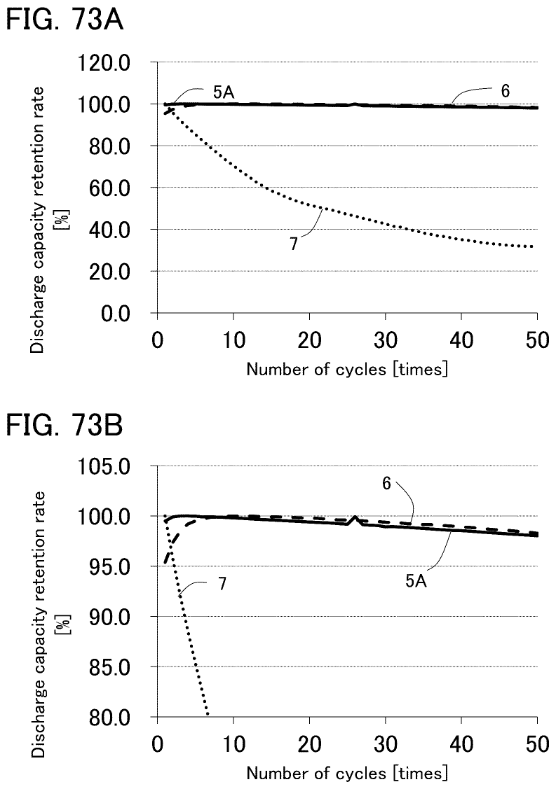

FIG. 68B, FIG. 69B, and FIG. 70B are graphs obtained by enlarging the vertical axes of FIG. 68A, FIG. 69A, and FIG. 70A, respectively. FIG. 71A, FIG. 71B, FIG. 72A, FIG. 72B, FIG. 73A, and FIG. 73B are graphs showing the discharge capacity in FIG. 68A, FIG. 68B, FIG. 69A, FIG. 69B, FIG. 70A, and FIG. 70B as discharge capacity retention rates, respectively. Note that the discharge capacity retention rate was calculated on the assumption that the discharge capacity value in the discharging that achieved the maximum discharge capacity in the charge/discharge cycling test was 100%.

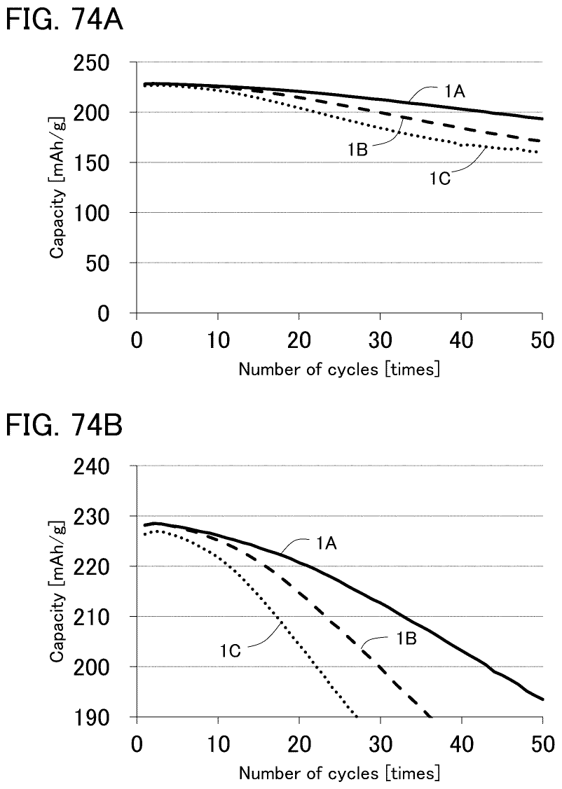

The second test conditions were similar to the first test conditions except that the temperature in the measurement environment was 45 °C. In the above manner, charging and discharging were repeated 50 times. FIG. 74A to FIG. 79B show the results of the charge/discharge cycling tests.

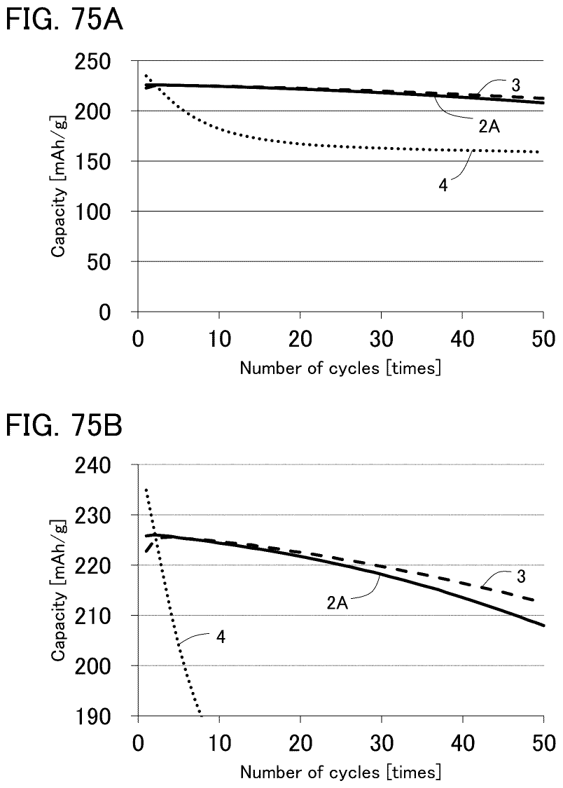

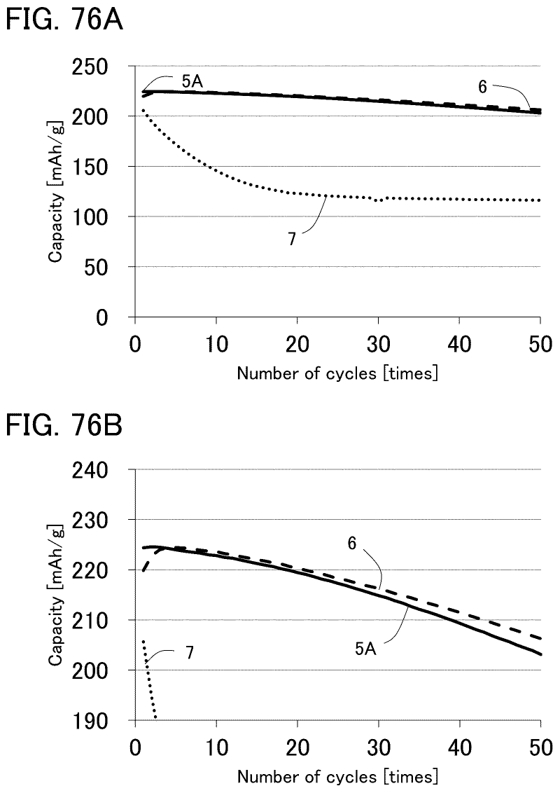

FIG. 74A is a graph showing discharge capacity and the number of cycles of the half cell including Sample 1A (solid line), the half cell including Sample 1B (dashed line), and the half cell sample including Sample 1C (dotted line). FIG. 75A is a graph showing discharge capacity and the number of cycles of the half cell including Sample 2A (solid line), the half cell including Sample 3 (dashed line), and the half cell sample including Sample 4 (dotted line). FIG. 76A is a graph showing discharge capacity and the number of cycles of the half cell including Sample 5A (solid line), the half cell including Sample 6 (dashed line), and the half cell sample including Sample 7 (dotted line).

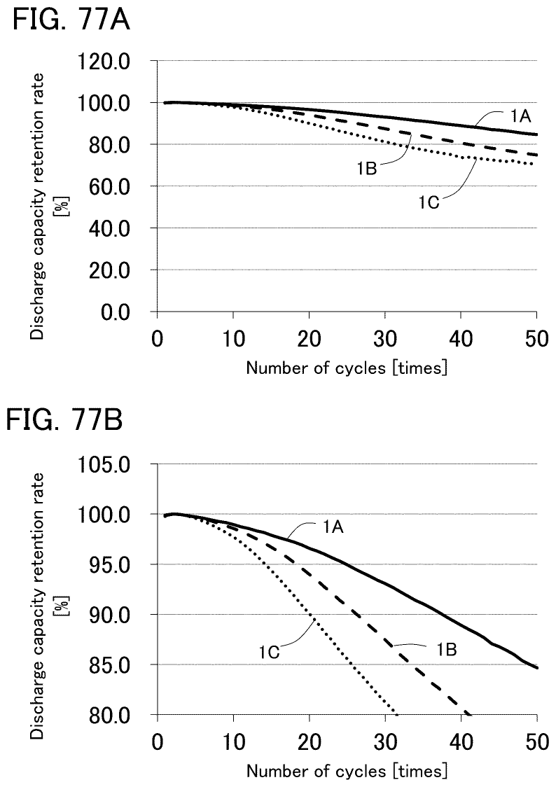

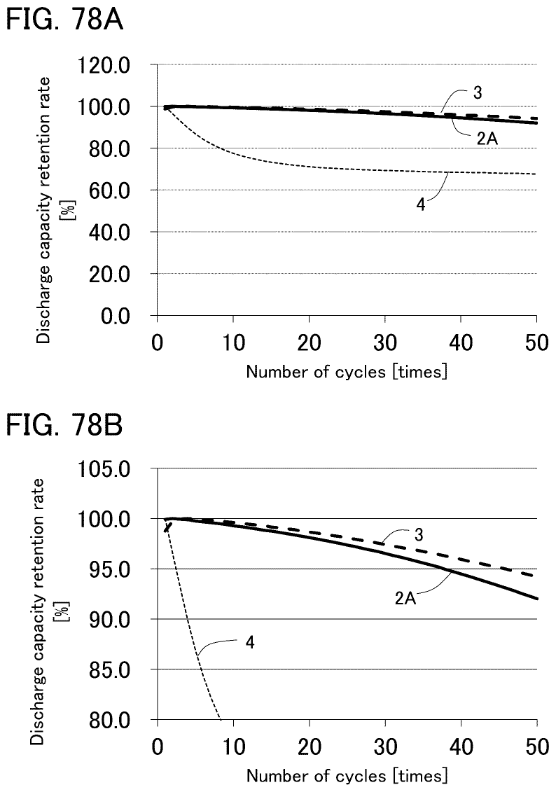

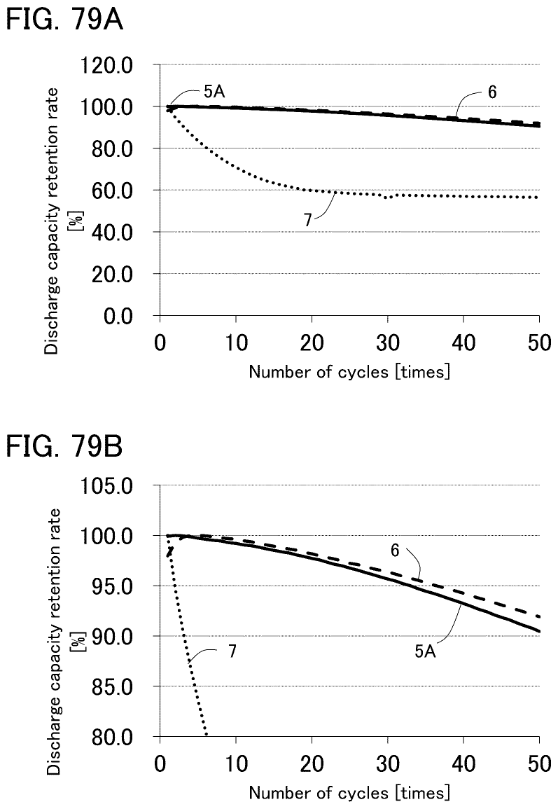

FIG. 74B, FIG. 75B, and FIG. 76B are graphs obtained by enlarging the vertical axes of FIG. 74A, FIG. 75A, and FIG. 76A, respectively. FIG. 77A, FIG. 77B, FIG. 78A, FIG. 78B, FIG. 79A, and FIG. 79B are graphs showing the discharge capacity in FIG. 74A, FIG. 74B, FIG. 75A, FIG. 75B, FIG. 76A, and FIG. 76B as discharge capacity retention rates, respectively. Note that the discharge capacity retention rate was calculated on the assumption that the discharge capacity value in the discharging that achieved the maximum discharge capacity in the charge/discharge cycling test was 100%.

Table 22 shows the measurement results. In Table 22, the first column from the left shows the sample name, the second column shows the discharge capacity in the first cycle under the 25 °C condition, the third column shows the discharge capacity in the first cycle under the 45 °C condition, the fourth column shows the maximum discharge capacity under the 25 °C condition, the fifth column shows the maximum discharge capacity under the 45 °C condition, the sixth column shows the discharge capacity in the 50th cycle under the 25 °C condition, the seventh column shows the discharge capacity in the 50th cycle under the 45 °C condition, the eighth column shows the discharge capacity retention rate in the 50th cycle under the 25 °C condition, and the ninth column shows the discharge capacity retention rate in the 50th cycle under the 45 °C condition. Note that the discharge capacity is a value per weight of the positive electrode active material included in each half cell.

TABLE 22

| | Discharge capacity (mAh/g) | | | | | | Discharge capacity | |
|---|---|---|---|---|---|---|---|---|
| | 1st cycle | | Maximum | | 50th cycle | | retention rate (%) | |
| | 25 °C | 45 °C | 25 °C | 45 °C | 25 °C | 45 °C | 25 °C | 45 °C |
| Sample 1A | 223.2 | 228.1 | 223.7 | 228.5 | 215.8 | 193.5 | 96.4 | 84.7 |
| Sample 1B | 223.0 | 228.2 | 223.2 | 228.4 | 211.4 | 171.1 | 94.7 | 74.9 |
| Sample 1C | 221.1 | 226.4 | 221.5 | 226.9 | 193.1 | 159.9 | 87.2 | 70.5 |
| Sample 2A | 220.2 | 225.8 | 220.8 | 226.0 | 217.1 | 207.9 | 98.3 | 92.0 |
| Sample 3 | 211.6 | 222.7 | 215.4 | 225.6 | 212.7 | 212.5 | 98.7 | 94.2 |
| Sample 4 | 234.1 | 234.9 | 234.1 | 234.9 | 118.5 | 158.9 | 50.6 | 67.6 |
| Sample 5A | 216.9 | 224.4 | 218.0 | 224.6 | 213.7 | 203.1 | 98.0 | 90.4 |
| Sample 6 | 205.1 | 219.8 | 215.0 | 224.4 | 211.3 | 206.3 | 98.3 | 91.9 |
| Sample 7 | 214.0 | 205.6 | 214.0 | 205.6 | 93.5 | 116.2 | 43.7 | 56.5 |

From the above, it was confirmed that Sample 1A, Sample 1B, Sample 1C, Sample 2A, Sample 3, Sample 5A, and Sample 6 containing magnesium, nickel, and aluminum as the additive elements each achieve favorable cycling performance with a discharge capacity retention rate higher than or equal to 85% under the conditions where the temperature is 25 °C and the charge upper limit voltage is 4.60 V.

It was also confirmed that among these, Sample 2A, Sample 3, Sample 5A, and Sample 6 each achieve particularly favorable cycling performance with a discharge capacity retention rate higher than or equal to 90% under the conditions where the temperature is 45 °C and the charge upper limit voltage is 4.60 V.

Among Sample 1A, Sample 1B, Sample 1C, Sample 2A, Sample 3, Sample 5A, and Sample 6, which achieve favorable cycling performance, Sample 1B, Sample 2A, and Sample 5A achieve a discharge capacity that is greater than or equal 80% of the discharge capacity at 25 °C even at −40 °C and also achieve favorable low-temperature characteristics. It is presumable that by containing magnesium, titanium, nickel, and aluminum as the additive elements, Sample 1B, Sample 2A, and Sample 5A achieve both the favorable cycling performance and the favorable low-temperature characteristics described above.

Specifically, Sample 2A and Sample 5A each achieve particularly excellent cycling performance under the conditions where the temperature is 45 °C and the charge upper limit voltage is 4.60 V and also achieve favorable low-temperature characteristics. The main differences in the formation conditions between these samples are the addition amount of magnesium and the addition amount of titanium. Thus, it is presumable that in Sample 2A and Sample 5A, the location and addition amount of titanium and the location and addition amount of magnesium are such that deterioration in high-voltage charging and discharging is reduced and lithium ions are easily inserted and extracted, which is a desirable state.

From another viewpoint, the capacity difference between the discharge capacity in the first cycle and the maximum discharge capacity is compared under the conditions where the temperature is 25 °C and the charge upper limit voltage is 4.60 V. In Sample 3 and Sample 6 containing magnesium, nickel, and aluminum as the additive elements and not containing titanium, the difference between the discharge capacity in the first cycle and the maximum discharge capacity is large; the difference is approximately 4 mAh/g in Sample 3 and approximately 10 mAh/g in Sample 6. Meanwhile, in Sample 1A, Sample 1B, Sample 1C, Sample 2A, and Sample 5A containing magnesium, nickel, aluminum, and titanium as the additive elements, the difference between the discharge capacity in the first cycle and the maximum discharge capacity is small; the difference is 0.5 mAh/g in Sample 1A, 0.2 mAh/g in Sample 1B, 0.4 mAh/g in Sample 1C, 0.6 mAh/g in Sample 2A, and 1.1 mAh/g in Sample 5A.

Considered from the above-described tendency of the capacity difference, it is presumably suggested that formation of a favorable path of lithium ions in the surface portion of the positive electrode active material particle of each of Sample 3 and Sample 6 containing magnesium, nickel, and aluminum as the additive elements and not containing titanium may occur after several cycles of charging and discharging, and that formation of a favorable path of lithium ions in the surface portion of the positive electrode active material particle of Sample 1A, Sample 1B, Sample 1C, Sample 2A, and Sample 5A containing magnesium, nickel, aluminum, and titanium as the additive elements may occur at the time of forming the positive electrode active material.

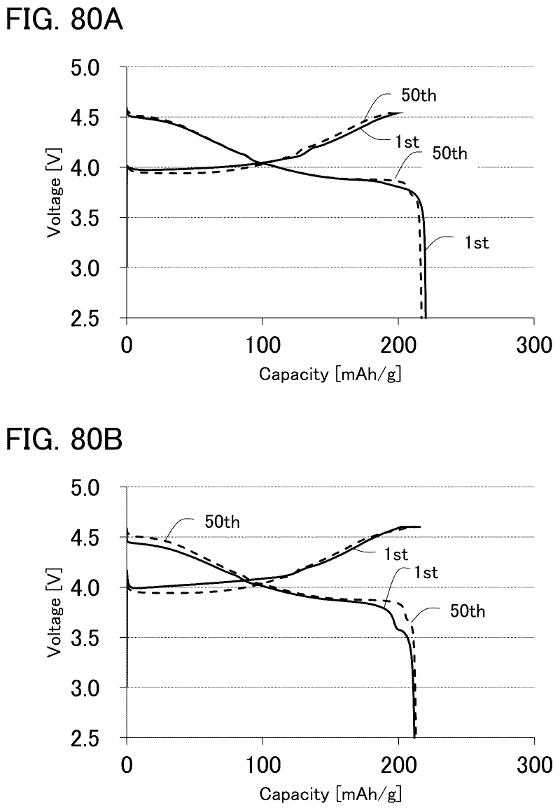

FIG. 80A is a graph showing the charge curve in the first cycle, the discharge curve in the first cycle, the charge curve in the 50th cycle, and the discharge curve in the 50th cycle of the half cell including Sample 2A and shown in FIG. 69A in the charge/discharge cycling test under the conditions where the temperature is 25 °C and the charge upper limit voltage is 4.60 V. FIG. 80B is a graph showing the charge curve in the first cycle, the discharge curve in the first cycle, the charge curve in the 50th cycle, and the discharge curve in the 50th cycle of the half cell including Sample 3 and shown in FIG. 69A in the charge/discharge cycling test under the conditions where the temperature is 25 °C and the charge upper limit voltage is 4.60 V. Comparison between FIG. 80A and FIG. 80B shows that the difference between the charge curve in the first cycle and the charge curve in the 50th cycle and the difference between the discharge curve in the first cycle and the discharge curve in the 50th cycle are smaller in Sample 2A containing magnesium, nickel, aluminum, and titanium as the additive elements than in Sample 3 containing magnesium, nickel, and aluminum as the additive elements and not containing titanium.

### <XRD Analysis in High-Voltage Charged State>

An experiment for examining the crystal structures of Sample 2A and Sample 5A in a high-voltage charged state was conducted.

First, charging, discharging, disassembly of a half cell, and XRD measurement were performed on a half cell including Sample 2A and a half cell including Sample 5A. In the charging, constant current charging at 0.2 C was performed to 4.50 V and then, constant voltage charging was performed until the current value reached 0.05 C. As the discharging, constant current discharging at 0.2 C was performed to 3.0 V. Note that as in the other tests, 1 C was set to 200 mA/g.

Next, charging before the XRD analysis in a high-voltage charged state was performed. In the charging, constant current charging at 0.2 C was performed to 4.60 V and then, constant voltage charging was performed until the current value reached 0.02 C.

After that, the half cell was disassembled within one hour after the above charging was terminated. In order that a positive electrode can be taken out while being kept in a high-voltage charged state, the disassembly was performed carefully using an insulating tool so as not to cause a short circuit. Note that for the disassembly, an argon-filled glove box in which the dew point and the oxygen concentration were controlled was used. Note that the dew point of the glove box is preferably lower than or equal to −70 °C, and the oxygen concentration is preferably lower than or equal to 5 ppm. Since the crystal structure of the positive electrode active material might change due to self-discharging after a long time elapses from the above charging, disassembly and analysis are preferably performed as early as possible.

The above positive electrode obtained by disassembling the half cell was set on an XRD measurement stage that can be hermetically sealed in the glove box, whereby the positive electrode on the XRD measurement stage hermetically sealed together with argon was obtained.

After that, the XRD measurement was started within 15 minutes. The XRD apparatus and conditions are as follows.
XRD apparatus: D8 ADVANCE produced by Bruker AXS
X-ray: CuKα₁ radiation
Output: 40 kV, 40 mA
Angle of divergence:Div. Slit, 0.5°
Detector: LynxEye
Scanning method: 2θ/θ continuous scan
Measurement range (2θ): from 15° to 75°
Step width (2θ): 0.01°
Counting time: one second/step
Rotation of sample stage: 15 rpm

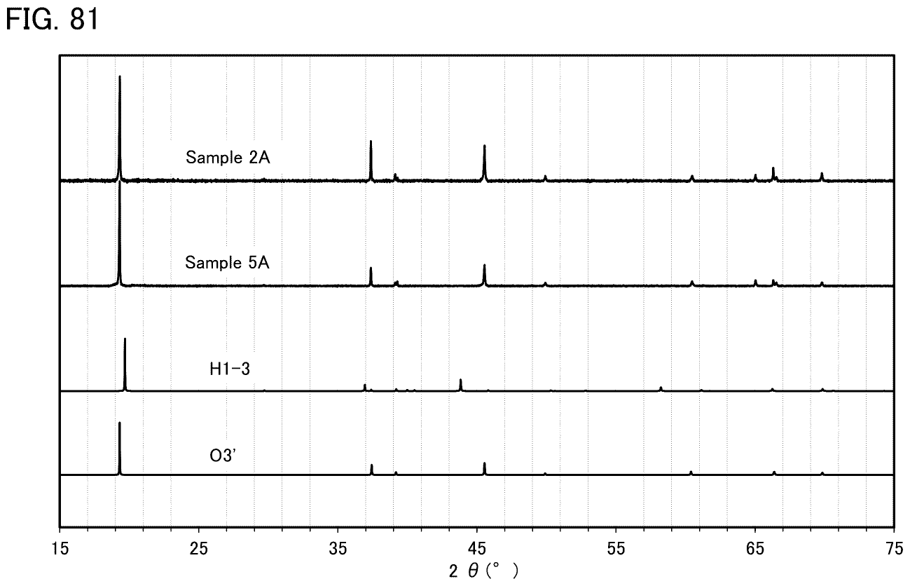

FIG. 81 shows the data of the above XRD measurement of the positive electrodes (Sample 2A and Sample 5A) in a high-voltage charged state. In FIG. 81, a reference pattern of the O3′ structure (O3′) and a reference pattern of the H1-3 structure (H1-3) are also shown.

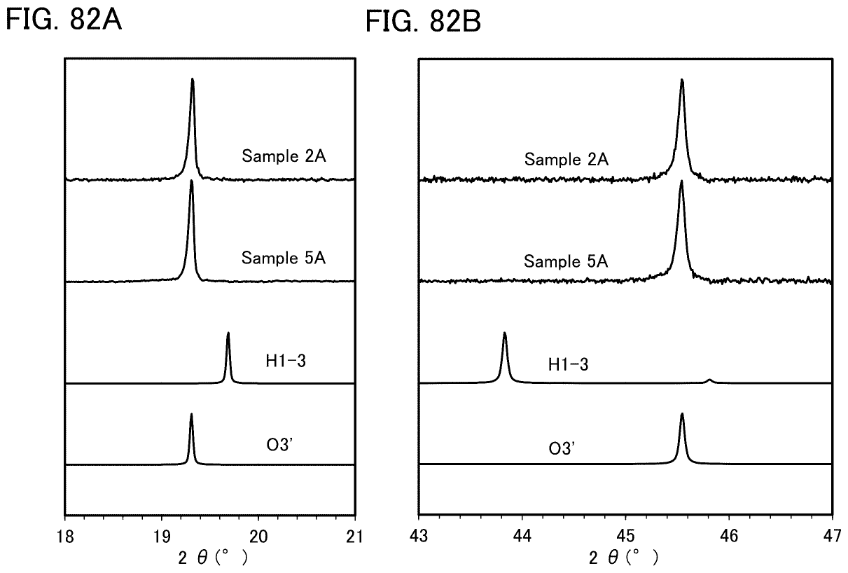

FIG. 82A shows the 20 range of 18° to 21° in the XRD measurement. FIG. 82B shows the 20 range of 43° to 47°. Table 23 shows typical peak positions extracted from the XRD measurement data of Sample 2A and Sample 5A and the reference pattern of the O3′ structure shown in FIG. 81.

TABLE 23

| Peak No. | Sample 2A | Sample 5A | O3′ |
|---|---|---|---|
| 1 | 19.316° | 19.306° | 19.310° |
| 2 | 37.373° | 37.373° | 37.430° |
| 3 | 39.131° | 39.285° | 39.170° |
| 4 | 45.544° | 45.544° | 45.550° |
| 5 | 49.912° | 49.922° | 49.900° |
| 6 | 60.487° | 60.466° | 60.390° |
| 7 | 66.304° | 66.314° | 66.370° |
| 8 | 69.798° | 69.798° | 69.840° |

As shown in FIG. 82A, FIG. 82B, and Table 23, Sample 2A and Sample 5A in a high-voltage charged state substantially match the reference pattern of the O3′ structure (O3′). In other words, Sample 2A and Sample 5A in a high-voltage charged state can be regarded as the O3′ structure.

### REFERENCE NUMERALS

100: positive electrode active material, 100a: surface portion, 100b: inner portion, 104: coating portion, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 901: mixture, 902: composite oxide, 903: mixture, 904: composite oxide, 905: mixture, 913: secondary battery, 4000: glasses-type device, 4000a: frame, 4000b: display portion, 4001: headset-type device, 4001a: microphone portion, 4001b: flexible pipe, 4001c: earphone portion, 4002: device, 4002a: housing, 4002b: secondary battery, 4003: device, 4003a: housing, 4003b: secondary battery, 4005: watch-type device, 4005a: display portion, 4005b: belt portion, 4006: belt-type device, 4006a: belt portion, 4006b: wireless power feeding and receiving portion, 4100a: main body, 4100b: main body, 4101: driver unit, 4102: antenna, 4103: secondary battery, 4104: display portion, 4110: case, 4111: secondary battery, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 6500: flying object, 6501: propeller, 6502: camera, 6503: secondary battery, 6504: electronic component, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 8021: charging apparatus, 8022: cable, 8024: secondary battery, 8400: automobile, 8401: headlight, 8406: electric motor, 8500: automobile, 8600: motor scooter, 8601: side mirror, 8602: secondary battery, 8603: direction indicator, 8604: under-seat storage

1. A battery comprising;
a positive electrode,
wherein the positive electrode comprises lithium cobalt oxide,
wherein a surface portion of the lithium cobalt oxide comprises magnesium, titanium, aluminum, and nickel,
wherein the surface portion is a region at less than or equal to 50 nm from a surface of the lithium cobalt oxide, and
wherein when the surface portion is subjected to STEM-EDX line analysis in a depth direction, a peak of the magnesium is closer to the surface of the lithium cobalt oxide than a peak of the aluminum.

2. The battery according to claim 1,
wherein the lithium cobalt oxide has a layered rock-salt crystal structure belonging to a space group R-3m,
wherein the surface portion comprises a basal region having a surface parallel to a (001) plane of the crystal structure and an edge region having a surface in a direction intersecting with the (001) plane,
wherein the edge region comprises the titanium, and
wherein when the surface portion is subjected to the STEM-EDX line analysis in the depth direction, the edge region comprises a region in which a distribution of the magnesium and a distribution of the titanium overlap with each other.

3. The battery according to claim 2,
wherein the edge region comprises the nickel, and
wherein when the surface portion is subjected to the STEM-EDX line analysis in the depth direction, the edge region comprises a region in which the distribution of the titanium and a distribution of the nickel overlap with each other.

4. The battery according to claim 1,
wherein the lithium cobalt oxide has a layered rock-salt crystal structure belonging to a space group R-3m,
wherein the surface portion comprises a basal region having a surface parallel to a (001) plane of the crystal structure and an edge region having a surface in a direction intersecting with the (001) plane,
wherein the edge region comprises the titanium, and
wherein when the surface portion is subjected to the STEM-EDX line analysis in the depth direction, the edge region comprises a region in which a difference between a depth of a peak of a detection amount of the magnesium and a depth of a peak of a detection amount of the titanium is less than or equal to 3 nm.

5. The battery according to claim 4,
wherein the edge region comprises the nickel, and
wherein when the surface portion is subjected to the STEM-EDX line analysis in the depth direction, the edge region comprises a region in which a difference between the depth of the peak of the detection amount of the titanium and a depth of a peak of a detection amount of the nickel is less than or equal to 3 nm.

6. The battery according to claim 2,
wherein an angle between a line normal to the surface of the edge region and a line perpendicular to the (001) plane is greater than or equal to 500 and less than or equal to 90°.

7. The battery according to claim 1,
wherein volume resistivity of powder of the lithium cobalt oxide is higher than or equal to 1.0×10⁸ Ω·cm and lower than or equal to 1.0×10¹⁰ Ω·cm under a pressure of 64 MPa.

8. The battery according to claim 1,
wherein when the lithium cobalt oxide is subjected to particle size distribution analysis using a cross-sectional SEM image of the positive electrode comprising the lithium cobalt oxide, as a particle diameter of the lithium cobalt oxide, D50 is greater than or equal to 1.98 μm and less than or equal to 2.26 μm and D90 is greater than or equal to 4.37 μm and less than or equal to 5.51 μm.

9. The battery according to claim 1, the battery further comprising;
an electrolyte,
wherein the electrolyte comprises lithium hexafluorophosphate, ethylene carbonate, ethyl methyl carbonate, and dimethyl carbonate,
wherein when a volume ratio between the ethylene carbonate, the ethyl methyl carbonate, and the dimethyl carbonate is x:y:100-x-y with volumes of contents of the ethylene carbonate, the ethyl methyl carbonate, and the dimethyl carbonate being 100 vol %, discharge capacity at −20 °C is greater than or equal to 95.0% of discharge capacity at 25 °C,
wherein 5≤x≤35, and
wherein 0<y<65.

10. The battery according to claim 1,
wherein when the battery charged until an open circuit voltage reaches higher than or equal to 4.50 V and lower than or equal to 4.60 V is subjected to discharging at a current of 6 mA/g per weight of the lithium cobalt oxide for one second, resistance DCIR obtained by dividing a difference between the open circuit voltage and a voltage during the discharging by the current is lower than or equal to 35 Ω.

11. A battery comprising:
a positive electrode,
wherein the positive electrode comprises lithium cobalt oxide,
wherein a surface portion of the lithium cobalt oxide comprises magnesium, titanium, aluminum, and nickel,
wherein the surface portion is a region at less than or equal to 50 nm from a surface of the lithium cobalt oxide,
wherein when the surface portion is subjected to STEM-EDX line analysis in a depth direction, a peak of the magnesium is closer to the surface of the lithium cobalt oxide than a peak of the aluminum, and
wherein when a test battery formed using the lithium cobalt oxide for a positive electrode, a lithium metal for a negative electrode, and an electrolyte solution in which 1 mol/L lithium hexafluorophosphate (LiPF₆) is a lithium salt and ethylene carbonate (EC) and diethyl carbonate (DEC) at a volume ratio of EC:DEC=3:7 and 2 wt % vinylene carbonate (VC) are mixed is subjected to constant current charging at a current value of 100 mA/g to a voltage of 4.60 V, subsequent constant voltage charging to a current value of 10 mA/g, and subsequent discharging at a current of 6 mA/g for one second in a 45 °C environment, resistance DCIR obtained by dividing a difference between a voltage before the discharging and a voltage during the discharging by the current is lower than or equal to 35 Ω.

12. A positive electrode active material comprising:
lithium cobalt oxide,
wherein the positive electrode active material comprises magnesium, nickel, titanium, and aluminum,
wherein when STEM-EDX line analysis in a depth direction is performed from a surface of a particle of the positive electrode active material, the particle comprises a region in which a position at which a concentration of the aluminum becomes maximum is closer to an inner portion than a position at which a concentration of the magnesium becomes maximum, a position at which a concentration of the nickel becomes maximum, and a position at which a concentration of the titanium becomes maximum,
wherein in the region, the position at which the concentration of the nickel becomes maximum and the position at which the concentration of the titanium becomes maximum are positioned at less than or equal to 3 nm from the position at which the concentration of the magnesium becomes maximum, and
wherein when the particle is subjected to EPMA analysis, in the inner portion of the particle, a ratio of the number of atoms of the magnesium to the number of atoms of cobalt is greater than or equal to 0.003 and less than or equal to 0.01, and a ratio of the number of atoms of the nickel to the number of the atoms of the cobalt is greater than or equal to 0.003 and less than or equal to 0.01.

13. The positive electrode active material according to claim 12,
wherein the lithium cobalt oxide has a layered rock-salt crystal structure belonging to a space group R-3m,
wherein the particle comprises a surface portion and the inner portion,
wherein the surface portion comprises a basal region having a surface parallel to a (001) plane of the crystal structure and an edge region having a surface in a direction intersecting with the (001) plane, and
wherein the region is included in the edge region.

14. The positive electrode active material according to claim 12,
wherein when the positive electrode active material is subjected to XPS analysis, the ratio of the number of the atoms of the magnesium to the number of the atoms of the cobalt is greater than or equal to 0.40 and less than or equal to 1.50, a ratio of the number of atoms of the titanium to the number of the atoms of the cobalt is greater than or equal to 0.05 and less than or equal to 0.20, and the ratio of the number of the atoms of the nickel to the number of the atoms of the cobalt is greater than or equal to 0.05 and less than or equal to 0.20.

15. A battery comprising:
a positive electrode,
wherein the positive electrode comprises a positive electrode active material layer,
wherein the positive electrode active material layer comprises a positive electrode active material particle comprising magnesium, titanium, nickel, aluminum, and lithium cobalt oxide,
wherein when STEM-EDX line analysis in a depth direction is performed from a surface of the positive electrode active material particle included in the positive electrode active material layer, the positive electrode active material particle comprises a region in which a position at which a concentration of the aluminum becomes maximum is closer to an inner portion of the positive electrode active material particle than a position at which a concentration of the magnesium becomes maximum, a position at which a concentration of the nickel becomes maximum, and a position at which a concentration of the titanium becomes maximum,
wherein in the region, the position at which the concentration of the nickel becomes maximum and the position at which the concentration of the titanium becomes maximum are positioned at less than or equal to 3 nm from the position at which the concentration of the magnesium becomes maximum, and
wherein when the positive electrode active material particle is subjected to EPMA analysis, in the inner portion of the positive electrode active material particle, a ratio of the number of atoms of the magnesium to the number of atoms of cobalt is greater than or equal to 0.003 and less than or equal to 0.01, and a ratio of the number of atoms of the nickel to the number of the atoms of the cobalt is greater than or equal to 0.003 and less than or equal to 0.01.

16. The battery according to claim 15,
wherein the lithium cobalt oxide has a layered rock-salt crystal structure belonging to a space group R-3m,
wherein the positive electrode active material particle comprises a surface portion and the inner portion,
wherein the surface portion comprises a basal region having a surface parallel to a (001) plane of the crystal structure and an edge region having a surface in a direction intersecting with the (001) plane, and
wherein the region is included in the edge region.

17. The battery according to claim 15,
wherein when a plurality of the positive electrode active material particles included in the positive electrode active material layer are subjected to XPS analysis, the ratio of the number of the atoms of the magnesium to the number of the atoms of the cobalt is greater than or equal to 0.40 and less than or equal to 1.50, a ratio of the number of atoms of the titanium to the number of the atoms of the cobalt is greater than or equal to 0.05 and less than or equal to 0.20, and the ratio of the number of the atoms of the nickel to the number of the atoms of the cobalt is greater than or equal to 0.05 and less than or equal to 0.20.
